(19) United States
(12) Patent Application Publication
(10) Pub. No.: US 2024/0330056 A1
(43) Pub. Date: Oct. 3, 2024

(54) ASYNCHRONOUS MEMORY ALLOCATION

(71) Applicant: NVIDIA Corporation, Santa Clara, CA (US)

(72) Inventors: Vivek Belve Kini, San Jose, CA (US); Steven Arthur Gurfinkel, San Francisco, CA (US); Fnu Vishnuswaroop Ramesh, Sunnyvale, CA (US); Houston Thompson Hoffman, San Jose, CA (US); Michael Christopher Delorme, San Jose, CA (US); Alicia Xiao Hu, Santa Clara, CA (US); Stephen Anthony Bernard Jones, San Francisco, CA (US); Vladislav Zhurba, San Jose, CA (US); William Young Fiser, San Jose, CA (US); Reza Mokhtari, Toronto (CA)

(21) Appl. No.: 18/742,964

(22) Filed: Jun. 13, 2024

Related U.S. Application Data
(63) Continuation of application No. 17/546,643, filed on Dec. 9, 2021.

(51) Int. Cl. G06F 9/50; G06F 9/38

(52) U.S. Cl. CPC G06F 9/5016; G06F 9/3885; G06F 9/5022; G06F 9/5044; G06F 2209/5011

(57) ABSTRACT

Apparatuses, systems, and techniques to allocate processor memory. In at least one embodiment, an application programming interface is used to execute instructions to asynchronously allocate memory locations to processors.

### CROSS-REFERENCE TO RELATED APPLICATIONS

The present application is a continuation of U.S. patent application Ser. No. 17/546,643, entitled “ASYNCHRONOUS MEMORY ALLOCATION” and filed on Dec. 9, 2021, which incorporates by reference for all purposes the full disclosure of U.S. patent application Ser. No. 17/546,979, entitled “ASYNCHRONOUS MEMORY DEALLOCATION” and filed on Dec. 9, 2021. The present application hereby incorporates by reference for all purposes the full disclosures of both U.S. patent application Ser. No. 17/546,643 and U.S. patent application Ser. No. 17/546,979.

### FIELD

At least one embodiment pertains to processing resources used to execute one or more CUDA programs. For example, at least one embodiment pertains to processors or computing systems used to execute one or more CUDA programs that implement asynchronous allocation and deallocation of memory.

### BACKGROUND

Stream-ordered computational operations have memory provided by an operating system. Providing memory for stream-ordered computational operations synchronously can introduce significant delays, reducing system performance and can cause memory fragmentation, increasing memory usage. An amount of memory, time, and computing resources used to perform stream-ordered and other computational operations can be improved.

### BRIEF DESCRIPTION OF THE DRAWINGS

FIG. 1 illustrates an example computer system where memory is asynchronously allocated, in accordance with at least one embodiment;

FIG. 2 illustrates an example computer system where memory is asynchronously allocated from a memory pool, in accordance with at least one embodiment;

FIG. 3 illustrates an example computer system where memory for a stream-ordered execution thread is asynchronously allocated from a memory pool, in accordance with at least one embodiment;

FIG. 4 illustrates an example computer system where memory for a stream-ordered execution thread is asynchronously deallocated and returned to a memory pool, in accordance with at least one embodiment;

FIG. 5 illustrates an example process for performing operations to asynchronously allocate memory, in accordance with at least one embodiment;

FIG. 6 illustrates an example process for performing operations to asynchronously allocate memory, in accordance with at least one embodiment;

FIG. 7 illustrates an example process for performing memory management operations to asynchronously deallocate memory, in accordance with at least one embodiment;

FIG. 8 illustrates an example data flow where memory is allocated synchronously, in accordance with at least one embodiment;

FIG. 9 illustrates an example first part of a data flow where memory is asynchronously allocated and deallocated, in accordance with at least one embodiment;

FIG. 10 illustrates an example second part of a data flow where memory is asynchronously allocated and deallocated, in accordance with at least one embodiment;

FIG. 11 illustrates an example third part of a data flow where memory is asynchronously allocated and deallocated, in accordance with at least one embodiment;

FIG. 12 illustrates an example fourth part of a data flow where memory is asynchronously allocated and deallocated, in accordance with at least one embodiment;

FIG. 13 illustrates an example process for performing memory management operations to asynchronously allocate memory using a memory pool, in accordance with at least one embodiment;

FIG. 14 illustrates an example computer system where memory management operations to asynchronously allocate memory using a memory pool for a single execution stream are performed, in accordance with at least one embodiment;

FIG. 15 illustrates an example computer system where memory management operations to asynchronously allocate memory using a memory pool for a plurality of execution streams are performed, in accordance with at least one embodiment;

FIG. 16 illustrates an example process for performing memory management operations to reuse asynchronously allocated memory from a memory pool, in accordance with at least one embodiment;

FIG. 17 illustrates an example computer system where memory management operations to reuse asynchronously allocated memory from a memory pool for a plurality of synchronized execution streams are performed, in accordance with at least one embodiment;

FIG. 18 illustrates an example process for performing memory management operations to reuse asynchronously allocated memory from a memory pool for a plurality of synchronized execution streams, in accordance with at least one embodiment;

FIG. 19 illustrates an exemplary data center, in accordance with at least one embodiment;

FIG. 20 illustrates a processing system, in accordance with at least one embodiment;

FIG. 21 illustrates a computer system, in accordance with at least one embodiment;

FIG. 22 illustrates a system, in accordance with at least one embodiment;

FIG. 23 illustrates an exemplary integrated circuit, in accordance with at least one embodiment;

FIG. 24 illustrates a computing system, according to at least one embodiment;

FIG. 25 illustrates an APU, in accordance with at least one embodiment;

FIG. 26 illustrates a CPU, in accordance with at least one embodiment;

FIG. 27 illustrates an exemplary accelerator integration slice, in accordance with at least one embodiment;

FIGS. 28A and 28B illustrate exemplary graphics processors, in accordance with at least one embodiment;

FIG. 29A illustrates a graphics core, in accordance with at least one embodiment;

FIG. 29B illustrates a GPGPU, in accordance with at least one embodiment;

FIG. 30A illustrates a parallel processor, in accordance with at least one embodiment;

FIG. 30B illustrates a processing cluster, in accordance with at least one embodiment;

FIG. 30C illustrates a graphics multiprocessor, in accordance with at least one embodiment;

FIG. 31 illustrates a graphics processor, in accordance with at least one embodiment;

FIG. 32 illustrates a processor, in accordance with at least one embodiment;

FIG. 33 illustrates a processor, in accordance with at least one embodiment;

FIG. 34 illustrates a graphics processor core, in accordance with at least one embodiment;

FIG. 35 illustrates a PPU, in accordance with at least one embodiment;

FIG. 36 illustrates a GPC, in accordance with at least one embodiment;

FIG. 37 illustrates a streaming multiprocessor, in accordance with at least one embodiment;

FIG. 38 illustrates a software stack of a programming platform, in accordance with at least one embodiment;

FIG. 39 illustrates a CUDA implementation of a software stack of FIG. 38, in accordance with at least one embodiment;

FIG. 40 illustrates a ROCm implementation of a software stack of FIG. 38, in accordance with at least one embodiment;

FIG. 41 illustrates an OpenCL implementation of a software stack of FIG. 38, in accordance with at least one embodiment;

FIG. 42 illustrates software that is supported by a programming platform, in accordance with at least one embodiment;

FIG. 43 illustrates compiling code to execute on programming platforms of FIGS. 38-41, in accordance with at least one embodiment;

FIG. 44 illustrates in greater detail compiling code to execute on programming platforms of FIGS. 38-41, in accordance with at least one embodiment;

FIG. 45 illustrates translating source code prior to compiling source code, in accordance with at least one embodiment;

FIG. 46A illustrates a system configured to compile and execute CUDA source code using different types of processing units, in accordance with at least one embodiment;

FIG. 46B illustrates a system configured to compile and execute CUDA source code of FIG. 46A using a CPU and a CUDA-enabled GPU, in accordance with at least one embodiment;

FIG. 46C illustrates a system configured to compile and execute CUDA source code of FIG. 46A using a CPU and a non-CUDA-enabled GPU, in accordance with at least one embodiment;

FIG. 47 illustrates an exemplary kernel translated by CUDA-to-HIP translation tool of FIG. 46C, in accordance with at least one embodiment;

FIG. 48 illustrates non-CUDA-enabled GPU of FIG. 46C in greater detail, in accordance with at least one embodiment;

FIG. 49 illustrates how threads of an exemplary CUDA grid are mapped to different compute units of FIG. 48, in accordance with at least one embodiment; and

FIG. 50 illustrates how to migrate existing CUDA code to Data Parallel C++ code, in accordance with at least one embodiment.

### DETAILED DESCRIPTION

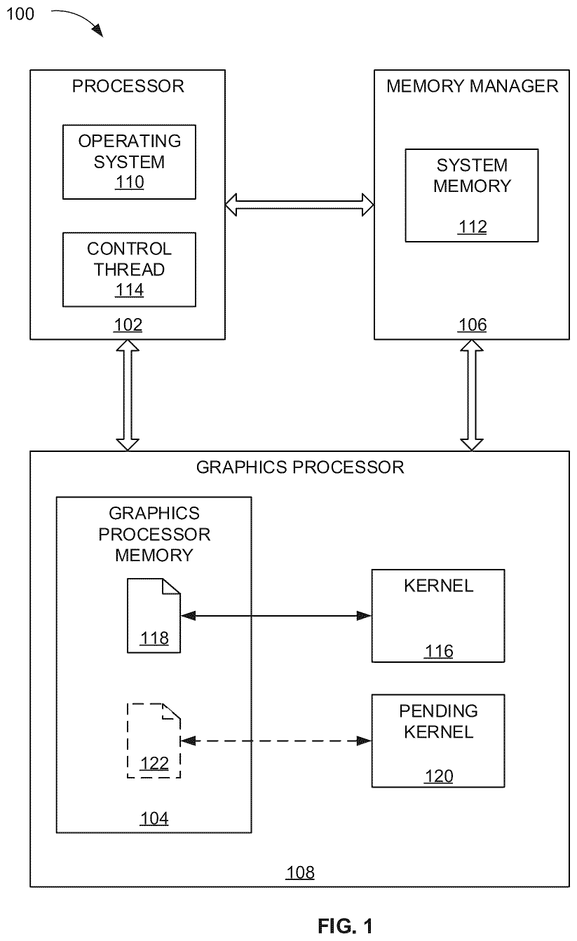

FIG. 1 illustrates an example computer system 100 where memory is asynchronously allocated, in accordance with at least one embodiment. In at least one embodiment, a processor 102 may be connected to a graphics processor 108. In at least one embodiment, processor 102 is a single-core processor. In at least one embodiment, processor 102 is a multi-core processor. In at least one embodiment, one or more additional processors, not shown, are connected to processor 102. In at least one embodiment, processor 102 is an element of a processing system such as processing system 2000 described herein. In at least one embodiment, processor 102 is an element of a computer system such as computer system 2100 described herein. In at least one embodiment, processor 102 is an element of a system such as system 2200 described herein. In at least one embodiment, processor 102 is an element of a computing system such as computing system 2400 described herein. In at least one embodiment, processor 102 is an element of a compute unit such as compute unit 4840 described herein.

In at least one embodiment, system memory 112 is memory of computer system 100 that may be instantiated and/or stored on a computer system, such as computer system 100, using systems and methods such as those described herein. In at least one embodiment, computer system 100 includes functionality to create a virtual address for system memory 112 that is asynchronously allocated memory that may be asynchronously allocated and/or deallocated using systems and methods such as those described herein. In at least one embodiment, computer system 100 uses a memory manager 106 to manage system memory 112. In at least one embodiment, computer system 100 includes functionality to associate a virtual address with memory that may be provided to graphics processor memory 104 for use by graphics processor 108.

In at least one embodiment, memory is allocated asynchronously by providing a virtual memory pointer to a calling process. In at least one embodiment, a virtual memory pointer is provided to a calling process when a calling process requests asynchronously allocated memory using systems and methods such as those described herein. In at least one embodiment, backing memory associated with a virtual memory pointer is provided at a later time such as, before a kernel is executed, using systems and methods such as those described herein. In at least one embodiment, memory that is allocated asynchronously is deallocated asynchronously, for example, after kernel execution completes, using systems and methods such as those described herein. In at least one embodiment, memory that is allocated asynchronously is deallocated asynchronously by returning memory to a memory pool and freeing a virtual memory pointer associated with deallocated memory using systems and methods such as those described herein.

In at least one embodiment, processor 102 comprises one or more circuits to perform an application programming interface (“API”) to cause one or more memory locations to be asynchronously allocated to one or more processors. In at least one embodiment, processor 102 comprises one or more circuits to perform an application programming interface (“API”) to cause one or more memory locations to be asynchronously allocated to one or more processes executing on one or more processors, such as those described here. In at least one embodiment, processor 102 has included thereon instructions that, when executed, perform an API to cause a virtual memory address to be associated with asynchronously allocated memory locations. In at least one embodiment, processor 102 has included thereon instructions that, when executed, perform an API to cause physical memory to be allocated and associated with a virtual memory address. In at least one embodiment, instructions for processor 102 that, when executed, cause one or more memory locations to be asynchronously allocated to one or more processors, are stored in processor memory (not shown in FIG. 1) associated with processor 102. In at least one embodiment, instructions for processor 102 that, when executed, cause one or more memory locations to be asynchronously allocated to one or more processors, are stored in system memory 112. In at least one embodiment, an API to asynchronously allocate memory is a driver API. In at least one embodiment, an API to asynchronously allocate memory is a runtime API.

In at least one embodiment, processor 102 comprises one or more circuits to perform an application programming interface (“API”) to cause one or more memory locations to be asynchronously deallocated from one or more processors. In at least one embodiment, processor 102 comprises one or more circuits to perform an application programming interface (“API”) to cause one or more memory locations to be asynchronously deallocated from one or more processes executing on one or more processors, such as those described here. In at least one embodiment, processor 102 has included thereon instructions that, when executed, perform an API to cause a virtual memory address to be associated with asynchronously deallocated memory locations. In at least one embodiment, processor 102 has included thereon instructions that, when executed, perform an API to cause physical memory to be deallocated and disassociated with a virtual memory address. In at least one embodiment, instructions for processor 102 that, when executed, cause one or more memory locations to be asynchronously deallocated from one or more processors, are stored in processor memory (not shown in FIG. 1) associated with processor 102. In at least one embodiment, instructions for processor 102 that, when executed, cause one or more memory locations to be asynchronously deallocated from one or more processors, are stored in system memory 112. In at least one embodiment, an API to asynchronously deallocate memory is a driver API. In at least one embodiment, an API to asynchronously deallocate memory is a runtime API.

In at least one embodiment, processor 102 comprises one or more circuits to perform an application programming interface (“API”) to cause one or more memory locations to be asynchronously allocated to one or more processors and to be asynchronously deallocated from one or more processors. In at least one embodiment, processor 102 comprises one or more circuits to perform an application programming interface (“API”) to cause one or more memory locations to be asynchronously allocated to and to be asynchronously deallocated from one or more processes executing on one or more processors, such as those described here. In at least one embodiment, instructions for processor 102 that, when executed, cause one or more memory locations to be asynchronously allocated to one or more processors and to be asynchronously deallocated from one or more processors, are stored in processor memory (not shown in FIG. 1) associated with processor 102. In at least one embodiment, instructions for processor 102 that, when executed, cause one or more memory locations to be asynchronously allocated to one or more processors and to be asynchronously deallocated from one or more processors are stored in system memory 112. In at least one embodiment, an API to asynchronously allocate and to asynchronously deallocate memory is a driver API. In at least one embodiment, an API to asynchronously allocate and to asynchronously deallocate memory is a runtime API.

In at least one embodiment, memory manager 106 executes one or more commands to create, destroy, copy, map, and/or unmap memory. In at least one embodiment, memory manager 106 executes one or more commands to create, destroy, copy, map, and/or unmap system memory 112. In at least one embodiment, memory manager 106 executes one or more commands to create, destroy, copy, map, and/or unmap graphics processor memory 104. In at least one embodiment, memory manager 106 is a software component that executes on processor 102. In at least one embodiment, memory manager 106 is a software component that executes on another processor, not shown in FIG. 1. In at least one embodiment, memory manager 106 is a software component that executes on a processor or processing unit associated with computer system 100.

In at least one embodiment, memory manager 106 receives one or more commands from processor 102 perform operations on memory such as system memory 112 and/or graphics processor memory 104. In at least one embodiment, processor 102 sends API commands to memory manager 106 that cause memory manager 106 perform operations on memory such as system memory 112 and/or graphics processor memory 104. In at least one embodiment, processor 102 executes one or more commands that cause memory manager 106 to perform operations on memory. In at least one embodiment, memory manager 106 receives one or more commands from graphics processor 108 perform operations on memory. In at least one embodiment, graphics processor 108 sends API instructions to memory manager 106 that cause memory manager 106 perform operations on memory. In at least one embodiment, graphics processor 108 executes one or more commands that cause memory manager 106 to perform operations on memory.

In at least one embodiment, one or more memory pages of memory are associated with graphics processor 108 and usable by graphics processor 108. In at least one embodiment, one or more pages of memory are provided by memory manager 106 to a processor such as processor 102 and/or to a graphics processor such as graphics processor 108. In at least one embodiment, a processor such as processor 102 and/or to a graphics processor such as graphics processor 108 uses one or more pages of memory provided by memory manager 106 to store instructions, perform computations, store results of computations, store intermediate results, and/or other such memory operations. In at least one embodiment, graphics processor 108 is a single-core processor. In at least one embodiment, graphics processor 108 is a multi-core processor. In at least one embodiment, one or more additional processors are connected to memory associated with graphics processor 108. In at least one embodiment, graphics processor 108 is an element of a processing system such as processing system 2000 described herein. In at least one embodiment, graphics processor 108 is an element of a computer system such as computer system 2100 described herein. In at least one embodiment, graphics processor 108 is an element of a system such as system 2200 described herein. In at least one embodiment, graphics processor 108 is an element of an integrated circuit such as integrated circuit 2300 described herein. In at least one embodiment, graphics processor 108 is an element of a computing system such as computing system 2400 described herein. In at least one embodiment, graphics processor 108 is a graphics processor such as graphics processor 2810 described herein. In at least one embodiment, graphics processor 108 is a graphics processor such as graphics processor 2840 described herein. In at least one embodiment, graphics processor 108 is a graphics processor such as graphics multiprocessor 3034 described herein. In at least one embodiment, graphics processor 108 is a graphics processor such as graphics processor 3100 described herein. In at least one embodiment, graphics processor 108 is a graphics processor such as graphics processor 3308 described herein. In at least one embodiment, graphics processor 108 is a GPU such as GPU 4692 described herein.

In at least one embodiment, a control thread 114 executing on processor 102 executes one or more commands to dispatch kernels such as, for example, kernel 116 and/or pending kernel 120, to graphics processor 108, as described herein. In at least one embodiment, control thread 114 executes one or more commands to manage kernels, as described herein. In at least one embodiment, control thread 114 executes one or more commands to manage kernels using a stream order (not illustrated in FIG. 1) that indicates an order of operation for dispatching kernels to graphics processor 108.

In at least one embodiment, an operating system 110 executing on processor 102 executes one or more commands to control a computer system such as computer system 100. In at least one embodiment, control thread 114 executes one or more API calls to cause operating system 110 to control a computer system such as computer system 100.

In at least one embodiment, processor 102 performs an API to cause memory manager 106 to cause one or more memory locations to be asynchronously allocated to one or more processors. In at least one embodiment, processor 102 performs an API to cause memory manager 106 to cause one or more memory locations to be asynchronously deallocated from one or more processors.

In at least one embodiment, control thread 114 executing on processor 102 performs an API to cause memory manager 106 to cause one or more memory locations to be asynchronously allocated to one or more processors. In at least one embodiment, control thread 114 executing on processor 102 performs an API to cause memory manager 106 to cause one or more memory locations to be asynchronously deallocated from one or more processors.

In at least one embodiment, operating system 110 executing on processor 102 performs an API to cause memory manager 106 to cause one or more memory locations to be asynchronously allocated to one or more processors. In at least one embodiment, operating system 110 executing on processor 102 performs an API to cause memory manager 106 to cause one or more memory locations to be asynchronously deallocated from one or more processors.

In at least one embodiment, graphics processor memory 104 is used when performing an API to cause one or more memory locations to be asynchronously allocated to one or more processors. In at least one embodiment, graphics processor memory 104 is used when performing an API to cause one or more memory locations to be asynchronously deallocated from one or more processors.

In at least one embodiment, system memory 112 is used when performing an API to cause one or more memory locations to be asynchronously allocated to one or more processors. In at least one embodiment, system memory 112 is used when performing an API to cause one or more memory locations to be asynchronously deallocated from one or more processors.

In at least one embodiment, a kernel 116 is executing on graphics processor 108. In at least one embodiment, kernel 116 is a compute kernel that is a set of instructions that are compiled, using systems and methods such as those described herein, so that they may be executed on a processor such as graphics processor 108. In at least one embodiment, kernel 116 is a GPU kernel. In at least one embodiment, kernel 116 is a shader. In at least one embodiment, kernel 116 is a vertex shader. In at least one embodiment, kernel 116 is a pixel shader. In at least one embodiment, a set of instructions for kernel 116 is expressed using a shader programming language (such as OpenCL C, OpenGL, C++ AMP, CUDA, Vulkan, etc.).

In at least one embodiment, kernel 116 has an associated asynchronously allocated memory location 118. In at least one embodiment, asynchronously allocated memory location 118 associated with executing kernel 116 is created asynchronously by providing a virtual memory address to associate with kernel 116 as described herein (for example, when an asynchronous memory allocation API is called, a virtual memory address is returned). In at least one embodiment, asynchronously allocated memory location 118 associated with executing kernel 116 is created asynchronously by allocating memory to associate with a virtual memory address of kernel 116 and associating allocated memory with an associated virtual memory address. In at least one embodiment, not shown in FIG. 1, asynchronously allocated memory location 118 may be later deallocated from kernel 116 when, for example, execution of kernel 116 terminates. In at least one embodiment, asynchronously allocated memory location 118 may be later deallocated from kernel 116 by first disassociating allocated memory from asynchronously allocated memory location 118 as described herein. In at least one embodiment, asynchronously allocated memory location 118 associated with executing kernel 116 is provided by memory manager 106. In at least one embodiment, asynchronously allocated memory location 118 associated with executing kernel 116 is provided when control thread 114 requests a memory location from memory manager 106, using systems and methods such as those described herein. In at least one embodiment, asynchronously allocated memory location 118 associated with executing kernel 116 is deallocated or released for reuse, as described herein, when control thread 114 sends a request to deallocate memory to memory manager 106, using systems and methods such as those described herein.

In at least one embodiment, a pending kernel 120 is prepared for execution on graphics processor 108, but is not yet executing. In at least one embodiment, pending kernel 120 has an asynchronously allocated memory location 122 with a virtual memory address. In at least one embodiment, because pending kernel 120 is not yet executing, allocated memory may not yet be associated with asynchronously allocated memory location 122. In at least one embodiment, not shown in FIG. 1, before pending kernel 120 begins execution, allocated memory may then be associated with asynchronously allocated memory location 122 (for example, before execution of pending kernel 120 begins). In at least one embodiment, not shown in FIG. 1, asynchronously allocated memory location 122 may be later deallocated from pending kernel 120 when, for example, after execution of pending kernel 120 terminates. In at least one embodiment, asynchronously allocated memory location 122 may be later deallocated from pending kernel 120 by first disassociating allocated memory from asynchronously allocated memory location 122 as described herein.

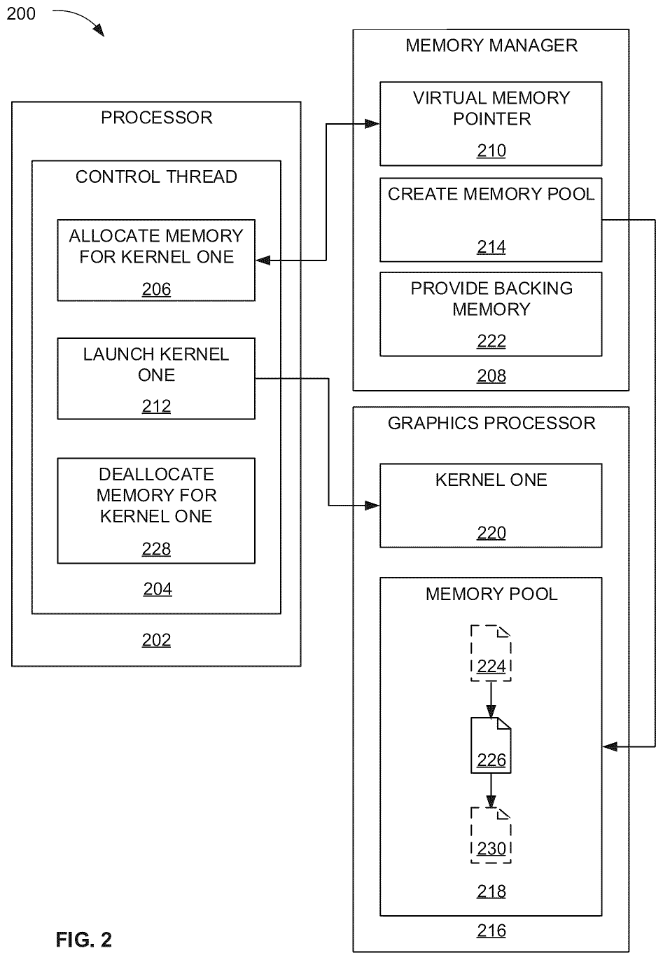

FIG. 2 illustrates an example computer system 200 where memory is asynchronously allocated from a memory pool, in accordance with at least one embodiment. In at least one embodiment, a control thread 204 is executing on a processor 202. In at least one embodiment, processor 202 is a processor such as processor 102 described herein at least in connection with FIG. 1. In at least one embodiment, control thread 204 is a control thread such as control thread 114 described herein at least in connection with FIG. 1. In at least one embodiment, control thread 204 performs an API to cause one or more memory locations to be asynchronously allocated to one or more processors.

In at least one embodiment, control thread 204 performs an API to asynchronously allocate memory 206 for a graphics processor kernel (for example, for graphics processor kernel one 220). In an embodiment, control thread 204 performs an API to cause a memory manager 208 to asynchronously allocate memory 206 for a graphics processor kernel. In at least one embodiment, memory manager 208 is a memory manager such as memory manager 106 described herein at least in connection with FIG. 1. In at least one embodiment, control thread 204 performs an API to cause memory manager 208 to asynchronously allocate memory 206 by sending one or more commands to memory manager 208. In at least one embodiment, not shown in FIG. 2, control thread 204 performs an API to cause memory manager 208 to asynchronously allocate memory 206 by sending one or more commands to memory manager 208 via an operating system such as operating system 110 described herein at least in connection with FIG. 1.

In at least one embodiment, in response to receiving one or more commands from control thread 204, memory manager 208 creates a virtual memory pointer 210 using systems and methods such as those described herein. In at least one embodiment, memory manager 208 provides virtual memory pointer 210 to control thread 204. In at least one embodiment, a virtual memory pointer 224 in memory pool 218 is provided to control thread 204. In at least one embodiment, virtual memory pointer 224 in memory pool 218 is an address in memory that does not have corresponding backing memory in memory pool 218. In at least one embodiment, virtual memory pointer 224 in memory pool 218 is an address in memory that will have corresponding backing memory in memory pool 218 when kernel one 220 begins execution.

In at least one embodiment, in response to receiving one or more commands from control thread 204, memory manager 208 determines whether a memory pool 218 exists. In at least one embodiment, if memory manager 208 determines that memory pool 218 does not exist, memory manager 208 creates 214 memory pool 218. In at least one embodiment, in response to receiving one or more commands from control thread 204, memory manager 208 creates a virtual memory pointer 210 that corresponds to a memory location in memory pool 218 that will be available for use by kernel one 220 before kernel one 220 begins execution.

In at least one embodiment, control thread 204 causes kernel one to be launched 212 on graphics processor 216. In at least one embodiment, graphics processor 216 is a graphics processor such as graphics processor 108 described herein at least in connection with FIG. 1. In at least one embodiment, control thread 204 launches kernel one after control thread 204 performs an API to cause a memory manager 208 to asynchronously allocate memory 206 for a graphics processor kernel. In at least one embodiment, control thread 204 launches kernel one after control thread 204 receives a virtual memory pointer 210 from memory manager 208. In at least one embodiment, control thread 204 performs an API to launch a kernel, using systems and methods such as those described herein.

In at least one embodiment, after memory pool 218 exists, as described above, memory manager 208 provides backing memory 222 for kernel one 220 using systems and methods such as those described herein. In at least one embodiment, when memory manager 208 provides backing memory 222 for kernel one, virtual memory pointer 224 that corresponds to backing memory when memory manager 208 provides backing memory 222 for kernel one 220 becomes memory pointer 226, that corresponds to backing memory in memory pool 218. In at least one embodiment, virtual memory pointer 224 and memory pointer 226 are identical.

In at least one embodiment, control thread 204 performs an API to cause a memory manager 208 to deallocate memory from kernel one 228. In at least one embodiment, control thread 204 performs an API to cause memory manager 208 to deallocate memory from kernel one 228 after control thread 204 launches kernel one. In at least one embodiment, in response to an API that causes memory manager 208 to deallocate memory from kernel one 228, memory manager 208 causes memory 226 that corresponds to backing memory in memory pool 218 to be returned 230 to memory pool 218, using systems and methods such as those described herein. In at least one embodiment, when control thread 204 performs an API to cause memory manager 208 to deallocate memory from kernel one 228, memory 226 that is returned 230 to memory pool 218 is made available for use by other processes, such as those described herein. In at least one embodiment, memory associated with memory pool 218 is not returned to an operating system such as operating system 110 described herein at least in connection with FIG. 1 until all graphics processes terminate. In at least one embodiment, memory associated with memory pool 218 is returned to an operating system such as operating system 110 described herein at least in connection with FIG. 1 when a synchronization operation (not shown in FIG. 2) is performed by an operating system, or performed by a control thread, or performed by a graphics processor.

In at least one embodiment, a stream execution order (not shown in FIG. 2) of control thread 204 performs an API to cause a memory manager 208 to asynchronously allocate memory 206 for a graphics processor kernel, then launches 212 kernel one on graphics processor 216, and then performs an API to cause a memory manager 208 to deallocate memory from kernel one 228. In at least one embodiment, memory manager 208 executes commands to create virtual memory pointer 210, provide a virtual memory pointer, create memory pool 214, provide backing memory 222, and/or to cause memory available to kernel one 220 to be returned 230 to memory pool 218 asynchronously, using systems and methods such as those described herein.

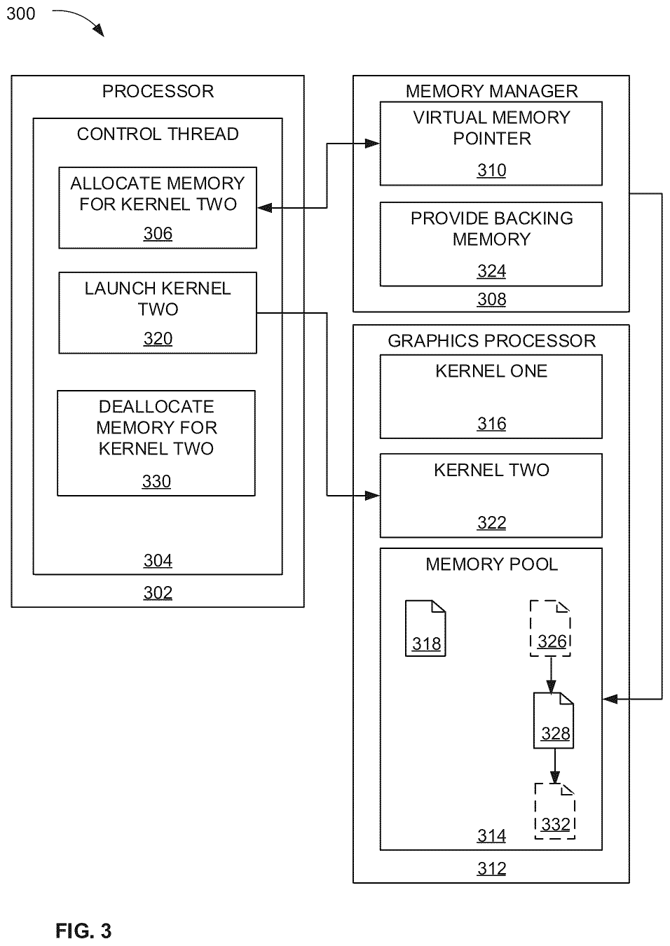

FIG. 3 illustrates an example computer system 300 where memory for a stream-ordered execution thread is asynchronously allocated from a memory pool, in accordance with at least one embodiment. In at least one embodiment, kernel one 316 is executing on graphics processor 312 and kernel one 316 has backing memory 318 as described herein at least in connection with FIG. 2. In at least one embodiment, graphics processor 312 is a graphics processor such as graphics processor 108 described herein at least in connection with FIG. 1. In at least one embodiment, backing memory 318 is backing memory such as backing memory 222 described herein at least in connection with FIG. 2.

In at least one embodiment, a control thread 304 executes on processor 302. In at least one embodiment, processor 302 is a processor such as processor 102 described herein at least in connection with FIG. 1. In at least one embodiment, control thread 304 is a control thread such as control thread 114 described herein at least in connection with FIG. 1. In at least one embodiment, control thread 304 performs an API to cause memory for a stream-ordered execution thread to be asynchronously allocated from a memory pool.

In at least one embodiment, control thread 304 performs an API to asynchronously allocate memory 306 for a kernel (for example, graphics processor kernel two 322) using systems and methods such as those described herein. In an embodiment, control thread 304 performs an API to cause a memory manager 308 to asynchronously allocate memory 306 for a kernel. In at least one embodiment, memory manager 308 is a memory manager such as memory manager 106 described herein at least in connection with FIG. 1. In at least one embodiment, control thread 304 performs an API to cause memory manager 308 to asynchronously allocate memory 306 by sending one or more commands to memory manager 308. In at least one embodiment, not shown in FIG. 3, control thread 304 performs an API to cause memory manager 308 to asynchronously allocate memory 306 by sending one or more commands to memory manager 308 via an operating system such as operating system 110 described herein at least in connection with FIG. 1.

In at least one embodiment, in response to receiving one or more commands from control thread 304, memory manager 308 creates a virtual memory pointer 310 using systems and methods such as those described herein. In at least one embodiment, memory manager 308 provides virtual memory pointer 310 to control thread 304 also using systems and methods such as those described herein.

In at least one embodiment, control thread 304 causes kernel two to be launched 320 on graphics processor 312. In at least one embodiment, control thread 304 launches kernel two after control thread 304 performs an API to cause a memory manager 308 to asynchronously allocate memory 306 for kernel two. In at least one embodiment, control thread 304 launches kernel two after control thread 304 receives a virtual memory pointer 310 from memory manager 308. In at least one embodiment, control thread 304 performs an API to launch kernel two, using systems and methods such as those described herein.

In at least one embodiment, before control thread 304 launches kernel two, memory manager 308 provides backing memory 324 for kernel two using systems and methods such as those described herein. In at least one embodiment, when memory manager 308 provides backing memory 324 for kernel two, virtual memory pointer 326 that corresponds to backing memory when memory manager 308 provides backing memory 324 for kernel two 322, becomes memory 328, that corresponds to backing memory in memory pool 314. In at least one embodiment, virtual memory pointer 326 and a pointer to memory 328 are identical. In at least one embodiment, kernel two 322 is executing while kernel one 316 is executing and memory 318 available to kernel one 316 differs from memory 328 available to kernel two 322. In at least one embodiment, for example, memory 318 available to kernel one 316 may have a different address in memory pool 314 than memory 328 available to kernel two 322. In at least one embodiment, not shown in FIG. 3, kernel two 322 is not executing while kernel one 316 is executing and memory 328 available to kernel two 322 is has a same address in memory pool 314 as memory 318 available to kernel one 316. In at least one embodiment, for example, memory 318 available to kernel one 316 may be reused and may have an identical address in memory pool 314 as memory 328 available to kernel two 322.

In at least one embodiment, control thread 304 performs an API to cause a memory manager 308 to deallocate memory from kernel two 330. In at least one embodiment, control thread 304 performs an API to cause memory manager 308 to deallocate memory from kernel two 330 after control thread 304 launches kernel two. In at least one embodiment, in response to an API that causes memory manager 308 to deallocate memory from kernel two 330, memory manager 308 causes memory 328 in memory pool 314 available to kernel two to be returned 332 to memory pool 314, using systems and methods such as those described herein. In at least one embodiment, when control thread 304 performs an API to cause memory manager 308 to deallocate memory from kernel two 330, memory 328 that is returned 332 to memory pool 314 is made available for use by other processes, as described herein. In at least one embodiment, a stream execution order (not shown in FIG. 3) of control thread 304 performs an API to cause a memory manager 308 to asynchronously allocate memory 306 for a graphics processor kernel, then launches 320 kernel two on graphics processor 312, and then performs an API to cause a memory manager 308 to deallocate memory from kernel two 330. In at least one embodiment, memory manager 308 executes commands to create virtual memory pointer 310, provide a virtual memory pointer, provide backing memory 324, and/or to cause memory available to kernel two 322 to be returned 332 to memory pool 314 asynchronously, using systems and methods such as those described herein.

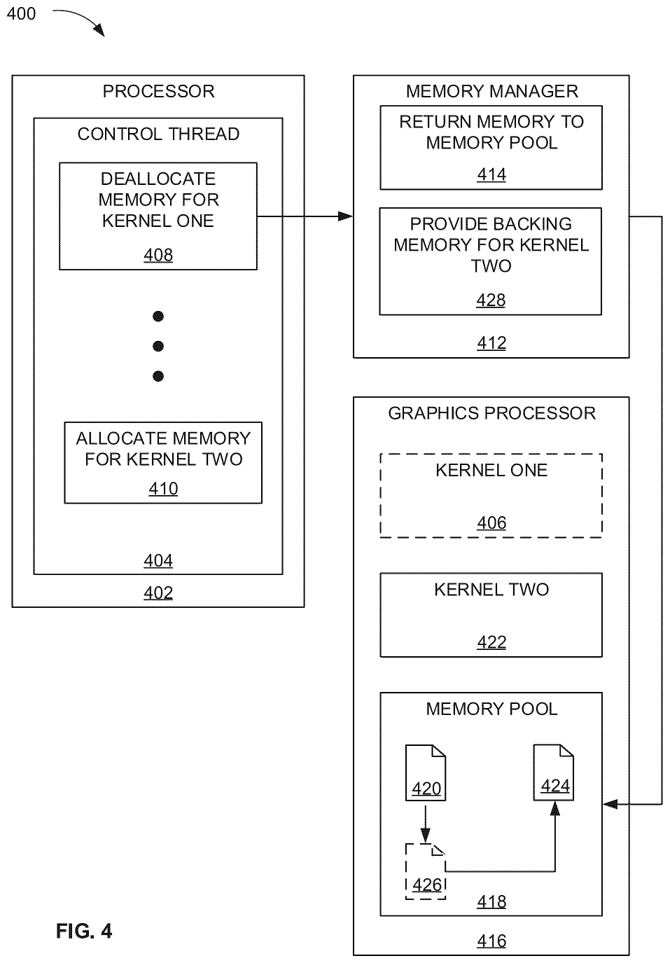

FIG. 4 illustrates an example computer system 400 where memory for a stream-ordered execution thread is asynchronously deallocated and returned to a memory pool, in accordance with at least one embodiment. In at least one embodiment, kernel one 406 is executing on graphics processor 416. In at least one embodiment, graphics processor 416 is a graphics processor such as graphics processor 108 described herein at least in connection with FIG. 1. In at least one embodiment, kernel one 406 has backing memory 420 in memory pool 418, provided using systems and methods such as those described herein.

In at least one embodiment, a control thread 404 executing on processor 402 performs an API to asynchronously deallocate 408 memory for kernel one 406 using systems and methods such as those described herein. In at least one embodiment, when control thread 404 performs an API to cause memory manager 412 to deallocate 408 memory from kernel one 406, memory 420 that is returned 414 to memory pool 418 is made available for use by other processes, such as those described herein. In at least one embodiment, control thread 404 is a control thread such as control thread 114 described herein at least in connection with FIG. 1. In at least one embodiment, processor 402 is a processor such as processor 102 described herein at least in connection with FIG. 1.

In at least one embodiment, when control thread 404 performs an API to asynchronously deallocate memory 408 for kernel one 406, a memory manager 412 asynchronously returns memory 414 to a memory pool 418 using systems and methods such as those described herein. In at least one embodiment, memory manager 412 is a memory manager such as memory manager 106 described herein at least in connection with FIG. 1. In at least one embodiment, memory pool 418 is a memory pool such as memory pool 218 described herein at least in connection with FIG. 2. In at least one embodiment, control thread 404 performs an API to cause memory manager 412 to asynchronously deallocate memory 408 for kernel one 406 by sending one or more commands to memory manager 412. In at least one embodiment, not shown in FIG. 4, control thread 404 performs an API to cause memory manager 412 to asynchronously deallocate memory by sending one or more commands to memory manager 412 via an operating system such as operating system 110 described herein at least in connection with FIG. 1.

In at least one embodiment, in response to receiving one or more commands from control thread 404, memory manager 412 executes commands to return memory 414 to a memory pool 418 using systems and methods such as those described herein. In at least one embodiment, when memory manager 412 executes commands to return memory 414 to a memory pool 418, memory 420 that was previously associated with memory in memory pool 418 for kernel one 406 becomes memory 426 that is no longer associated with memory in memory pool 418.

In at least one embodiment, control thread 404 performs an API to asynchronously allocate memory 410 for kernel two 422 at some point after control thread 404 performs an API to asynchronously deallocate memory 408 for kernel one 406. In at least one embodiment, when control thread 404 performs an API to asynchronously allocate memory 410 for kernel two 422, memory manager 412 provides backing memory for kernel two 428, as described herein. In at least one embodiment, memory 426 that is no longer associated with memory in memory pool 418 for kernel one 406 may be available to kernel two 422 using a virtual memory address, as described herein when memory manager 412 provides backing memory for kernel two 428. In at least one embodiment, a virtual address associated with memory 426 that is no longer associated with memory in memory pool 418 for kernel one 406 may be reused to become memory 424 available to kernel two 422, using systems and methods such as those described herein.

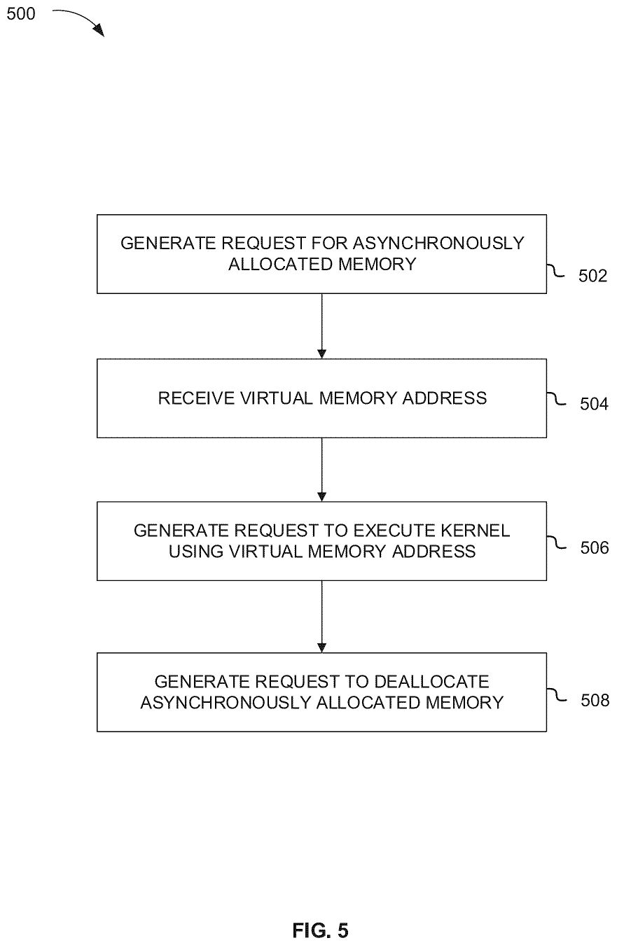

FIG. 5 illustrates an example process 500 for performing operations to asynchronously allocate memory, in accordance with at least one embodiment. In at least one embodiment, a processor such as processor 102 described herein at least in connection with FIG. 1 executes instructions to perform example process 500 illustrated in FIG. 5.

In at least one embodiment, at step 502 of example process 500, a request is generated for asynchronously allocated memory. In at least one embodiment, a generated request for asynchronously allocated memory is sent to a memory manager such as memory manager 106 described herein at least in connection with FIG. 1. In at least one embodiment, a request for asynchronously allocated memory is sent using an API. In at least one embodiment, a request for asynchronously allocated memory is a command. In at least one embodiment, a request for asynchronously allocated memory is an executable command. In at least one embodiment, a request for asynchronously allocated memory is an instruction. In at least one embodiment, a request for asynchronously allocated memory is an executable instruction. In at least one embodiment, a request for asynchronously allocated memory is sent using an API that indicates a location used to return an asynchronously allocated memory address, a size of memory requested, and an execution stream that at least indicates a stream order. In at least one embodiment, a request for asynchronously allocated memory is sent using an API that indicates a memory pool from which asynchronously allocated memory may be allocated. In at least one embodiment, not illustrated in FIG. 5, a response to a request for asynchronously allocated memory is received. In at least one embodiment a response to a request for asynchronously allocated memory is received from a memory manager such as memory manager 106 described herein at least in connection with FIG. 1. In at least one embodiment, a response to a request for asynchronously allocated memory is received using an API. In at least one embodiment, a response to a request for asynchronously allocated memory is received using an API that indicates an error result. In at least one embodiment, after step 502, execution of example process 500 advances to step 504.

In at least one embodiment, at step 504 of example process 500, a virtual memory address is received. In at least one embodiment, a virtual memory address is a a pointer to an address in virtual memory. In at least one embodiment, a virtual memory pointer is received in response to a request for asynchronously allocated memory as described in connection with step 502. In at least one embodiment, a virtual memory address is received from a memory manager such as memory manager 106 described herein at least in connection with FIG. 1. In at least one embodiment, a virtual memory address is received using an API. In at least one embodiment, a virtual memory address is received using an API that indicates a location to store a virtual memory address. In at least one embodiment, not illustrated in FIG. 5, a response to receiving a virtual memory address is generated. In at least one embodiment, a response to receiving a virtual memory address is generated using an API. In at least one embodiment, after step 504, execution of example process 500 advances to step 506.

In at least one embodiment, at step 506 of example process 500, a request to execute a kernel using a provided virtual memory address such as a virtual memory address returned in step 504 is generated. In at least one embodiment, a request to execute a kernel is sent to a memory manager such as memory manager 106 described herein at least in connection with FIG. 1 using systems and methods such as those described in connection with step 502. In at least one embodiment, a request to execute a kernel is sent to a graphics processor such as graphics processor 108 described herein at least in connection with FIG. 1 using systems and methods such as those described in connection with step 502. In at least one embodiment, a request to execute a kernel is sent by inserting a request to execute a kernel in an execution queue of, for example, a graphics processor such as graphics processor 108 described herein at least in connection with FIG. 1. In at least one embodiment, not illustrated in FIG. 5, a request to execute a kernel is sent to a graphics processor using a memory manager. In at least one embodiment, also not illustrated in FIG. 5, a request to execute a kernel generates a request to allocate memory, using systems and methods such as those described herein. In at least one embodiment, for example, a request to execute a kernel generates a request to allocate memory automatically. In at least one embodiment, a request to allocate memory associated with a request to execute a kernel is sent using systems and methods such as those described herein in connection with 502. In at least one embodiment, after step 506, execution of example process 500 advances to step 508.

In at least one embodiment, at step 508 of example process 500, a request to deallocate asynchronously allocated memory is generated. In at least one embodiment, a generated request to deallocate asynchronously allocated memory is sent to a memory manager such as memory manager 106 described herein at least in connection with FIG. 1. In at least one embodiment, a request to deallocate asynchronously allocated memory is sent using an API. In at least one embodiment, a request generated to deallocate asynchronously allocated memory is a command. In at least one embodiment, a request generated to deallocate asynchronously allocated memory is an executable command. In at least one embodiment, a request generated to deallocate asynchronously allocated memory is an instruction. In at least one embodiment, a request generated to deallocate asynchronously allocated memory is an executable instruction. In at least one embodiment, a request to deallocate asynchronously allocated memory is sent using an API that indicates a location of previously asynchronously allocated memory address and an execution stream that at least indicates a stream order. In at least one embodiment, a request for asynchronously allocated memory is sent using an API that indicates a memory pool associated with asynchronously allocated memory. In at least one embodiment, not illustrated in FIG. 5, a response to a generated request for asynchronously allocated memory is received. In at least one embodiment a response to a request to deallocate asynchronously allocated memory is received from a memory manager such as memory manager 106 described herein at least in connection with FIG. 1. In at least one embodiment, a response to a request to deallocate asynchronously allocated memory is received using an API. In at least one embodiment, a response to a request to deallocate asynchronously allocated memory is received using an API that indicates an error result. In at least one embodiment, after step 508, example process 500 terminates. In at least one embodiment, after step 508, example process 500 returns to step 502 to generate a new request for asynchronously allocated memory.

In at least one embodiment, operations of example process 500 illustrated in FIG. 5 are performed in a different order than indicated in FIG. 5. In at least one embodiment, operations of example process 500 illustrated in FIG. 5 are performed simultaneously and/or in parallel. In at least one embodiment, operations of example process 500 illustrated in FIG. 5 are performed by a plurality of threads executing on a processor such as processor 102 described herein at least in connection with FIG. 1.

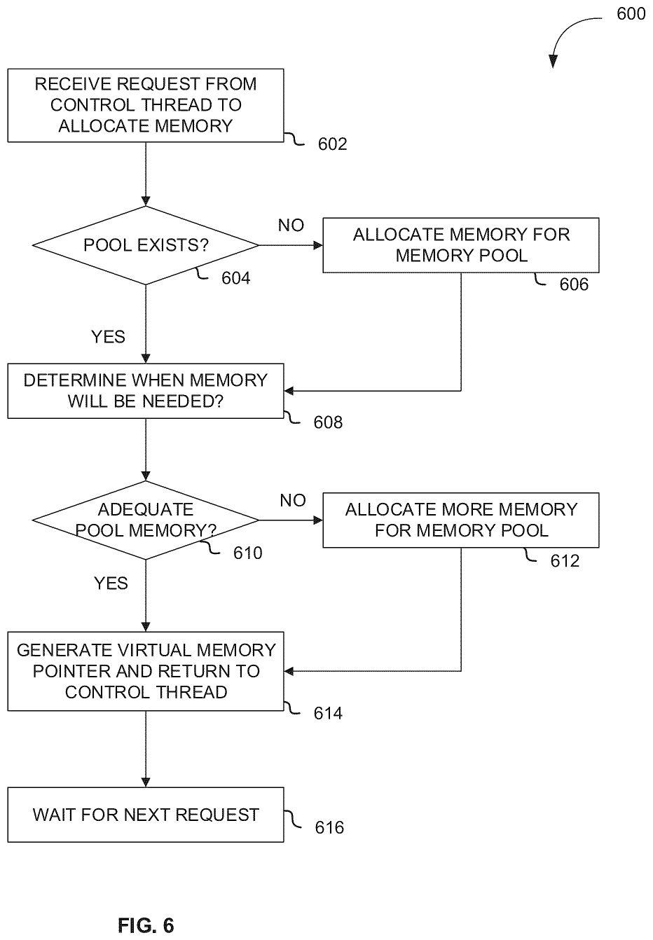

FIG. 6 illustrates an example process 600 for performing operations to asynchronously allocate memory, in accordance with at least one embodiment. In at least one embodiment, a processor such as processor 102 described herein at least in connection with FIG. 1 executes instructions to perform example process 600 illustrated in FIG. 6.

In at least one embodiment, at step 602 of example process 600, a request is received to asynchronously allocate memory. In at least one embodiment, a received request to asynchronously allocate memory is received from a control thread. In at least one embodiment, a received request to asynchronously allocate memory is received from a control thread such as control thread 114 described herein at least in connection with FIG. 1. In at least one embodiment, a received request to asynchronously allocate memory is received from a control thread executing a process such as example process 500 illustrated in FIG. 5. In at least one embodiment, a received request to asynchronously allocate memory is received from a control thread executing step 502 of example process 500 as described herein at least in connection with FIG. 5. In at least one embodiment, a received request to asynchronously allocate memory is sent using an API. In at least one embodiment, a received request to asynchronously allocate memory is a command. In at least one embodiment, a received request to asynchronously allocate memory is an executable command. In at least one embodiment, a received request to asynchronously allocate memory is an instruction. In at least one embodiment, a received request to asynchronously allocate memory is an executable instruction. In at least one embodiment, a received request to asynchronously allocate memory is sent using an API as described herein at least in connection with FIG. 5. In at least one embodiment, not illustrated in FIG. 6, a response to a received request to asynchronously allocate memory is generated. In at least one embodiment a response to a received request to asynchronously allocate memory is sent to a control thread such as control thread 114 described herein at least in connection with FIG. 1. In at least one embodiment, a response to a received request to asynchronously allocate memory is sent using an API. In at least one embodiment, a response to a received request to asynchronously allocate memory is sent using an API that indicates an error result. In at least one embodiment, after step 602, execution of example process 600 advances to step 604.

In at least one embodiment, at step 604 of example process 600, it is determined whether a memory pool exists that may be used to provide asynchronously allocated memory, using systems and methods such as those described herein. In at least one embodiment, at step 604, if it is determined that a memory pool exists (“YES” branch), execution of example process 600 advances to step 608. In at least one embodiment, at step 604, if it is determined that a memory pool does not exist (“NO” branch), execution of example process 600 advances to step 606.

In at least one embodiment, at step 606 of example process 600, memory for a new memory pool is allocated. In at least one embodiment, after step 606, execution of example process 600 advances to step 608.

In at least one embodiment, at step 608 of example process 600, a memory manager determines when memory will be needed for a request for asynchronously allocated memory. In at least one embodiment, a memory manager may determine when memory will be needed for a request for asynchronously allocated memory based at least in part on one or more other memory requests. In at least one embodiment, for example, if associated work such as, for example, a kernel is executing but will be done executing before memory will be needed for a request for asynchronously allocated memory, such memory may be used to fulfill a request for asynchronously allocated memory, using systems and methods such as those described herein. In at least one embodiment, after step 608, execution of example process 600 advances to step 610.

In at least one embodiment, at step 610 of example process 600, it is determined whether a sufficiently sized memory pool exists. In at least one embodiment, if it is determined that a sufficiently sized memory pool exists (“YES” branch), execution of example process advances to step 614. In at least one embodiment, if it is determined that a sufficiently sized memory pool does not exist (“NO” branch), execution of example process advances to step 612. In at least one embodiment, not illustrated in FIG. 6, step 604 and step 610 may be combined so that, for example, a memory manager simultaneously determines whether a sufficiently sized memory pool exists and, if not, allocates new and/or additional memory for a memory pool. In at least one embodiment, for example, memory for a new memory pool is allocated when there is not an existing memory pool and additional memory for a memory pool is allocated when there is an existing memory pool, but it is determined that an amount of memory in an existing memory pool is not sufficient to provide asynchronously allocated memory for a memory request.

In at least one embodiment, at step 612 of example process 600, additional memory for an existing memory pool is allocated using systems and methods such as those described herein. In at least one embodiment, after step 612, execution of example process 600 advances to step 614.

In at least one embodiment, at step 614 of example process 600, a memory manager generates a virtual memory pointer that corresponds to memory that will be used for a request for asynchronously when needed. In at least one embodiment, a memory manager returns a virtual memory pointer to a control thread such as control thread 114 described herein at least in connection with FIG. 1. In at least one embodiment, memory manager returns a virtual memory pointer to a control thread executing a process such as example process 500 illustrated in FIG. 5. In at least one embodiment, memory manager returns a virtual memory pointer to a control thread performing step 504 of example process 500 described herein at least in connection with FIG. 5. In at least one embodiment, after step 614, execution of example process 600 advances to step 616.

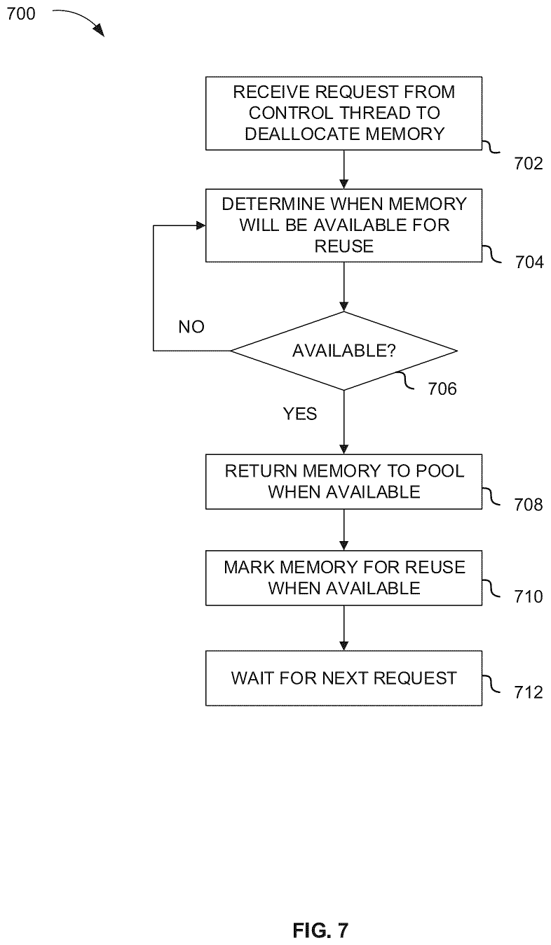

In at least one embodiment, at step 616 of example process 600, a memory manager waits for a next request. In at least one embodiment, after step 616, example process 600 continues at step 502 of example process 500 to wait for a next request. In at least one embodiment, after step 616, example process 600 continues at step 602 to receive a new request to asynchronously allocate memory. In at least one embodiment, after step 616, example process 600 continues at step 702 of example process 700, described herein at least in connection with FIG. 7, to receive a request to asynchronously deallocate memory. In at least one embodiment, after step 616, example process 600 terminates.

In at least one embodiment, operations of example process 600 illustrated in FIG. 6 are performed in a different order than indicated in FIG. 6. In at least one embodiment, operations of example process 600 illustrated in FIG. 6 are performed simultaneously and/or in parallel. In at least one embodiment, operations of example process 600 illustrated in FIG. 6 are performed by a plurality of threads executing on a processor such as processor 102 described herein at least in connection with FIG. 1.

FIG. 7 illustrates an example process 700 for performing memory management operations to asynchronously deallocate memory, in accordance with at least one embodiment. In at least one embodiment, a memory manager such as memory manager 106 described herein at least in connection with FIG. 1 executes instructions to perform example process 700 illustrated in FIG. 7.

In at least one embodiment, at step 702 of example process 700, a request is received to asynchronously deallocate memory. In at least one embodiment, a received request to asynchronously deallocate memory is received from a control thread. In at least one embodiment, a received request to asynchronously deallocate memory is received from a control thread such as control thread 114 described herein at least in connection with FIG. 1. In at least one embodiment, a received request to asynchronously deallocate memory is received from a control thread executing a process such as example process 500 illustrated in FIG. 5. In at least one embodiment, a received request to asynchronously deallocate memory is received from a control thread executing step 508 of example process 500 as described herein at least in connection with FIG. 5. In at least one embodiment, a received request to asynchronously deallocate memory is sent using an API. In at least one embodiment, a received request to asynchronously deallocate memory is a command. In at least one embodiment, a received request to asynchronously deallocate memory is an executable command. In at least one embodiment, a received request to asynchronously deallocate memory is an instruction. In at least one embodiment, a received request to asynchronously deallocate memory is an executable instruction. In at least one embodiment, a received request to asynchronously deallocate memory is sent using an API as described herein at least in connection with FIG. 5. In at least one embodiment, not illustrated in FIG. 5, a response to a received request to asynchronously deallocate memory is generated. In at least one embodiment a response to a received request to asynchronously deallocate memory is sent to a control thread such as control thread 114 described herein at least in connection with FIG. 1. In at least one embodiment, a response to a received request to asynchronously deallocate memory is sent using an API. In at least one embodiment, a response to a received request to asynchronously deallocate memory is sent using an API that indicates an error result. In at least one embodiment, after step 702, execution of example process 700 advances to step 704.

In at least one embodiment, at step 704 of example process 700, a memory manager determines when asynchronously allocated memory will become available for reuse using systems and methods such as those described herein. In at least one embodiment, after step 704, execution of example process 700 advances to step 706.

In at least one embodiment, at step 706 of example process 700, if it is determined, in step 704, that asynchronously allocated memory is available for reuse (“YES” branch), execution of example process 700 advances to step 708. In at least one embodiment, at step 706, if it is determined, in step 704, that asynchronously allocated memory is not yet available for reuse (“NO” branch), execution of example process 700 continues at step 704, to wait for asynchronously allocated memory to become available for reuse. In at least one embodiment, not illustrated in FIG. 7, a memory manager may perform other actions while waiting for asynchronously allocated memory to become available for reuse.

In at least one embodiment, at step 708 of example process 700, a memory manager returns asynchronously allocated memory to a memory pool, using systems and methods such as those described herein. In at least one embodiment, after step 708, execution of example process 700 advances to step 710.

In at least one embodiment, at step 710 of example process 700, a memory manager may perform one or more operations to mark asynchronously allocated memory as available for reuse. In at least one embodiment, after step 710, execution of example process 700 advances to step 712.

In at least one embodiment, at step 712 of example process 700, a memory manager waits for a next request. In at least one embodiment, after step 712, example process 700 continues at step 502 of example process 500 to wait for a next request. In at least one embodiment, after step 712, example process 700 continues at step 602 of example process 600 to receive a new request to asynchronously allocate memory. In at least one embodiment, after step 712, example process 700 continues at step 702 to receive a request to asynchronously deallocate memory. In at least one embodiment, after step 712, example process 700 terminates.

In at least one embodiment, operations of example process 700 illustrated in FIG. 7 are performed in a different order than indicated in FIG. 7. In at least one embodiment, operations of example process 700 illustrated in FIG. 7 are performed simultaneously and/or in parallel. In at least one embodiment, operations of example process 700 illustrated in FIG. 7 are performed by a plurality of threads executing on a memory manager such as memory manager 106 described herein at least in connection with FIG. 1.

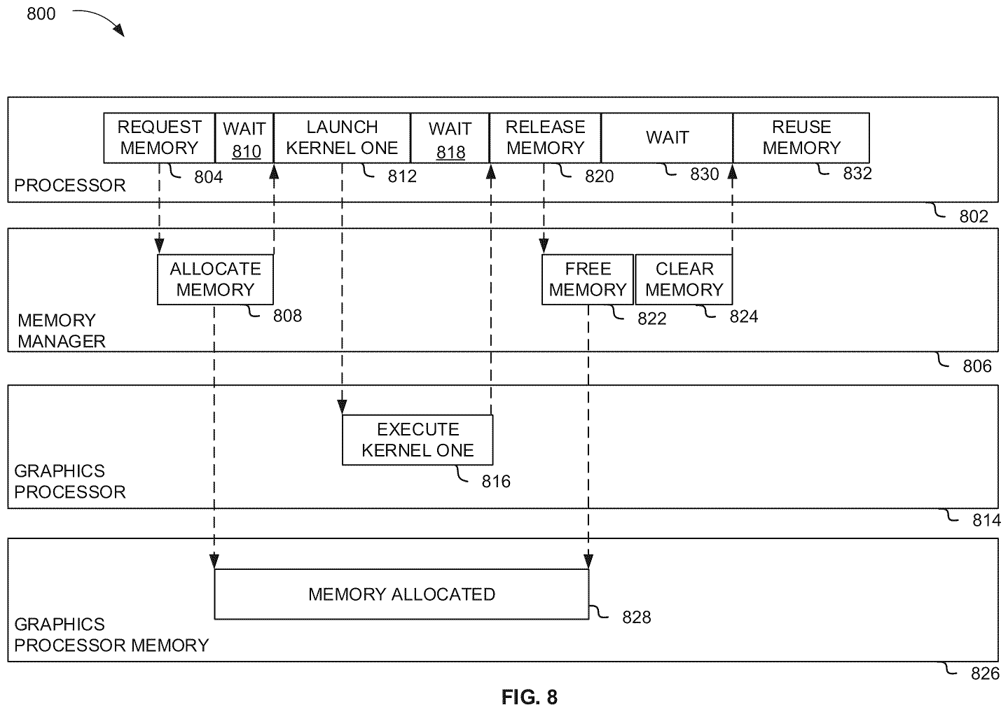

FIG. 8 illustrates an example data flow 800 where memory is allocated synchronously, in accordance with at least one embodiment. In at least one embodiment, a processor 802 performs operations to request memory 804 from a memory manager 806. In at least one embodiment, processor 802 is a processor such as processor 102 described herein at least in connection with FIG. 1. In at least one embodiment, memory manager 806 is a memory manager such as memory manager 106 described herein at least in connection with FIG. 1.

In at least one embodiment, memory manager 806 allocates memory 808 and, as example data flow 800 is not asynchronous, processor 802 waits 810 until memory manager 806 completes allocating memory 808. In at least one embodiment, memory manager 806 then launches 812 kernel one on graphics processor 814. In at least one embodiment, graphics processor 814 is a graphics processor such as graphics processor 108 described herein at least in connection with FIG. 1. In at least one embodiment, as example data flow 800 is not asynchronous, processor 802 may then wait 818 while kernel one is executing 816 on graphics processor 814. In at least one embodiment, not shown in FIG. 8, processor 802 may perform other actions while kernel one is executing 816 on graphics processor 814.

In at least one embodiment, after kernel one is done executing, processor 802 can then release memory 820 by causing memory manager 806 to free memory 822. In at least one embodiment, memory in graphics processor memory 826 is allocated 828 from a time when memory manager 806 allocates memory 808 until a time when memory manager 806 frees memory 822. In at least one embodiment, graphics processor memory 826 is graphics processor memory such as graphics processor memory 104 described herein at least in connection with FIG. 1. In at least one embodiment, memory manager 806 may clear memory 824 before it may be reused. In at least one embodiment, as example data flow 800 is not asynchronous, processor 802 may wait 830 until after memory manager 806 clears memory 824 before processor 802 can reuse memory 832.

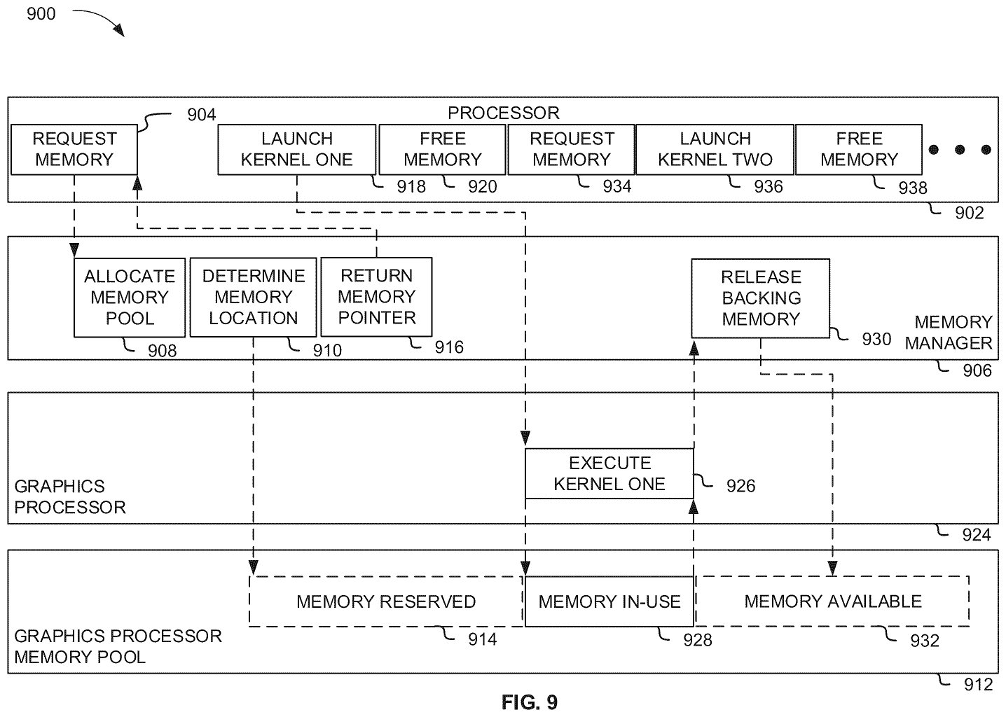

FIG. 9 illustrates an example first part of a data flow 900 where memory is asynchronously allocated and deallocated, in accordance with at least one embodiment. In at least one embodiment, a processor 902 requests memory 904 from a memory manager 906. In at least one embodiment, processor 902 is a processor such as processor 102 described herein at least in connection with FIG. 1. In at least one embodiment, memory manager 906 is a memory manager such as memory manager 106 described herein at least in connection with FIG. 1. In at least one embodiment, memory manager 906 may first determine whether a memory pool is available to use. In at least one embodiment, if a memory pool is not available to use, a memory manager 906 allocates a memory pool 908 to create a graphics processor memory pool 912. In at least one embodiment, graphics processor memory pool 912 is identical to memory pool 218 described herein at least in connection with FIG. 2.

In at least one embodiment, after a graphics processor memory pool 912 is available to use to allocate backing memory, a memory manager 906 determines a memory location 910 in graphics processor memory pool 912 using systems and methods such as those described herein. In at least one embodiment, memory manager 906 returns a virtual memory pointer 916 to processor 902, as described herein. In at least one embodiment, memory manager 906 returns virtual memory pointer 916 to processor 902 asynchronously in that, as described herein, a virtual memory pointer is returned to a processor in response to a memory request, before backing memory is used by an execution stream.

In at least one embodiment, processor 902 executes a command to launch kernel one 918 with a provided virtual memory pointer. In at least one embodiment, a graphics processor 924 executes kernel one 926. In at least one embodiment, graphics processor 924 is a graphics processor such as graphics processor 108 described herein at least in connection with FIG. 1. In at least one embodiment, when memory manager 906 determines a memory location 910 in graphics processor memory pool 912, memory is reserved for use 914. In at least one embodiment, memory is reserved for use 914 so that memory will be available for use by kernel one when graphics processor 924 executes kernel one 926.

In at least one embodiment, processor 902 executes a command to free memory 920 associated with kernel one. In at least one embodiment, when kernel one completes, memory manager 906 releases backing memory 930 for later reuse, as described herein. In at least one embodiment, memory manager 906 releases backing memory 930 by returning backing memory to a memory pool. In at least one embodiment, memory manager 906 releases backing memory 930 by returning backing memory to a memory pool by making backing memory available for use or reuse. In at least one embodiment, memory manager 906 releases backing memory 930 by returning backing memory to a memory pool by releasing virtual memory pointer for reuse. In at least one embodiment, memory in graphics processor memory pool 912 is in use 928 while graphics processor 924 executes kernel one 926. In at least one embodiment, memory in graphics processor memory pool 912 is available for reuse 932 after kernel one completes and after memory manager 906 releases backing memory 930 for later reuse.

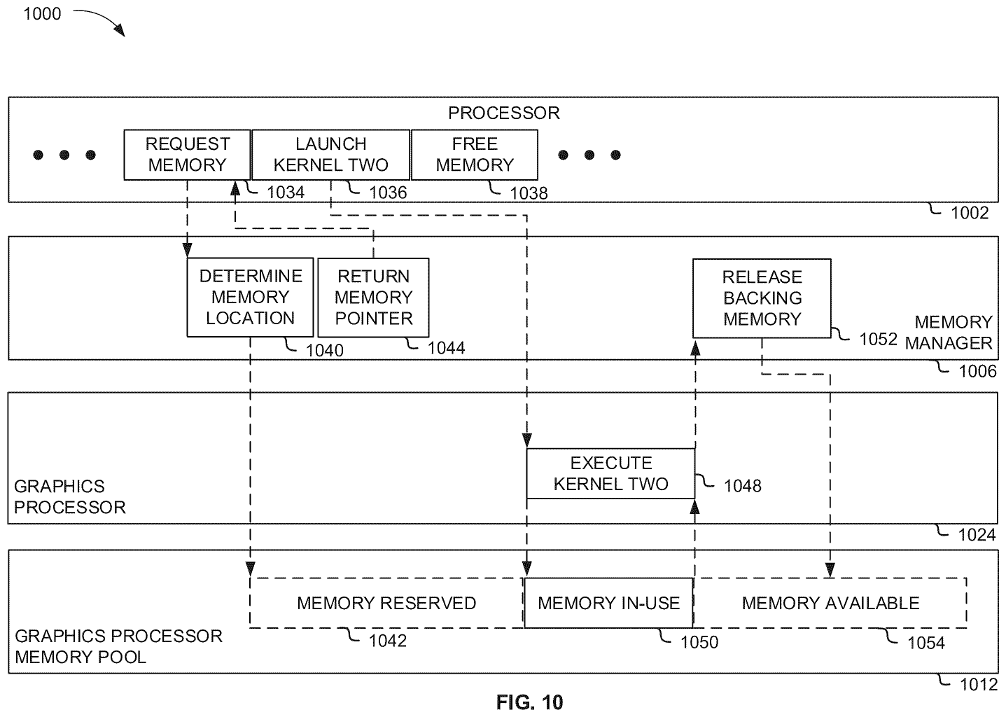

In at least one embodiment, processor 902 may then make a request to allocate memory 934 for kernel two, launch kernel two 936, and make a request to free memory 938, all of which are described herein in connection with FIGS. 10-12 as, for example, a request to allocate memory 1034 for kernel two, launch kernel two 1036, a request to free memory 1038, a request to allocate memory 1234 for kernel two, launch kernel two 1236, a request to free memory 1238, etc.

FIG. 10 illustrates an example second part of a data flow 1000 where memory is asynchronously allocated and deallocated, in accordance with at least one embodiment. In at least one embodiment, example second part of a data flow 1000 continues from example first part of a data flow 900, described in connection with FIG. 9.

In at least one embodiment, a processor 1002 requests memory 1034 from a memory manager 1006. In at least one embodiment, processor 1002 is identical to processor 902 described in connection with FIG. 9. In at least one embodiment, memory manager 1006 is identical to memory manager 906 described in connection with FIG. 9. In at least one embodiment, memory manager 1006 determines a memory location 1040 in graphics processor memory pool 1012 using systems and methods such as those described herein. In at least one embodiment, graphics processor memory pool 1012 is identical to graphics processor memory pool 912 described in connection with FIG. 9. In at least one embodiment, memory manager 1006 returns a virtual memory pointer 1044 to processor 1002, as described herein. In at least one embodiment, memory manager 1006 returns virtual memory pointer 1044 to processor 1002 asynchronously in that, as described herein, a virtual memory pointer is returned to a processor in response to a memory request, before backing memory is used by an execution stream.

In at least one embodiment, processor 1002 executes a command to launch kernel two 1036 with a provided virtual memory pointer. In at least one embodiment, a graphics processor 1024 executes kernel two 1048. In at least one embodiment, graphics processor 1024 is identical to graphics processor 924 described in connection with FIG. 9. In at least one embodiment, when memory manager 1006 determines a memory location 1040 in graphics processor memory pool 1012, memory is reserved for use 1042. In at least one embodiment, memory is reserved for use 1042 so that memory will be available for use by kernel two when graphics processor 1024 executes kernel two 1048.

In at least one embodiment, processor 1002 executes a command to free memory 1038 associated with kernel two. In at least one embodiment, when kernel two completes, memory manager 1006 releases backing memory 1052 for later reuse, as described herein. In at least one embodiment, memory manager 1006 releases backing memory 1052 by returning backing memory to a memory pool and/or by making backing memory available for use or reuse and by releasing virtual memory pointer for reuse, as described herein. In at least one embodiment, memory in graphics processor memory pool 1012 is in use 1050 while graphics processor 1024 executes kernel two 1048. In at least one embodiment, memory in graphics processor memory pool 1012 is available for reuse 1054 after kernel two completes and after memory manager 1006 releases backing memory 1052 for later reuse.

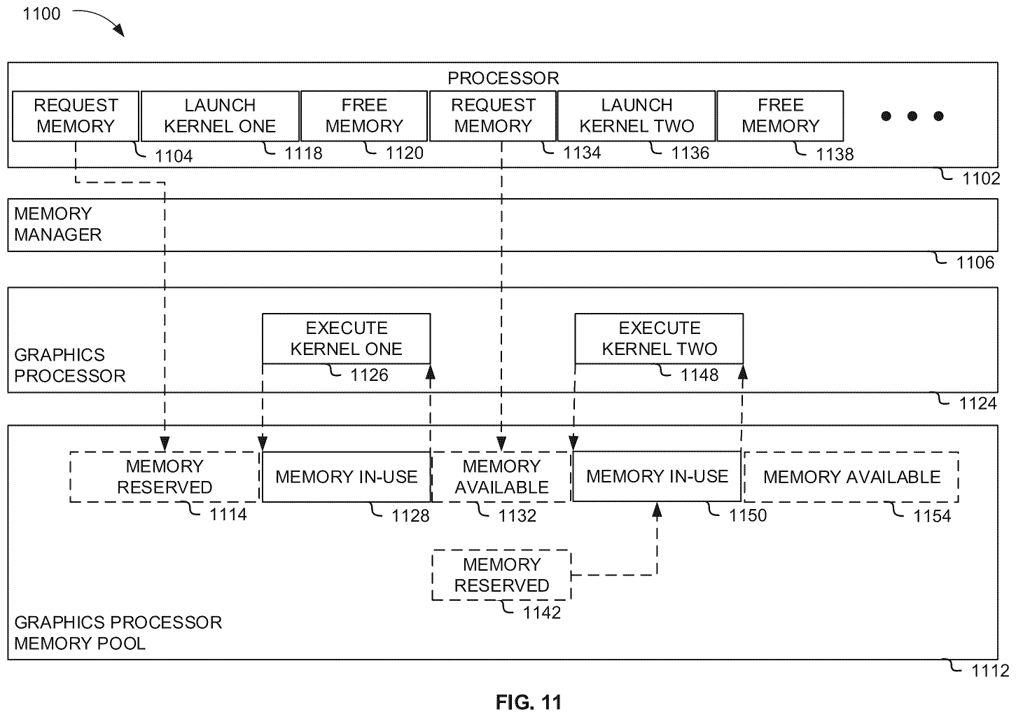

FIG. 11 illustrates an example third part of a data flow 1100 where memory is asynchronously allocated and deallocated, in accordance with at least one embodiment. In at least one embodiment, example third part of a data flow 1100 continues from example second part of a data flow 1000, described in connection with FIG. 10. In at least one embodiment, actions of a memory manager 1106 (which is identical to memory manager 906 described herein at least in connection with FIG. 9 and which is identical to memory manager 1006 described herein at least in connection with FIG. 10) are identical to actions of memory manager 906 and/or are identical to actions of memory manager 1006 as described herein and such actions are not illustrated in FIG. 11 for clarity.

In at least one embodiment, processor 1102 requests memory 1104, executes a command to launch kernel one 1118, and executes a command to free memory 1120, all as described herein at least in connection with FIG. 9 (where processor 902 requests memory 904, executes a command to launch kernel one 918, and executes a command to free memory 920). In at least one embodiment, processor 1102 is identical to processor 1002 described herein in connection with FIG. 10.

In at least one embodiment, when processor 1102 requests memory 1104, memory is reserved for use 1114. In at least one embodiment, while graphics processor 1124 is executing kernel one 1126, memory is in use 1128 in graphics processor memory pool 1112. In at least one embodiment, graphics processor 1124 is identical to graphics processor 1024 described herein in connection with FIG. 10. In at least one embodiment, graphics processor memory pool 1112 is identical to graphics processor memory pool 1012 described herein in connection with FIG. 10. In at least one embodiment, when processor 1102 executes a command to free memory 1120 associated with kernel one, and when kernel one completes, memory that was in use 1128 in graphics processor memory pool 1112 become available 1132, as described herein.

In at least one embodiment, processor 1102 requests memory 1134, executes a command to launch kernel two 1136, and executes a command to free memory 1138, all as described herein at least in connection with FIG. 10 such as, where processor 1002 requests memory 1034, executes a command to launch kernel two 1036, and executes a command to free memory 1038. In at least one embodiment, when processor 1102 requests memory 1134 for kernel two, memory manager 1106 determines that memory that was in use 1128 in graphics processor memory pool 1112 will become available 1132 before it is used by kernel two. In at least one embodiment, memory manager reserves memory 1142 using memory that will become available 1132 for use by kernel two.

In at least one embodiment, processor 1102 executes a command to launch kernel two 1136 with a provided virtual memory pointer from memory that will become available 1132. In at least one embodiment, a graphics processor 1124 executes kernel two 1148. In at least one embodiment, graphics processor 1124 is identical to graphics processor 1024 described in connection with FIG. 10. In at least one embodiment, when memory manager 1106 determines a memory location in graphics processor memory pool as described above, memory is reserved for use 1142 from memory that will become available 1132. In at least one embodiment, memory is reserved for use 1142 so that memory will be available for use by kernel two when graphics processor 1124 executes kernel two 1148.

In at least one embodiment, processor 1102 executes a command to free memory 1138 associated with kernel two. In at least one embodiment, when kernel two completes, memory manager 1106 releases backing memory for later reuse, as described herein. In at least one embodiment, memory manager 1106 releases backing memory by returning backing memory to a memory pool and/or by making backing memory available for use or reuse), and by releasing virtual memory pointer for reuse, as described herein. In at least one embodiment, memory in graphics processor memory pool 1112 is in use 1150 while graphics processor 1124 executes kernel two 1148. In at least one embodiment, memory in graphics processor memory pool 1112 is available for reuse 1154 after kernel two completes and after memory manager 1106 releases backing memory for later reuse.

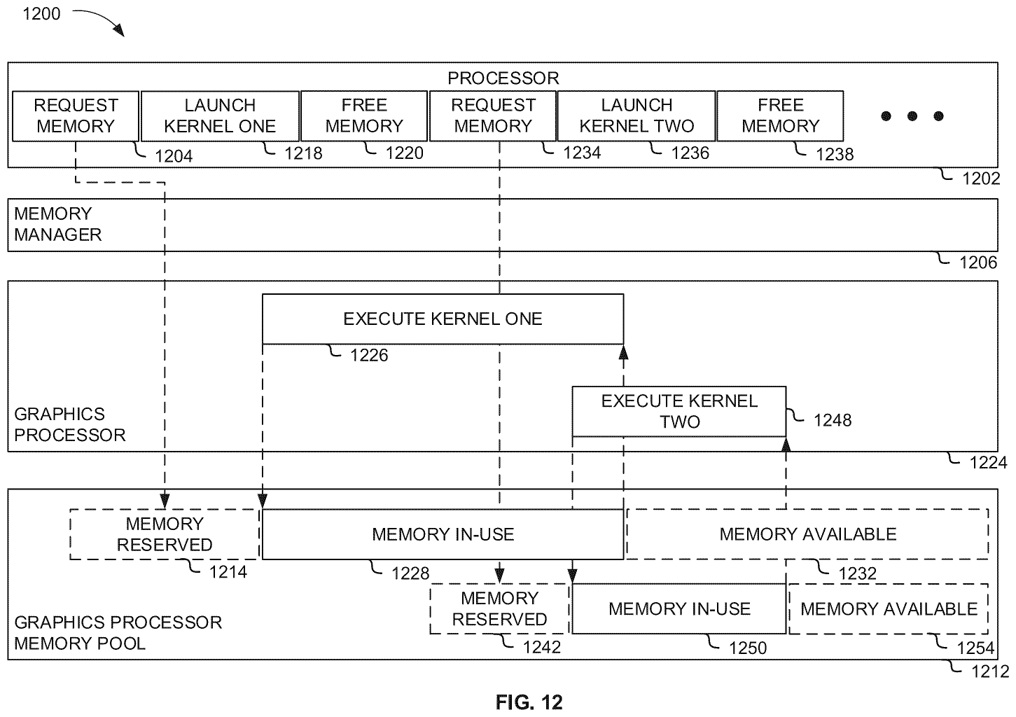

FIG. 12 illustrates an example fourth part of a data flow 1200 where memory is asynchronously allocated and deallocated, in accordance with at least one embodiment. In at least one embodiment, example fourth part of a data flow 1200 continues from example second part of a data flow 1000, described in connection with FIG. 10 and is an alternative to example third part of a data flow 1100, described herein in connection with FIG. 10. In at least one embodiment, actions of a memory manager 1206 (which is identical to memory manager 906 described herein at least in connection with FIG. 9, which is identical to memory manager 1006 described herein at least in connection with FIG. 10, and which is identical to memory manager 1106 described herein at least in connection with FIG. 11) are identical to actions of memory manager 906 and/or are identical to actions of memory manager 1006 as described herein and such actions are not illustrated in FIG. 12 for clarity.

In at least one embodiment, processor 1202 requests memory 1204, executes a command to launch kernel one 1218, and executes a command to free memory 1220, all as described herein at least in connection with FIG. 9 such as, where processor 902 requests memory 904, executes a command to launch kernel one 918, and executes a command to free memory 920. In at least one embodiment, processor 1202 is identical to processor 1002 described herein in connection with FIG. 10.

In at least one embodiment, when processor 1202 requests memory 1204, memory is reserved for use 1214. In at least one embodiment, while graphics processor 1224 is executing kernel one 1226, memory is in use 1228 in graphics processor memory pool 1212. In at least one embodiment, graphics processor 1224 is identical to graphics processor 1024 described herein in connection with FIG. 10. In at least one embodiment, graphics processor memory pool 1212 is identical to graphics processor memory pool 1012 described herein in connection with FIG. 10. In at least one embodiment, when processor 1202 executes a command to free memory 1220 associated with kernel one, and when kernel one completes, memory that was in use 1228 in graphics processor memory pool 1212 become available 1232, as described herein.

In at least one embodiment, processor 1202 requests memory 1234, executes a command to launch kernel two 1236, and executes a command to free memory 1238, all as described herein at least in connection with FIG. 10 such as, where processor 1002 requests memory 1034, executes a command to launch kernel two 1036, and executes a command to free memory 1038. In at least one embodiment, when processor 1202 requests memory 1234 for kernel two, memory manager 1206 determines that memory that was in use 1228 in graphics processor memory pool 1212 will not become available 1232 before it will be used by kernel two when, for example kernel one is still be executing. In at least one embodiment, memory manager reserves memory 1242 using other memory than memory that will become available 1232.

In at least one embodiment, processor 1202 executes a command to launch kernel two 1236 with a provided virtual memory pointer from reserved memory 1242. In at least one embodiment, a graphics processor 1224 executes kernel two 1248. In at least one embodiment, graphics processor 1224 is identical to graphics processor 1024 described in connection with FIG. 10. In at least one embodiment, when memory manager 1206 determines a memory location in graphics processor memory pool as described above, memory is reserved for use 1242 from memory that is not memory that will become available 1232. In at least one embodiment, memory is reserved for use 1242 so that memory will be available for use by kernel two when graphics processor 1224 executes kernel two 1248.

In at least one embodiment, processor 1202 executes a command to free memory 1238 associated with kernel two. In at least one embodiment, when kernel two completes, memory manager 1206 releases backing memory for later reuse, as described herein. In at least one embodiment, memory manager 1206 releases backing memory by returning backing memory to a memory pool and/or by making backing memory available for use or reuse) and by releasing virtual memory pointer for reuse, as described herein. In at least one embodiment, memory in graphics processor memory pool 1212 is in use 1250 while graphics processor 1224 executes kernel two 1248. In at least one embodiment, memory in graphics processor memory pool 1212 is available for reuse 1254 after kernel two completes and after memory manager 1206 releases backing memory for later reuse.

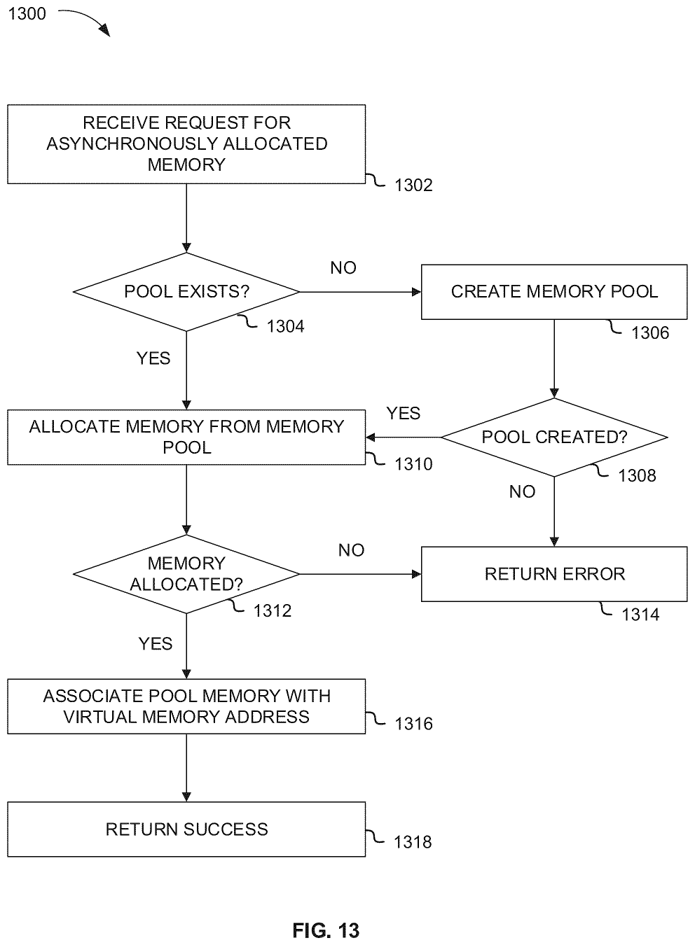

FIG. 13 illustrates an example process 1300 for performing memory management operations to asynchronously allocate memory using a memory pool, in accordance with at least one embodiment. In at least one embodiment, a memory manager such as memory manager 106 described herein at least in connection with FIG. 1 executes instructions to perform example process 1300 illustrated in FIG. 13.

In at least one embodiment, at step 1302 of example process 1300, a request for asynchronously allocated memory associated with a kernel is received using systems and methods such as those described herein. In at least one embodiment a request for asynchronously allocated memory with an associated virtual memory address that may be used to execute a kernel is received from a process such as example process 500 executing on a processor such as processor 102 described herein at least in connection with FIG. 1. In at least one embodiment, a request for asynchronously allocated memory with an associated virtual memory address that may be used to execute a kernel is received using an API. In at least one embodiment, not illustrated in FIG. 13, a response to a request for asynchronously allocated memory with an associated virtual memory address that may be used to execute a kernel is generated. In at least one embodiment, a response to receiving a request for asynchronously allocated memory with an associated virtual memory address that may be used to execute a kernel is generated using an API. In at least one embodiment, after step 1302, execution of example process 1300 advances to step 1304.

In at least one embodiment, at step 1304 of example process 1300, it is determined whether a previously allocated memory pool exists such as, for example, memory that has been previously created as described herein. In at least one embodiment, at step 1304, if it is determined that a previously allocated memory pool exists (“YES” branch), execution of example process advances to step 1310. In at least one embodiment, at step 1304, if it is determined that a previously allocated memory pool does not exist (“NO” branch), execution of example process advances to step 1306.

In at least one embodiment, at step 1306 of example process 1300, a memory pool is created by allocating memory for a memory pool using systems and methods such as those described herein. In at least one embodiment, after step 1306, execution of example process 1300 advances to step 1308.

In at least one embodiment, at step 1308 of example process 1300, it is determined whether a memory pool was successfully created. In at least one embodiment, at step 1308, if it is determined that a memory pool was successfully created (“YES” branch), execution of example process advances to step 1310. In at least one embodiment, at step 1308, if it is determined that a memory pool was not successfully created (“NO” branch), execution of example process advances to step 1314.

In at least one embodiment, at step 1310 of example process 1300, memory is allocated from a memory pool using systems and methods such as those described herein. In at least one embodiment, after step 1310, execution of example process 1300 advances to step 1312.

In at least one embodiment, at step 1312 of example process 1300, it is determined whether memory was successfully allocated from a memory pool. In at least one embodiment, at step 1312, if it is determined that memory was successfully allocated from a memory pool (“YES” branch), execution of example process advances to step 1316. In at least one embodiment, at step 1312, if it is determined that memory was not successfully allocated from a memory pool (“NO” branch), execution of example process advances to step 1314.

In at least one embodiment, at step 1314 of example process 1300, as a result of determining that memory was not successfully allocated from a memory pool (in step 1310), an indication of failure is returned. In at least one embodiment, an indication of failure is returned to a requesting process. In at least one embodiment, an indication of failure is returned to a requesting process such as example process 500 executing on a processor such as processor 102 described herein at least in connection with FIG. 1. In at least one embodiment, an indication of failure is returned using an API. In at least one embodiment, an indication of failure is returned to a calling process using a signal. In at least one embodiment an indication of failure is returned to a calling process using a semaphore. In at least one embodiment, not illustrated in FIG. 13, a response to an indication of failure is received. In at least one embodiment, after step 1314, example process 1300 terminates. In at least one embodiment, after step 1314, example process 1300 returns to step 1302 to receive a new request to execute a kernel with an associated virtual memory address.

In at least one embodiment, at step 1316 of example process 1300, memory allocated from a memory pool is associated with a virtual memory address such as, for example, a virtual memory address received in step 1302, using systems and methods such as those described herein. In at least one embodiment, after step 1316, execution of example process 1300 advances to step 1318.

In at least one embodiment, at step 1318 of example process 1300 as a result of determining that memory was not successfully allocated from a memory pool (in step 1310), an indication of failure is returned using systems and methods such as those described in connection with step 1314, using an API, using a signal, and/or using a semaphore. In at least one embodiment, after step 1318, example process 1300 terminates. In at least one embodiment, after step 1318, example process 1300 returns to step 1302 to 1302 to receive a new request to execute a kernel with an associated virtual memory address.

In at least one embodiment, operations of example process 1300 illustrated in FIG. 13 are performed in a different order than indicated in FIG. 13. In at least one embodiment, operations of example process 1300 illustrated in FIG. 13 are performed simultaneously and/or in parallel. In at least one embodiment, operations of example process 1300 illustrated in FIG. 13 are performed by a plurality of threads executing on a memory manager such as memory manager 106 described herein at least in connection with FIG. 1.

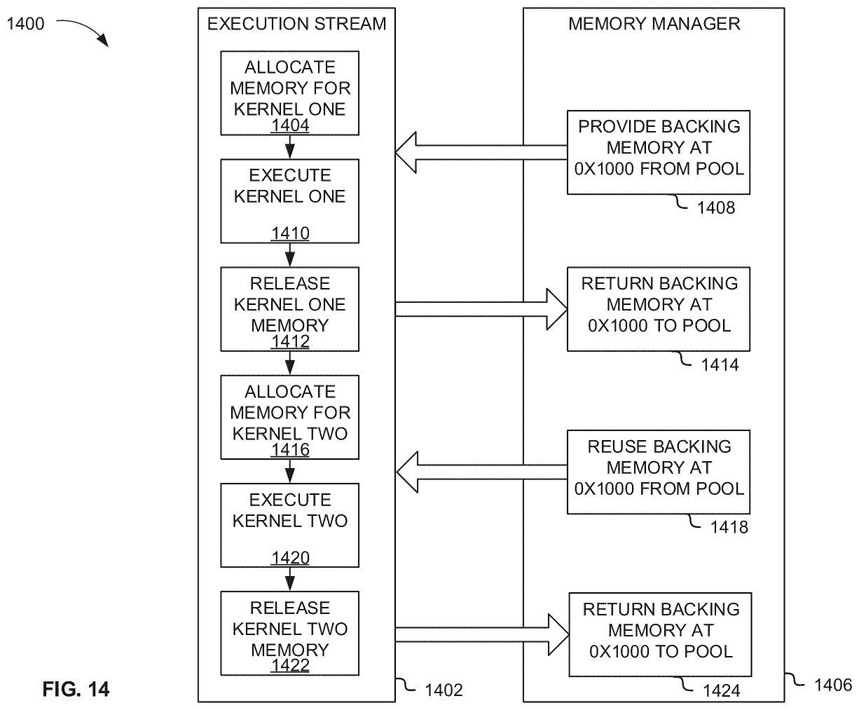

FIG. 14 illustrates an example computer system 1400 where memory management operations to asynchronously allocate memory using a memory pool for a single execution stream are performed, in accordance with at least one embodiment. In at least one embodiment, an execution stream 1402 indicates a stream order for operations that use one or more memory locations in asynchronously allocated memory allocated from a memory pool. In at least one embodiment, execution stream 1402 indicates ordered operations to allocate memory for kernel one 1404, execute kernel one 1410, release kernel one memory 1412, allocate memory for kernel two 1416, execute kernel two 1420, and release kernel two memory 1422.

In at least one embodiment, operations specified in execution stream 1402 may be implicit. In at least one embodiment, for example, an ordered operation to allocate memory for kernel one 1404 may be automatically executed when an ordered operation to execute kernel one 1410 is executed and an ordered operation to release kernel one memory 1412 may be automatically executed when an ordered operation to execute kernel one 1410 completes. In at least one embodiment, operations specified in execution stream 1402 may be explicitly called by, for example, an API, using systems and methods such as those described herein.

In at least one embodiment, when execution stream 1402 indicates execution of an ordered operation to allocate memory for kernel one 1404, a memory manager 1406 (which is a memory manager such as memory manager 106 described herein at least in connection with FIG. 1) provides backing memory 1408 from a memory pool using systems and methods such as those described herein. In at least one embodiment, for example, memory manager 1406 may provide backing memory from a memory pool at address 0X1000.

In at least one embodiment, when execution stream 1402 indicates execution of an ordered operation to release kernel one memory 1412, memory manager 1406 may perform one or more operations to return backing memory to a memory pool 1414, may perform one or more operations to mark backing memory as reusable, and/or may perform one or more operations to release a virtual memory pointer associated with said backing memory, using systems and methods such as those described herein.

In at least one embodiment, when execution stream 1402 indicates execution of an ordered operation to allocate memory for kernel two 1416, memory manager 1406 provides backing memory 1418 from a memory pool using systems and methods such as those described herein. In at least one embodiment, memory manager 1406 reuses backing memory at address 0X1000 because, due to an order of operations specified by execution stream 1402, memory manager 1406 determines that kernel one will complete before kernel two is executed and, accordingly, memory available to kernel one may be reused by kernel two and may, for example, be made available to kernel two).

In at least one embodiment, when execution stream 1402 indicates execution of an ordered operation to release kernel two memory 1422, memory manager 1406 may perform one or more operations to return backing memory to a memory pool 1424, may perform one or more operations to mark said backing memory as reusable, and/or may perform one or more operations to release a virtual memory pointer associated with said backing memory, using systems and methods such as those described herein.

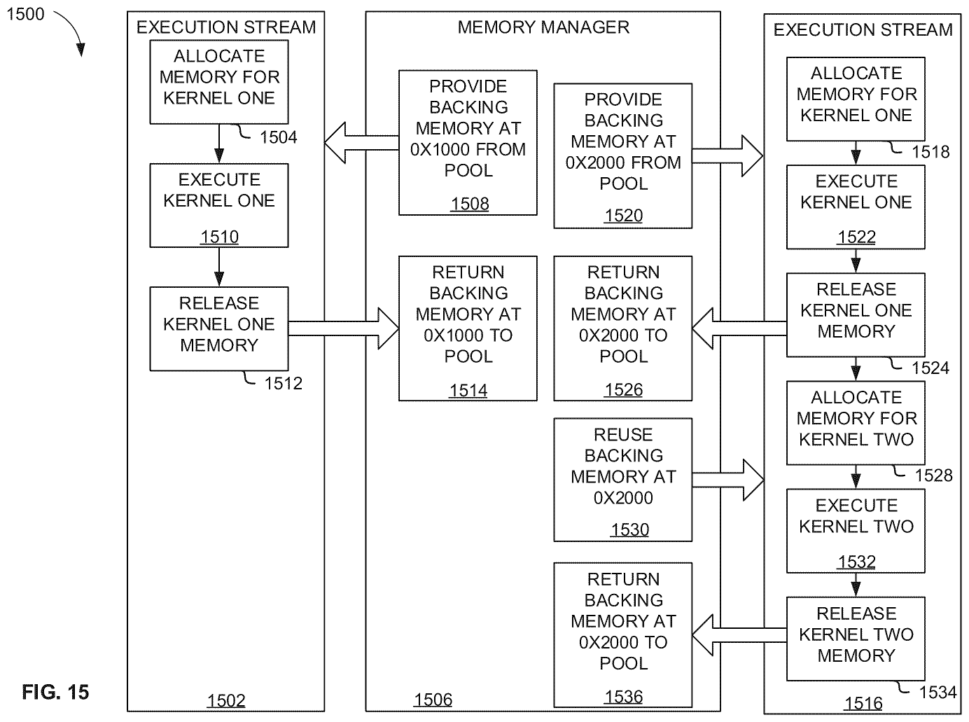

FIG. 15 illustrates an example computer system 1500 where memory management operations to asynchronously allocate memory using a memory pool for a plurality of execution streams are performed, in accordance with at least one embodiment. In at least one embodiment, an execution stream indicates a stream order for operations that use one or more memory locations in asynchronously allocated memory allocated from a memory pool. In at least one embodiment, a first execution stream 1502 indicates ordered operations to allocate memory for kernel one 1504, execute kernel one 1510, and release kernel one memory 1512. In at least one embodiment, a second execution stream 1516 indicates ordered operations to allocate memory for kernel one 1518, execute kernel one 1522, release kernel one memory 1524, allocate memory for kernel two 1528, execute kernel two 1532, and release kernel two memory 1534. In at least one embodiment, operations specified in first execution stream 1502 may be implicit, may be explicit, and/or may be called by an API and operations specified in second execution stream 1516 may also be implicit, may be explicit, and/or may called by an API.

In at least one embodiment, when first execution stream 1502 indicates execution of an ordered operation to allocate memory for kernel one 1504, a memory manager 1506 (which is a memory manager such as memory manager 106 described herein at least in connection with FIG. 1) provides backing memory 1508 from a memory pool using systems and methods such as those described herein. In at least one embodiment, for example, memory manager 1506 may provide backing memory from a memory pool at address 0X1000. In at least one embodiment, when first execution stream 1502 indicates execution of an ordered operation to release kernel one memory 1512, memory manager 1506 may perform one or more operations to return backing memory to a memory pool 1514, using systems and methods such as those described herein.

In at least one embodiment, when second execution stream 1516 indicates execution of an ordered operation to allocate memory for kernel one 1518, memory manager 1506 provides backing memory 1520 from a memory pool using systems and methods such as those described herein. In at least one embodiment, for example, memory manager 1506 may provide backing memory from a memory pool at address 0X2000. In at least one embodiment, memory manager 1506 may not provide backing memory from a memory pool at address 0X1000 (may not reuse memory at address 0X1000) because execution of kernel one from execution stream 1502 may or may not be complete. In at least one embodiment, when second execution stream 1516 indicates execution of an ordered operation to release kernel one memory 1524, memory manager 1506 may perform one or more operations to return backing memory to a memory pool 1526, using systems and methods such as those described herein.

In at least one embodiment, when second execution stream 1516 indicates execution of an ordered operation to allocate memory for kernel two 1518, memory manager 1506 provides backing memory 1508 from a memory pool using systems and methods such as those described herein. In at least one embodiment, memory manager 1506 may reuse backing memory 1530 at address 0X2000 because, due to an order of operations specified by execution stream 1516, memory manager 1506 determines that kernel one will complete before kernel two is executed and, accordingly, memory available to kernel one may be reused by kernel two. In at least one embodiment, memory manager 1506 still may not provide backing memory from a memory pool at address 0X1000 (may not reuse memory at address 0X1000) because execution of kernel one from execution stream 1502 still may or may not be complete. In at least one embodiment, when second execution stream 1516 indicates execution of an ordered operation to release kernel two memory 1534, memory manager 1506 may perform one or more operations to return backing memory to a memory pool 1536, using systems and methods such as those described herein.

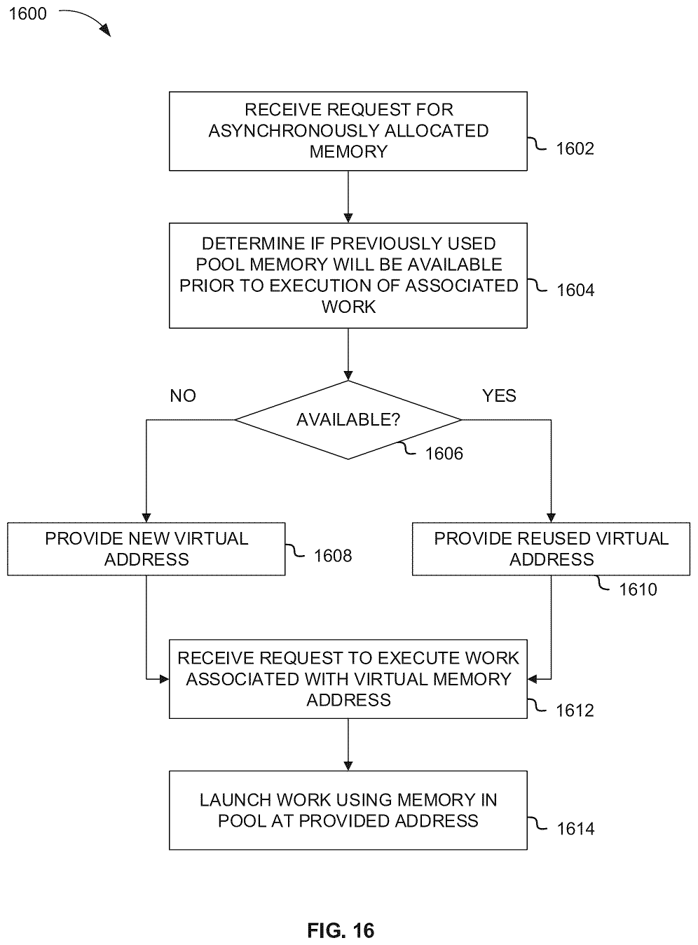

FIG. 16 illustrates an example process 1600 for performing memory management operations to reuse asynchronously allocated memory from a memory pool, in accordance with at least one embodiment. In at least one embodiment, a memory manager such as memory manager 106 described herein at least in connection with FIG. 1 executes instructions to perform example process 1600 illustrated in FIG. 16.

In at least one embodiment, at step 1602 of example process 1600, a request is received for asynchronously allocated memory. In at least one embodiment, a request for asynchronously allocated memory is received from a process such as example process 500 executing on a processor such as processor 102 described herein at least in connection with FIG. 1. In at least one embodiment, a request for asynchronously allocated memory is received using an API, as described herein at least in connection with FIG. 5. In at least one embodiment, not illustrated in FIG. 16, a response to receiving a request for asynchronously allocated memory is generated. In at least one embodiment, a response to receiving a request for asynchronously allocated memory is generated using an API. In at least one embodiment, after step 1602, execution of example process 1600 advances to step 1604.

In at least one embodiment, at step 1604 of example process 1600, a determination is made as to whether previously used pool memory will be available prior to execution of work associated with a request for asynchronously allocated memory such as, for example, a kernel. In at least one embodiment, a determination is made as to whether previously used pool memory will be available prior to execution of work associated with a request for asynchronously allocated memory based at least in part on a stream execution order, as described herein at least in connection with FIG. 14 and FIG. 15. In at least one embodiment, after step 1604, execution of example process 1600 advances to step 1606.

In at least one embodiment, at step 1606 of example process 1600, if it is determined that previously used pool memory will be available prior to execution of work associated with a request for asynchronously allocated memory as described in step 1604 (“YES” branch), execution of example process advances to step 1610. In at least one embodiment, at step 1606, if it is determined that previously used pool memory will not be available prior to execution of work associated with a request for asynchronously allocated memory as described in step 1604 (“NO” branch), execution of example process advances to step 1608.

In at least one embodiment, at step 1608 of example process 1600, a new, not reused, virtual address is provided using systems and methods such as those described herein. In at least one embodiment, a new virtual address is provided to a requesting process such as example process 500, described herein. In at least one embodiment, a new virtual address is provided to a requesting process executing on a processor such as processor 102 described herein at least in connection with FIG. 1. In at least one embodiment, a new virtual address is provided using an API as described herein at least in connection with FIG. 5. In at least one embodiment, not illustrated in FIG. 16, a response to a provided new virtual memory address is received. In at least one embodiment, a response to a provided new virtual memory address is received from a processor such as processor 102 described herein at least in connection with FIG. 1. In at least one embodiment, a response to a provided a provided new virtual memory address is received using an API. In at least one embodiment, after step 1608, execution of example process 1600 advances to step 1612.

In at least one embodiment, at step 1610 of example process 1600, a reused virtual address such as, a virtual address that was previously used, as described herein in connection with FIG. 14 and FIG. 15, is provided using systems and methods such as those described in connection with step 1608. In at least one embodiment, after step 1610, execution of example process 1600 advances to step 1612.

In at least one embodiment, at step 1612 of example process 1600, a request is received to execute work associated with a virtual memory address using systems and methods such as those described herein. In at least one embodiment, a request is received to execute work associated with a virtual memory address using systems and methods such as those described in connection with step 1602 such as, from a calling process and/or using an API. In at least one embodiment, after step 1612, execution of example process 1600 advances to step 1614.

In at least one embodiment, at step 1614 of example process 1600, work that uses memory from a memory pool at an address provided in step 1608 or step 1610 is launched, using systems and methods such as those described herein. In at least one embodiment, after step 1614, execution of example process 1600 terminates. In at least one embodiment, after step 1614, example process 1600 returns to step 1602 to receive a new request for asynchronously allocated memory.

In at least one embodiment, operations of example process 1600 illustrated in FIG. 16 are performed in a different order than indicated in FIG. 16. In at least one embodiment, operations of example process 1600 illustrated in FIG. 16 are performed simultaneously and/or in parallel. In at least one embodiment, operations of example process 1600 illustrated in FIG. 16 are performed by a plurality of threads executing on a memory manager such as memory manager 106 described herein at least in connection with FIG. 1.

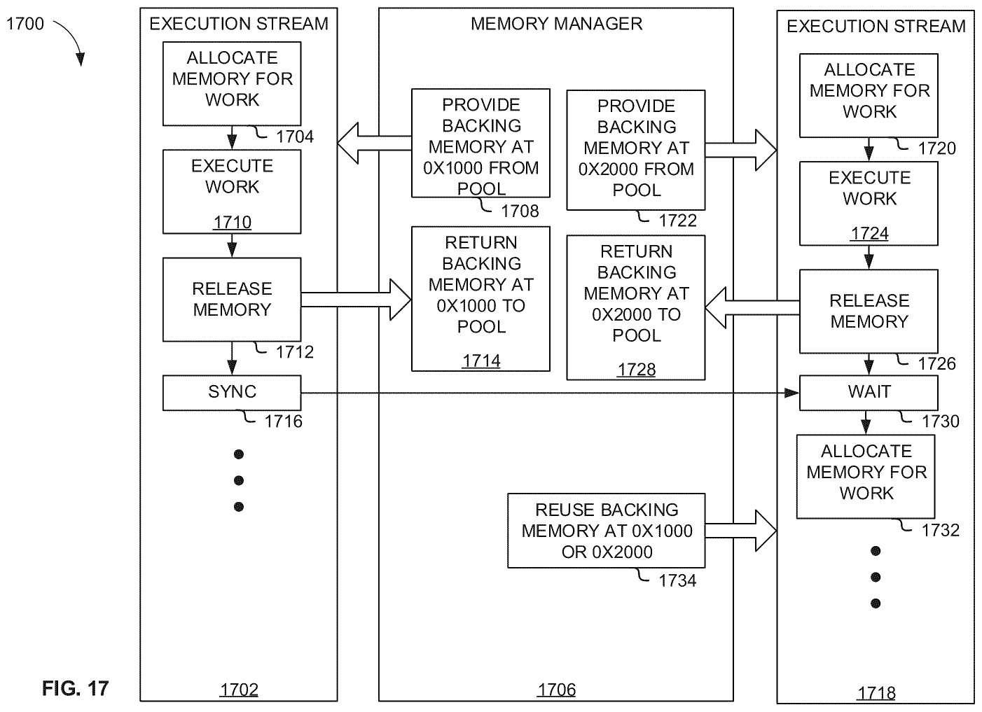

FIG. 17 illustrates an example computer system 1700 where memory management operations to reuse asynchronously allocated memory from a memory pool for a plurality of synchronized execution streams are performed, in accordance with at least one embodiment. In at least one embodiment, an execution stream indicates a stream order for operations that use one or more memory locations in asynchronously allocated memory allocated from a memory pool. In at least one embodiment, a first execution stream 1702 indicates ordered operations to allocate memory for work 1704 associated with asynchronously allocated memory, execute associated work 1710, and release memory 1712. In at least one embodiment, first execution stream 1702 indicates an ordered operation to sync 1716 with a second execution stream 1718. In at least one embodiment, operations specified in first execution stream 1702 may be implicit, may be explicit, and/or may be called by an API.

In at least one embodiment, second execution stream 1718 indicates ordered operations to allocate memory for work 1720 associated with asynchronously allocated memory, execute work 1724, release memory 1726, and allocate memory for work 1732. In at least one embodiment, not shown in FIG. 17, second execution stream 1718 may also indicate ordered operations to execute work and release allocated memory. In at least one embodiment, second execution stream 1718 indicates an ordered operation to wait 1730 for a sync from execution stream 1702. In at least one embodiment, operations specified in second execution stream 1718 may also be implicit, may be explicit, and/or may be called by an API.

In at least one embodiment, when first execution stream 1702 indicates execution of an ordered operation to allocate memory for work 1704, a memory manager 1706 (which is a memory manager such as memory manager 106 described herein at least in connection with FIG. 1) provides memory 1708 from a memory pool at address 0X1000 using systems and methods such as those described herein. In at least one embodiment, when first execution stream 1702 indicates execution of an ordered operation to release memory 1712, memory manager 1706 may perform one or more operations to return backing memory to a memory pool 1714, using systems and methods such as those described herein.

In at least one embodiment, when second execution stream 1718 indicates execution of an ordered operation to allocate memory for work 1720, memory manager 1706 provides backing memory 1722 from a memory pool at address 0X2000 using systems and methods such as those described herein. In at least one embodiment, memory manager 1706 may not provide backing memory from a memory pool at address 0X1000 (may not reuse memory at address 0X1000) because execution of work from execution stream 1702 may or may not be complete. In at least one embodiment, when second execution stream 1718 indicates execution of an ordered operation to release memory 1726, memory manager 1706 may perform one or more operations to return backing memory to a memory pool 1728, using systems and methods such as those described herein.

In at least one embodiment, first execution stream 1702 indicates an ordered operation to sync 1716 with second execution stream 1718 and second execution stream 1718 indicates an ordered operation to wait 1730 for a sync from execution stream 1702. In at least one embodiment, when second execution stream 1718 indicates execution of an ordered operation to allocate memory for work 1732, memory manager 1706 provides backing memory 1708 from a memory pool using systems and methods such as those described herein. In at least one embodiment, memory manager 1706 may reuse backing memory 1734 at address 0X2000 because, due to an order of operations specified by second execution stream 1718, memory manager 1706 can determine that work in execution stream 1718 will complete before other work is executed and, accordingly, memory available may be reused. In at least one embodiment, memory manager 1706 also reuse 1734 backing memory from a memory pool at address 0X1000 because execution of work from first execution stream 1702 will be complete before beginning execution of additional work from second execution stream 1718 due to sync and wait operations.

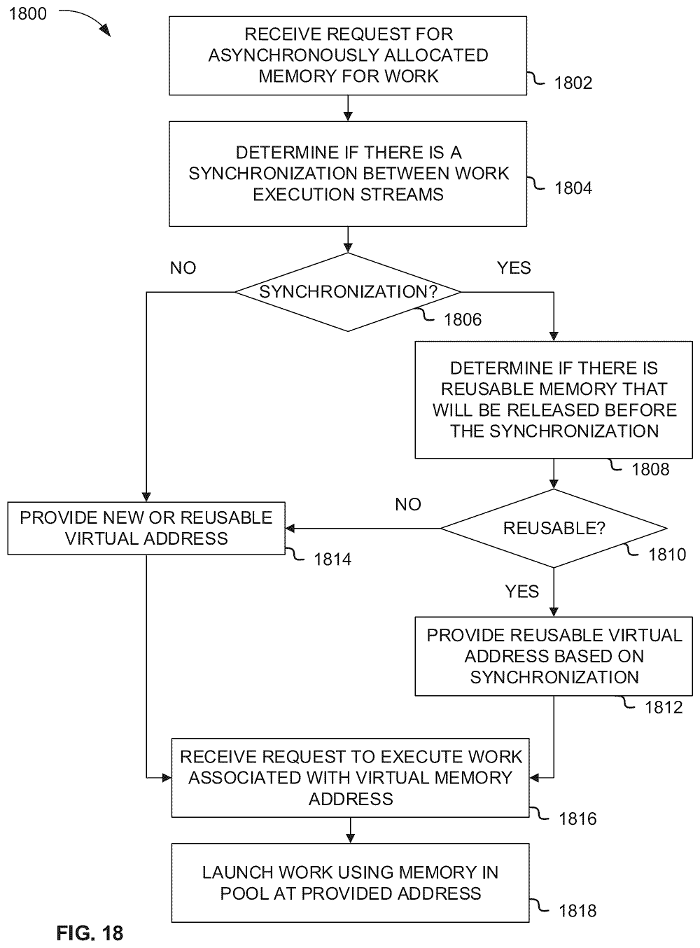

FIG. 18 illustrates an example process 1800 for performing memory management operations to reuse asynchronously allocated memory from a memory pool for a plurality of synchronized execution streams, in accordance with at least one embodiment. In at least one embodiment, a memory manager such as memory manager 106 described herein at least in connection with FIG. 1 executes instructions to perform example process 1800 illustrated in FIG. 18.

In at least one embodiment, at step 1802 of example process 1800, a request is received for asynchronously allocated memory for an execution stream, as described herein. In at least one embodiment, a request for an asynchronously allocated memory is received from a process such as process 500, described herein at least in connection with FIG. 5. In at least one embodiment, a request for asynchronously allocated memory is received from a processor such as processor 102 described herein at least in connection with FIG. 1. In at least one embodiment, a process sends a request for asynchronously allocated memory on behalf of another process. In at least one embodiment, a request for asynchronously allocated memory is received using an API as described herein at least in connection with FIG. 5. In at least one embodiment, not illustrated in FIG. 18, a response to receiving a request for asynchronously allocated memory is generated. In at least one embodiment, a response to a request for asynchronously allocated memory is generated using an API. In at least one embodiment, after step 1802, execution of example process 1800 advances to step 1804.

In at least one embodiment, at step 1804 of example process 1800, it is determined whether there is a synchronization event between a first execution stream and a second execution stream. In at least one embodiment, a memory manager may examine an execution stream to determine if there is a synchronization event between a first execution stream and a second execution stream. In at least one embodiment, a memory manager may examine a specification for a stream order of an execution stream to determine if there is a synchronization event between a first execution stream and a second execution stream. In at least one embodiment, a memory manager may examine a specification for an execution graph of an execution stream to determine if there is a synchronization event between a first execution stream and a second execution stream. In at least one embodiment, after step 1804, execution of example process 1800 advances to step 1806.

In at least one embodiment, at step 1806 of example process 1800, if it is determined (in step 1806) that there is a synchronization event between a first execution stream and a second execution stream (“YES” branch), execution of example process advances to step 1808. In at least one embodiment, at step 1806, if it is determined (in step 1806) that there is not a synchronization event between a first execution stream and a second execution stream (“NO” branch), execution of example process advances to step 1814.

In at least one embodiment, at step 1808 of example process 1800, it is determined whether there is reusable memory in another execution stream and whether there is a synchronization event between a first execution stream and a second execution stream. In at least one embodiment, after step 1808, execution of example process 1800 advances to step 1810.

In at least one embodiment, at step 1810 of example process 1800, if it is determined (in step 1808) that there is reusable memory in another execution stream that may be released before a synchronization event (“YES” branch), execution of example process advances to step 1812. In at least one embodiment, at step 1810, if it is determined (in step 1808) that there is not reusable memory in another execution stream that may be released before a synchronization event (“NO” branch), execution of example process advances to step 1814.

In at least one embodiment, at step 1812 of example process 1800, a reusable virtual address determined based on synchronization is provided. In at least one embodiment, a reusable virtual address determined based on synchronization is provided to a process such as example process 500, described herein at least in connection with FIG. 5. In at least one embodiment a reusable virtual address determined based on synchronization is provided to a processor such as processor 102 described herein at least in connection with FIG. 1. In at least one embodiment a reusable virtual address determined based on synchronization is provided to a graphics processor such as graphics processor 108 described herein at least in connection with FIG. 1. In at least one embodiment, a reusable virtual address determined based on synchronization is provided using an API as described herein at least in connection with FIG. 5.

In at least one embodiment, not illustrated in FIG. 18, a response to a provided reusable virtual address determined based on synchronization is received. In at least one embodiment, a response to a provided reusable virtual address determined based on synchronization is received from a process such as example process 500, described herein at least in connection with FIG. 5. In at least one embodiment, a response to a provided reusable virtual address determined based on synchronization is received a processor such as processor 102 described herein at least in connection with FIG. 1. In at least one embodiment a response to a provided reusable virtual address determined based on synchronization is received from a graphics processor such as graphics processor 108 described herein at least in connection with FIG. 1. In at least one embodiment, a response to a provided reusable virtual address determined based on synchronization is received using an API. In at least one embodiment, after step 1812, execution of example process 1800 advances to step 1816.

In at least one embodiment, at step 1814 of example process 1800, a new or a reusable virtual address is generated using systems and methods such as those described herein, at least in connection with FIGS. 14-17 and is provided using systems and methods such as those described in connection with step 1812. In at least one embodiment, after step 1814, execution of example process 1800 advances to step 1816.

In at least one embodiment, at step 1816 of example process 1800, a request is received to execute work associated with a virtual memory address using systems and methods such as those described herein. In at least one embodiment, a request is received to execute work associated with a virtual memory address using systems and methods such as those described in connection with step 1802 such as, from a calling process and/or using an API. In at least one embodiment, after step 1816, execution of example process 1600 advances to step 1818.

In at least one embodiment, at step 1818 of example process 1800, work that uses memory from a memory pool at an address provided in step 1812 or step 1814 is launched, using systems and methods such as those described herein. In at least one embodiment, after step 1818, execution of example process 1800 terminates. In at least one embodiment, after step 1818, example process 1800 returns to step 1802 to receive a new request for asynchronously allocated memory.

In at least one embodiment, operations of example process 1800 illustrated in FIG. 18 are performed in a different order than indicated in FIG. 18. In at least one embodiment, operations of example process 1800 illustrated in FIG. 18 are performed simultaneously and/or in parallel. In at least one embodiment, operations of example process 1800 illustrated in FIG. 18 are performed by a plurality of threads executing on a memory manager such as memory manager 106 described herein at least in connection with FIG. 1.

In the following description, numerous specific details are set forth to provide a more thorough understanding of at least one embodiment. However, it will be apparent to one skilled in the art that the inventive concepts may be practiced without one or more of these specific details.

### Data Center

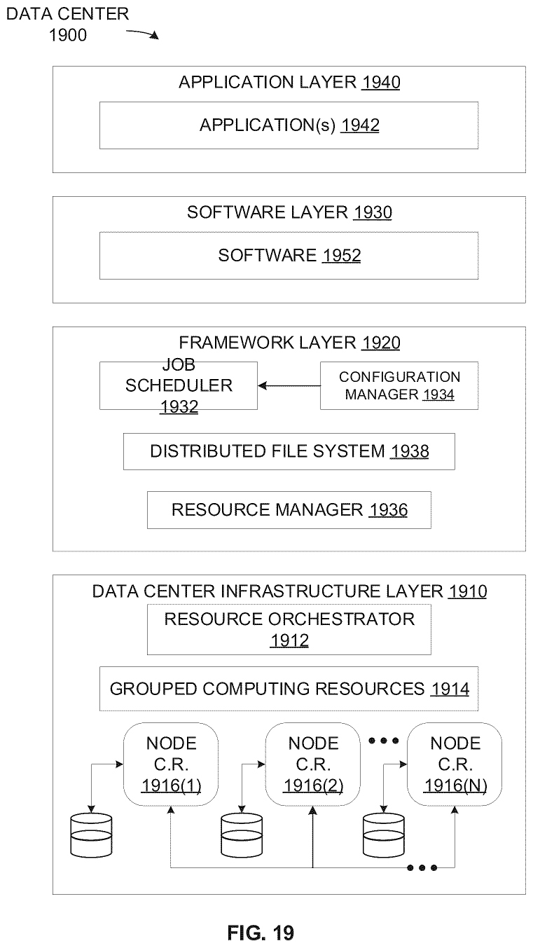

FIG. 19 illustrates an exemplary data center 1900, in accordance with at least one embodiment. In at least one embodiment, data center 1900 includes, without limitation, a data center infrastructure layer 1910, a framework layer 1920, a software layer 1930 and an application layer 1940.

In at least one embodiment, as shown in FIG. 19, data center infrastructure layer 1910 may include a resource orchestrator 1912, grouped computing resources 1914, and node computing resources (“node C.R.s”) 1916(1)-1916(N), where “N” represents any whole, positive integer. In at least one embodiment, node C.R.s 1916(1)-1916(N) may include, but are not limited to, any number of central processing units (“CPUs”) or other processors (including accelerators, field programmable gate arrays (“FPGAs”), data processing units (“DPUs”) in network devices, graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 1916(1)-1916(N) may be a server having one or more of above-mentioned computing resources.

In at least one embodiment, grouped computing resources 1914 may include separate groupings of node C.R.s housed within one or more racks (not shown), or many racks housed in data centers at various geographical locations (also not shown). Separate groupings of node C.R.s within grouped computing resources 1914 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 1912 may configure or otherwise control one or more node C.R.s 1916(1)-1916(N) and/or grouped computing resources 1914. In at least one embodiment, resource orchestrator 1912 may include a software design infrastructure (“SDI”) management entity for data center 1900. In at least one embodiment, resource orchestrator 1912 may include hardware, software or some combination thereof.

In at least one embodiment, as shown in FIG. 19, framework layer 1920 includes, without limitation, a job scheduler 1932, a configuration manager 1934, a resource manager 1936 and a distributed file system 1938. In at least one embodiment, framework layer 1920 may include a framework to support software 1952 of software layer 1930 and/or one or more application(s) 1942 of application layer 1940. In at least one embodiment, software 1952 or application(s) 1942 may respectively include web-based service software or applications, such as those provided by Amazon Web Services, Google Cloud and Microsoft Azure. In at least one embodiment, framework layer 1920 may be, but is not limited to, a type of free and open-source software web application framework such as Apache Spark™ (hereinafter “Spark”) that may utilize distributed file system 1938 for large-scale data processing (e.g., “big data”). In at least one embodiment, job scheduler 1932 may include a Spark driver to facilitate scheduling of workloads supported by various layers of data center 1900. In at least one embodiment, configuration manager 1934 may be capable of configuring different layers such as software layer 1930 and framework layer 1920, including Spark and distributed file system 1938 for supporting large-scale data processing. In at least one embodiment, resource manager 1936 may be capable of managing clustered or grouped computing resources mapped to or allocated for support of distributed file system 1938 and job scheduler 1932. In at least one embodiment, clustered or grouped computing resources may include grouped computing resource 1914 at data center infrastructure layer 1910. In at least one embodiment, resource manager 1936 may coordinate with resource orchestrator 1912 to manage these mapped or allocated computing resources.

In at least one embodiment, software 1952 included in software layer 1930 may include software used by at least portions of node C.R.s 1916(1)-1916(N), grouped computing resources 1914, and/or distributed file system 1938 of framework layer 1920. One or more types of software may include, but are not limited to, Internet web page search software, e-mail virus scan software, database software, and streaming video content software.

In at least one embodiment, application(s) 1942 included in application layer 1940 may include one or more types of applications used by at least portions of node C.R.s 1916(1)-1916(N), grouped computing resources 1914, and/or distributed file system 1938 of framework layer 1920. In at least one or more types of applications may include, without limitation, CUDA applications.

In at least one embodiment, any of configuration manager 1934, resource manager 1936, and resource orchestrator 1912 may implement any number and type of self-modifying actions based on any amount and type of data acquired in any technically feasible fashion. In at least one embodiment, self-modifying actions may relieve a data center operator of data center 1900 from making possibly bad configuration decisions and possibly avoiding underutilized and/or poor performing portions of a data center.

In at least one embodiment, at least one component shown or described with respect to FIG. 19 is utilized to implement techniques and/or functions described in connection with FIGS. 1-18. In at least one embodiment, at least one of grouped computing resources 1914 and node C.R. 1916(1-N) are used to perform asynchronous memory allocation and/or asynchronous memory deallocation. In at least one embodiment, at least one of grouped computing resources 1914 and node C.R. 1916(1-N) are used to perform an API to cause one or more memory locations to be asynchronously allocated to one or more processors. In at least one embodiment, at least one of grouped computing resources 1914 and node C.R. 1916(1-N) are used to perform an API to cause one or more memory locations to be asynchronously allocated to one or more processors. In at least one embodiment, at least one of grouped computing resources 1914 and node C.R. 1916(1-N) are used to perform an API to cause one or more memory locations to be asynchronously deallocated from one or more processors. In at least one embodiment, at least one of grouped computing resources 1914 and node C.R. 1916(1-N) are used to perform at least one aspect described with respect to example computer system 100, example computer system 200, example computer system 300, example computer system 400, example process 500, example process 600, example process 700, example process 800, example data flow 900, example first part of a data flow 1000, example second part of a data flow 1100, example third part of a data flow 1200, example process 1300, example computer system 1400, example computer system 1500, example process 1600, example computer system 1700, and/or example process 1800.

### Computer-Based Systems

The following figures set forth, without limitation, exemplary computer-based systems that can be used to implement at least one embodiment.

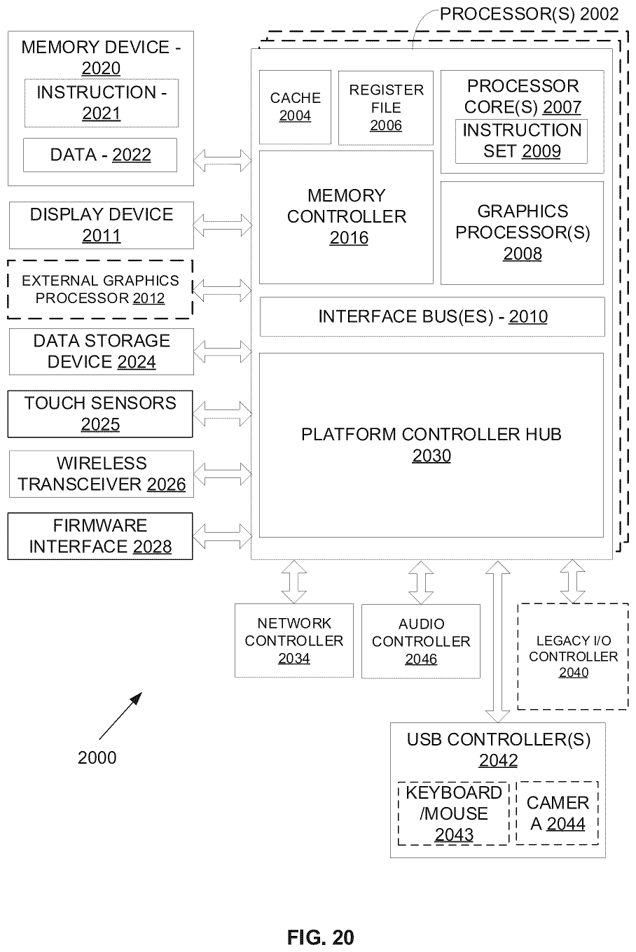

FIG. 20 illustrates a processing system 2000, in accordance with at least one embodiment. In at least one embodiment, processing system 2000 includes one or more processors 2002 and one or more graphics processors 2008, and may be a single processor desktop system, a multiprocessor workstation system, or a server system having a large number of processors 2002 or processor cores 2007. In at least one embodiment, processing system 2000 is a processing platform incorporated within a system-on-a-chip (“SoC”) integrated circuit for use in mobile, handheld, or embedded devices.

In at least one embodiment, processing system 2000 can include, or be incorporated within a server-based gaming platform, a game console, a media console, a mobile gaming console, a handheld game console, or an online game console. In at least one embodiment, processing system 2000 is a mobile phone, smart phone, tablet computing device or mobile Internet device. In at least one embodiment, processing system 2000 can also include, couple with, or be integrated within a wearable device, such as a smart watch wearable device, smart eyewear device, augmented reality device, or virtual reality device. In at least one embodiment, processing system 2000 is a television or set top box device having one or more processors 2002 and a graphical interface generated by one or more graphics processors 2008.

In at least one embodiment, one or more processors 2002 each include one or more processor cores 2007 to process instructions which, when executed, perform operations for system and user software. In at least one embodiment, each of one or more processor cores 2007 is configured to process a specific instruction set 2009. In at least one embodiment, instruction set 2009 may facilitate Complex Instruction Set Computing (“CISC”), Reduced Instruction Set Computing (“RISC”), or computing via a Very Long Instruction Word (“VLIW”). In at least one embodiment, processor cores 2007 may each process a different instruction set 2009, which may include instructions to facilitate emulation of other instruction sets. In at least one embodiment, processor core 2007 may also include other processing devices, such as a digital signal processor (“DSP”).

In at least one embodiment, processor 2002 includes cache memory (‘cache”) 2004. In at least one embodiment, processor 2002 can have a single internal cache or multiple levels of internal cache. In at least one embodiment, cache memory is shared among various components of processor 2002. In at least one embodiment, processor 2002 also uses an external cache (e.g., a Level 3 (“L3”) cache or Last Level Cache (“LLC”)) (not shown), which may be shared among processor cores 2007 using known cache coherency techniques. In at least one embodiment, register file 2006 is additionally included in processor 2002 which may include different types of registers for storing different types of data (e.g., integer registers, floating point registers, status registers, and an instruction pointer register). In at least one embodiment, register file 2006 may include general-purpose registers or other registers.

In at least one embodiment, one or more processor(s) 2002 are coupled with one or more interface bus(es) 2010 to transmit communication signals such as address, data, or control signals between processor 2002 and other components in processing system 2000. In at least one embodiment interface bus 2010, in one embodiment, can be a processor bus, such as a version of a Direct Media Interface (“DMI”) bus. In at least one embodiment, interface bus 2010 is not limited to a DMI bus, and may include one or more Peripheral Component Interconnect buses (e.g., “PCI,” PCI Express (“PCIe”)), memory buses, or other types of interface buses. In at least one embodiment processor(s) 2002 include an integrated memory controller 2016 and a platform controller hub 2030. In at least one embodiment, memory controller 2016 facilitates communication between a memory device and other components of processing system 2000, while platform controller hub (“PCH”) 2030 provides connections to Input/Output (“I/O”) devices via a local I/O bus.

In at least one embodiment, memory device 2020 can be a dynamic random access memory (“DRAM”) device, a static random access memory (“SRAM”) device, flash memory device, phase-change memory device, or some other memory device having suitable performance to serve as processor memory. In at least one embodiment memory device 2020 can operate as system memory for processing system 2000, to store data 2022 and instructions 2021 for use when one or more processors 2002 executes an application or process. In at least one embodiment, memory controller 2016 also couples with an optional external graphics processor 2012, which may communicate with one or more graphics processors 2008 in processors 2002 to perform graphics and media operations. In at least one embodiment, a display device 2011 can connect to processor(s) 2002. In at least one embodiment display device 2011 can include one or more of an internal display device, as in a mobile electronic device or a laptop device or an external display device attached via a display interface (e.g., DisplayPort, etc.). In at least one embodiment, display device 2011 can include a head mounted display (“HMD”) such as a stereoscopic display device for use in virtual reality (“VR”) applications or augmented reality (“AR”) applications.

In at least one embodiment, platform controller hub 2030 enables peripherals to connect to memory device 2020 and processor 2002 via a high-speed I/O bus. In at least one embodiment, I/O peripherals include, but are not limited to, an audio controller 2046, a network controller 2034, a firmware interface 2028, a wireless transceiver 2026, touch sensors 2025, a data storage device 2024 (e.g., hard disk drive, flash memory, etc.). In at least one embodiment, data storage device 2024 can connect via a storage interface (e.g., SATA) or via a peripheral bus, such as PCI, or PCIe. In at least one embodiment, touch sensors 2025 can include touch screen sensors, pressure sensors, or fingerprint sensors. In at least one embodiment, wireless transceiver 2026 can be a Wi-Fi transceiver, a Bluetooth transceiver, or a mobile network transceiver such as a 3G, 4G, or Long Term Evolution (“LTE”) transceiver. In at least one embodiment, firmware interface 2028 enables communication with system firmware, and can be, for example, a unified extensible firmware interface (“UEFI”). In at least one embodiment, network controller 2034 can enable a network connection to a wired network. In at least one embodiment, a high-performance network controller (not shown) couples with interface bus 2010. In at least one embodiment, audio controller 2046 is a multi-channel high definition audio controller. In at least one embodiment, processing system 2000 includes an optional legacy I/O controller 2040 for coupling legacy (e.g., Personal System 2 (“PS/2”)) devices to processing system 2000. In at least one embodiment, platform controller hub 2030 can also connect to one or more Universal Serial Bus (“USB”) controllers 2042 connect input devices, such as keyboard and mouse 2043 combinations, a camera 2044, or other USB input devices.

In at least one embodiment, an instance of memory controller 2016 and platform controller hub 2030 may be integrated into a discreet external graphics processor, such as external graphics processor 2012. In at least one embodiment, platform controller hub 2030 and/or memory controller 2016 may be external to one or more processor(s) 2002. For example, in at least one embodiment, processing system 2000 can include an external memory controller 2016 and platform controller hub 2030, which may be configured as a memory controller hub and peripheral controller hub within a system chipset that is in communication with processor(s) 2002.

In at least one embodiment, at least one component shown or described with respect to FIG. 20 is utilized to implement techniques and/or functions described in connection with FIGS. 1-18. In at least one embodiment, at least one of processor(s) 2002 or external graphics processor 2012 are used to perform asynchronous memory allocation and/or asynchronous memory deallocation. In at least one embodiment, at least one of processor(s) 2002 or external graphics processor 2012 are used to perform an API to cause one or more memory locations to be asynchronously allocated to one or more processors. In at least one embodiment, at least one of processor(s) 2002 or external graphics processor 2012 are used to perform an API to cause one or more memory locations to be asynchronously allocated to one or more processors. In at least one embodiment, at least one of processor(s) 2002 or external graphics processor 2012 are used to perform an API to cause one or more memory locations to be asynchronously deallocated from one or more processors. In at least one embodiment, at least one of processor(s) 2002 or external graphics processor 2012 are used to perform at least one aspect described with respect to example computer system 100, example computer system 200, example computer system 300, example computer system 400, example process 500, example process 600, example process 700, example process 800, example data flow 900, example first part of a data flow 1000, example second part of a data flow 1100, example third part of a data flow 1200, example process 1300, example computer system 1400, example computer system 1500, example process 1600, example computer system 1700, and/or example process 1800.

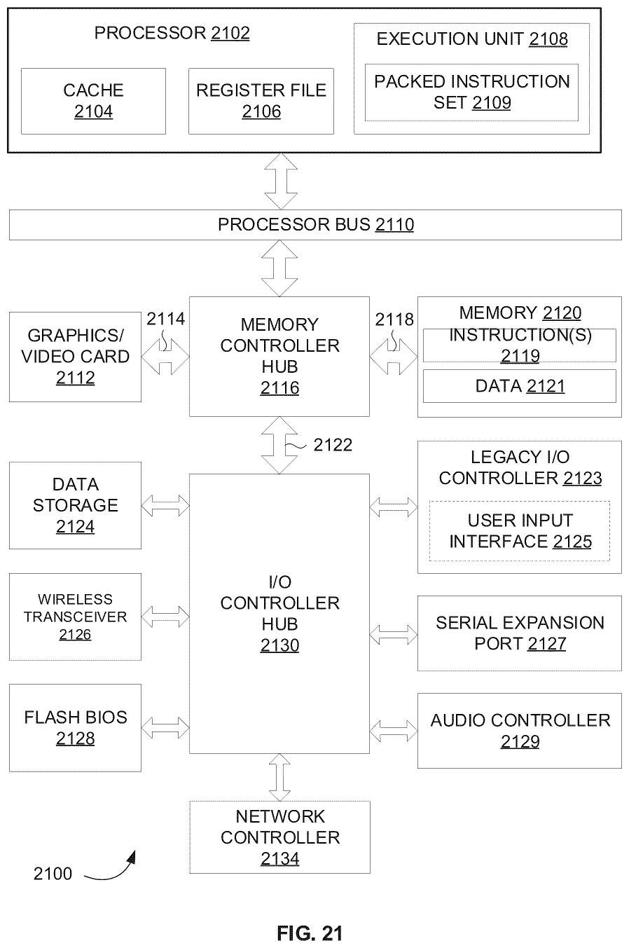

FIG. 21 illustrates a computer system 2100, in accordance with at least one embodiment. In at least one embodiment, computer system 2100 may be a system with interconnected devices and components, an SOC, or some combination. In at least on embodiment, computer system 2100 is formed with a processor 2102 that may include execution units to execute an instruction. In at least one embodiment, computer system 2100 may include, without limitation, a component, such as processor 2102 to employ execution units including logic to perform algorithms for processing data. In at least one embodiment, computer system 2100 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 2100 may execute a version of WINDOWS' operating system available from Microsoft Corporation of Redmond, Wash., although other operating systems (UNIX and Linux for example), embedded software, and/or graphical user interfaces, may also be used.

In at least one embodiment, computer system 2100 may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (DSP), an SoC, network computers (“NetPCs”), set-top boxes, network hubs, wide area network (“WAN”) switches, or any other system that may perform one or more instructions.

In at least one embodiment, computer system 2100 may include, without limitation, processor 2102 that may include, without limitation, one or more execution units 2108 that may be configured to execute a Compute Unified Device Architecture (“CUDA”) (CUDA® is developed by NVIDIA Corporation of Santa Clara, CA) program. In at least one embodiment, a CUDA program is at least a portion of a software application written in a CUDA programming language. In at least one embodiment, computer system 2100 is a single processor desktop or server system. In at least one embodiment, computer system 2100 may be a multiprocessor system. In at least one embodiment, processor 2102 may include, without limitation, a CISC microprocessor, a RISC microprocessor, a VLIW microprocessor, a processor implementing a combination of instruction sets, or any other processor device, such as a digital signal processor, for example. In at least one embodiment, processor 2102 may be coupled to a processor bus 2110 that may transmit data signals between processor 2102 and other components in computer system 2100.

In at least one embodiment, processor 2102 may include, without limitation, a Level 1 (“L1”) internal cache memory (“cache”) 2104. In at least one embodiment, processor 2102 may have a single internal cache or multiple levels of internal cache. In at least one embodiment, cache memory may reside external to processor 2102. In at least one embodiment, processor 2102 may also include a combination of both internal and external caches. In at least one embodiment, a register file 2106 may store different types of data in various registers including, without limitation, integer registers, floating point registers, status registers, and instruction pointer register.

In at least one embodiment, execution unit 2108, including, without limitation, logic to perform integer and floating point operations, also resides in processor 2102. Processor 2102 may also include a microcode (“ucode”) read only memory (“ROM”) that stores microcode for certain macro instructions. In at least one embodiment, execution unit 2108 may include logic to handle a packed instruction set 2109. In at least one embodiment, by including packed instruction set 2109 in an instruction set of a general-purpose processor 2102, along with associated circuitry to execute instructions, operations used by many multimedia applications may be performed using packed data in a general-purpose processor 2102. In at least one embodiment, many multimedia applications may be accelerated and executed more efficiently by using full width of a processor's data bus for performing operations on packed data, which may eliminate a need to transfer smaller units of data across a processor's data bus to perform one or more operations one data element at a time.

In at least one embodiment, execution unit 2108 may also be used in microcontrollers, embedded processors, graphics devices, DSPs, and other types of logic circuits. In at least one embodiment, computer system 2100 may include, without limitation, a memory 2120. In at least one embodiment, memory 2120 may be implemented as a DRAM device, an SRAM device, flash memory device, or other memory device. Memory 2120 may store instruction(s) 2119 and/or data 2121 represented by data signals that may be executed by processor 2102.

In at least one embodiment, a system logic chip may be coupled to processor bus 2110 and memory 2120. In at least one embodiment, the system logic chip may include, without limitation, a memory controller hub (“MCH”) 2116, and processor 2102 may communicate with MCH 2116 via processor bus 2110. In at least one embodiment, MCH 2116 may provide a high bandwidth memory path 2118 to memory 2120 for instruction and data storage and for storage of graphics commands, data and textures. In at least one embodiment, MCH 2116 may direct data signals between processor 2102, memory 2120, and other components in computer system 2100 and to bridge data signals between processor bus 2110, memory 2120, and a system I/O 2122. In at least one embodiment, system logic chip may provide a graphics port for coupling to a graphics controller. In at least one embodiment, MCH 2116 may be coupled to memory 2120 through high bandwidth memory path 2118 and graphics/video card 2112 may be coupled to MCH 2116 through an Accelerated Graphics Port (“AGP”) interconnect 2114.

In at least one embodiment, computer system 2100 may use system I/O 2122 that is a proprietary hub interface bus to couple MCH 2116 to I/O controller hub (“ICH”) 2130. In at least one embodiment, ICH 2130 may provide direct connections to some I/O devices via a local I/O bus. In at least one embodiment, local I/O bus may include, without limitation, a high-speed I/O bus for connecting peripherals to memory 2120, a chipset, and processor 2102. Examples may include, without limitation, an audio controller 2129, a firmware hub (“flash BIOS”) 2128, a wireless transceiver 2126, a data storage 2124, a legacy I/O controller 2123 containing a user input interface 2125 and a keyboard interface, a serial expansion port 2127, such as a USB, and a network controller 2134. Data storage 2124 may comprise a hard disk drive, a floppy disk drive, a CD-ROM device, a flash memory device, or other mass storage device.

In at least one embodiment, FIG. 21 illustrates a system, which includes interconnected hardware devices or “chips.” In at least one embodiment, FIG. 21 may illustrate an exemplary SoC. In at least one embodiment, devices illustrated in FIG. 21 may be interconnected with proprietary interconnects, standardized interconnects (e.g., PCIe), or some combination thereof. In at least one embodiment, one or more components of system 2100 are interconnected using compute express link (“CXL”) interconnects.

In at least one embodiment, at least one component shown or described with respect to FIG. 21 is utilized to implement techniques and/or functions described in connection with FIGS. 1-18. In at least one embodiment, processor 2102 is used to perform asynchronous memory allocation and/or asynchronous memory deallocation. In at least one embodiment, processor 2102 is used to perform an API to cause one or more memory locations to be asynchronously allocated to one or more processors. In at least one embodiment, processor 2102 is used to perform an API to cause one or more memory locations to be asynchronously allocated to one or more processors. In at least one embodiment, processor 2102 is used to perform an API to cause one or more memory locations to be asynchronously deallocated from one or more processors. In at least one embodiment, processor 2102 is to perform at least one aspect described with respect to example computer system 100, example computer system 200, example computer system 300, example computer system 400, example process 500, example process 600, example process 700, example process 800, example data flow 900, example first part of a data flow 1000, example second part of a data flow 1100, example third part of a data flow 1200, example process 1300, example computer system 1400, example computer system 1500, example process 1600, example computer system 1700, and/or example process 1800.

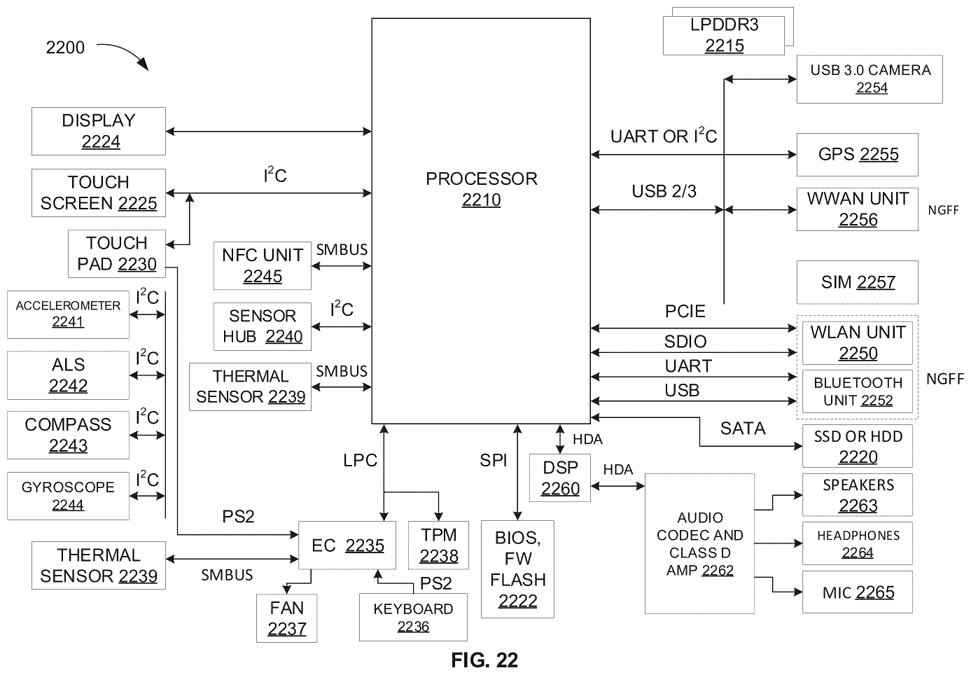

FIG. 22 illustrates a system 2200, in accordance with at least one embodiment. In at least one embodiment, system 2200 is an electronic device that utilizes a processor 2210. In at least one embodiment, system 2200 may be, for example and without limitation, a notebook, a tower server, a rack server, a blade server, an edge device communicatively coupled to one or more on-premise or cloud service providers, a laptop, a desktop, a tablet, a mobile device, a phone, an embedded computer, or any other suitable electronic device.

In at least one embodiment, system 2200 may include, without limitation, processor 2210 communicatively coupled to any suitable number or kind of components, peripherals, modules, or devices. In at least one embodiment, processor 2210 is coupled using a bus or interface, such as an I²C bus, a System Management Bus (“SMBus”), a Low Pin Count (“LPC”) bus, a Serial Peripheral Interface (“SPI”), a High Definition Audio (“HDA”) bus, a Serial Advance Technology Attachment (“SATA”) bus, a USB (versions 1, 2, 3), or a Universal Asynchronous Receiver/Transmitter (“UART”) bus. In at least one embodiment, FIG. 22 illustrates a system which includes interconnected hardware devices or “chips.” In at least one embodiment, FIG. 22 may illustrate an exemplary SoC. In at least one embodiment, devices illustrated in FIG. 22 may be interconnected with proprietary interconnects, standardized interconnects (e.g., PCIe) or some combination thereof. In at least one embodiment, one or more components of FIG. 22 are interconnected using CXL interconnects.

In at least one embodiment, FIG. 22 may include a display 2224, a touch screen 2225, a touch pad 2230, a Near Field Communications unit (“NFC”) 2245, a sensor hub 2240, a thermal sensor 2246, an Express Chipset (“EC”) 2235, a Trusted Platform Module (“TPM”) 2238, BIOS/firmware/flash memory (“BIOS, FW Flash”) 2222, a DSP 2260, a Solid State Disk (“SSD”) or Hard Disk Drive (“HDD”) 2220, a wireless local area network unit (“WLAN”) 2250, a Bluetooth unit 2252, a Wireless Wide Area Network unit (“WWAN”) 2256, a Global Positioning System (“GPS”) 2255, a camera (“USB 3.0 camera”) 2254 such as a USB 3.0 camera, or a Low Power Double Data Rate (“LPDDR”) memory unit (“LPDDR3”) 2215 implemented in, for example, LPDDR3 standard. These components may each be implemented in any suitable manner.

In at least one embodiment, other components may be communicatively coupled to processor 2210 through components discussed above. In at least one embodiment, an accelerometer 2241, an Ambient Light Sensor (“ALS”) 2242, a compass 2243, and a gyroscope 2244 may be communicatively coupled to sensor hub 2240. In at least one embodiment, a thermal sensor 2239, a fan 2237, a keyboard 2236, and a touch pad 2230 may be communicatively coupled to EC 2235. In at least one embodiment, a speaker 2263, a headphones 2264, and a microphone (“mic”) 2265 may be communicatively coupled to an audio unit (“audio codec and class d amp”) 2262, which may in turn be communicatively coupled to DSP 2260. In at least one embodiment, audio unit 2262 may include, for example and without limitation, an audio coder/decoder (“codec”) and a class D amplifier. In at least one embodiment, a SIM card (“SIM”) 2257 may be communicatively coupled to WWAN unit 2256. In at least one embodiment, components such as WLAN unit 2250 and Bluetooth unit 2252, as well as WWAN unit 2256 may be implemented in a Next Generation Form Factor (“NGFF”).

In at least one embodiment, at least one component shown or described with respect to FIG. 22 is utilized to implement techniques and/or functions described in connection with FIGS. 1-18. In at least one embodiment, processor 2210 is used to perform asynchronous memory allocation and/or asynchronous memory deallocation. In at least one embodiment, processor 2210 is used to perform an API to cause one or more memory locations to be asynchronously allocated to one or more processors. In at least one embodiment, processor 2210 is used to perform an API to cause one or more memory locations to be asynchronously allocated to one or more processors. In at least one embodiment, processor 2210 is used to perform an API to cause one or more memory locations to be asynchronously deallocated from one or more processors. In at least one embodiment processor 2210 is used to perform at least one aspect described with respect to example computer system 100, example computer system 200, example computer system 300, example computer system 400, example process 500, example process 600, example process 700, example process 800, example data flow 900, example first part of a data flow 1000, example second part of a data flow 1100, example third part of a data flow 1200, example process 1300, example computer system 1400, example computer system 1500, example process 1600, example computer system 1700, and/or example process 1800.

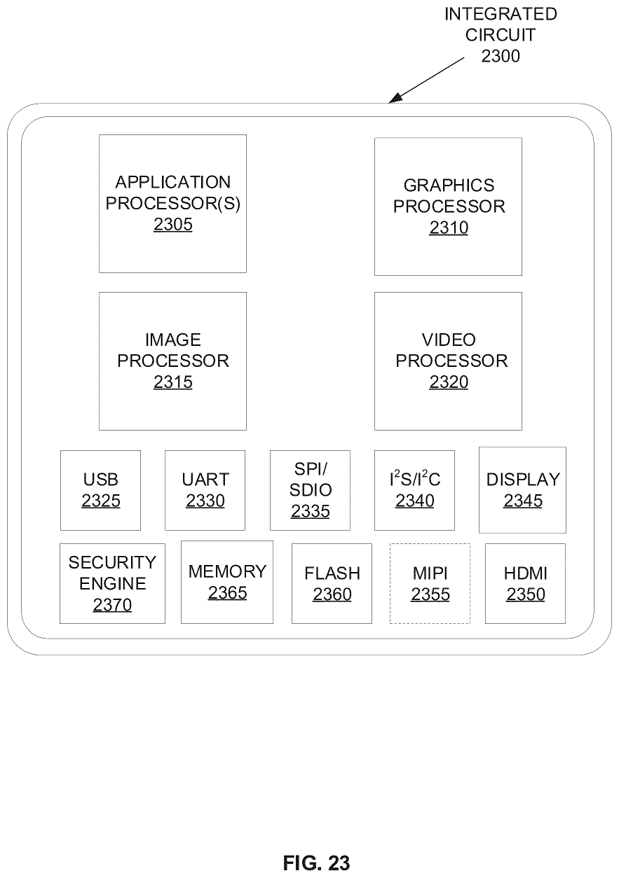

FIG. 23 illustrates an exemplary integrated circuit 2300, in accordance with at least one embodiment. In at least one embodiment, exemplary integrated circuit 2300 is an SoC that may be fabricated using one or more IP cores. In at least one embodiment, integrated circuit 2300 includes one or more application processor(s) 2305 (e.g., CPUs, DPUs), at least one graphics processor 2310, and may additionally include an image processor 2315 and/or a video processor 2320, any of which may be a modular IP core. In at least one embodiment, integrated circuit 2300 includes peripheral or bus logic including a USB controller 2325, a UART controller 2330, an SPI/SDIO controller 2335, and an I²S/I²C controller 2340. In at least one embodiment, integrated circuit 2300 can include a display device 2345 coupled to one or more of a high-definition multimedia interface (“HDMI”) controller 2350 and a mobile industry processor interface (“MIPI”) display interface 2355. In at least one embodiment, storage may be provided by a flash memory subsystem 2360 including flash memory and a flash memory controller. In at least one embodiment, a memory interface may be provided via a memory controller 2365 for access to SDRAM or SRAM memory devices. In at least one embodiment, some integrated circuits additionally include an embedded security engine 2370.

In at least one embodiment, at least one component shown or described with respect to FIG. 23 is utilized to implement techniques and/or functions described in connection with FIGS. 1-18. In at least one embodiment, at least one of application processor 2305, graphics processor 2310, image processor 2315, or video processor 2320 are used to perform asynchronous memory allocation and/or asynchronous memory deallocation. In at least one embodiment, at least one of application processor 2305, graphics processor 2310, image processor 2315, or video processor 2320 are used to perform an API to cause one or more memory locations to be asynchronously allocated to one or more processors. In at least one embodiment, at least one of application processor 2305, graphics processor 2310, image processor 2315, or video processor 2320 are used to perform an API to cause one or more memory locations to be asynchronously allocated to one or more processors. In at least one embodiment, at least one of application processor 2305, graphics processor 2310, image processor 2315, or video processor 2320 are used to perform an API to cause one or more memory locations to be asynchronously deallocated from one or more processors. In at least one embodiment, at least one of application processor 2305, graphics processor 2310, image processor 2315, or video processor 2320 are used to perform at least one aspect described with respect to example computer system 100, example computer system 200, example computer system 300, example computer system 400, example process 500, example process 600, example process 700, example process 800, example data flow 900, example first part of a data flow 1000, example second part of a data flow 1100, example third part of a data flow 1200, example process 1300, example computer system 1400, example computer system 1500, example process 1600, example computer system 1700, and/or example process 1800.

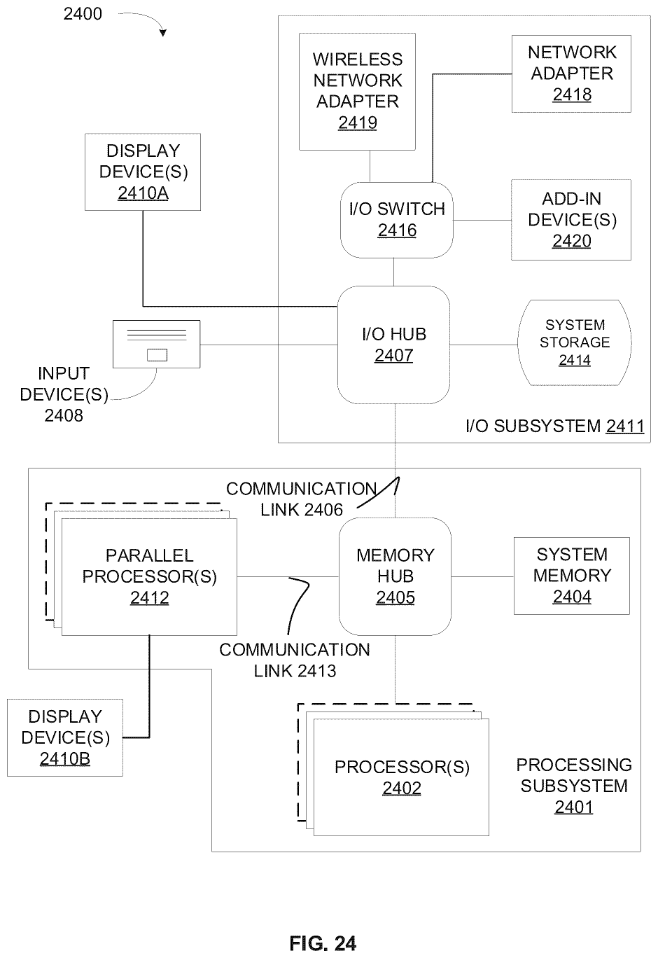

FIG. 24 illustrates a computing system 2400, according to at least one embodiment; In at least one embodiment, computing system 2400 includes a processing subsystem 2401 having one or more processor(s) 2402 and a system memory 2404 communicating via an interconnection path that may include a memory hub 2405. In at least one embodiment, memory hub 2405 may be a separate component within a chipset component or may be integrated within one or more processor(s) 2402. In at least one embodiment, memory hub 2405 couples with an I/O subsystem 2411 via a communication link 2406. In at least one embodiment, I/O subsystem 2411 includes an I/O hub 2407 that can enable computing system 2400 to receive input from one or more input device(s) 2408. In at least one embodiment, I/O hub 2407 can enable a display controller, which may be included in one or more processor(s) 2402, to provide outputs to one or more display device(s) 2410A. In at least one embodiment, one or more display device(s) 2410A coupled with I/O hub 2407 can include a local, internal, or embedded display device.

In at least one embodiment, processing subsystem 2401 includes one or more parallel processor(s) 2412 coupled to memory hub 2405 via a bus or other communication link 2413. In at least one embodiment, communication link 2413 may be one of any number of standards based communication link technologies or protocols, such as, but not limited to PCIe, or may be a vendor specific communications interface or communications fabric. In at least one embodiment, one or more parallel processor(s) 2412 form a computationally focused parallel or vector processing system that can include a large number of processing cores and/or processing clusters, such as a many integrated core processor. In at least one embodiment, one or more parallel processor(s) 2412 form a graphics processing subsystem that can output pixels to one of one or more display device(s) 2410A coupled via I/O Hub 2407. In at least one embodiment, one or more parallel processor(s) 2412 can also include a display controller and display interface (not shown) to enable a direct connection to one or more display device(s) 2410B.

In at least one embodiment, a system storage unit 2414 can connect to I/O hub 2407 to provide a storage mechanism for computing system 2400. In at least one embodiment, an I/O switch 2416 can be used to provide an interface mechanism to enable connections between I/O hub 2407 and other components, such as a network adapter 2418 and/or wireless network adapter 2419 that may be integrated into a platform, and various other devices that can be added via one or more add-in device(s) 2420. In at least one embodiment, network adapter 2418 can be an Ethernet adapter or another wired network adapter. In at least one embodiment, wireless network adapter 2419 can include one or more of a Wi-Fi, Bluetooth, NFC, or other network device that includes one or more wireless radios.

In at least one embodiment, computing system 2400 can include other components not explicitly shown, including USB or other port connections, optical storage drives, video capture devices, and the like, that may also be connected to I/O hub 2407. In at least one embodiment, communication paths interconnecting various components in FIG. 24 may be implemented using any suitable protocols, such as PCI based protocols (e.g., PCIe), or other bus or point-to-point communication interfaces and/or protocol(s), such as NVLink high-speed interconnect, or interconnect protocols.

In at least one embodiment, one or more parallel processor(s) 2412 incorporate circuitry optimized for graphics and video processing, including, for example, video output circuitry, and constitutes a graphics processing unit (“GPU”). In at least one embodiment, one or more parallel processor(s) 2412 incorporate circuitry optimized for general purpose processing. In at least embodiment, components of computing system 2400 may be integrated with one or more other system elements on a single integrated circuit. For example, in at least one embodiment, one or more parallel processor(s) 2412, memory hub 2405, processor(s) 2402, and I/O hub 2407 can be integrated into an SoC integrated circuit. In at least one embodiment, components of computing system 2400 can be integrated into a single package to form a system in package (“SIP”) configuration. In at least one embodiment, at least a portion of the components of computing system 2400 can be integrated into a multi-chip module (“MCM”), which can be interconnected with other multi-chip modules into a modular computing system. In at least one embodiment, I/O subsystem 2411 and display devices 2410B are omitted from computing system 2400.

In at least one embodiment, at least one component shown or described with respect to FIG. 24 is utilized to implement techniques and/or functions described in connection with FIGS. 1-18. In at least one embodiment, at least one of processor(s) 2402 or parallel processor(s) 2412 are used to perform asynchronous memory allocation and/or asynchronous memory deallocation. In at least one embodiment, at least one of processor(s) 2402 or parallel processor(s) 2412 are used to perform an API to cause one or more memory locations to be asynchronously allocated to one or more processors. In at least one embodiment, at least one of processor(s) 2402 or parallel processor(s) 2412 are used to perform an API to cause one or more memory locations to be asynchronously allocated to one or more processors. In at least one embodiment, at least one of processor(s) 2402 or parallel processor(s) 2412 are used to perform an API to cause one or more memory locations to be asynchronously deallocated from one or more processors. In at least one embodiment, at least one of processor(s) 2402 or parallel processor(s) 2412 are used to perform at least one aspect described with respect to example computer system 100, example computer system 200, example computer system 300, example computer system 400, example process 500, example process 600, example process 700, example process 800, example data flow 900, example first part of a data flow 1000, example second part of a data flow 1100, example third part of a data flow 1200, example process 1300, example computer system 1400, example computer system 1500, example process 1600, example computer system 1700, and/or example process 1800.

### Processing Systems

The following figures set forth, without limitation, exemplary processing systems that can be used to implement at least one embodiment.

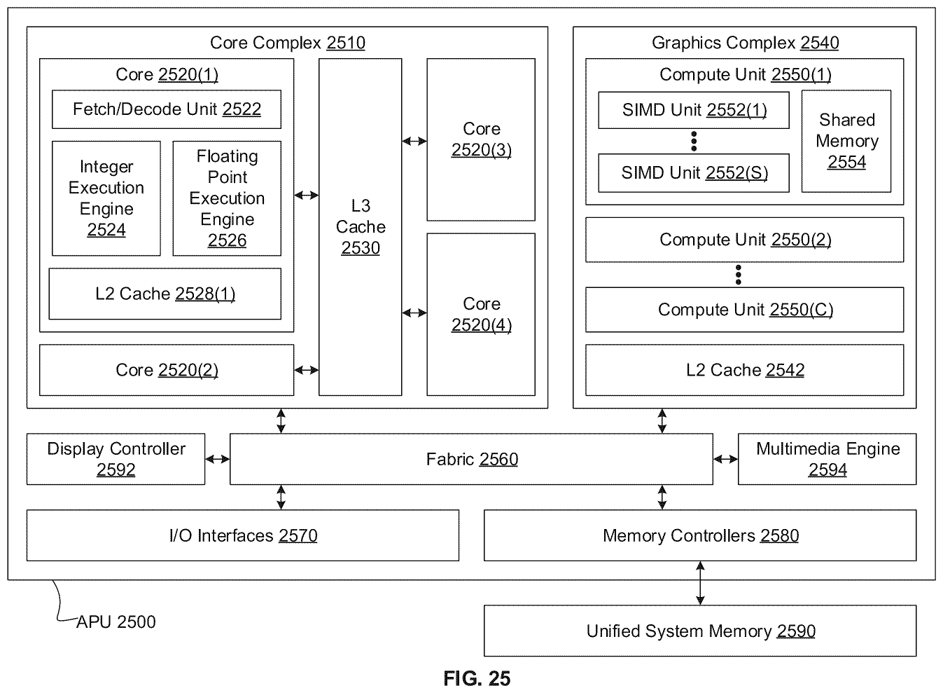

FIG. 25 illustrates an accelerated processing unit (“APU”) 2500, in accordance with at least one embodiment. In at least one embodiment, APU 2500 is developed by AMD Corporation of Santa Clara, CA. In at least one embodiment, APU 2500 can be configured to execute an application program, such as a CUDA program. In at least one embodiment, APU 2500 includes, without limitation, a core complex 2510, a graphics complex 2540, fabric 2560, I/O interfaces 2570, memory controllers 2580, a display controller 2592, and a multimedia engine 2594. In at least one embodiment, APU 2500 may include, without limitation, any number of core complexes 2510, any number of graphics complexes 2550, any number of display controllers 2592, and any number of multimedia engines 2594 in any combination. For explanatory purposes, multiple instances of like objects are denoted herein with reference numbers identifying the object and parenthetical numbers identifying the instance where needed.

In at least one embodiment, core complex 2510 is a CPU, graphics complex 2540 is a GPU, and APU 2500 is a processing unit that integrates, without limitation, 2510 and 2540 onto a single chip. In at least one embodiment, some tasks may be assigned to core complex 2510 and other tasks may be assigned to graphics complex 2540. In at least one embodiment, core complex 2510 is configured to execute main control software associated with APU 2500, such as an operating system. In at least one embodiment, core complex 2510 is the master processor of APU 2500, controlling and coordinating operations of other processors. In at least one embodiment, core complex 2510 issues commands that control the operation of graphics complex 2540. In at least one embodiment, core complex 2510 can be configured to execute host executable code derived from CUDA source code, and graphics complex 2540 can be configured to execute device executable code derived from CUDA source code.

In at least one embodiment, core complex 2510 includes, without limitation, cores 2520(1)-2520(4) and an L3 cache 2530. In at least one embodiment, core complex 2510 may include, without limitation, any number of cores 2520 and any number and type of caches in any combination. In at least one embodiment, cores 2520 are configured to execute instructions of a particular instruction set architecture (“ISA”). In at least one embodiment, each core 2520 is a CPU core.

In at least one embodiment, each core 2520 includes, without limitation, a fetch/decode unit 2522, an integer execution engine 2524, a floating point execution engine 2526, and an L2 cache 2528. In at least one embodiment, fetch/decode unit 2522 fetches instructions, decodes such instructions, generates micro-operations, and dispatches separate micro-instructions to integer execution engine 2524 and floating point execution engine 2526. In at least one embodiment, fetch/decode unit 2522 can concurrently dispatch one micro-instruction to integer execution engine 2524 and another micro-instruction to floating point execution engine 2526. In at least one embodiment, integer execution engine 2524 executes, without limitation, integer and memory operations. In at least one embodiment, floating point engine 2526 executes, without limitation, floating point and vector operations. In at least one embodiment, fetch-decode unit 2522 dispatches micro-instructions to a single execution engine that replaces both integer execution engine 2524 and floating point execution engine 2526.

In at least one embodiment, each core 2520(i), where i is an integer representing a particular instance of core 2520, may access L2 cache 2528(i) included in core 2520(i). In at least one embodiment, each core 2520 included in core complex 2510(j), where j is an integer representing a particular instance of core complex 2510, is connected to other cores 2520 included in core complex 2510(j) via L3 cache 2530(j) included in core complex 2510(j). In at least one embodiment, cores 2520 included in core complex 2510(j), where j is an integer representing a particular instance of core complex 2510, can access all of L3 cache 2530(j) included in core complex 2510(j). In at least one embodiment, L3 cache 2530 may include, without limitation, any number of slices.

In at least one embodiment, graphics complex 2540 can be configured to perform compute operations in a highly-parallel fashion. In at least one embodiment, graphics complex 2540 is configured to execute graphics pipeline operations such as draw commands, pixel operations, geometric computations, and other operations associated with rendering an image to a display. In at least one embodiment, graphics complex 2540 is configured to execute operations unrelated to graphics. In at least one embodiment, graphics complex 2540 is configured to execute both operations related to graphics and operations unrelated to graphics.

In at least one embodiment, graphics complex 2540 includes, without limitation, any number of compute units 2550 and an L2 cache 2542. In at least one embodiment, compute units 2550 share L2 cache 2542. In at least one embodiment, L2 cache 2542 is partitioned. In at least one embodiment, graphics complex 2540 includes, without limitation, any number of compute units 2550 and any number (including zero) and type of caches. In at least one embodiment, graphics complex 2540 includes, without limitation, any amount of dedicated graphics hardware.

In at least one embodiment, each compute unit 2550 includes, without limitation, any number of SIMD units 2552 and a shared memory 2554. In at least one embodiment, each SIMD unit 2552 implements a SIMD architecture and is configured to perform operations in parallel. In at least one embodiment, each compute unit 2550 may execute any number of thread blocks, but each thread block executes on a single compute unit 2550. In at least one embodiment, a thread block includes, without limitation, any number of threads of execution. In at least one embodiment, a workgroup is a thread block. In at least one embodiment, each SIMD unit 2552 executes a different warp. In at least one embodiment, a warp is a group of threads (e.g., 16 threads), where each thread in the warp belongs to a single thread block and is configured to process a different set of data based on a single set of instructions. In at least one embodiment, predication can be used to disable one or more threads in a warp. In at least one embodiment, a lane is a thread. In at least one embodiment, a work item is a thread. In at least one embodiment, a wavefront is a warp. In at least one embodiment, different wavefronts in a thread block may synchronize together and communicate via shared memory 2554.

In at least one embodiment, fabric 2560 is a system interconnect that facilitates data and control transmissions across core complex 2510, graphics complex 2540, I/O interfaces 2570, memory controllers 2580, display controller 2592, and multimedia engine 2594. In at least one embodiment, APU 2500 may include, without limitation, any amount and type of system interconnect in addition to or instead of fabric 2560 that facilitates data and control transmissions across any number and type of directly or indirectly linked components that may be internal or external to APU 2500. In at least one embodiment, I/O interfaces 2570 are representative of any number and type of I/O interfaces (e.g., PCI, PCI-Extended (“PCI-X”), PCIe, gigabit Ethernet (“GBE”), USB, etc.). In at least one embodiment, various types of peripheral devices are coupled to I/O interfaces 2570 In at least one embodiment, peripheral devices that are coupled to I/O interfaces 2570 may include, without limitation, keyboards, mice, printers, scanners, joysticks or other types of game controllers, media recording devices, external storage devices, network interface cards, and so forth.

In at least one embodiment, display controller AMD92 displays images on one or more display device(s), such as a liquid crystal display (“LCD”) device. In at least one embodiment, multimedia engine 2594 includes, without limitation, any amount and type of circuitry that is related to multimedia, such as a video decoder, a video encoder, an image signal processor, etc. In at least one embodiment, memory controllers 2580 facilitate data transfers between APU 2500 and a unified system memory 2590. In at least one embodiment, core complex 2510 and graphics complex 2540 share unified system memory 2590.

In at least one embodiment, APU 2500 implements a memory subsystem that includes, without limitation, any amount and type of memory controllers 2580 and memory devices (e.g., shared memory 2554) that may be dedicated to one component or shared among multiple components. In at least one embodiment, APU 2500 implements a cache subsystem that includes, without limitation, one or more cache memories (e.g., L2 caches 2628, L3 cache 2530, and L2 cache 2542) that may each be private to or shared between any number of components (e.g., cores 2520, core complex 2510, SIMD units 2552, compute units 2550, and graphics complex 2540).

In at least one embodiment, at least one component shown or described with respect to FIG. 25 is utilized to implement techniques and/or functions described in connection with FIGS. 1-18. In at least one embodiment, at least one element of core complex 2510 or graphics complex 2540 are used to perform asynchronous memory allocation and/or asynchronous memory deallocation. In at least one embodiment, at least one element of core complex 2510 or graphics complex 2540 are used to perform an API to cause one or more memory locations to be asynchronously allocated to one or more processors. In at least one embodiment, at least one element of core complex 2510 or graphics complex 2540 are used to perform an API to cause one or more memory locations to be asynchronously allocated to one or more processors. In at least one embodiment, at least one element of core complex 2510 or graphics complex 2540 are used to perform an API to cause one or more memory locations to be asynchronously deallocated from one or more processors. In at least one embodiment, at least one element of core complex 2510 or graphics complex 2540 are used to perform at least one aspect described with respect to example computer system 100, example computer system 200, example computer system 300, example computer system 400, example process 500, example process 600, example process 700, example process 800, example data flow 900, example first part of a data flow 1000, example second part of a data flow 1100, example third part of a data flow 1200, example process 1300, example computer system 1400, example computer system 1500, example process 1600, example computer system 1700, and/or example process 1800.

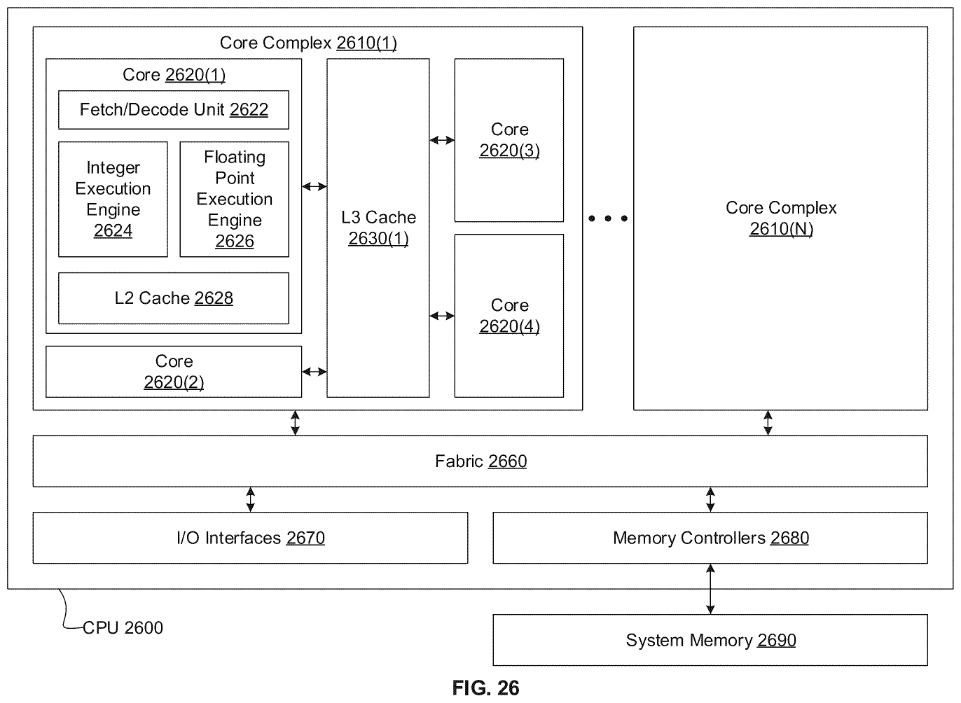

FIG. 26 illustrates a CPU 2600, in accordance with at least one embodiment. In at least one embodiment, CPU 2600 is developed by AMD Corporation of Santa Clara, CA. In at least one embodiment, CPU 2600 can be configured to execute an application program. In at least one embodiment, CPU 2600 is configured to execute main control software, such as an operating system. In at least one embodiment, CPU 2600 issues commands that control the operation of an external GPU (not shown). In at least one embodiment, CPU 2600 can be configured to execute host executable code derived from CUDA source code, and an external GPU can be configured to execute device executable code derived from such CUDA source code. In at least one embodiment, CPU 2600 includes, without limitation, any number of core complexes 2610, fabric 2660, I/O interfaces 2670, and memory controllers 2680.

In at least one embodiment, core complex 2610 includes, without limitation, cores 2620(1)-2620(4) and an L3 cache 2630. In at least one embodiment, core complex 2610 may include, without limitation, any number of cores 2620 and any number and type of caches in any combination. In at least one embodiment, cores 2620 are configured to execute instructions of a particular ISA. In at least one embodiment, each core 2620 is a CPU core.

In at least one embodiment, each core 2620 includes, without limitation, a fetch/decode unit 2622, an integer execution engine 2624, a floating point execution engine 2626, and an L2 cache 2628. In at least one embodiment, fetch/decode unit 2622 fetches instructions, decodes such instructions, generates micro-operations, and dispatches separate micro-instructions to integer execution engine 2624 and floating point execution engine 2626. In at least one embodiment, fetch/decode unit 2622 can concurrently dispatch one micro-instruction to integer execution engine 2624 and another micro-instruction to floating point execution engine 2626. In at least one embodiment, integer execution engine 2624 executes, without limitation, integer and memory operations. In at least one embodiment, floating point engine 2626 executes, without limitation, floating point and vector operations. In at least one embodiment, fetch-decode unit 2622 dispatches micro-instructions to a single execution engine that replaces both integer execution engine 2624 and floating point execution engine 2626.

In at least one embodiment, each core 2620(i), where i is an integer representing a particular instance of core 2620, may access L2 cache 2628(i) included in core 2620(i). In at least one embodiment, each core 2620 included in core complex 2610(j), where j is an integer representing a particular instance of core complex 2610, is connected to other cores 2620 in core complex 2610(j) via L3 cache 2630(j) included in core complex 2610(j). In at least one embodiment, cores 2620 included in core complex 2610(j), where j is an integer representing a particular instance of core complex 2610, can access all of L3 cache 2630(j) included in core complex 2610(j). In at least one embodiment, L3 cache 2630 may include, without limitation, any number of slices.

In at least one embodiment, fabric 2660 is a system interconnect that facilitates data and control transmissions across core complexes 2610(1)-2610(N) (where N is an integer greater than zero), I/O interfaces 2670, and memory controllers 2680. In at least one embodiment, CPU 2600 may include, without limitation, any amount and type of system interconnect in addition to or instead of fabric 2660 that facilitates data and control transmissions across any number and type of directly or indirectly linked components that may be internal or external to CPU 2600. In at least one embodiment, I/O interfaces 2670 are representative of any number and type of I/O interfaces (e.g., PCI, PCI-X, PCIe, GBE, USB, etc.). In at least one embodiment, various types of peripheral devices are coupled to I/O interfaces 2670 In at least one embodiment, peripheral devices that are coupled to I/O interfaces 2670 may include, without limitation, displays, keyboards, mice, printers, scanners, joysticks or other types of game controllers, media recording devices, external storage devices, network interface cards, and so forth.

In at least one embodiment, memory controllers 2680 facilitate data transfers between CPU 2600 and a system memory 2690. In at least one embodiment, core complex 2610 and graphics complex 2640 share system memory 2690. In at least one embodiment, CPU 2600 implements a memory subsystem that includes, without limitation, any amount and type of memory controllers 2680 and memory devices that may be dedicated to one component or shared among multiple components. In at least one embodiment, CPU 2600 implements a cache subsystem that includes, without limitation, one or more cache memories (e.g., L2 caches 2628 and L3 caches 2630) that may each be private to or shared between any number of components (e.g., cores 2620 and core complexes 2610).

In at least one embodiment, at least one component shown or described with respect to FIG. 26 is utilized to implement techniques and/or functions described in connection with FIGS. 1-18. In at least one embodiment, at least one element of core complex 2610(1)-2610(n) are used to perform asynchronous memory allocation and/or asynchronous memory deallocation. In at least one embodiment, at least one element of core complex 2610(1)-2610(n) are used to perform an API to cause one or more memory locations to be asynchronously allocated to one or more processors. In at least one embodiment, at least one element of core complex 2610(1)-2610(n) are used to perform an API to cause one or more memory locations to be asynchronously allocated to one or more processors. In at least one embodiment, at least one element of core complex 2610(1)-2610(n) are used to perform an API to cause one or more memory locations to be asynchronously deallocated from one or more processors. In at least one embodiment, at least one element of core complex 2610(1)-2610(n) are used to perform at least one aspect described with respect to example computer system 100, example computer system 200, example computer system 300, example computer system 400, example process 500, example process 600, example process 700, example process 800, example data flow 900, example first part of a data flow 1000, example second part of a data flow 1100, example third part of a data flow 1200, example process 1300, example computer system 1400, example computer system 1500, example process 1600, example computer system 1700, and/or example process 1800.

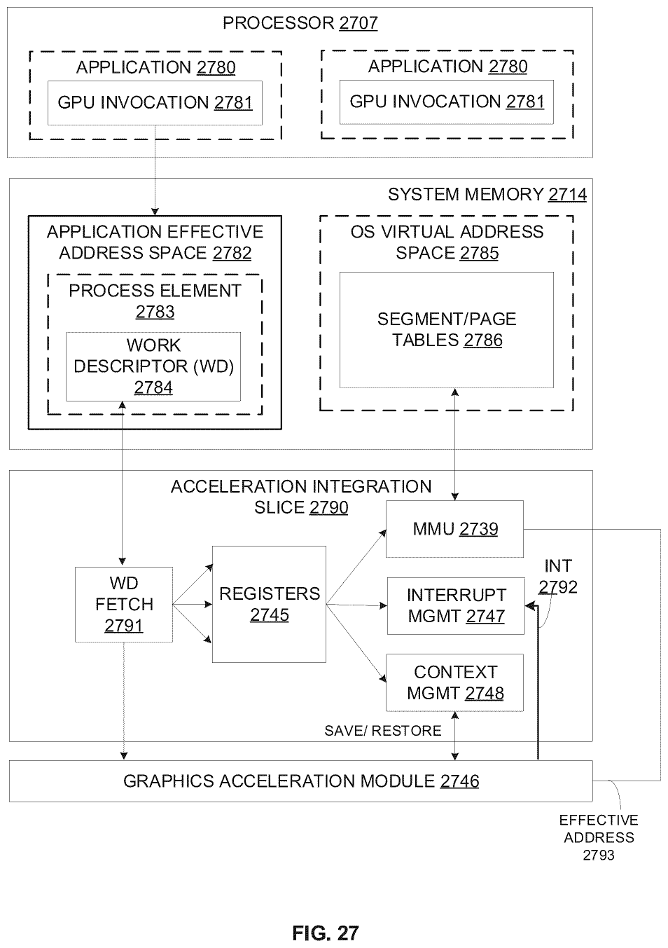

FIG. 27 illustrates an exemplary accelerator integration slice 2790, in accordance with at least one embodiment. As used herein, a “slice” comprises a specified portion of processing resources of an accelerator integration circuit. In at least one embodiment, the accelerator integration circuit provides cache management, memory access, context management, and interrupt management services on behalf of multiple graphics processing engines included in a graphics acceleration module. The graphics processing engines may each comprise a separate GPU. Alternatively, the graphics processing engines may comprise different types of graphics processing engines within a GPU such as graphics execution units, media processing engines (e.g., video encoders/decoders), samplers, and blit engines. In at least one embodiment, the graphics acceleration module may be a GPU with multiple graphics processing engines. In at least one embodiment, the graphics processing engines may be individual GPUs integrated on a common package, line card, or chip.

An application effective address space 2782 within system memory 2714 stores process elements 2783. In one embodiment, process elements 2783 are stored in response to GPU invocations 2781 from applications 2780 executed on processor 2707. A process element 2783 contains process state for corresponding application 2780. A work descriptor (“WD”) 2784 contained in process element 2783 can be a single job requested by an application or may contain a pointer to a queue of jobs. In at least one embodiment, WD 2784 is a pointer to a job request queue in application effective address space 2782.

Graphics acceleration module 2746 and/or individual graphics processing engines can be shared by all or a subset of processes in a system. In at least one embodiment, an infrastructure for setting up process state and sending WD 2784 to graphics acceleration module 2746 to start a job in a virtualized environment may be included.

In at least one embodiment, a dedicated-process programming model is implementation-specific. In this model, a single process owns graphics acceleration module 2746 or an individual graphics processing engine. Because graphics acceleration module 2746 is owned by a single process, a hypervisor initializes an accelerator integration circuit for an owning partition and an operating system initializes accelerator integration circuit for an owning process when graphics acceleration module 2746 is assigned.

In operation, a WD fetch unit 2791 in accelerator integration slice 2790 fetches next WD 2784 which includes an indication of work to be done by one or more graphics processing engines of graphics acceleration module 2746. Data from WD 2784 may be stored in registers 2745 and used by a memory management unit (“MMU”) 2739, interrupt management circuit 2747 and/or context management circuit 2748 as illustrated. For example, one embodiment of MMU 2739 includes segment/page walk circuitry for accessing segment/page tables 2786 within OS virtual address space 2785. Interrupt management circuit 2747 may process interrupt events (“INT”) 2792 received from graphics acceleration module 2746. When performing graphics operations, an effective address 2793 generated by a graphics processing engine is translated to a real address by MMU 2739.

In one embodiment, a same set of registers 2745 are duplicated for each graphics processing engine and/or graphics acceleration module 2746 and may be initialized by a hypervisor or operating system. Each of these duplicated registers may be included in accelerator integration slice 2790. Exemplary registers that may be initialized by a hypervisor are shown in Table 1.

TABLE 1
Hypervisor Initialized Registers

| | |
|---|---|
| 1 | Slice Control Register |
| 2 | Real Address (RA) Scheduled Processes Area Pointer |
| 3 | Authority Mask Override Register |
| 4 | Interrupt Vector Table Entry Offset |
| 5 | Interrupt Vector Table Entry Limit |
| 6 | State Register |
| 7 | Logical Partition ID |
| 8 | Real address (RA) Hypervisor Accelerator Utilization Record Pointer |
| 9 | Storage Description Register |

Exemplary registers that may be initialized by an operating system are shown in Table 2.

TABLE 2
Operating System Initialized Registers

| | |
|---|---|
| 1 | Process and Thread Identification |
| 2 | Effective Address (EA) Context Save/Restore Pointer |
| 3 | Virtual Address (VA) Accelerator Utilization Record Pointer |
| 4 | Virtual Address (VA) Storage Segment Table Pointer |
| 5 | Authority Mask |
| 6 | Work descriptor |

In one embodiment, each WD 2784 is specific to a particular graphics acceleration module 2746 and/or a particular graphics processing engine. It contains all information required by a graphics processing engine to do work or it can be a pointer to a memory location where an application has set up a command queue of work to be completed.

In at least one embodiment, at least one component shown or described with respect to FIG. 27 is utilized to implement techniques and/or functions described in connection with FIGS. 1-18. In at least one embodiment, processor 2707 is used to perform asynchronous memory allocation and/or asynchronous memory deallocation. In at least one embodiment, processor 2707 is used to perform an API to cause one or more memory locations to be asynchronously allocated to one or more processors. In at least one embodiment, processor 2707 is used to perform an API to cause one or more memory locations to be asynchronously allocated to one or more processors. In at least one embodiment, processor 2707 is used to perform an API to cause one or more memory locations to be asynchronously deallocated from one or more processors. In at least one embodiment, processor 2707 is used to perform at least one aspect described with respect to example computer system 100, example computer system 200, example computer system 300, example computer system 400, example process 500, example process 600, example process 700, example process 800, example data flow 900, example first part of a data flow 1000, example second part of a data flow 1100, example third part of a data flow 1200, example process 1300, example computer system 1400, example computer system 1500, example process 1600, example computer system 1700, and/or example process 1800.

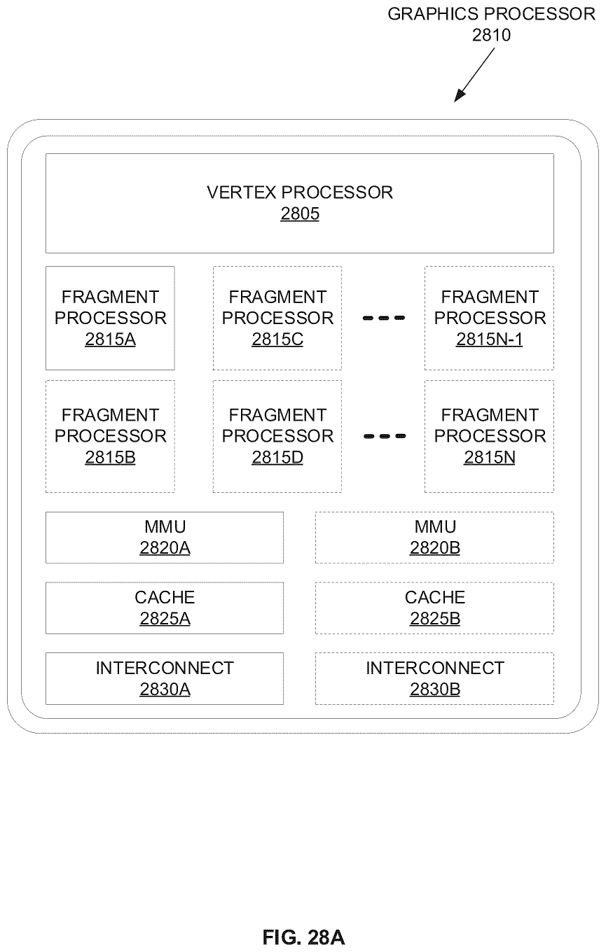

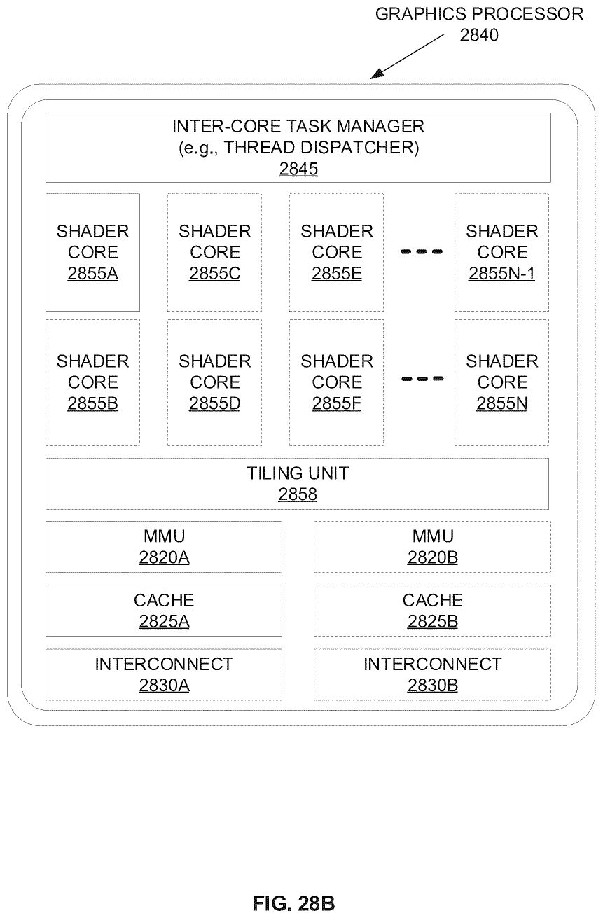

FIGS. 28A-28B illustrate exemplary graphics processors, in accordance with at least one embodiment. In at least one embodiment, any of the exemplary graphics processors may be fabricated using one or more IP cores. In addition to what is illustrated, other logic and circuits may be included in at least one embodiment, including additional graphics processors/cores, peripheral interface controllers, or general-purpose processor cores. In at least one embodiment, the exemplary graphics processors are for use within an SoC.

FIG. 28A illustrates an exemplary graphics processor 2810 of an SoC integrated circuit that may be fabricated using one or more IP cores, in accordance with at least one embodiment. FIG. 28B illustrates an additional exemplary graphics processor 2840 of an SoC integrated circuit that may be fabricated using one or more IP cores, in accordance with at least one embodiment. In at least one embodiment, graphics processor 2810 of FIG. 28A is a low power graphics processor core. In at least one embodiment, graphics processor 2840 of FIG. 28B is a higher performance graphics processor core. In at least one embodiment, each of graphics processors 2810, 2840 can be variants of graphics processor 2310 of FIG. 23.

In at least one embodiment, graphics processor 2810 includes a vertex processor 2805 and one or more fragment processor(s) 2815A-2815N (e.g., 2815A, 2815B, 2815C, 2815D, through 2815N-1, and 2815N). In at least one embodiment, graphics processor 2810 can execute different shader programs via separate logic, such that vertex processor 2805 is optimized to execute operations for vertex shader programs, while one or more fragment processor(s) 2815A-2815N execute fragment (e.g., pixel) shading operations for fragment or pixel shader programs. In at least one embodiment, vertex processor 2805 performs a vertex processing stage of a 3D graphics pipeline and generates primitives and vertex data. In at least one embodiment, fragment processor(s) 2815A-2815N use primitive and vertex data generated by vertex processor 2805 to produce a framebuffer that is displayed on a display device. In at least one embodiment, fragment processor(s) 2815A-2815N are optimized to execute fragment shader programs as provided for in an OpenGL API, which may be used to perform similar operations as a pixel shader program as provided for in a Direct 3D API.

In at least one embodiment, graphics processor 2810 additionally includes one or more MMU(s) 2820A-2820B, cache(s) 2825A-2825B, and circuit interconnect(s) 2830A-2830B. In at least one embodiment, one or more MMU(s) 2820A-2820B provide for virtual to physical address mapping for graphics processor 2810, including for vertex processor 2805 and/or fragment processor(s) 2815A-2815N, which may reference vertex or image/texture data stored in memory, in addition to vertex or image/texture data stored in one or more cache(s) 2825A-2825B. In at least one embodiment, one or more MMU(s) 2820A-2820B may be synchronized with other MMUs within a system, including one or more MMUs associated with one or more application processor(s) 2305, image processors 2315, and/or video processors 2320 of FIG. 23, such that each processor 2305-2320 can participate in a shared or unified virtual memory system. In at least one embodiment, one or more circuit interconnect(s) 2830A-2830B enable graphics processor 2810 to interface with other IP cores within an SoC, either via an internal bus of the SoC or via a direct connection.

In at least one embodiment, graphics processor 2840 includes one or more MMU(s) 2820A-2820B, caches 2825A-2825B, and circuit interconnects 2830A-2830B of graphics processor 2810 of FIG. 28A. In at least one embodiment, graphics processor 2840 includes one or more shader core(s) 2855A-2855N (e.g., 2855A, 2855B, 2855C, 2855D, 2855E, 2855F, through 2855N-1, and 2855N), which provides for a unified shader core architecture in which a single core or type or core can execute all types of programmable shader code, including shader program code to implement vertex shaders, fragment shaders, and/or compute shaders. In at least one embodiment, a number of shader cores can vary. In at least one embodiment, graphics processor 2840 includes an inter-core task manager 2845, which acts as a thread dispatcher to dispatch execution threads to one or more shader cores 2855A-2855N and a tiling unit 2858 to accelerate tiling operations for tile-based rendering, in which rendering operations for a scene are subdivided in image space, for example to exploit local spatial coherence within a scene or to optimize use of internal caches.

In at least one embodiment, at least one component shown or described with respect to FIGS. 28A-28B is utilized to implement techniques and/or functions described in connection with FIGS. 1-18. In at least one embodiment, at least one of graphics processor 2810 or graphics processor 2840 are used to perform asynchronous memory allocation and/or asynchronous memory deallocation. In at least one embodiment, at least one of graphics processor 2810 or graphics processor 2840 are used to perform an API to cause one or more memory locations to be asynchronously allocated to one or more processors. In at least one embodiment, at least one of graphics processor 2810 or graphics processor 2840 are used to perform an API to cause one or more memory locations to be asynchronously allocated to one or more processors. In at least one embodiment, at least one of graphics processor 2810 or graphics processor 2840 are used to perform an API to cause one or more memory locations to be asynchronously deallocated from one or more processors. In at least one embodiment, at least one of graphics processor 2810 or graphics processor 2840 are used to perform at least one aspect described with respect to example computer system 100, example computer system 200, example computer system 300, example computer system 400, example process 500, example process 600, example process 700, example process 800, example data flow 900, example first part of a data flow 1000, example second part of a data flow 1100, example third part of a data flow 1200, example process 1300, example computer system 1400, example computer system 1500, example process 1600, example computer system 1700, and/or example process 1800.

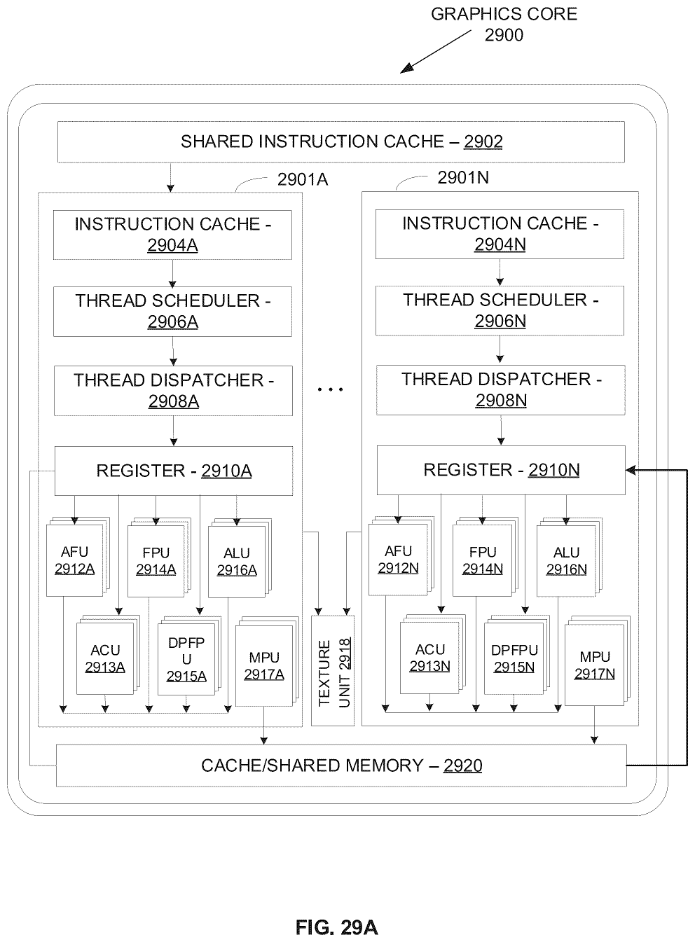

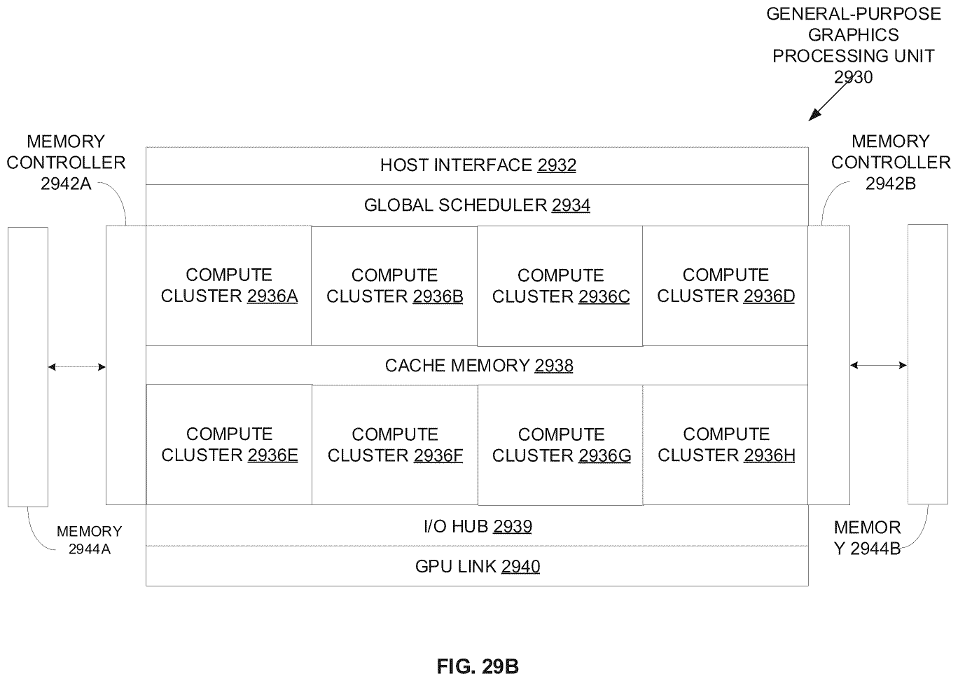

FIG. 29A illustrates a graphics core 2900, in accordance with at least one embodiment. In at least one embodiment, graphics core 2900 may be included within graphics processor 2310 of FIG. 23. In at least one embodiment, graphics core 2900 may be a unified shader core 2855A-2855N as in FIG. 28B. In at least one embodiment, graphics core 2900 includes a shared instruction cache 2902, a texture unit 2918, and a cache/shared memory 2920 that are common to execution resources within graphics core 2900. In at least one embodiment, graphics core 2900 can include multiple slices 2901A-2901N or partition for each core, and a graphics processor can include multiple instances of graphics core 2900. Slices 2901A-2901N can include support logic including a local instruction cache 2904A-2904N, a thread scheduler 2906A-2906N, a thread dispatcher 2908A-2908N, and a set of registers 2910A-2910N. In at least one embodiment, slices 2901A-2901N can include a set of additional function units (“AFUs”) 2912A-2912N, floating-point units (“FPUs”) 2914A-2914N, integer arithmetic logic units (“ALUs”) 2916-2916N, address computational units (“ACUs”) 2913A-2913N, double-precision floating-point units (“DPFPUs”) 2915A-2915N, and matrix processing units (“MPUs”) 2917A-2917N.

In at least one embodiment, FPUs 2914A-2914N can perform single-precision (32-bit) and half-precision (16-bit) floating point operations, while DPFPUs 2915A-2915N perform double precision (64-bit) floating point operations. In at least one embodiment, ALUs 2916A-2916N can perform variable precision integer operations at 8-bit, 16-bit, and 32-bit precision, and can be configured for mixed precision operations. In at least one embodiment, MPUs 2917A-2917N can also be configured for mixed precision matrix operations, including half-precision floating point and 8-bit integer operations. In at least one embodiment, MPUs 2917-2917N can perform a variety of matrix operations to accelerate CUDA programs, including enabling support for accelerated general matrix to matrix multiplication (“GEMM”). In at least one embodiment, AFUs 2912A-2912N can perform additional logic operations not supported by floating-point or integer units, including trigonometric operations (e.g., Sine, Cosine, etc.).

FIG. 29B illustrates a general-purpose graphics processing unit (“GPGPU”) 2930, in accordance with at least one embodiment. In at least one embodiment, GPGPU 2930 is highly-parallel and suitable for deployment on a multi-chip module. In at least one embodiment, GPGPU 2930 can be configured to enable highly-parallel compute operations to be performed by an array of GPUs. In at least one embodiment, GPGPU 2930 can be linked directly to other instances of GPGPU 2930 to create a multi-GPU cluster to improve execution time for CUDA programs. In at least one embodiment, GPGPU 2930 includes a host interface 2932 to enable a connection with a host processor. In at least one embodiment, host interface 2932 is a PCIe interface. In at least one embodiment, host interface 2932 can be a vendor specific communications interface or communications fabric. In at least one embodiment, GPGPU 2930 receives commands from a host processor and uses a global scheduler 2934 to distribute execution threads associated with those commands to a set of compute clusters 2936A-2936H. In at least one embodiment, compute clusters 2936A-2936H share a cache memory 2938. In at least one embodiment, cache memory 2938 can serve as a higher-level cache for cache memories within compute clusters 2936A-2936H.

In at least one embodiment, GPGPU 2930 includes memory 2944A-2944B coupled with compute clusters 2936A-2936H via a set of memory controllers 2942A-2942B. In at least one embodiment, memory 2944A-2944B can include various types of memory devices including DRAM or graphics random access memory, such as synchronous graphics random access memory (“SGRAM”), including graphics double data rate (“GDDR”) memory.

In at least one embodiment, compute clusters 2936A-2936H each include a set of graphics cores, such as graphics core 2900 of FIG. 29A, which can include multiple types of integer and floating point logic units that can perform computational operations at a range of precisions including suited for computations associated with CUDA programs. For example, in at least one embodiment, at least a subset of floating point units in each of compute clusters 2936A-2936H can be configured to perform 16-bit or 32-bit floating point operations, while a different subset of floating point units can be configured to perform 64-bit floating point operations.

In at least one embodiment, multiple instances of GPGPU 2930 can be configured to operate as a compute cluster. Compute clusters 2936A-2936H may implement any technically feasible communication techniques for synchronization and data exchange. In at least one embodiment, multiple instances of GPGPU 2930 communicate over host interface 2932. In at least one embodiment, GPGPU 2930 includes an I/O hub 2939 that couples GPGPU 2930 with a GPU link 2940 that enables a direct connection to other instances of GPGPU 2930. In at least one embodiment, GPU link 2940 is coupled to a dedicated GPU-to-GPU bridge that enables communication and synchronization between multiple instances of GPGPU 2930. In at least one embodiment GPU link 2940 couples with a high speed interconnect to transmit and receive data to other GPGPUs 2930 or parallel processors. In at least one embodiment, multiple instances of GPGPU 2930 are located in separate data processing systems and communicate via a network device that is accessible via host interface 2932. In at least one embodiment GPU link 2940 can be configured to enable a connection to a host processor in addition to or as an alternative to host interface 2932. In at least one embodiment, GPGPU 2930 can be configured to execute a CUDA program.

In at least one embodiment, at least one component shown or described with respect to FIGS. 29A-29B is utilized to implement techniques and/or functions described in connection with FIGS. 1-18. In at least one embodiment, at least one of graphics core 2900 or general-purpose graphics processing unit (“GPGPU”) 2930 are used to perform asynchronous memory allocation and/or asynchronous memory deallocation. In at least one embodiment, at least one of graphics core 2900 or GPGPU 2930 are used to perform an API to cause one or more memory locations to be asynchronously allocated to one or more processors. In at least one embodiment, at least one of graphics core 2900 or GPGPU 2930 are used to perform an API to cause one or more memory locations to be asynchronously allocated to one or more processors. In at least one embodiment, at least one of graphics core 2900 or GPGPU 2930 are used to perform an API to cause one or more memory locations to be asynchronously deallocated from one or more processors. In at least one embodiment, at least one of graphics core 2900 or GPGPU 2930 are used to perform at least one aspect described with respect to example computer system 100, example computer system 200, example computer system 300, example computer system 400, example process 500, example process 600, example process 700, example process 800, example data flow 900, example first part of a data flow 1000, example second part of a data flow 1100, example third part of a data flow 1200, example process 1300, example computer system 1400, example computer system 1500, example process 1600, example computer system 1700, and/or example process 1800.

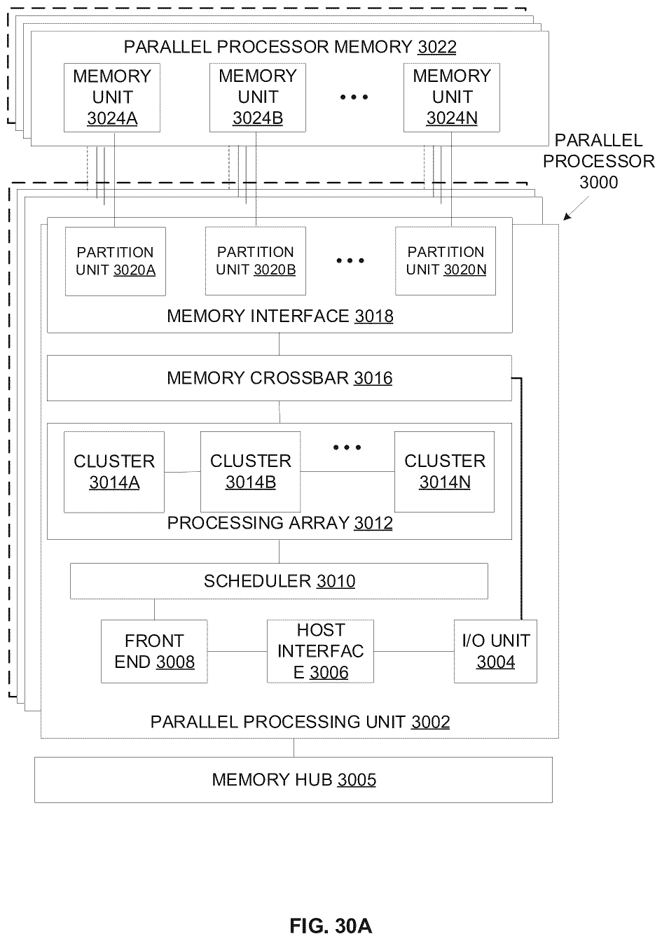

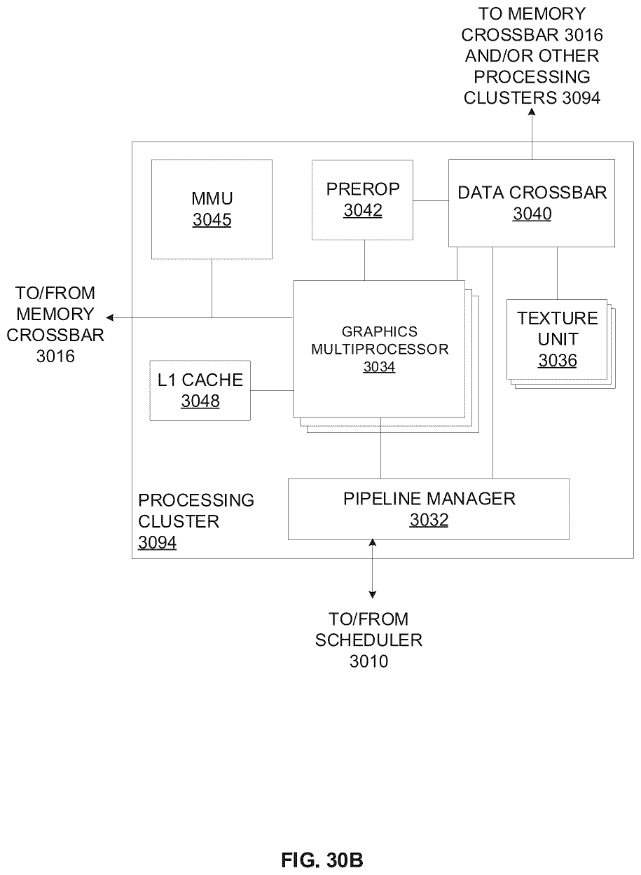

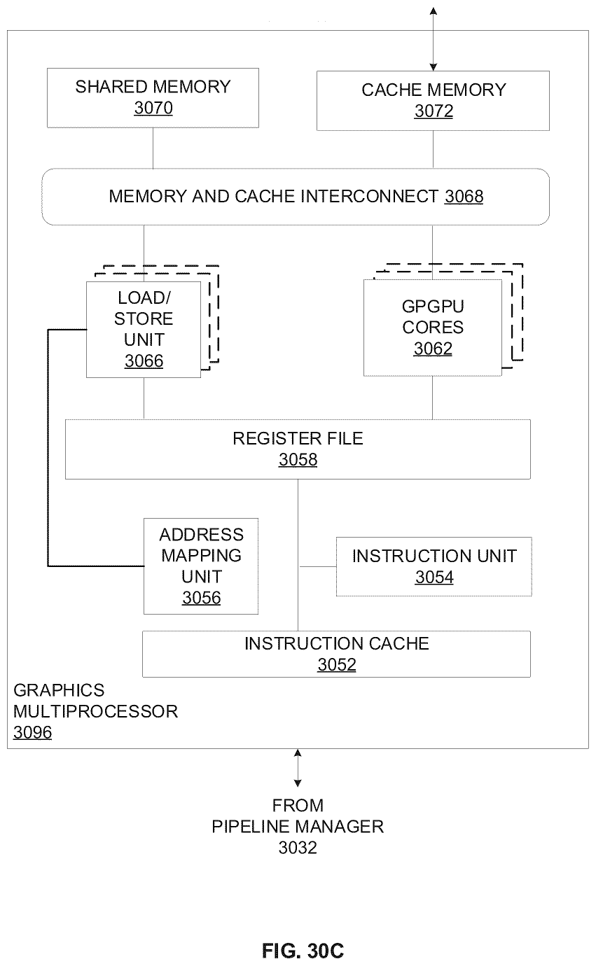

FIG. 30A illustrates a parallel processor 3000, in accordance with at least one embodiment. In at least one embodiment, various components of parallel processor 3000 may be implemented using one or more integrated circuit devices, such as programmable processors, application specific integrated circuits (“ASICs”), or FPGAs.

In at least one embodiment, parallel processor 3000 includes a parallel processing unit 3002. In at least one embodiment, parallel processing unit 3002 includes an I/O unit 3004 that enables communication with other devices, including other instances of parallel processing unit 3002. In at least one embodiment, I/O unit 3004 may be directly connected to other devices. In at least one embodiment, I/O unit 3004 connects with other devices via use of a hub or switch interface, such as memory hub 3005. In at least one embodiment, connections between memory hub 3005 and I/O unit 3004 form a communication link. In at least one embodiment, I/O unit 3004 connects with a host interface 3006 and a memory crossbar 3016, where host interface 3006 receives commands directed to performing processing operations and memory crossbar 3016 receives commands directed to performing memory operations.

In at least one embodiment, when host interface 3006 receives a command buffer via I/O unit 3004, host interface 3006 can direct work operations to perform those commands to a front end 3008. In at least one embodiment, front end 3008 couples with a scheduler 3010, which is configured to distribute commands or other work items to a processing array 3012. In at least one embodiment, scheduler 3010 ensures that processing array 3012 is properly configured and in a valid state before tasks are distributed to processing array 3012. In at least one embodiment, scheduler 3010 is implemented via firmware logic executing on a microcontroller. In at least one embodiment, microcontroller implemented scheduler 3010 is configurable to perform complex scheduling and work distribution operations at coarse and fine granularity, enabling rapid preemption and context switching of threads executing on processing array 3012. In at least one embodiment, host software can prove workloads for scheduling on processing array 3012 via one of multiple graphics processing doorbells. In at least one embodiment, workloads can then be automatically distributed across processing array 3012 by scheduler 3010 logic within a microcontroller including scheduler 3010.

In at least one embodiment, processing array 3012 can include up to “N” clusters (e.g., cluster 3014A, cluster 3014B, through cluster 3014N). In at least one embodiment, each cluster 3014A-3014N of processing array 3012 can execute a large number of concurrent threads. In at least one embodiment, scheduler 3010 can allocate work to clusters 3014A-3014N of processing array 3012 using various scheduling and/or work distribution algorithms, which may vary depending on the workload arising for each type of program or computation. In at least one embodiment, scheduling can be handled dynamically by scheduler 3010, or can be assisted in part by compiler logic during compilation of program logic configured for execution by processing array 3012. In at least one embodiment, different clusters 3014A-3014N of processing array 3012 can be allocated for processing different types of programs or for performing different types of computations.

In at least one embodiment, processing array 3012 can be configured to perform various types of parallel processing operations. In at least one embodiment, processing array 3012 is configured to perform general-purpose parallel compute operations. For example, in at least one embodiment, processing array 3012 can include logic to execute processing tasks including filtering of video and/or audio data, performing modeling operations, including physics operations, and performing data transformations.

In at least one embodiment, processing array 3012 is configured to perform parallel graphics processing operations. In at least one embodiment, processing array 3012 can include additional logic to support execution of such graphics processing operations, including, but not limited to texture sampling logic to perform texture operations, as well as tessellation logic and other vertex processing logic. In at least one embodiment, processing array 3012 can be configured to execute graphics processing related shader programs such as, but not limited to vertex shaders, tessellation shaders, geometry shaders, and pixel shaders. In at least one embodiment, parallel processing unit 3002 can transfer data from system memory via I/O unit 3004 for processing. In at least one embodiment, during processing, transferred data can be stored to on-chip memory (e.g., a parallel processor memory 3022) during processing, then written back to system memory.

In at least one embodiment, when parallel processing unit 3002 is used to perform graphics processing, scheduler 3010 can be configured to divide a processing workload into approximately equal sized tasks, to better enable distribution of graphics processing operations to multiple clusters 3014A-3014N of processing array 3012. In at least one embodiment, portions of processing array 3012 can be configured to perform different types of processing. For example, in at least one embodiment, a first portion may be configured to perform vertex shading and topology generation, a second portion may be configured to perform tessellation and geometry shading, and a third portion may be configured to perform pixel shading or other screen space operations, to produce a rendered image for display. In at least one embodiment, intermediate data produced by one or more of clusters 3014A-3014N may be stored in buffers to allow intermediate data to be transmitted between clusters 3014A-3014N for further processing.

In at least one embodiment, processing array 3012 can receive processing tasks to be executed via scheduler 3010, which receives commands defining processing tasks from front end 3008. In at least one embodiment, processing tasks can include indices of data to be processed, e.g., surface (patch) data, primitive data, vertex data, and/or pixel data, as well as state parameters and commands defining how data is to be processed (e.g., what program is to be executed). In at least one embodiment, scheduler 3010 may be configured to fetch indices corresponding to tasks or may receive indices from front end 3008. In at least one embodiment, front end 3008 can be configured to ensure processing array 3012 is configured to a valid state before a workload specified by incoming command buffers (e.g., batch-buffers, push buffers, etc.) is initiated.

In at least one embodiment, each of one or more instances of parallel processing unit 3002 can couple with parallel processor memory 3022. In at least one embodiment, parallel processor memory 3022 can be accessed via memory crossbar 3016, which can receive memory requests from processing array 3012 as well as I/O unit 3004. In at least one embodiment, memory crossbar 3016 can access parallel processor memory 3022 via a memory interface 3018. In at least one embodiment, memory interface 3018 can include multiple partition units (e.g., a partition unit 3020A, partition unit 3020B, through partition unit 3020N) that can each couple to a portion (e.g., memory unit) of parallel processor memory 3022. In at least one embodiment, a number of partition units 3020A-3020N is configured to be equal to a number of memory units, such that a first partition unit 3020A has a corresponding first memory unit 3024A, a second partition unit 3020B has a corresponding memory unit 3024B, and an Nth partition unit 3020N has a corresponding Nth memory unit 3024N. In at least one embodiment, a number of partition units 3020A-3020N may not be equal to a number of memory devices.

In at least one embodiment, memory units 3024A-3024N can include various types of memory devices, including DRAM or graphics random access memory, such as SGRAM, including GDDR memory. In at least one embodiment, memory units 3024A-3024N may also include 3D stacked memory, including but not limited to high bandwidth memory (“HBM”). In at least one embodiment, render targets, such as frame buffers or texture maps may be stored across memory units 3024A-3024N, allowing partition units 3020A-3020N to write portions of each render target in parallel to efficiently use available bandwidth of parallel processor memory 3022. In at least one embodiment, a local instance of parallel processor memory 3022 may be excluded in favor of a unified memory design that utilizes system memory in conjunction with local cache memory.

In at least one embodiment, any one of clusters 3014A-3014N of processing array 3012 can process data that will be written to any of memory units 3024A-3024N within parallel processor memory 3022. In at least one embodiment, memory crossbar 3016 can be configured to transfer an output of each cluster 3014A-3014N to any partition unit 3020A-3020N or to another cluster 3014A-3014N, which can perform additional processing operations on an output. In at least one embodiment, each cluster 3014A-3014N can communicate with memory interface 3018 through memory crossbar 3016 to read from or write to various external memory devices. In at least one embodiment, memory crossbar 3016 has a connection to memory interface 3018 to communicate with I/O unit 3004, as well as a connection to a local instance of parallel processor memory 3022, enabling processing units within different clusters 3014A-3014N to communicate with system memory or other memory that is not local to parallel processing unit 3002. In at least one embodiment, memory crossbar 3016 can use virtual channels to separate traffic streams between clusters 3014A-3014N and partition units 3020A-3020N.

In at least one embodiment, multiple instances of parallel processing unit 3002 can be provided on a single add-in card, or multiple add-in cards can be interconnected. In at least one embodiment, different instances of parallel processing unit 3002 can be configured to inter-operate even if different instances have different numbers of processing cores, different amounts of local parallel processor memory, and/or other configuration differences. For example, in at least one embodiment, some instances of parallel processing unit 3002 can include higher precision floating point units relative to other instances. In at least one embodiment, systems incorporating one or more instances of parallel processing unit 3002 or parallel processor 3000 can be implemented in a variety of configurations and form factors, including but not limited to desktop, laptop, or handheld personal computers, servers, workstations, game consoles, and/or embedded systems.

FIG. 30B illustrates a processing cluster 3094, in accordance with at least one embodiment. In at least one embodiment, processing cluster 3094 is included within a parallel processing unit. In at least one embodiment, processing cluster 3094 is one of processing clusters 3014A-3014N of FIG. 30. In at least one embodiment, processing cluster 3094 can be configured to execute many threads in parallel, where the term “thread” refers to an instance of a particular program executing on a particular set of input data. In at least one embodiment, single instruction, multiple data (“SIMD”) instruction issue techniques are used to support parallel execution of a large number of threads without providing multiple independent instruction units. In at least one embodiment, single instruction, multiple thread (“SIMT”) techniques are used to support parallel execution of a large number of generally synchronized threads, using a common instruction unit configured to issue instructions to a set of processing engines within each processing cluster 3094.

In at least one embodiment, operation of processing cluster 3094 can be controlled via a pipeline manager 3032 that distributes processing tasks to SIMT parallel processors. In at least one embodiment, pipeline manager 3032 receives instructions from scheduler 3010 of FIG. 30 and manages execution of those instructions via a graphics multiprocessor 3034 and/or a texture unit 3036. In at least one embodiment, graphics multiprocessor 3034 is an exemplary instance of a SIMT parallel processor. However, in at least one embodiment, various types of SIMT parallel processors of differing architectures may be included within processing cluster 3094. In at least one embodiment, one or more instances of graphics multiprocessor 3034 can be included within processing cluster 3094. In at least one embodiment, graphics multiprocessor 3034 can process data and a data crossbar 3040 can be used to distribute processed data to one of multiple possible destinations, including other shader units. In at least one embodiment, pipeline manager 3032 can facilitate distribution of processed data by specifying destinations for processed data to be distributed via data crossbar 3040.

In at least one embodiment, each graphics multiprocessor 3034 within processing cluster 3094 can include an identical set of functional execution logic (e.g., arithmetic logic units, load/store units (“LSUs”), etc.). In at least one embodiment, functional execution logic can be configured in a pipelined manner in which new instructions can be issued before previous instructions are complete. In at least one embodiment, functional execution logic supports a variety of operations including integer and floating point arithmetic, comparison operations, Boolean operations, bit-shifting, and computation of various algebraic functions. In at least one embodiment, same functional-unit hardware can be leveraged to perform different operations and any combination of functional units may be present.

In at least one embodiment, instructions transmitted to processing cluster 3094 constitute a thread. In at least one embodiment, a set of threads executing across a set of parallel processing engines is a thread group. In at least one embodiment, a thread group executes a program on different input data. In at least one embodiment, each thread within a thread group can be assigned to a different processing engine within graphics multiprocessor 3034. In at least one embodiment, a thread group may include fewer threads than a number of processing engines within graphics multiprocessor 3034. In at least one embodiment, when a thread group includes fewer threads than a number of processing engines, one or more of the processing engines may be idle during cycles in which that thread group is being processed. In at least one embodiment, a thread group may also include more threads than a number of processing engines within graphics multiprocessor 3034. In at least one embodiment, when a thread group includes more threads than the number of processing engines within graphics multiprocessor 3034, processing can be performed over consecutive clock cycles. In at least one embodiment, multiple thread groups can be executed concurrently on graphics multiprocessor 3034.

In at least one embodiment, graphics multiprocessor 3034 includes an internal cache memory to perform load and store operations. In at least one embodiment, graphics multiprocessor 3034 can forego an internal cache and use a cache memory (e.g., L1 cache 3048) within processing cluster 3094. In at least one embodiment, each graphics multiprocessor 3034 also has access to Level 2 (“L2”) caches within partition units (e.g., partition units 3020A-3020N of FIG. 30A) that are shared among all processing clusters 3094 and may be used to transfer data between threads. In at least one embodiment, graphics multiprocessor 3034 may also access off-chip global memory, which can include one or more of local parallel processor memory and/or system memory. In at least one embodiment, any memory external to parallel processing unit 3002 may be used as global memory. In at least one embodiment, processing cluster 3094 includes multiple instances of graphics multiprocessor 3034 that can share common instructions and data, which may be stored in L1 cache 3048.

In at least one embodiment, each processing cluster 3094 may include an MMU 3045 that is configured to map virtual addresses into physical addresses. In at least one embodiment, one or more instances of MMU 3045 may reside within memory interface 3018 of FIG. 30. In at least one embodiment, MMU 3045 includes a set of page table entries (“PTEs”) used to map a virtual address to a physical address of a tile and optionally a cache line index. In at least one embodiment, MMU 3045 may include address translation lookaside buffers (“TLBs”) or caches that may reside within graphics multiprocessor 3034 or L1 cache 3048 or processing cluster 3094. In at least one embodiment, a physical address is processed to distribute surface data access locality to allow efficient request interleaving among partition units. In at least one embodiment, a cache line index may be used to determine whether a request for a cache line is a hit or miss.

In at least one embodiment, processing cluster 3094 may be configured such that each graphics multiprocessor 3034 is coupled to a texture unit 3036 for performing texture mapping operations, e.g., determining texture sample positions, reading texture data, and filtering texture data. In at least one embodiment, texture data is read from an internal texture L1 cache (not shown) or from an L1 cache within graphics multiprocessor 3034 and is fetched from an L2 cache, local parallel processor memory, or system memory, as needed. In at least one embodiment, each graphics multiprocessor 3034 outputs a processed task to data crossbar 3040 to provide the processed task to another processing cluster 3094 for further processing or to store the processed task in an L2 cache, a local parallel processor memory, or a system memory via memory crossbar 3016. In at least one embodiment, a pre-raster operations unit (“preROP”) 3042 is configured to receive data from graphics multiprocessor 3034, direct data to ROP units, which may be located with partition units as described herein (e.g., partition units 3020A-3020N of FIG. 30). In at least one embodiment, PreROP 3042 can perform optimizations for color blending, organize pixel color data, and perform address translations.

FIG. 30C illustrates a graphics multiprocessor 3096, in accordance with at least one embodiment. In at least one embodiment, graphics multiprocessor 3096 is graphics multiprocessor 3034 of FIG. 30B. In at least one embodiment, graphics multiprocessor 3096 couples with pipeline manager 3032 of processing cluster 3094. In at least one embodiment, graphics multiprocessor 3096 has an execution pipeline including but not limited to an instruction cache 3052, an instruction unit 3054, an address mapping unit 3056, a register file 3058, one or more GPGPU cores 3062, and one or more LSUs 3066. GPGPU cores 3062 and LSUs 3066 are coupled with cache memory 3072 and shared memory 3070 via a memory and cache interconnect 3068.

In at least one embodiment, instruction cache 3052 receives a stream of instructions to execute from pipeline manager 3032. In at least one embodiment, instructions are cached in instruction cache 3052 and dispatched for execution by instruction unit 3054. In at least one embodiment, instruction unit 3054 can dispatch instructions as thread groups (e.g., warps), with each thread of a thread group assigned to a different execution unit within GPGPU core 3062. In at least one embodiment, an instruction can access any of a local, shared, or global address space by specifying an address within a unified address space. In at least one embodiment, address mapping unit 3056 can be used to translate addresses in a unified address space into a distinct memory address that can be accessed by LSUs 3066.

In at least one embodiment, register file 3058 provides a set of registers for functional units of graphics multiprocessor 3096. In at least one embodiment, register file 3058 provides temporary storage for operands connected to data paths of functional units (e.g., GPGPU cores 3062, LSUs 3066) of graphics multiprocessor 3096. In at least one embodiment, register file 3058 is divided between each of functional units such that each functional unit is allocated a dedicated portion of register file 3058. In at least one embodiment, register file 3058 is divided between different thread groups being executed by graphics multiprocessor 3096.

In at least one embodiment, GPGPU cores 3062 can each include FPUs and/or integer ALUs that are used to execute instructions of graphics multiprocessor 3096. GPGPU cores 3062 can be similar in architecture or can differ in architecture. In at least one embodiment, a first portion of GPGPU cores 3062 include a single precision FPU and an integer ALU while a second portion of GPGPU cores 3062 include a double precision FPU. In at least one embodiment, FPUs can implement IEEE 754-2008 standard for floating point arithmetic or enable variable precision floating point arithmetic. In at least one embodiment, graphics multiprocessor 3096 can additionally include one or more fixed function or special function units to perform specific functions such as copy rectangle or pixel blending operations. In at least one embodiment one or more of GPGPU cores 3062 can also include fixed or special function logic.

In at least one embodiment, GPGPU cores 3062 include SIMD logic capable of performing a single instruction on multiple sets of data. In at least one embodiment GPGPU cores 3062 can physically execute SIMD4, SIMD8, and SIMD16 instructions and logically execute SIMD1, SIMD2, and SIMD32 instructions. In at least one embodiment, SIMD instructions for GPGPU cores 3062 can be generated at compile time by a shader compiler or automatically generated when executing programs written and compiled for single program multiple data (“SPMD”) or SIMT architectures. In at least one embodiment, multiple threads of a program configured for an SIMT execution model can executed via a single SIMD instruction. For example, in at least one embodiment, eight SIMT threads that perform the same or similar operations can be executed in parallel via a single SIMD8 logic unit.

In at least one embodiment, memory and cache interconnect 3068 is an interconnect network that connects each functional unit of graphics multiprocessor 3096 to register file 3058 and to shared memory 3070. In at least one embodiment, memory and cache interconnect 3068 is a crossbar interconnect that allows LSU 3066 to implement load and store operations between shared memory 3070 and register file 3058. In at least one embodiment, register file 3058 can operate at a same frequency as GPGPU cores 3062, thus data transfer between GPGPU cores 3062 and register file 3058 is very low latency. In at least one embodiment, shared memory 3070 can be used to enable communication between threads that execute on functional units within graphics multiprocessor 3096. In at least one embodiment, cache memory 3072 can be used as a data cache for example, to cache texture data communicated between functional units and texture unit 3036. In at least one embodiment, shared memory 3070 can also be used as a program managed cached. In at least one embodiment, threads executing on GPGPU cores 3062 can programmatically store data within shared memory in addition to automatically cached data that is stored within cache memory 3072.

In at least one embodiment, a parallel processor or GPGPU as described herein is communicatively coupled to host/processor cores to accelerate graphics operations, machine-learning operations, pattern analysis operations, and various general purpose GPU (GPGPU) functions. In at least one embodiment, a GPU may be communicatively coupled to host processor/cores over a bus or other interconnect (e.g., a high speed interconnect such as PCIe or NVLink). In at least one embodiment, a GPU may be integrated on the same package or chip as cores and communicatively coupled to cores over a processor bus/interconnect that is internal to a package or a chip. In at least one embodiment, regardless of the manner in which a GPU is connected, processor cores may allocate work to the GPU in the form of sequences of commands/instructions contained in a WD. In at least one embodiment, the GPU then uses dedicated circuitry/logic for efficiently processing these commands/instructions.

In at least one embodiment, at least one component shown or described with respect to FIGS. 30A-30C is utilized to implement techniques and/or functions described in connection with FIGS. 1-18. In at least one embodiment, at least one of parallel processor 3000, graphics multiprocessor 3034, or graphics multiprocessor 3096 are used to perform asynchronous memory allocation and/or asynchronous memory deallocation. In at least one embodiment, at least one of parallel processor 3000, graphics multiprocessor 3034, or graphics multiprocessor 3096 are used to perform an API to cause one or more memory locations to be asynchronously allocated to one or more processors. In at least one embodiment, at least one of parallel processor 3000, graphics multiprocessor 3034, or graphics multiprocessor 3096 are used to perform an API to cause one or more memory locations to be asynchronously allocated to one or more processors. In at least one embodiment, at least one of parallel processor 3000, graphics multiprocessor 3034, or graphics multiprocessor 3096 are used to perform an API to cause one or more memory locations to be asynchronously deallocated from one or more processors. In at least one embodiment, at least one of parallel processor 3000, graphics multiprocessor 3034, or graphics multiprocessor 3096 are used to perform at least one aspect described with respect to example computer system 100, example computer system 200, example computer system 300, example computer system 400, example process 500, example process 600, example process 700, example process 800, example data flow 900, example first part of a data flow 1000, example second part of a data flow 1100, example third part of a data flow 1200, example process 1300, example computer system 1400, example computer system 1500, example process 1600, example computer system 1700, and/or example process 1800.

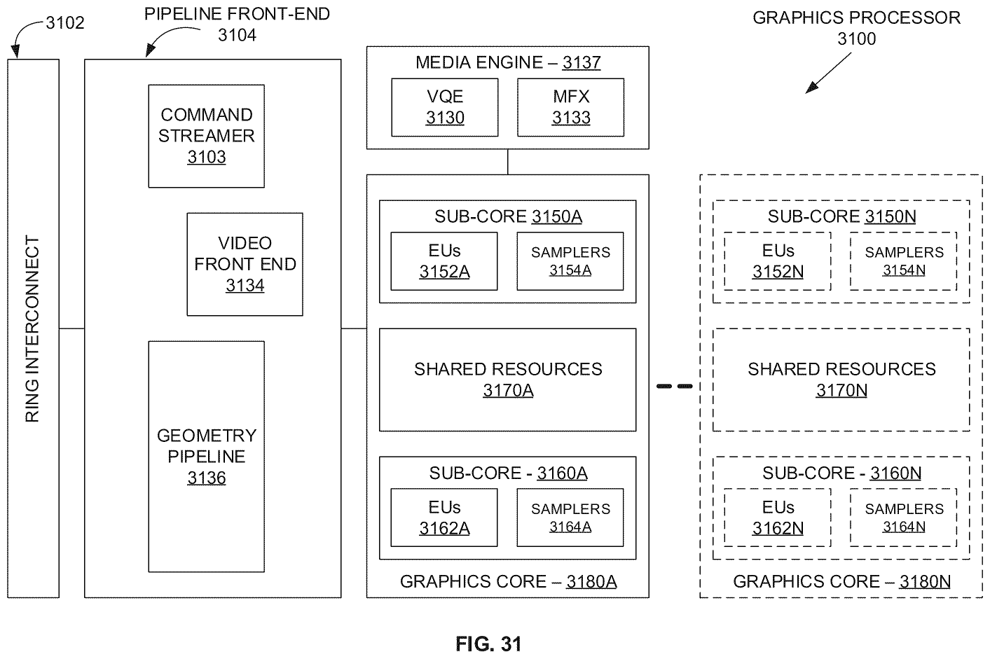

FIG. 31 illustrates a graphics processor 3100, in accordance with at least one embodiment. In at least one embodiment, graphics processor 3100 includes a ring interconnect 3102, a pipeline front-end 3104, a media engine 3137, and graphics cores 3180A-3180N. In at least one embodiment, ring interconnect 3102 couples graphics processor 3100 to other processing units, including other graphics processors or one or more general-purpose processor cores. In at least one embodiment, graphics processor 3100 is one of many processors integrated within a multi-core processing system.

In at least one embodiment, graphics processor 3100 receives batches of commands via ring interconnect 3102. In at least one embodiment, incoming commands are interpreted by a command streamer 3103 in pipeline front-end 3104. In at least one embodiment, graphics processor 3100 includes scalable execution logic to perform 3D geometry processing and media processing via graphics core(s) 3180A-3180N. In at least one embodiment, for 3D geometry processing commands, command streamer 3103 supplies commands to geometry pipeline 3136. In at least one embodiment, for at least some media processing commands, command streamer 3103 supplies commands to a video front end 3134, which couples with a media engine 3137. In at least one embodiment, media engine 3137 includes a Video Quality Engine (“VQE”) 3130 for video and image post-processing and a multi-format encode/decode (“MFX”) engine 3133 to provide hardware-accelerated media data encode and decode. In at least one embodiment, geometry pipeline 3136 and media engine 3137 each generate execution threads for thread execution resources provided by at least one graphics core 3180A.

In at least one embodiment, graphics processor 3100 includes scalable thread execution resources featuring modular graphics cores 3180A-3180N (sometimes referred to as core slices), each having multiple sub-cores 3150A-550N, 3160A-3160N (sometimes referred to as core sub-slices). In at least one embodiment, graphics processor 3100 can have any number of graphics cores 3180A through 3180N. In at least one embodiment, graphics processor 3100 includes a graphics core 3180A having at least a first sub-core 3150A and a second sub-core 3160A. In at least one embodiment, graphics processor 3100 is a low power processor with a single sub-core (e.g., sub-core 3150A). In at least one embodiment, graphics processor 3100 includes multiple graphics cores 3180A-3180N, each including a set of first sub-cores 3150A-3150N and a set of second sub-cores 3160A-3160N. In at least one embodiment, each sub-core in first sub-cores 3150A-3150N includes at least a first set of execution units (“EUs”) 3152A-3152N and media/texture samplers 3154A-3154N. In at least one embodiment, each sub-core in second sub-cores 3160A-3160N includes at least a second set of execution units 3162A-3162N and samplers 3164A-3164N. In at least one embodiment, each sub-core 3150A-3150N, 3160A-3160N shares a set of shared resources 3170A-3170N. In at least one embodiment, shared resources 3170 include shared cache memory and pixel operation logic.

In at least one embodiment, at least one component shown or described with respect to FIG. 31 is utilized to implement techniques and/or functions described in connection with FIGS. 1-18. In at least one embodiment, graphics processor 3100 is used to perform asynchronous memory allocation and/or asynchronous memory deallocation. In at least one embodiment, graphics processor 3100 is used to perform an API to cause one or more memory locations to be asynchronously allocated to one or more processors. In at least one embodiment, graphics processor 3100 is used to perform an API to cause one or more memory locations to be asynchronously allocated to one or more processors. In at least one embodiment, graphics processor 3100 is used to perform an API to cause one or more memory locations to be asynchronously deallocated from one or more processors. In at least one embodiment, graphics processor 3100 is used to perform at least one aspect described with respect to example computer system 100, example computer system 200, example computer system 300, example computer system 400, example process 500, example process 600, example process 700, example process 800, example data flow 900, example first part of a data flow 1000, example second part of a data flow 1100, example third part of a data flow 1200, example process 1300, example computer system 1400, example computer system 1500, example process 1600, example computer system 1700, and/or example process 1800.

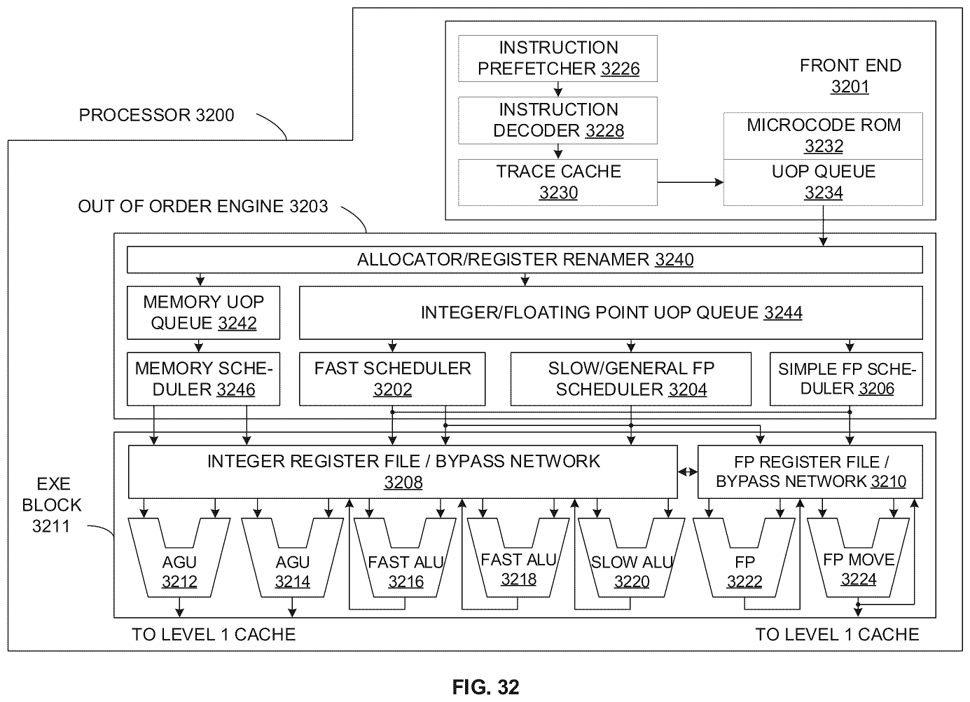

FIG. 32 illustrates a processor 3200, in accordance with at least one embodiment. In at least one embodiment, processor 3200 may include, without limitation, logic circuits to perform instructions. In at least one embodiment, processor 3200 may perform instructions, including x86 instructions, ARM instructions, specialized instructions for ASICs, etc. In at least one embodiment, processor 3210 may include registers to store packed data, such as 64-bit wide MMX™ registers in microprocessors enabled with MMX technology from Intel Corporation of Santa Clara, Calif. In at least one embodiment, MMX registers, available in both integer and floating point forms, may operate with packed data elements that accompany SIMD and streaming SIMD extensions (“SSE”) instructions. In at least one embodiment, 128-bit wide XMM registers relating to SSE2, SSE3, SSE4, AVX, or beyond (referred to generically as “SSEx”) technology may hold such packed data operands. In at least one embodiment, processors 3210 may perform instructions to accelerate CUDA programs.

In at least one embodiment, processor 3200 includes an in-order front end (“front end”) 3201 to fetch instructions to be executed and prepare instructions to be used later in processor pipeline. In at least one embodiment, front end 3201 may include several units. In at least one embodiment, an instruction prefetcher 3226 fetches instructions from memory and feeds instructions to an instruction decoder 3228 which in turn decodes or interprets instructions. For example, in at least one embodiment, instruction decoder 3228 decodes a received instruction into one or more operations called “micro-instructions” or “micro-operations” (also called “micro ops” or “uops”) for execution. In at least one embodiment, instruction decoder 3228 parses instruction into an opcode and corresponding data and control fields that may be used by micro-architecture to perform operations. In at least one embodiment, a trace cache 3230 may assemble decoded uops into program ordered sequences or traces in a uop queue 3234 for execution. In at least one embodiment, when trace cache 3230 encounters a complex instruction, a microcode ROM 3232 provides uops needed to complete an operation.

In at least one embodiment, some instructions may be converted into a single micro-op, whereas others need several micro-ops to complete full operation. In at least one embodiment, if more than four micro-ops are needed to complete an instruction, instruction decoder 3228 may access microcode ROM 3232 to perform instruction. In at least one embodiment, an instruction may be decoded into a small number of micro-ops for processing at instruction decoder 3228. In at least one embodiment, an instruction may be stored within microcode ROM 3232 should a number of micro-ops be needed to accomplish operation. In at least one embodiment, trace cache 3230 refers to an entry point programmable logic array (“PLA”) to determine a correct micro-instruction pointer for reading microcode sequences to complete one or more instructions from microcode ROM 3232. In at least one embodiment, after microcode ROM 3232 finishes sequencing micro-ops for an instruction, front end 3201 of machine may resume fetching micro-ops from trace cache 3230.

In at least one embodiment, out-of-order execution engine (“out of order engine”) 3203 may prepare instructions for execution. In at least one embodiment, out-of-order execution logic has a number of buffers to smooth out and re-order the flow of instructions to optimize performance as they go down a pipeline and get scheduled for execution. Out-of-order execution engine 3203 includes, without limitation, an allocator/register renamer 3240, a memory uop queue 3242, an integer/floating point uop queue 3244, a memory scheduler 3246, a fast scheduler 3202, a slow/general floating point scheduler (“slow/general FP scheduler”) 3204, and a simple floating point scheduler (“simple FP scheduler”) 3206. In at least one embodiment, fast schedule 3202, slow/general floating point scheduler 3204, and simple floating point scheduler 3206 are also collectively referred to herein as “uop schedulers 3202, 3204, 3206.” Allocator/register renamer 3240 allocates machine buffers and resources that each uop needs in order to execute. In at least one embodiment, allocator/register renamer 3240 renames logic registers onto entries in a register file. In at least one embodiment, allocator/register renamer 3240 also allocates an entry for each uop in one of two uop queues, memory uop queue 3242 for memory operations and integer/floating point uop queue 3244 for non-memory operations, in front of memory scheduler 3246 and uop schedulers 3202, 3204, 3206. In at least one embodiment, uop schedulers 3202, 3204, 3206, determine when a uop is ready to execute based on readiness of their dependent input register operand sources and availability of execution resources uops need to complete their operation. In at least one embodiment, fast scheduler 3202 of at least one embodiment may schedule on each half of main clock cycle while slow/general floating point scheduler 3204 and simple floating point scheduler 3206 may schedule once per main processor clock cycle. In at least one embodiment, uop schedulers 3202, 3204, 3206 arbitrate for dispatch ports to schedule uops for execution.

In at least one embodiment, execution block 3211 includes, without limitation, an integer register file/bypass network 3208, a floating point register file/bypass network (“FP register file/bypass network”) 3210, address generation units (“AGUs”) 3212 and 3214, fast ALUs 3216 and 3218, a slow ALU 3220, a floating point ALU (“FP”) 3222, and a floating point move unit (“FP move”) 3224. In at least one embodiment, integer register file/bypass network 3208 and floating point register file/bypass network 3210 are also referred to herein as “register files 3208, 3210.” In at least one embodiment, AGUSs 3212 and 3214, fast ALUs 3216 and 3218, slow ALU 3220, floating point ALU 3222, and floating point move unit 3224 are also referred to herein as “execution units 3212, 3214, 3216, 3218, 3220, 3222, and 3224.” In at least one embodiment, an execution block may include, without limitation, any number (including zero) and type of register files, bypass networks, address generation units, and execution units, in any combination.

In at least one embodiment, register files 3208, 3210 may be arranged between uop schedulers 3202, 3204, 3206, and execution units 3212, 3214, 3216, 3218, 3220, 3222, and 3224. In at least one embodiment, integer register file/bypass network 3208 performs integer operations. In at least one embodiment, floating point register file/bypass network 3210 performs floating point operations. In at least one embodiment, each of register files 3208, 3210 may include, without limitation, a bypass network that may bypass or forward just completed results that have not yet been written into register file to new dependent uops. In at least one embodiment, register files 3208, 3210 may communicate data with each other. In at least one embodiment, integer register file/bypass network 3208 may include, without limitation, two separate register files, one register file for low-order thirty-two bits of data and a second register file for high order thirty-two bits of data. In at least one embodiment, floating point register file/bypass network 3210 may include, without limitation, 128-bit wide entries because floating point instructions typically have operands from 64 to 128 bits in width.

In at least one embodiment, execution units 3212, 3214, 3216, 3218, 3220, 3222, 3224 may execute instructions. In at least one embodiment, register files 3208, 3210 store integer and floating point data operand values that micro-instructions need to execute. In at least one embodiment, processor 3200 may include, without limitation, any number and combination of execution units 3212, 3214, 3216, 3218, 3220, 3222, 3224. In at least one embodiment, floating point ALU 3222 and floating point move unit 3224 may execute floating point, MMX, SIMD, AVX and SSE, or other operations. In at least one embodiment, floating point ALU 3222 may include, without limitation, a 64-bit by 64-bit floating point divider to execute divide, square root, and remainder micro ops. In at least one embodiment, instructions involving a floating point value may be handled with floating point hardware. In at least one embodiment, ALU operations may be passed to fast ALUs 3216, 3218. In at least one embodiment, fast ALUS 3216, 3218 may execute fast operations with an effective latency of half a clock cycle. In at least one embodiment, most complex integer operations go to slow ALU 3220 as slow ALU 3220 may include, without limitation, integer execution hardware for long-latency type of operations, such as a multiplier, shifts, flag logic, and branch processing. In at least one embodiment, memory load/store operations may be executed by AGUs 3212, 3214. In at least one embodiment, fast ALU 3216, fast ALU 3218, and slow ALU 3220 may perform integer operations on 64-bit data operands. In at least one embodiment, fast ALU 3216, fast ALU 3218, and slow ALU 3220 may be implemented to support a variety of data bit sizes including sixteen, thirty-two, 128, 256, etc. In at least one embodiment, floating point ALU 3222 and floating point move unit 3224 may be implemented to support a range of operands having bits of various widths. In at least one embodiment, floating point ALU 3222 and floating point move unit 3224 may operate on 128-bit wide packed data operands in conjunction with SIMD and multimedia instructions.

In at least one embodiment, uop schedulers 3202, 3204, 3206 dispatch dependent operations before parent load has finished executing. In at least one embodiment, as uops may be speculatively scheduled and executed in processor 3200, processor 3200 may also include logic to handle memory misses. In at least one embodiment, if a data load misses in a data cache, there may be dependent operations in flight in pipeline that have left a scheduler with temporarily incorrect data. In at least one embodiment, a replay mechanism tracks and re-executes instructions that use incorrect data. In at least one embodiment, dependent operations might need to be replayed and independent ones may be allowed to complete. In at least one embodiment, schedulers and replay mechanisms of at least one embodiment of a processor may also be designed to catch instruction sequences for text string comparison operations.

In at least one embodiment, the term “registers” may refer to on-board processor storage locations that may be used as part of instructions to identify operands. In at least one embodiment, registers may be those that may be usable from outside of a processor (from a programmer's perspective). In at least one embodiment, registers might not be limited to a particular type of circuit. Rather, in at least one embodiment, a register may store data, provide data, and perform functions described herein. In at least one embodiment, registers described herein may be implemented by circuitry within a processor using any number of different techniques, such as dedicated physical registers, dynamically allocated physical registers using register renaming, combinations of dedicated and dynamically allocated physical registers, etc. In at least one embodiment, integer registers store 32-bit integer data. A register file of at least one embodiment also contains eight multimedia SIMD registers for packed data.

In at least one embodiment, at least one component shown or described with respect to FIG. 32 is utilized to implement techniques and/or functions described in connection with FIGS. 1-18. In at least one embodiment, processor 3200 is used to perform asynchronous memory allocation and/or asynchronous memory deallocation. In at least one embodiment, processor 3200 is used to perform an API to cause one or more memory locations to be asynchronously allocated to one or more processors. In at least one embodiment, processor 3200 is used to perform an API to cause one or more memory locations to be asynchronously allocated to one or more processors. In at least one embodiment, processor 3200 is used to perform an API to cause one or more memory locations to be asynchronously deallocated from one or more processors. In at least one embodiment, processor 3200 is used to perform at least one aspect described with respect to example computer system 100, example computer system 200, example computer system 300, example computer system 400, example process 500, example process 600, example process 700, example process 800, example data flow 900, example first part of a data flow 1000, example second part of a data flow 1100, example third part of a data flow 1200, example process 1300, example computer system 1400, example computer system 1500, example process 1600, example computer system 1700, and/or example process 1800.

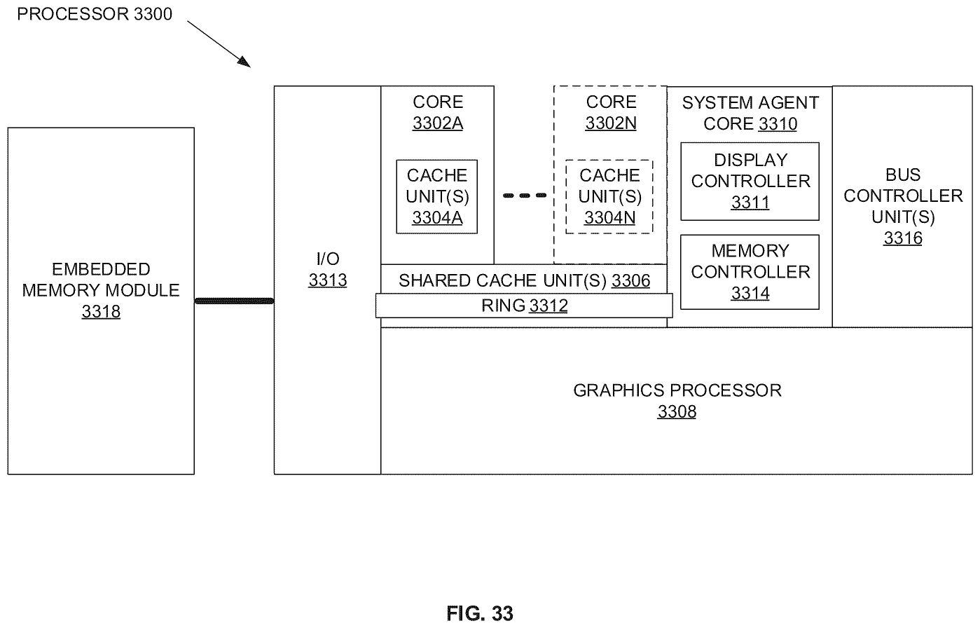

FIG. 33 illustrates a processor 3300, in accordance with at least one embodiment. In at least one embodiment, processor 3300 includes, without limitation, one or more processor cores (“cores”) 3302A-3302N, an integrated memory controller 3314, and an integrated graphics processor 3308. In at least one embodiment, processor 3300 can include additional cores up to and including additional processor core 3302N represented by dashed lined boxes. In at least one embodiment, each of processor cores 3302A-3302N includes one or more internal cache units 3304A-3304N. In at least one embodiment, each processor core also has access to one or more shared cached units 3306.

In at least one embodiment, internal cache units 3304A-3304N and shared cache units 3306 represent a cache memory hierarchy within processor 3300. In at least one embodiment, cache memory units 3304A-3304N may include at least one level of instruction and data cache within each processor core and one or more levels of shared mid-level cache, such as an L2, L3, Level 4 (“L4”), or other levels of cache, where a highest level of cache before external memory is classified as an LLC. In at least one embodiment, cache coherency logic maintains coherency between various cache units 3306 and 3304A-3304N.

In at least one embodiment, processor 3300 may also include a set of one or more bus controller units 3316 and a system agent core 3310. In at least one embodiment, one or more bus controller units 3316 manage a set of peripheral buses, such as one or more PCI or PCI express buses. In at least one embodiment, system agent core 3310 provides management functionality for various processor components. In at least one embodiment, system agent core 3310 includes one or more integrated memory controllers 3314 to manage access to various external memory devices (not shown).

In at least one embodiment, one or more of processor cores 3302A-3302N include support for simultaneous multi-threading. In at least one embodiment, system agent core 3310 includes components for coordinating and operating processor cores 3302A-3302N during multi-threaded processing. In at least one embodiment, system agent core 3310 may additionally include a power control unit (“PCU”), which includes logic and components to regulate one or more power states of processor cores 3302A-3302N and graphics processor 3308.

In at least one embodiment, processor 3300 additionally includes graphics processor 3308 to execute graphics processing operations. In at least one embodiment, graphics processor 3308 couples with shared cache units 3306, and system agent core 3310, including one or more integrated memory controllers 3314. In at least one embodiment, system agent core 3310 also includes a display controller 3311 to drive graphics processor output to one or more coupled displays. In at least one embodiment, display controller 3311 may also be a separate module coupled with graphics processor 3308 via at least one interconnect, or may be integrated within graphics processor 3308.

In at least one embodiment, a ring based interconnect unit 3312 is used to couple internal components of processor 3300. In at least one embodiment, an alternative interconnect unit may be used, such as a point-to-point interconnect, a switched interconnect, or other techniques. In at least one embodiment, graphics processor 3308 couples with ring interconnect 3312 via an I/O link 3313.

In at least one embodiment, I/O link 3313 represents at least one of multiple varieties of I/O interconnects, including an on package I/O interconnect which facilitates communication between various processor components and a high-performance embedded memory module 3318, such as an eDRAM module. In at least one embodiment, each of processor cores 3302A-3302N and graphics processor 3308 use embedded memory modules 3318 as a shared LLC.

In at least one embodiment, processor cores 3302A-3302N are homogeneous cores executing a common instruction set architecture. In at least one embodiment, processor cores 3302A-3302N are heterogeneous in terms of ISA, where one or more of processor cores 3302A-3302N execute a common instruction set, while one or more other cores of processor cores 3302A-33-02N executes a subset of a common instruction set or a different instruction set. In at least one embodiment, processor cores 3302A-3302N are heterogeneous in terms of microarchitecture, where one or more cores having a relatively higher power consumption couple with one or more cores having a lower power consumption. In at least one embodiment, processor 3300 can be implemented on one or more chips or as an SoC integrated circuit.

In at least one embodiment, at least one component shown or described with respect to FIG. 33 is utilized to implement techniques and/or functions described in connection with FIGS. 1-18. In at least one embodiment, at least one of processor 3300 or graphics processor 3308 are used to perform asynchronous memory allocation and/or asynchronous memory deallocation. In at least one embodiment, at least one of processor 3300 or graphics processor 3308 are used to perform an API to cause one or more memory locations to be asynchronously allocated to one or more processors. In at least one embodiment, at least one of processor 3300 or graphics processor 3308 are used to perform an API to cause one or more memory locations to be asynchronously allocated to one or more processors. In at least one embodiment, at least one of processor 3300 or graphics processor 3308 are used to perform an API to cause one or more memory locations to be asynchronously deallocated from one or more processors. In at least one embodiment, at least one of processor 3300 or graphics processor 3308 are used to perform at least one aspect described with respect to example computer system 100, example computer system 200, example computer system 300, example computer system 400, example process 500, example process 600, example process 700, example process 800, example data flow 900, example first part of a data flow 1000, example second part of a data flow 1100, example third part of a data flow 1200, example process 1300, example computer system 1400, example computer system 1500, example process 1600, example computer system 1700, and/or example process 1800.

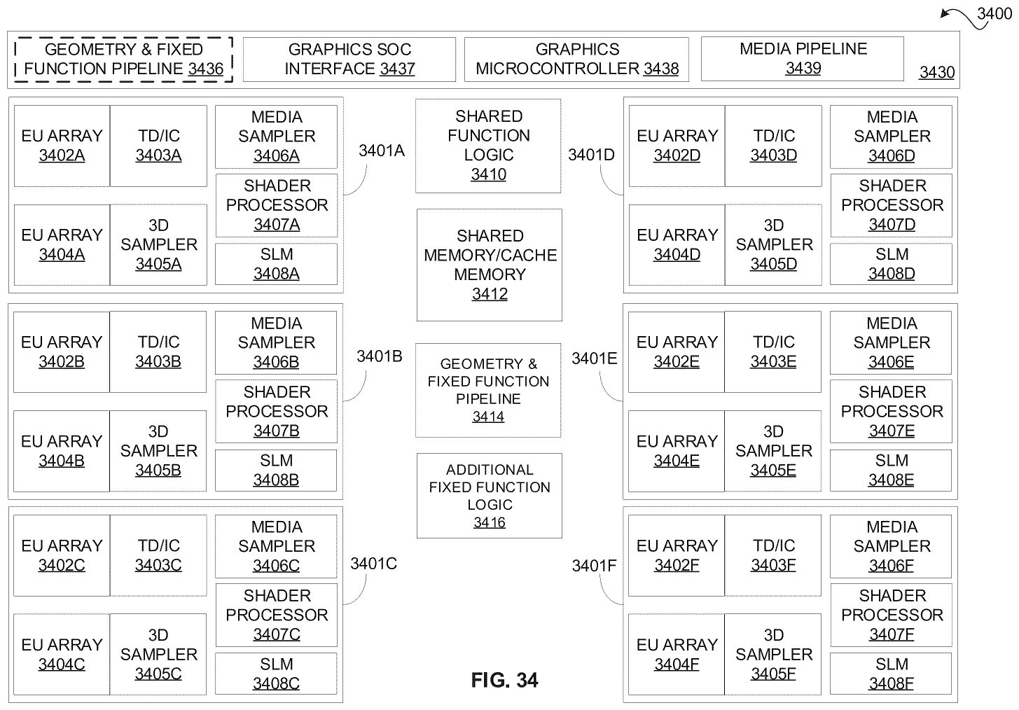

FIG. 34 illustrates a graphics processor core 3400, in accordance with at least one embodiment described. In at least one embodiment, graphics processor core 3400 is included within a graphics core array. In at least one embodiment, graphics processor core 3400, sometimes referred to as a core slice, can be one or multiple graphics cores within a modular graphics processor. In at least one embodiment, graphics processor core 3400 is exemplary of one graphics core slice, and a graphics processor as described herein may include multiple graphics core slices based on target power and performance envelopes. In at least one embodiment, each graphics core 3400 can include a fixed function block 3430 coupled with multiple sub-cores 3401A-3401F, also referred to as sub-slices, that include modular blocks of general-purpose and fixed function logic.

In at least one embodiment, fixed function block 3430 includes a geometry/fixed function pipeline 3436 that can be shared by all sub-cores in graphics processor 3400, for example, in lower performance and/or lower power graphics processor implementations. In at least one embodiment, geometry/fixed function pipeline 3436 includes a 3D fixed function pipeline, a video front-end unit, a thread spawner and thread dispatcher, and a unified return buffer manager, which manages unified return buffers.

In at least one embodiment, fixed function block 3430 also includes a graphics SoC interface 3437, a graphics microcontroller 3438, and a media pipeline 3439. Graphics SoC interface 3437 provides an interface between graphics core 3400 and other processor cores within an SoC integrated circuit. In at least one embodiment, graphics microcontroller 3438 is a programmable sub-processor that is configurable to manage various functions of graphics processor 3400, including thread dispatch, scheduling, and pre-emption. In at least one embodiment, media pipeline 3439 includes logic to facilitate decoding, encoding, pre-processing, and/or post-processing of multimedia data, including image and video data. In at least one embodiment, media pipeline 3439 implements media operations via requests to compute or sampling logic within sub-cores 3401-3401F.

In at least one embodiment, SoC interface 3437 enables graphics core 3400 to communicate with general-purpose application processor cores (e.g., CPUs) and/or other components within an SoC, including memory hierarchy elements such as a shared LLC memory, system RAM, and/or embedded on-chip or on-package DRAM. In at least one embodiment, SoC interface 3437 can also enable communication with fixed function devices within an SoC, such as camera imaging pipelines, and enables use of and/or implements global memory atomics that may be shared between graphics core 3400 and CPUs within an SoC. In at least one embodiment, SoC interface 3437 can also implement power management controls for graphics core 3400 and enable an interface between a clock domain of graphic core 3400 and other clock domains within an SoC. In at least one embodiment, SoC interface 3437 enables receipt of command buffers from a command streamer and global thread dispatcher that are configured to provide commands and instructions to each of one or more graphics cores within a graphics processor. In at least one embodiment, commands and instructions can be dispatched to media pipeline 3439, when media operations are to be performed, or a geometry and fixed function pipeline (e.g., geometry and fixed function pipeline 3436, geometry and fixed function pipeline 3414) when graphics processing operations are to be performed.

In at least one embodiment, graphics microcontroller 3438 can be configured to perform various scheduling and management tasks for graphics core 3400. In at least one embodiment, graphics microcontroller 3438 can perform graphics and/or compute workload scheduling on various graphics parallel engines within execution unit (EU) arrays 3402A-3402F, 3404A-3404F within sub-cores 3401A-3401F. In at least one embodiment, host software executing on a CPU core of an SoC including graphics core 3400 can submit workloads one of multiple graphic processor doorbells, which invokes a scheduling operation on an appropriate graphics engine. In at least one embodiment, scheduling operations include determining which workload to run next, submitting a workload to a command streamer, pre-empting existing workloads running on an engine, monitoring progress of a workload, and notifying host software when a workload is complete. In at least one embodiment, graphics microcontroller 3438 can also facilitate low-power or idle states for graphics core 3400, providing graphics core 3400 with an ability to save and restore registers within graphics core 3400 across low-power state transitions independently from an operating system and/or graphics driver software on a system.

In at least one embodiment, graphics core 3400 may have greater than or fewer than illustrated sub-cores 3401A-3401F, up to N modular sub-cores. For each set of N sub-cores, in at least one embodiment, graphics core 3400 can also include shared function logic 3410, shared and/or cache memory 3412, a geometry/fixed function pipeline 3414, as well as additional fixed function logic 3416 to accelerate various graphics and compute processing operations. In at least one embodiment, shared function logic 3410 can include logic units (e.g., sampler, math, and/or inter-thread communication logic) that can be shared by each N sub-cores within graphics core 3400. Shared and/or cache memory 3412 can be an LLC for N sub-cores 3401A-3401F within graphics core 3400 and can also serve as shared memory that is accessible by multiple sub-cores. In at least one embodiment, geometry/fixed function pipeline 3414 can be included instead of geometry/fixed function pipeline 3436 within fixed function block 3430 and can include same or similar logic units.

In at least one embodiment, graphics core 3400 includes additional fixed function logic 3416 that can include various fixed function acceleration logic for use by graphics core 3400. In at least one embodiment, additional fixed function logic 3416 includes an additional geometry pipeline for use in position only shading. In position-only shading, at least two geometry pipelines exist, whereas in a full geometry pipeline within geometry/fixed function pipeline 3416, 3436, and a cull pipeline, which is an additional geometry pipeline which may be included within additional fixed function logic 3416. In at least one embodiment, cull pipeline is a trimmed down version of a full geometry pipeline. In at least one embodiment, a full pipeline and a cull pipeline can execute different instances of an application, each instance having a separate context. In at least one embodiment, position only shading can hide long cull runs of discarded triangles, enabling shading to be completed earlier in some instances. For example, in at least one embodiment, cull pipeline logic within additional fixed function logic 3416 can execute position shaders in parallel with a main application and generally generates critical results faster than a full pipeline, as a cull pipeline fetches and shades position attribute of vertices, without performing rasterization and rendering of pixels to a frame buffer. In at least one embodiment, a cull pipeline can use generated critical results to compute visibility information for all triangles without regard to whether those triangles are culled. In at least one embodiment, a full pipeline (which in this instance may be referred to as a replay pipeline) can consume visibility information to skip culled triangles to shade only visible triangles that are finally passed to a rasterization phase.

In at least one embodiment, additional fixed function logic 3416 can also include general purpose processing acceleration logic, such as fixed function matrix multiplication logic, for accelerating CUDA programs.

In at least one embodiment, each graphics sub-core 3401A-3401F includes a set of execution resources that may be used to perform graphics, media, and compute operations in response to requests by graphics pipeline, media pipeline, or shader programs. In at least one embodiment, graphics sub-cores 3401A-3401F include multiple EU arrays 3402A-3402F, 3404A-3404F, thread dispatch and inter-thread communication (“TD/IC”) logic 3403A-3403F, a 3D (e.g., texture) sampler 3405A-3405F, a media sampler 3406A-3406F, a shader processor 3407A-3407F, and shared local memory (“SLM”) 3408A-3408F. EU arrays 3402A-3402F, 3404A-3404F each include multiple execution units, which are GPGPUs capable of performing floating-point and integer/fixed-point logic operations in service of a graphics, media, or compute operation, including graphics, media, or compute shader programs. In at least one embodiment, TD/IC logic 3403A-3403F performs local thread dispatch and thread control operations for execution units within a sub-core and facilitate communication between threads executing on execution units of a sub-core. In at least one embodiment, 3D sampler 3405A-3405F can read texture or other 3D graphics related data into memory. In at least one embodiment, 3D sampler can read texture data differently based on a configured sample state and texture format associated with a given texture. In at least one embodiment, media sampler 3406A-3406F can perform similar read operations based on a type and format associated with media data. In at least one embodiment, each graphics sub-core 3401A-3401F can alternately include a unified 3D and media sampler. In at least one embodiment, threads executing on execution units within each of sub-cores 3401A-3401F can make use of shared local memory 3408A-3408F within each sub-core, to enable threads executing within a thread group to execute using a common pool of on-chip memory.

In at least one embodiment, at least one component shown or described with respect to FIG. 34 is utilized to implement techniques and/or functions described in connection with FIGS. 1-18. In at least one embodiment, at least one element of graphics processor core 3400 is used to perform asynchronous memory allocation and/or asynchronous memory deallocation. In at least one embodiment, at least one element of graphics processor core 3400 is used to perform an API to cause one or more memory locations to be asynchronously allocated to one or more processors. In at least one embodiment, at least one element of graphics processor core 3400 is used to perform an API to cause one or more memory locations to be asynchronously allocated to one or more processors. In at least one embodiment, at least one element of graphics processor core 3400 is used to perform an API to cause one or more memory locations to be asynchronously deallocated from one or more processors. In at least one embodiment, at least one element of graphics processor core 3400 is used to perform at least one aspect described with respect to example computer system 100, example computer system 200, example computer system 300, example computer system 400, example process 500, example process 600, example process 700, example process 800, example data flow 900, example first part of a data flow 1000, example second part of a data flow 1100, example third part of a data flow 1200, example process 1300, example computer system 1400, example computer system 1500, example process 1600, example computer system 1700, and/or example process 1800.

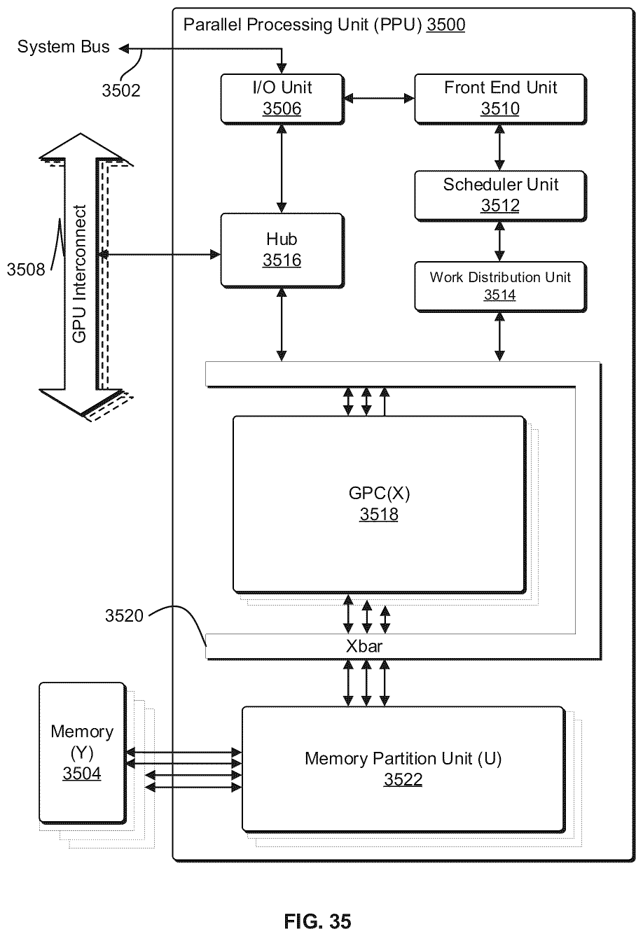

FIG. 35 illustrates a parallel processing unit (“PPU”) 3500, in accordance with at least one embodiment. In at least one embodiment, PPU 3500 is configured with machine-readable code that, if executed by PPU 3500, causes PPU 3500 to perform some or all of processes and techniques described herein. In at least one embodiment, PPU 3500 is a multi-threaded processor that is implemented on one or more integrated circuit devices and that utilizes multithreading as a latency-hiding technique designed to process computer-readable instructions (also referred to as machine-readable instructions or simply instructions) on multiple threads in parallel. In at least one embodiment, a thread refers to a thread of execution and is an instantiation of a set of instructions configured to be executed by PPU 3500. In at least one embodiment, PPU 3500 is a GPU configured to implement a graphics rendering pipeline for processing three-dimensional (“3D”) graphics data in order to generate two-dimensional (“2D”) image data for display on a display device such as an LCD device. In at least one embodiment, PPU 3500 is utilized to perform computations such as linear algebra operations and machine-learning operations. FIG. 35 illustrates an example parallel processor for illustrative purposes only and should be construed as a non-limiting example of a processor architecture that may be implemented in at least one embodiment.

In at least one embodiment, one or more PPUs 3500 are configured to accelerate High Performance Computing (“HPC”), data center, and machine learning applications. In at least one embodiment, one or more PPUs 3500 are configured to accelerate CUDA programs. In at least one embodiment, PPU 3500 includes, without limitation, an I/O unit 3506, a front-end unit 3510, a scheduler unit 3512, a work distribution unit 3514, a hub 3516, a crossbar (“Xbar”) 3520, one or more general processing clusters (“GPCs”) 3518, and one or more partition units (“memory partition units”) 3522. In at least one embodiment, PPU 3500 is connected to a host processor or other PPUs 3500 via one or more high-speed GPU interconnects (“GPU interconnects”) 3508. In at least one embodiment, PPU 3500 is connected to a host processor or other peripheral devices via a system bus or interconnect 3502. In at least one embodiment, PPU 3500 is connected to a local memory comprising one or more memory devices (“memory”) 3504. In at least one embodiment, memory devices 3504 include, without limitation, one or more dynamic random access memory (DRAM) devices. In at least one embodiment, one or more DRAM devices are configured and/or configurable as high-bandwidth memory (“HBM”) subsystems, with multiple DRAM dies stacked within each device.

In at least one embodiment, high-speed GPU interconnect 3508 may refer to a wire-based multi-lane communications link that is used by systems to scale and include one or more PPUs 3500 combined with one or more CPUs, supports cache coherence between PPUs 3500 and CPUs, and CPU mastering. In at least one embodiment, data and/or commands are transmitted by high-speed GPU interconnect 3508 through hub 3516 to/from other units of PPU 3500 such as one or more copy engines, video encoders, video decoders, power management units, and other components which may not be explicitly illustrated in FIG. 35.

In at least one embodiment, I/O unit 3506 is configured to transmit and receive communications (e.g., commands, data) from a host processor (not illustrated in FIG. 35) over system bus 3502. In at least one embodiment, I/O unit 3506 communicates with host processor directly via system bus 3502 or through one or more intermediate devices such as a memory bridge. In at least one embodiment, I/O unit 3506 may communicate with one or more other processors, such as one or more of PPUs 3500 via system bus 3502. In at least one embodiment, I/O unit 3506 implements a PCIe interface for communications over a PCIe bus. In at least one embodiment, I/O unit 3506 implements interfaces for communicating with external devices.

In at least one embodiment, I/O unit 3506 decodes packets received via system bus 3502. In at least one embodiment, at least some packets represent commands configured to cause PPU 3500 to perform various operations. In at least one embodiment, I/O unit 3506 transmits decoded commands to various other units of PPU 3500 as specified by commands. In at least one embodiment, commands are transmitted to front-end unit 3510 and/or transmitted to hub 3516 or other units of PPU 3500 such as one or more copy engines, a video encoder, a video decoder, a power management unit, etc. (not explicitly illustrated in FIG. 35). In at least one embodiment, I/O unit 3506 is configured to route communications between and among various logical units of PPU 3500.

In at least one embodiment, a program executed by host processor encodes a command stream in a buffer that provides workloads to PPU 3500 for processing. In at least one embodiment, a workload comprises instructions and data to be processed by those instructions. In at least one embodiment, buffer is a region in a memory that is accessible (e.g., read/write) by both a host processor and PPU 3500—a host interface unit may be configured to access buffer in a system memory connected to system bus 3502 via memory requests transmitted over system bus 3502 by I/O unit 3506. In at least one embodiment, a host processor writes a command stream to a buffer and then transmits a pointer to the start of the command stream to PPU 3500 such that front-end unit 3510 receives pointers to one or more command streams and manages one or more command streams, reading commands from command streams and forwarding commands to various units of PPU 3500.

In at least one embodiment, front-end unit 3510 is coupled to scheduler unit 3512 that configures various GPCs 3518 to process tasks defined by one or more command streams. In at least one embodiment, scheduler unit 3512 is configured to track state information related to various tasks managed by scheduler unit 3512 where state information may indicate which of GPCs 3518 a task is assigned to, whether task is active or inactive, a priority level associated with task, and so forth. In at least one embodiment, scheduler unit 3512 manages execution of a plurality of tasks on one or more of GPCs 3518.

In at least one embodiment, scheduler unit 3512 is coupled to work distribution unit 3514 that is configured to dispatch tasks for execution on GPCs 3518. In at least one embodiment, work distribution unit 3514 tracks a number of scheduled tasks received from scheduler unit 3512 and work distribution unit 3514 manages a pending task pool and an active task pool for each of GPCs 3518. In at least one embodiment, pending task pool comprises a number of slots (e.g., 32 slots) that contain tasks assigned to be processed by a particular GPC 3518; active task pool may comprise a number of slots (e.g., 4 slots) for tasks that are actively being processed by GPCs 3518 such that as one of GPCs 3518 completes execution of a task, that task is evicted from active task pool for GPC 3518 and one of other tasks from pending task pool is selected and scheduled for execution on GPC 3518. In at least one embodiment, if an active task is idle on GPC 3518, such as while waiting for a data dependency to be resolved, then the active task is evicted from GPC 3518 and returned to a pending task pool while another task in the pending task pool is selected and scheduled for execution on GPC 3518.

In at least one embodiment, work distribution unit 3514 communicates with one or more GPCs 3518 via XBar 3520. In at least one embodiment, XBar 3520 is an interconnect network that couples many units of PPU 3500 to other units of PPU 3500 and can be configured to couple work distribution unit 3514 to a particular GPC 3518. In at least one embodiment, one or more other units of PPU 3500 may also be connected to XBar 3520 via hub 3516.

In at least one embodiment, tasks are managed by scheduler unit 3512 and dispatched to one of GPCs 3518 by work distribution unit 3514. GPC 3518 is configured to process task and generate results. In at least one embodiment, results may be consumed by other tasks within GPC 3518, routed to a different GPC 3518 via XBar 3520, or stored in memory 3504. In at least one embodiment, results can be written to memory 3504 via partition units 3522, which implement a memory interface for reading and writing data to/from memory 3504. In at least one embodiment, results can be transmitted to another PPU 3504 or CPU via high-speed GPU interconnect 3508. In at least one embodiment, PPU 3500 includes, without limitation, a number U of partition units 3522 that is equal to number of separate and distinct memory devices 3504 coupled to PPU 3500.

In at least one embodiment, a host processor executes a driver kernel that implements an application programming interface (“API”) that enables one or more applications executing on host processor to schedule operations for execution on PPU 3500. In at least one embodiment, multiple compute applications are simultaneously executed by PPU 3500 and PPU 3500 provides isolation, quality of service (“QoS”), and independent address spaces for multiple compute applications. In at least one embodiment, an application generates instructions (e.g., in the form of API calls) that cause a driver kernel to generate one or more tasks for execution by PPU 3500 and the driver kernel outputs tasks to one or more streams being processed by PPU 3500. In at least one embodiment, each task comprises one or more groups of related threads, which may be referred to as a warp. In at least one embodiment, a warp comprises a plurality of related threads (e.g., 32 threads) that can be executed in parallel. In at least one embodiment, cooperating threads can refer to a plurality of threads including instructions to perform a task and that exchange data through shared memory.

In at least one embodiment, at least one component shown or described with respect to FIG. 35 is utilized to implement techniques and/or functions described in connection with FIGS. 1-18. In at least one embodiment, parallel processing unit 3500 is used to perform asynchronous memory allocation and/or asynchronous memory deallocation. In at least one embodiment, parallel processing unit 3500 is used to perform an API to cause one or more memory locations to be asynchronously allocated to one or more processors. In at least one embodiment, parallel processing unit 3500 is used to perform an API to cause one or more memory locations to be asynchronously allocated to one or more processors. In at least one embodiment, parallel processing unit 3500 is used to perform an API to cause one or more memory locations to be asynchronously deallocated from one or more processors. In at least one embodiment, parallel processing unit 3500 is used to perform at least one aspect described with respect to example computer system 100, example computer system 200, example computer system 300, example computer system 400, example process 500, example process 600, example process 700, example process 800, example data flow 900, example first part of a data flow 1000, example second part of a data flow 1100, example third part of a data flow 1200, example process 1300, example computer system 1400, example computer system 1500, example process 1600, example computer system 1700, and/or example process 1800.

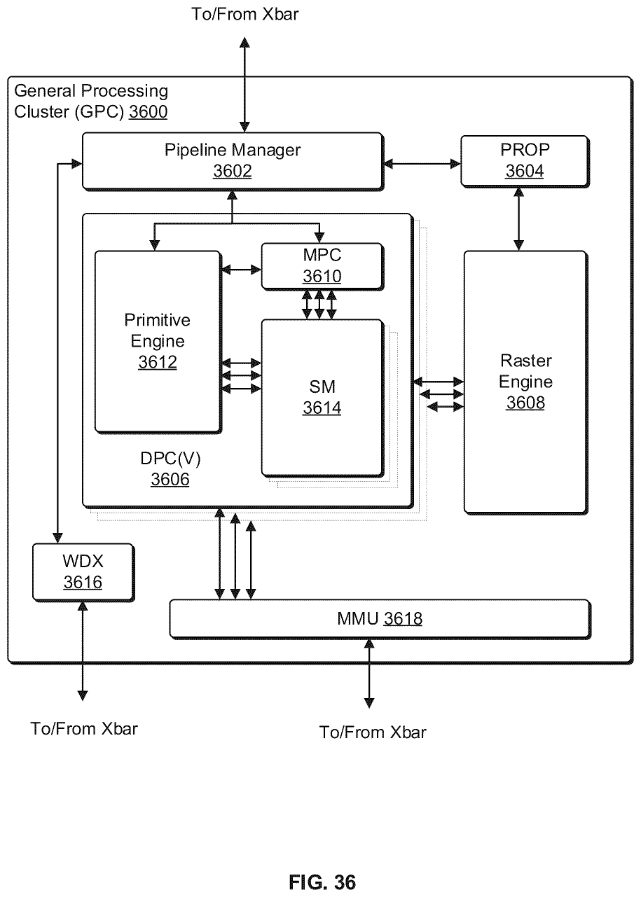

FIG. 36 illustrates a GPC 3600, in accordance with at least one embodiment. In at least one embodiment, GPC 3600 is GPC 3518 of FIG. 35. In at least one embodiment, each GPC 3600 includes, without limitation, a number of hardware units for processing tasks and each GPC 3600 includes, without limitation, a pipeline manager 3602, a pre-raster operations unit (“PROP”) 3604, a raster engine 3608, a work distribution crossbar (“WDX”) 3616, an MMU 3618, one or more Data Processing Clusters (“DPCs”) 3606, and any suitable combination of parts.

In at least one embodiment, operation of GPC 3600 is controlled by pipeline manager 3602. In at least one embodiment, pipeline manager 3602 manages configuration of one or more DPCs 3606 for processing tasks allocated to GPC 3600. In at least one embodiment, pipeline manager 3602 configures at least one of one or more DPCs 3606 to implement at least a portion of a graphics rendering pipeline. In at least one embodiment, DPC 3606 is configured to execute a vertex shader program on a programmable streaming multiprocessor (“SM”) 3614. In at least one embodiment, pipeline manager 3602 is configured to route packets received from a work distribution unit to appropriate logical units within GPC 3600 and, in at least one embodiment, some packets may be routed to fixed function hardware units in PROP 3604 and/or raster engine 3608 while other packets may be routed to DPCs 3606 for processing by a primitive engine 3612 or SM 3614. In at least one embodiment, pipeline manager 3602 configures at least one of DPCs 3606 to implement a computing pipeline. In at least one embodiment, pipeline manager 3602 configures at least one of DPCs 3606 to execute at least a portion of a CUDA program.

In at least one embodiment, PROP unit 3604 is configured to route data generated by raster engine 3608 and DPCs 3606 to a Raster Operations (“ROP”) unit in a partition unit, such as memory partition unit 3522 described in more detail above in conjunction with FIG. 35. In at least one embodiment, PROP unit 3604 is configured to perform optimizations for color blending, organize pixel data, perform address translations, and more. In at least one embodiment, raster engine 3608 includes, without limitation, a number of fixed function hardware units configured to perform various raster operations and, in at least one embodiment, raster engine 3608 includes, without limitation, a setup engine, a coarse raster engine, a culling engine, a clipping engine, a fine raster engine, a tile coalescing engine, and any suitable combination thereof. In at least one embodiment, a setup engine receives transformed vertices and generates plane equations associated with geometric primitive defined by vertices; plane equations are transmitted to a coarse raster engine to generate coverage information (e.g., an x, y coverage mask for a tile) for a primitive; the output of the coarse raster engine is transmitted to a culling engine where fragments associated with a primitive that fail a z-test are culled, and transmitted to a clipping engine where fragments lying outside a viewing frustum are clipped. In at least one embodiment, fragments that survive clipping and culling are passed to a fine raster engine to generate attributes for pixel fragments based on plane equations generated by a setup engine. In at least one embodiment, the output of raster engine 3608 comprises fragments to be processed by any suitable entity such as by a fragment shader implemented within DPC 3606.

In at least one embodiment, each DPC 3606 included in GPC 3600 comprise, without limitation, an M-Pipe Controller (“MPC”) 3610; primitive engine 3612; one or more SMs 3614; and any suitable combination thereof. In at least one embodiment, MPC 3610 controls operation of DPC 3606, routing packets received from pipeline manager 3602 to appropriate units in DPC 3606. In at least one embodiment, packets associated with a vertex are routed to primitive engine 3612, which is configured to fetch vertex attributes associated with vertex from memory; in contrast, packets associated with a shader program may be transmitted to SM 3614.

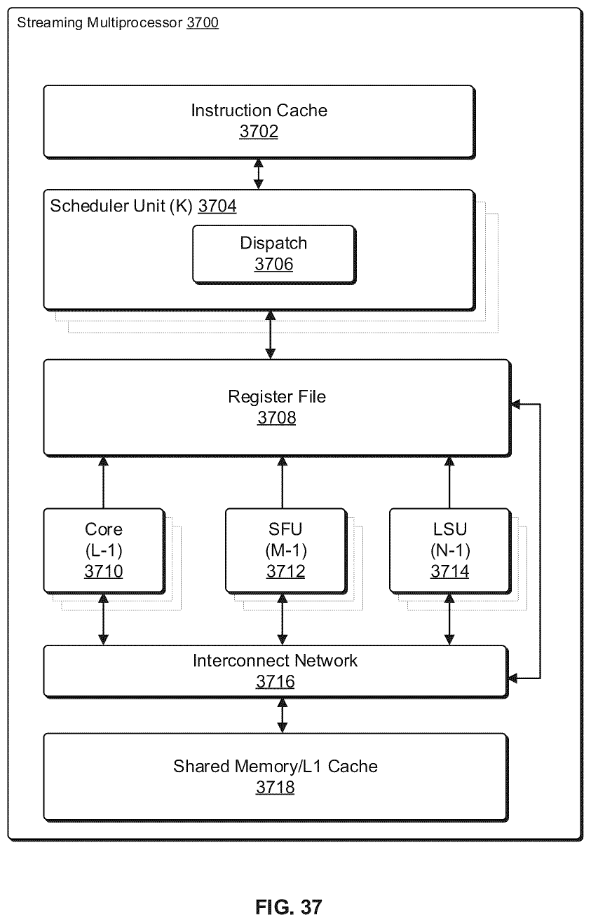

In at least one embodiment, SM 3614 comprises, without limitation, a programmable streaming processor that is configured to process tasks represented by a number of threads. In at least one embodiment, SM 3614 is multi-threaded and configured to execute a plurality of threads (e.g., 32 threads) from a particular group of threads concurrently and implements a SIMD architecture where each thread in a group of threads (e.g., a warp) is configured to process a different set of data based on same set of instructions. In at least one embodiment, all threads in group of threads execute same instructions. In at least one embodiment, SM 3614 implements a SIMT architecture wherein each thread in a group of threads is configured to process a different set of data based on same set of instructions, but where individual threads in group of threads are allowed to diverge during execution. In at least one embodiment, a program counter, a call stack, and an execution state is maintained for each warp, enabling concurrency between warps and serial execution within warps when threads within a warp diverge. In another embodiment, a program counter, a call stack, and an execution state is maintained for each individual thread, enabling equal concurrency between all threads, within and between warps. In at least one embodiment, an execution state is maintained for each individual thread and threads executing the same instructions may be converged and executed in parallel for better efficiency. At least one embodiment of SM 3614 is described in more detail in conjunction with FIG. 37.

In at least one embodiment, MMU 3618 provides an interface between GPC 3600 and a memory partition unit (e.g., partition unit 3522 of FIG. 35) and MMU 3618 provides translation of virtual addresses into physical addresses, memory protection, and arbitration of memory requests. In at least one embodiment, MMU 3618 provides one or more translation lookaside buffers (TLBs) for performing translation of virtual addresses into physical addresses in memory.

In at least one embodiment, at least one component shown or described with respect to FIG. 36 is utilized to implement techniques and/or functions described in connection with FIGS. 1-18. In at least one embodiment, general processing cluster 3600 is used to perform asynchronous memory allocation and/or asynchronous memory deallocation. In at least one embodiment, general processing cluster 3600 is used to perform an API to cause one or more memory locations to be asynchronously allocated to one or more processors. In at least one embodiment, general processing cluster 3600 is used to perform an API to cause one or more memory locations to be asynchronously allocated to one or more processors. In at least one embodiment, general processing cluster 3600 is used to perform an API to cause one or more memory locations to be asynchronously deallocated from one or more processors. In at least one embodiment, general processing cluster 3600 is used to perform at least one aspect described with respect to example computer system 100, example computer system 200, example computer system 300, example computer system 400, example process 500, example process 600, example process 700, example process 800, example data flow 900, example first part of a data flow 1000, example second part of a data flow 1100, example third part of a data flow 1200, example process 1300, example computer system 1400, example computer system 1500, example process 1600, example computer system 1700, and/or example process 1800.

FIG. 37 illustrates a streaming multiprocessor (“SM”) 3700, in accordance with at least one embodiment. In at least one embodiment, SM 3700 is SM 3614 of FIG. 36. In at least one embodiment, SM 3700 includes, without limitation, an instruction cache 3702; one or more scheduler units 3704; a register file 3708; one or more processing cores (“cores”) 3710; one or more special function units (“SFUs”) 3712; one or more LSUs 3714; an interconnect network 3716; a shared memory/L1 cache 3718; and any suitable combination thereof. In at least one embodiment, a work distribution unit dispatches tasks for execution on GPCs of parallel processing units (PPUs) and each task is allocated to a particular Data Processing Cluster (DPC) within a GPC and, if a task is associated with a shader program, then the task is allocated to one of SMs 3700. In at least one embodiment, scheduler unit 3704 receives tasks from a work distribution unit and manages instruction scheduling for one or more thread blocks assigned to SM 3700. In at least one embodiment, scheduler unit 3704 schedules thread blocks for execution as warps of parallel threads, wherein each thread block is allocated at least one warp. In at least one embodiment, each warp executes threads. In at least one embodiment, scheduler unit 3704 manages a plurality of different thread blocks, allocating warps to different thread blocks and then dispatching instructions from a plurality of different cooperative groups to various functional units (e.g., processing cores 3710, SFUs 3712, and LSUs 3714) during each clock cycle.

In at least one embodiment, “cooperative groups” may refer to a programming model for organizing groups of communicating threads that allows developers to express granularity at which threads are communicating, enabling expression of richer, more efficient parallel decompositions. In at least one embodiment, cooperative launch APIs support synchronization amongst thread blocks for execution of parallel algorithms. In at least one embodiment, APIs of conventional programming models provide a single, simple construct for synchronizing cooperating threads: a barrier across all threads of a thread block (e.g., syncthreads( ) function). However, in at least one embodiment, programmers may define groups of threads at smaller than thread block granularities and synchronize within defined groups to enable greater performance, design flexibility, and software reuse in the form of collective group-wide function interfaces. In at least one embodiment, cooperative groups enable programmers to define groups of threads explicitly at sub-block and multi-block granularities, and to perform collective operations such as synchronization on threads in a cooperative group. In at least one embodiment, a sub-block granularity is as small as a single thread. In at least one embodiment, a programming model supports clean composition across software boundaries, so that libraries and utility functions can synchronize safely within their local context without having to make assumptions about convergence. In at least one embodiment, cooperative group primitives enable new patterns of cooperative parallelism, including, without limitation, producer-consumer parallelism, opportunistic parallelism, and global synchronization across an entire grid of thread blocks.

In at least one embodiment, a dispatch unit 3706 is configured to transmit instructions to one or more of functional units and scheduler unit 3704 includes, without limitation, two dispatch units 3706 that enable two different instructions from same warp to be dispatched during each clock cycle. In at least one embodiment, each scheduler unit 3704 includes a single dispatch unit 3706 or additional dispatch units 3706.

In at least one embodiment, each SM 3700, in at least one embodiment, includes, without limitation, register file 3708 that provides a set of registers for functional units of SM 3700. In at least one embodiment, register file 3708 is divided between each of the functional units such that each functional unit is allocated a dedicated portion of register file 3708. In at least one embodiment, register file 3708 is divided between different warps being executed by SM 3700 and register file 3708 provides temporary storage for operands connected to data paths of functional units. In at least one embodiment, each SM 3700 comprises, without limitation, a plurality of L processing cores 3710. In at least one embodiment, SM 3700 includes, without limitation, a large number (e.g., 128 or more) of distinct processing cores 3710. In at least one embodiment, each processing core 3710 includes, without limitation, a fully-pipelined, single-precision, double-precision, and/or mixed precision processing unit that includes, without limitation, a floating point arithmetic logic unit and an integer arithmetic logic unit. In at least one embodiment, floating point arithmetic logic units implement IEEE 754-2008 standard for floating point arithmetic. In at least one embodiment, processing cores 3710 include, without limitation, 64 single-precision (32-bit) floating point cores, 64 integer cores, 32 double-precision (64-bit) floating point cores, and 8 tensor cores.

In at least one embodiment, tensor cores are configured to perform matrix operations. In at least one embodiment, one or more tensor cores are included in processing cores 3710. In at least one embodiment, tensor cores are configured to perform deep learning matrix arithmetic, such as convolution operations for neural network training and inferencing. In at least one embodiment, each tensor core operates on a 4×4 matrix and performs a matrix multiply and accumulate operation D=A×B+C, where A, B, C, and D are 4×4 matrices.

In at least one embodiment, matrix multiply inputs A and B are 16-bit floating point matrices and accumulation matrices C and D are 16-bit floating point or 32-bit floating point matrices. In at least one embodiment, tensor cores operate on 16-bit floating point input data with 32-bit floating point accumulation. In at least one embodiment, 16-bit floating point multiply uses 64 operations and results in a full precision product that is then accumulated using 32-bit floating point addition with other intermediate products for a 4×4×4 matrix multiply. Tensor cores are used to perform much larger two-dimensional or higher dimensional matrix operations, built up from these smaller elements, in at least one embodiment. In at least one embodiment, an API, such as a CUDA-C++ API, exposes specialized matrix load, matrix multiply and accumulate, and matrix store operations to efficiently use tensor cores from a CUDA-C++ program. In at least one embodiment, at the CUDA level, a warp-level interface assumes 16×16 size matrices spanning all 32 threads of a warp.

In at least one embodiment, each SM 3700 comprises, without limitation, M SFUs 3712 that perform special functions (e.g., attribute evaluation, reciprocal square root, and like). In at least one embodiment, SFUs 3712 include, without limitation, a tree traversal unit configured to traverse a hierarchical tree data structure. In at least one embodiment, SFUs 3712 include, without limitation, a texture unit configured to perform texture map filtering operations. In at least one embodiment, texture units are configured to load texture maps (e.g., a 2D array of texels) from memory and sample texture maps to produce sampled texture values for use in shader programs executed by SM 3700. In at least one embodiment, texture maps are stored in shared memory/L1 cache 3718. In at least one embodiment, texture units implement texture operations such as filtering operations using mip-maps (e.g., texture maps of varying levels of detail). In at least one embodiment, each SM 3700 includes, without limitation, two texture units.

In at least one embodiment, each SM 3700 comprises, without limitation, N LSUs 3714 that implement load and store operations between shared memory/L1 cache 3718 and register file 3708. In at least one embodiment, each SM 3700 includes, without limitation, interconnect network 3716 that connects each of the functional units to register file 3708 and LSU 3714 to register file 3708 and shared memory/L1 cache 3718. In at least one embodiment, interconnect network 3716 is a crossbar that can be configured to connect any of the functional units to any of the registers in register file 3708 and connect LSUs 3714 to register file 3708 and memory locations in shared memory/L1 cache 3718.

In at least one embodiment, shared memory/L1 cache 3718 is an array of on-chip memory that allows for data storage and communication between SM 3700 and a primitive engine and between threads in SM 3700. In at least one embodiment, shared memory/L1 cache 3718 comprises, without limitation, 128 KB of storage capacity and is in a path from SM 3700 to a partition unit. In at least one embodiment, shared memory/L1 cache 3718 is used to cache reads and writes. In at least one embodiment, one or more of shared memory/L1 cache 3718, L2 cache, and memory are backing stores.

In at least one embodiment, combining data cache and shared memory functionality into a single memory block provides improved performance for both types of memory accesses. In at least one embodiment, capacity is used or is usable as a cache by programs that do not use shared memory, such as if shared memory is configured to use half of capacity, texture and load/store operations can use remaining capacity. In at least one embodiment, integration within shared memory/L1 cache 3718 enables shared memory/L1 cache 3718 to function as a high-throughput conduit for streaming data while simultaneously providing high-bandwidth and low-latency access to frequently reused data. In at least one embodiment, when configured for general purpose parallel computation, a simpler configuration can be used compared with graphics processing. In at least one embodiment, fixed function GPUs are bypassed, creating a much simpler programming model. In at least one embodiment and in a general purpose parallel computation configuration, a work distribution unit assigns and distributes blocks of threads directly to DPCs. In at least one embodiment, threads in a block execute the same program, using a unique thread ID in a calculation to ensure each thread generates unique results, using SM 3700 to execute a program and perform calculations, shared memory/L1 cache 3718 to communicate between threads, and LSU 3714 to read and write global memory through shared memory/L1 cache 3718 and a memory partition unit. In at least one embodiment, when configured for general purpose parallel computation, SM 3700 writes commands that scheduler unit 3704 can use to launch new work on DPCs.

In at least one embodiment, PPU is included in or coupled to a desktop computer, a laptop computer, a tablet computer, servers, supercomputers, a smart-phone (e.g., a wireless, hand-held device), a PDA, a digital camera, a vehicle, a head mounted display, a hand-held electronic device, and more. In at least one embodiment, PPU is embodied on a single semiconductor substrate. In at least one embodiment, PPU is included in an SoC along with one or more other devices such as additional PPUs, memory, a RISC CPU, an MMU, a digital-to-analog converter (“DAC”), and like.

In at least one embodiment, PPU may be included on a graphics card that includes one or more memory devices. In at least one embodiment, a graphics card may be configured to interface with a PCIe slot on a motherboard of a desktop computer. In at least one embodiment, PPU may be an integrated GPU (“iGPU”) included in chipset of motherboard.

In at least one embodiment, at least one component shown or described with respect to FIG. 37 is utilized to implement techniques and/or functions described in connection with FIGS. 1-18. In at least one embodiment, streaming multiprocessor 3700 is used to perform asynchronous memory allocation and/or asynchronous memory deallocation. In at least one embodiment, streaming multiprocessor 3700 is used to perform an API to cause one or more memory locations to be asynchronously allocated to one or more processors. In at least one embodiment, streaming multiprocessor 3700 is used to perform an API to cause one or more memory locations to be asynchronously allocated to one or more processors. In at least one embodiment, streaming multiprocessor 3700 is used to perform an API to cause one or more memory locations to be asynchronously deallocated from one or more processors. In at least one embodiment, streaming multiprocessor 3700 is used to perform at least one aspect described with respect to example computer system 100, example computer system 200, example computer system 300, example computer system 400, example process 500, example process 600, example process 700, example process 800, example data flow 900, example first part of a data flow 1000, example second part of a data flow 1100, example third part of a data flow 1200, example process 1300, example computer system 1400, example computer system 1500, example process 1600, example computer system 1700, and/or example process 1800.

### Software Constructions for General-Purpose Computing

The following figures set forth, without limitation, exemplary software constructs for implementing at least one embodiment.

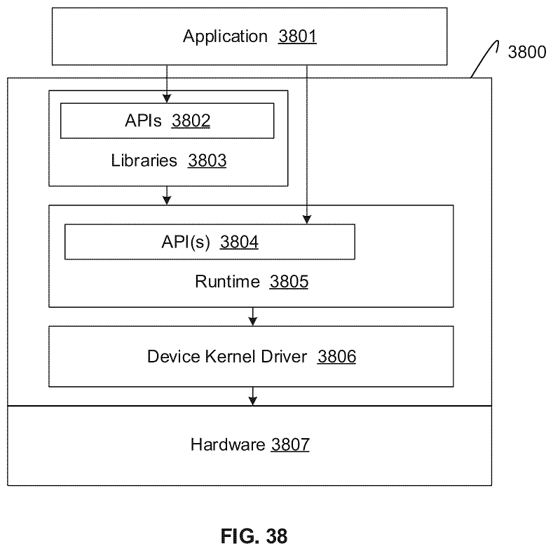

FIG. 38 illustrates a software stack of a programming platform, in accordance with at least one embodiment. In at least one embodiment, a programming platform is a platform for leveraging hardware on a computing system to accelerate computational tasks. A programming platform may be accessible to software developers through libraries, compiler directives, and/or extensions to programming languages, in at least one embodiment. In at least one embodiment, a programming platform may be, but is not limited to, CUDA, Radeon Open Compute Platform (“ROCm”), OpenCL (OpenCL™ is developed by Khronos group), SYCL, or Intel One API.

In at least one embodiment, a software stack 3800 of a programming platform provides an execution environment for an application 3801. In at least one embodiment, application 3801 may include any computer software capable of being launched on software stack 3800. In at least one embodiment, application 3801 may include, but is not limited to, an artificial intelligence (“AI”)/machine learning (“MLL”) application, a high performance computing (“HPC”) application, a virtual desktop infrastructure (“VDI”), or a data center workload.

In at least one embodiment, application 3801 and software stack 3800 run on hardware 3807. Hardware 3807 may include one or more GPUs, CPUs, FPGAs, AI engines, and/or other types of compute devices that support a programming platform, in at least one embodiment. In at least one embodiment, such as with CUDA, software stack 3800 may be vendor specific and compatible with only devices from particular vendor(s). In at least one embodiment, such as in with OpenCL, software stack 3800 may be used with devices from different vendors. In at least one embodiment, hardware 3807 includes a host connected to one more devices that can be accessed to perform computational tasks via application programming interface (“API”) calls. A device within hardware 3807 may include, but is not limited to, a GPU, FPGA, AI engine, or other compute device (but may also include a CPU) and its memory, as opposed to a host within hardware 3807 that may include, but is not limited to, a CPU (but may also include a compute device) and its memory, in at least one embodiment.

In at least one embodiment, software stack 3800 of a programming platform includes, without limitation, a number of libraries 3803, a runtime 3805, and a device kernel driver 3806. Each of libraries 3803 may include data and programming code that can be used by computer programs and leveraged during software development, in at least one embodiment. In at least one embodiment, libraries 3803 may include, but are not limited to, pre-written code and subroutines, classes, values, type specifications, configuration data, documentation, help data, and/or message templates. In at least one embodiment, libraries 3803 include functions that are optimized for execution on one or more types of devices. In at least one embodiment, libraries 3803 may include, but are not limited to, functions for performing mathematical, deep learning, and/or other types of operations on devices. In at least one embodiment, libraries 3803 are associated with corresponding APIs 3802, which may include one or more APIs, that expose functions implemented in libraries 3803.

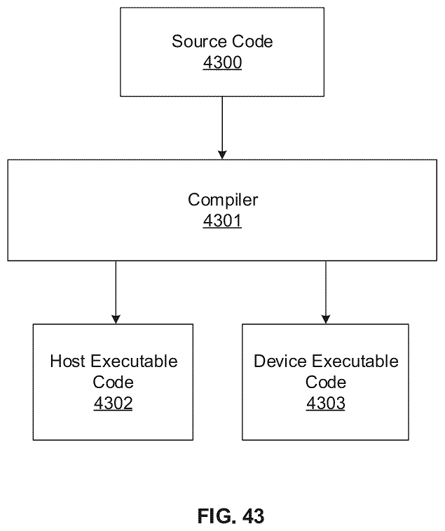

In at least one embodiment, application 3801 is written as source code that is compiled into executable code, as discussed in greater detail below in conjunction with FIGS. 43-45. Executable code of application 3801 may run, at least in part, on an execution environment provided by software stack 3800, in at least one embodiment. In at least one embodiment, during execution of application 3801, code may be reached that needs to run on a device, as opposed to a host. In such a case, runtime 3805 may be called to load and launch requisite code on the device, in at least one embodiment. In at least one embodiment, runtime 3805 may include any technically feasible runtime system that is able to support execution of application S01.

In at least one embodiment, runtime 3805 is implemented as one or more runtime libraries associated with corresponding APIs, which are shown as API(s) 3804. One or more of such runtime libraries may include, without limitation, functions for memory management, execution control, device management, error handling, and/or synchronization, among other things, in at least one embodiment. In at least one embodiment, memory management functions may include, but are not limited to, functions to allocate, deallocate, and copy device memory, as well as transfer data between host memory and device memory. In at least one embodiment, execution control functions may include, but are not limited to, functions to launch a function (sometimes referred to as a “kernel” when a function is a global function callable from a host) on a device and set attribute values in a buffer maintained by a runtime library for a given function to be executed on a device.

Runtime libraries and corresponding API(s) 3804 may be implemented in any technically feasible manner, in at least one embodiment. In at least one embodiment, one (or any number of) API may expose a low-level set of functions for fine-grained control of a device, while another (or any number of) API may expose a higher-level set of such functions. In at least one embodiment, a high-level runtime API may be built on top of a low-level API. In at least one embodiment, one or more of runtime APIs may be language-specific APIs that are layered on top of a language-independent runtime API.

In at least one embodiment, device kernel driver 3806 is configured to facilitate communication with an underlying device. In at least one embodiment, device kernel driver 3806 may provide low-level functionalities upon which APIs, such as API(s) 3804, and/or other software relies. In at least one embodiment, device kernel driver 3806 may be configured to compile intermediate representation (“IR”) code into binary code at runtime. For CUDA, device kernel driver 3806 may compile Parallel Thread Execution (“PTX”) IR code that is not hardware specific into binary code for a specific target device at runtime (with caching of compiled binary code), which is also sometimes referred to as “finalizing” code, in at least one embodiment. Doing so may permit finalized code to run on a target device, which may not have existed when source code was originally compiled into PTX code, in at least one embodiment. Alternatively, in at least one embodiment, device source code may be compiled into binary code offline, without requiring device kernel driver 3806 to compile IR code at runtime.

In at least one embodiment, at least one component shown or described with respect to FIG. 38 is utilized to implement techniques and/or functions described in connection with FIGS. 1-18. In at least one embodiment, at least one element of software stack 3800 of a programming platform is used to perform asynchronous memory allocation and/or asynchronous memory deallocation. In at least one embodiment, at least one element of software stack 3800 of a programming platform is used to perform an API to cause one or more memory locations to be asynchronously allocated to one or more processors. In at least one embodiment, at least one element of software stack 3800 of a programming platform is used to perform an API to cause one or more memory locations to be asynchronously allocated to one or more processors. In at least one embodiment, at least one element of software stack 3800 of a programming platform is used to perform an API to cause one or more memory locations to be asynchronously deallocated from one or more processors. In at least one embodiment, at least one element of software stack 3800 of a programming platform is used to perform at least one aspect described with respect to example computer system 100, example computer system 200, example computer system 300, example computer system 400, example process 500, example process 600, example process 700, example process 800, example data flow 900, example first part of a data flow 1000, example second part of a data flow 1100, example third part of a data flow 1200, example process 1300, example computer system 1400, example computer system 1500, example process 1600, example computer system 1700, and/or example process 1800.

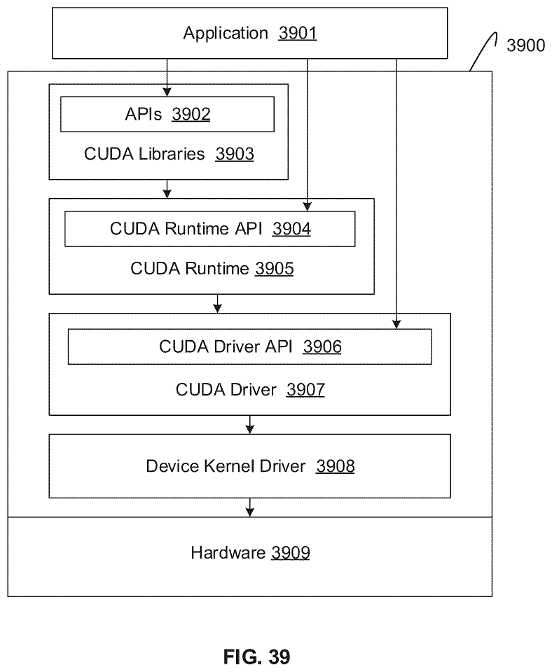

FIG. 39 illustrates a CUDA implementation of software stack 3800 of FIG. 38, in accordance with at least one embodiment. In at least one embodiment, a CUDA software stack 3900, on which an application 3901 may be launched, includes CUDA libraries 3903, a CUDA runtime 3905, a CUDA driver 3907, and a device kernel driver 3908. In at least one embodiment, CUDA software stack 3900 executes on hardware 3909, which may include a GPU that supports CUDA and is developed by NVIDIA Corporation of Santa Clara, CA.

In at least one embodiment, application 3901, CUDA runtime 3905, and device kernel driver 3908 may perform similar functionalities as application 3801, runtime 3805, and device kernel driver 3806, respectively, which are described above in conjunction with FIG. 38. In at least one embodiment, CUDA driver 3907 includes a library (libcuda.so) that implements a CUDA driver API 3906. Similar to a CUDA runtime API 3904 implemented by a CUDA runtime library (cudart), CUDA driver API 3906 may, without limitation, expose functions for memory management, execution control, device management, error handling, synchronization, and/or graphics interoperability, among other things, in at least one embodiment. In at least one embodiment, CUDA driver API 3906 differs from CUDA runtime API 3904 in that CUDA runtime API 3904 simplifies device code management by providing implicit initialization, context (analogous to a process) management, and module (analogous to dynamically loaded libraries) management. In contrast to high-level CUDA runtime API 3904, CUDA driver API 3906 is a low-level API providing more fine-grained control of the device, particularly with respect to contexts and module loading, in at least one embodiment. In at least one embodiment, CUDA driver API 3906 may expose functions for context management that are not exposed by CUDA runtime API 3904. In at least one embodiment, CUDA driver API 3906 is also language-independent and supports, e.g., OpenCL in addition to CUDA runtime API 3904. Further, in at least one embodiment, development libraries, including CUDA runtime 3905, may be considered as separate from driver components, including user-mode CUDA driver 3907 and kernel-mode device driver 3908 (also sometimes referred to as a “display” driver).

In at least one embodiment, CUDA libraries 3903 may include, but are not limited to, mathematical libraries, deep learning libraries, parallel algorithm libraries, and/or signal/image/video processing libraries, which parallel computing applications such as application 3901 may utilize. In at least one embodiment, CUDA libraries 3903 may include mathematical libraries such as a cuBLAS library that is an implementation of Basic Linear Algebra Subprograms (“BLAS”) for performing linear algebra operations, a cuFFT library for computing fast Fourier transforms (“FFTs”), and a cuRAND library for generating random numbers, among others. In at least one embodiment, CUDA libraries 3903 may include deep learning libraries such as a cuDNN library of primitives for deep neural networks and a TensorRT platform for high-performance deep learning inference, among others.

In at least one embodiment, at least one component shown or described with respect to FIG. 39 is utilized to implement techniques and/or functions described in connection with FIGS. 1-18. In at least one embodiment, at least one element of CUDA software stack 3900 is used to perform asynchronous memory allocation and/or asynchronous memory deallocation. In at least one embodiment, at least one element of CUDA software stack 3900 is used to perform an API to cause one or more memory locations to be asynchronously allocated to one or more processors. In at least one embodiment, at least one element of CUDA software stack 3900 is used to perform an API to cause one or more memory locations to be asynchronously allocated to one or more processors. In at least one embodiment, at least one element of CUDA software stack 3900 is used to perform an API to cause one or more memory locations to be asynchronously deallocated from one or more processors. In at least one embodiment, at least one element of CUDA software stack 3900 is used to perform at least one aspect described with respect to example computer system 100, example computer system 200, example computer system 300, example computer system 400, example process 500, example process 600, example process 700, example process 800, example data flow 900, example first part of a data flow 1000, example second part of a data flow 1100, example third part of a data flow 1200, example process 1300, example computer system 1400, example computer system 1500, example process 1600, example computer system 1700, and/or example process 1800.

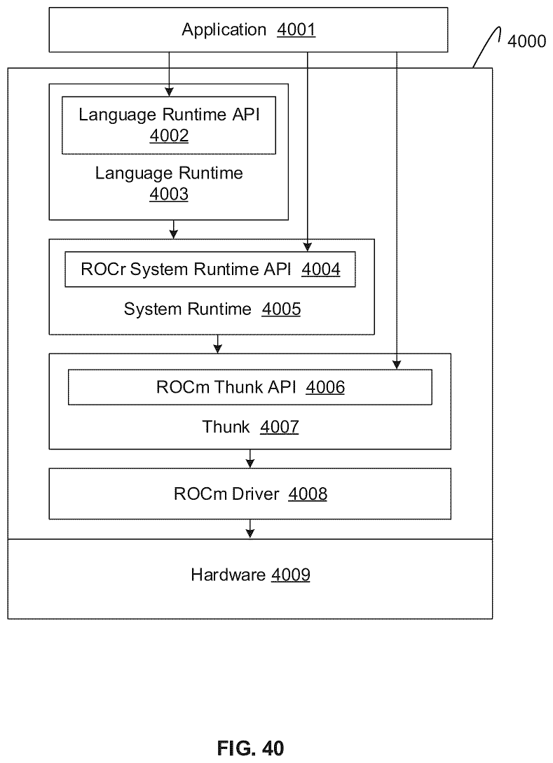

FIG. 40 illustrates a ROCm implementation of software stack 3800 of FIG. 38, in accordance with at least one embodiment. In at least one embodiment, a ROCm software stack 4000, on which an application 4001 may be launched, includes a language runtime 4003, a system runtime 4005, a thunk 4007, and a ROCm kernel driver 4008. In at least one embodiment, ROCm software stack 4000 executes on hardware 4009, which may include a GPU that supports ROCm and is developed by AMD Corporation of Santa Clara, CA.

In at least one embodiment, application 4001 may perform similar functionalities as application 3801 discussed above in conjunction with FIG. 38. In addition, language runtime 4003 and system runtime 4005 may perform similar functionalities as runtime 3805 discussed above in conjunction with FIG. 38, in at least one embodiment. In at least one embodiment, language runtime 4003 and system runtime 4005 differ in that system runtime 4005 is a language-independent runtime that implements a ROCr system runtime API 4004 and makes use of a Heterogeneous System Architecture (“HSA”) Runtime API. HSA runtime API is a thin, user-mode API that exposes interfaces to access and interact with an AMD GPU, including functions for memory management, execution control via architected dispatch of kernels, error handling, system and agent information, and runtime initialization and shutdown, among other things, in at least one embodiment. In contrast to system runtime 4005, language runtime 4003 is an implementation of a language-specific runtime API 4002 layered on top of ROCr system runtime API 4004, in at least one embodiment. In at least one embodiment, language runtime API may include, but is not limited to, a Heterogeneous compute Interface for Portability (“HIP”) language runtime API, a Heterogeneous Compute Compiler (“HCC”) language runtime API, or an OpenCL API, among others. HIP language in particular is an extension of C++ programming language with functionally similar versions of CUDA mechanisms, and, in at least one embodiment, a HIP language runtime API includes functions that are similar to those of CUDA runtime API 3904 discussed above in conjunction with FIG. 39, such as functions for memory management, execution control, device management, error handling, and synchronization, among other things.

In at least one embodiment, thunk (ROCt) 4007 is an interface 4006 that can be used to interact with underlying ROCm driver 4008. In at least one embodiment, ROCm driver 4008 is a ROCk driver, which is a combination of an AMDGPU driver and a HSA kernel driver (amdkfd). In at least one embodiment, AMDGPU driver is a device kernel driver for GPUs developed by AMD that performs similar functionalities as device kernel driver 3806 discussed above in conjunction with FIG. 38. In at least one embodiment, HSA kernel driver is a driver permitting different types of processors to share system resources more effectively via hardware features.

In at least one embodiment, various libraries (not shown) may be included in ROCm software stack 4000 above language runtime 4003 and provide functionality similarity to CUDA libraries 3903, discussed above in conjunction with FIG. 39. In at least one embodiment, various libraries may include, but are not limited to, mathematical, deep learning, and/or other libraries such as a hipBLAS library that implements functions similar to those of CUDA cuBLAS, a rocFFT library for computing FFTs that is similar to CUDA cuFFT, among others.

In at least one embodiment, at least one component shown or described with respect to FIG. 40 is utilized to implement techniques and/or functions described in connection with FIGS. 1-18. In at least one embodiment, at least one element of ROCm software stack 4000 is used to perform asynchronous memory allocation and/or asynchronous memory deallocation. In at least one embodiment, at least one element of ROCm software stack 4000 is used to perform an API to cause one or more memory locations to be asynchronously allocated to one or more processors. In at least one embodiment, at least one element of ROCm software stack 4000 is used to perform an API to cause one or more memory locations to be asynchronously allocated to one or more processors. In at least one embodiment at least one element of ROCm software stack 4000 is used to perform an API to cause one or more memory locations to be asynchronously deallocated from one or more processors. In at least one embodiment, at least one element of ROCm software stack 4000 is used to perform at least one aspect described with respect to example computer system 100, example computer system 200, example computer system 300, example computer system 400, example process 500, example process 600, example process 700, example process 800, example data flow 900, example first part of a data flow 1000, example second part of a data flow 1100, example third part of a data flow 1200, example process 1300, example computer system 1400, example computer system 1500, example process 1600, example computer system 1700, and/or example process 1800.

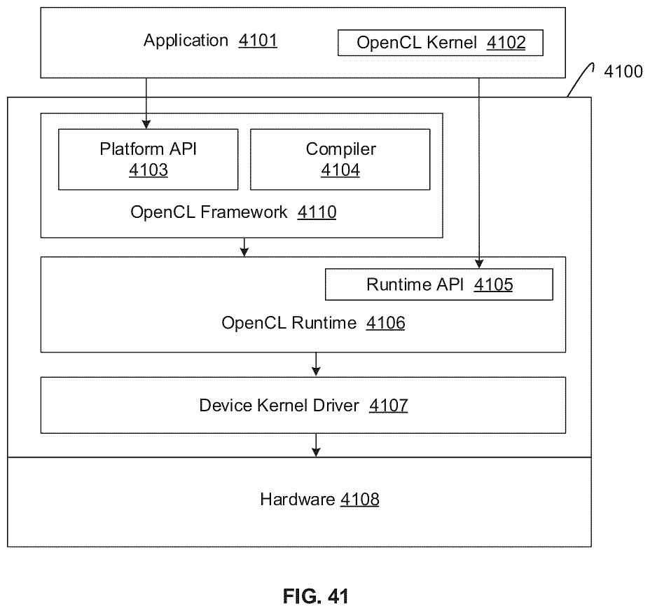

FIG. 41 illustrates an OpenCL implementation of software stack 3800 of FIG. 38, in accordance with at least one embodiment. In at least one embodiment, an OpenCL software stack 4100, on which an application 4101 may be launched, includes an OpenCL framework 4110, an OpenCL runtime 4106, and a driver 4107. In at least one embodiment, OpenCL software stack 4100 executes on hardware 3909 that is not vendor-specific. As OpenCL is supported by devices developed by different vendors, specific OpenCL drivers may be required to interoperate with hardware from such vendors, in at least one embodiment.

In at least one embodiment, application 4101, OpenCL runtime 4106, device kernel driver 4107, and hardware 4108 may perform similar functionalities as application 3801, runtime 3805, device kernel driver 3806, and hardware 3807, respectively, that are discussed above in conjunction with FIG. 38. In at least one embodiment, application 4101 further includes an OpenCL kernel 4102 with code that is to be executed on a device.

In at least one embodiment, OpenCL defines a “platform” that allows a host to control devices connected to the host. In at least one embodiment, an OpenCL framework provides a platform layer API and a runtime API, shown as platform API 4103 and runtime API 4105. In at least one embodiment, runtime API 4105 uses contexts to manage execution of kernels on devices. In at least one embodiment, each identified device may be associated with a respective context, which runtime API 4105 may use to manage command queues, program objects, and kernel objects, share memory objects, among other things, for that device. In at least one embodiment, platform API 4103 exposes functions that permit device contexts to be used to select and initialize devices, submit work to devices via command queues, and enable data transfer to and from devices, among other things. In addition, OpenCL framework provides various built-in functions (not shown), including math functions, relational functions, and image processing functions, among others, in at least one embodiment.

In at least one embodiment, a compiler 4104 is also included in OpenCL frame-work 4110. Source code may be compiled offline prior to executing an application or online during execution of an application, in at least one embodiment. In contrast to CUDA and ROCm, OpenCL applications in at least one embodiment may be compiled online by compiler 4104, which is included to be representative of any number of compilers that may be used to compile source code and/or IR code, such as Standard Portable Intermediate Representation (“SPIR-V”) code, into binary code. Alternatively, in at least one embodiment, OpenCL applications may be compiled offline, prior to execution of such applications.

In at least one embodiment, at least one component shown or described with respect to FIG. 41 is utilized to implement techniques and/or functions described in connection with FIGS. 1-18. In at least one embodiment, at least one element of OpenCL software stack 4100 is used to perform asynchronous memory allocation and/or asynchronous memory deallocation. In at least one embodiment, at least one element of OpenCL software stack 4100 is used to perform an API to cause one or more memory locations to be asynchronously allocated to one or more processors. In at least one embodiment, at least one element of OpenCL software stack 4100 is used to perform an API to cause one or more memory locations to be asynchronously allocated to one or more processors. In at least one embodiment, at least one element of OpenCL software stack 4100 is used to perform an API to cause one or more memory locations to be asynchronously deallocated from one or more processors. In at least one embodiment, at least one element of OpenCL software stack 4100 is used to perform at least one aspect described with respect to example computer system 100, example computer system 200, example computer system 300, example computer system 400, example process 500, example process 600, example process 700, example process 800, example data flow 900, example first part of a data flow 1000, example second part of a data flow 1100, example third part of a data flow 1200, example process 1300, example computer system 1400, example computer system 1500, example process 1600, example computer system 1700, and/or example process 1800.

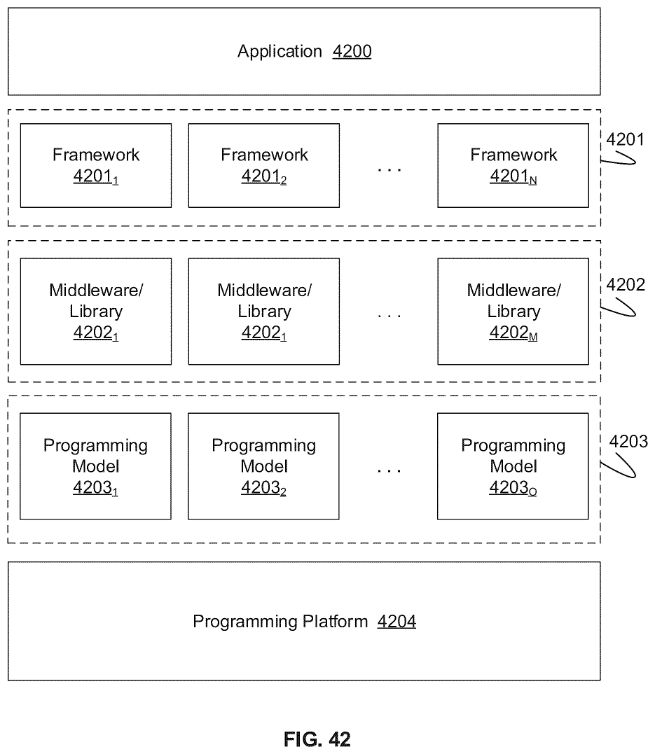

FIG. 42 illustrates software that is supported by a programming platform, in accordance with at least one embodiment. In at least one embodiment, a programming platform 4204 is configured to support various programming models 4203, middlewares and/or libraries 4202, and frameworks 4201 that an application 4200 may rely upon. In at least one embodiment, application 4200 may be an AI/ML application implemented using, for example, a deep learning framework such as MXNet, PyTorch, or TensorFlow, which may rely on libraries such as cuDNN, NVIDIA Collective Communications Library (“NCCL”), and/or NVIDA Developer Data Loading Library (“DALI”) CUDA libraries to provide accelerated computing on underlying hardware.

In at least one embodiment, programming platform 4204 may be one of a CUDA, ROCm, or OpenCL platform described above in conjunction with FIG. 39, FIG. 40, and FIG. 41, respectively. In at least one embodiment, programming platform 4204 supports multiple programming models 4203, which are abstractions of an underlying computing system permitting expressions of algorithms and data structures. Programming models 4203 may expose features of underlying hardware in order to improve performance, in at least one embodiment. In at least one embodiment, programming models 4203 may include, but are not limited to, CUDA, HIP, OpenCL, C++ Accelerated Massive Parallelism (“C++ AMP”), Open Multi-Processing (“OpenMP”), Open Accelerators (“OpenACC”), and/or Vulcan Compute.

In at least one embodiment, libraries and/or middlewares 4202 provide implementations of abstractions of programming models 4204. In at least one embodiment, such libraries include data and programming code that may be used by computer programs and leveraged during software development. In at least one embodiment, such middlewares include software that provides services to applications beyond those available from programming platform 4204. In at least one embodiment, libraries and/or middlewares 4202 may include, but are not limited to, cuBLAS, cuFFT, cuRAND, and other CUDA libraries, or rocBLAS, rocFFT, rocRAND, and other ROCm libraries. In addition, in at least one embodiment, libraries and/or middlewares 4202 may include NCCL and ROCm Communication Collectives Library (“RCCL”) libraries providing communication routines for GPUs, a MIOpen library for deep learning acceleration, and/or an Eigen library for linear algebra, matrix and vector operations, geometrical transformations, numerical solvers, and related algorithms.

In at least one embodiment, application frameworks 4201 depend on libraries and/or middlewares 4202. In at least one embodiment, each of application frameworks 4201 is a software framework used to implement a standard structure of application software. Returning to the AI/ML example discussed above, an AI/ML application may be implemented using a framework such as Caffe, Caffe2, TensorFlow, Keras, PyTorch, or MxNet deep learning frameworks, in at least one embodiment.

In at least one embodiment, at least one component shown or described with respect to FIG. 42 is utilized to implement techniques and/or functions described in connection with FIGS. 1-18. In at least one embodiment, at least element of application 4200 is used to perform asynchronous memory allocation and/or asynchronous memory deallocation. In at least one embodiment, at least element of application 4200 is used to perform an API to cause one or more memory locations to be asynchronously allocated to one or more processors. In at least one embodiment, at least element of application 4200 is used to perform an API to cause one or more memory locations to be asynchronously allocated to one or more processors. In at least one embodiment, at least element of application 4200 is used to perform an API to cause one or more memory locations to be asynchronously deallocated from one or more processors. In at least one embodiment, at least element of application 4200 is used to perform at least one aspect described with respect to example computer system 100, example computer system 200, example computer system 300, example computer system 400, example process 500, example process 600, example process 700, example process 800, example data flow 900, example first part of a data flow 1000, example second part of a data flow 1100, example third part of a data flow 1200, example process 1300, example computer system 1400, example computer system 1500, example process 1600, example computer system 1700, and/or example process 1800.

FIG. 43 illustrates compiling code to execute on one of programming platforms of FIGS. 38-41, in accordance with at least one embodiment. In at least one embodiment, a compiler 4301 receives source code 4300 that includes both host code as well as device code. In at least one embodiment, complier 4301 is configured to convert source code 4300 into host executable code 4302 for execution on a host and device executable code 4303 for execution on a device. In at least one embodiment, source code 4300 may either be compiled offline prior to execution of an application, or online during execution of an application.

In at least one embodiment, source code 4300 may include code in any programming language supported by compiler 4301, such as C++, C, Fortran, etc. In at least one embodiment, source code 4300 may be included in a single-source file having a mixture of host code and device code, with locations of device code being indicated therein. In at least one embodiment, a single-source file may be a .cu file that includes CUDA code or a .hip.cpp file that includes HIP code. Alternatively, in at least one embodiment, source code 4300 may include multiple source code files, rather than a single-source file, into which host code and device code are separated.

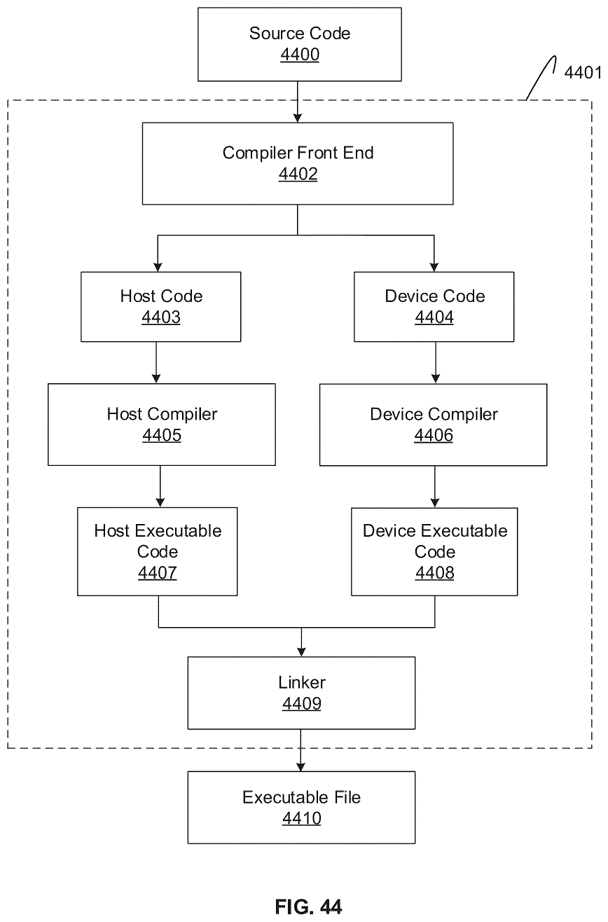

In at least one embodiment, compiler 4301 is configured to compile source code 4300 into host executable code 4302 for execution on a host and device executable code 4303 for execution on a device. In at least one embodiment, compiler 4301 performs operations including parsing source code 4300 into an abstract system tree (AST), performing optimizations, and generating executable code. In at least one embodiment in which source code 4300 includes a single-source file, compiler 4301 may separate device code from host code in such a single-source file, compile device code and host code into device executable code 4303 and host executable code 4302, respectively, and link device executable code 4303 and host executable code 4302 together in a single file, as discussed in greater detail below with respect to FIG. 44.

In at least one embodiment, host executable code 4302 and device executable code 4303 may be in any suitable format, such as binary code and/or IR code. In the case of CUDA, host executable code 4302 may include native object code and device executable code 4303 may include code in PTX intermediate representation, in at least one embodiment. In the case of ROCm, both host executable code 4302 and device executable code 4303 may include target binary code, in at least one embodiment.

In at least one embodiment, at least one component shown or described with respect to FIG. 43 is utilized to implement techniques and/or functions described in connection with FIGS. 1-18. In at least one embodiment, at least one of host executable code 4302 or device executable code 4303 specified in source code 4300 are used to perform asynchronous memory allocation and/or asynchronous memory deallocation. In at least one embodiment, at least one of host executable code 4302 or device executable code 4303 specified in source code 4300 are used to perform an API to cause one or more memory locations to be asynchronously allocated to one or more processors. In at least one embodiment, at least one of host executable code 4302 or device executable code 4303 specified in source code 4300 are used to perform an API to cause one or more memory locations to be asynchronously allocated to one or more processors. In at least one embodiment, at least one of host executable code 4302 or device executable code 4303 specified in source code 4300 are used to perform an API to cause one or more memory locations to be asynchronously deallocated from one or more processors. In at least one embodiment, at least one of host executable code 4302 or device executable code 4303 specified in source code 4300 are used to perform at least one aspect described with respect to example computer system 100, example computer system 200, example computer system 300, example computer system 400, example process 500, example process 600, example process 700, example process 800, example data flow 900, example first part of a data flow 1000, example second part of a data flow 1100, example third part of a data flow 1200, example process 1300, example computer system 1400, example computer system 1500, example process 1600, example computer system 1700, and/or example process 1800.

FIG. 44 is a more detailed illustration of compiling code to execute on one of programming platforms of FIGS. 38-41, in accordance with at least one embodiment. In at least one embodiment, a compiler 4401 is configured to receive source code 4400, compile source code 4400, and output an executable file 4410. In at least one embodiment, source code 4400 is a single-source file, such as a .cu file, a .hip.cpp file, or a file in another format, that includes both host and device code. In at least one embodiment, compiler 4401 may be, but is not limited to, an NVIDIA CUDA compiler (“NVCC”) for compiling CUDA code in .cu files, or a HCC compiler for compiling HIP code in .hip.cpp files.

In at least one embodiment, compiler 4401 includes a compiler front end 4402, a host compiler 4405, a device compiler 4406, and a linker 4409. In at least one embodiment, compiler front end 4402 is configured to separate device code 4404 from host code 4403 in source code 4400. Device code 4404 is compiled by device compiler 4406 into device executable code 4408, which as described may include binary code or IR code, in at least one embodiment. Separately, host code 4403 is compiled by host compiler 4405 into host executable code 4407, in at least one embodiment. For NVCC, host compiler 4405 may be, but is not limited to, a general purpose C/C++ compiler that outputs native object code, while device compiler 4406 may be, but is not limited to, a Low Level Virtual Machine (“LLVM”)-based compiler that forks a LLVM compiler infrastructure and outputs PTX code or binary code, in at least one embodiment. For HCC, both host compiler 4405 and device compiler 4406 may be, but are not limited to, LLVM-based compilers that output target binary code, in at least one embodiment.

Subsequent to compiling source code 4400 into host executable code 4407 and device executable code 4408, linker 4409 links host and device executable code 4407 and 4408 together in executable file 4410, in at least one embodiment. In at least one embodiment, native object code for a host and PTX or binary code for a device may be linked together in an Executable and Linkable Format (“ELF”) file, which is a container format used to store object code.

In at least one embodiment, at least one component shown or described with respect to FIG. 44 is utilized to implement techniques and/or functions described in connection with FIGS. 1-18. In at least one embodiment, executable file 4410 specified in source code 4400 is used to perform asynchronous memory allocation and/or asynchronous memory deallocation. In at least one embodiment, executable file 4410 specified in source code 4400 is used to perform an API to cause one or more memory locations to be asynchronously allocated to one or more processors. In at least one embodiment, executable file 4410 specified in source code 4400 is used to perform an API to cause one or more memory locations to be asynchronously allocated to one or more processors. In at least one embodiment, executable file 4410 specified in source code 4400 is used to perform an API to cause one or more memory locations to be asynchronously deallocated from one or more processors. In at least one embodiment, executable file 4410 specified in source code 4400 is used to perform at least one aspect described with respect to example computer system 100, example computer system 200, example computer system 300, example computer system 400, example process 500, example process 600, example process 700, example process 800, example data flow 900, example first part of a data flow 1000, example second part of a data flow 1100, example third part of a data flow 1200, example process 1300, example computer system 1400, example computer system 1500, example process 1600, example computer system 1700, and/or example process 1800.

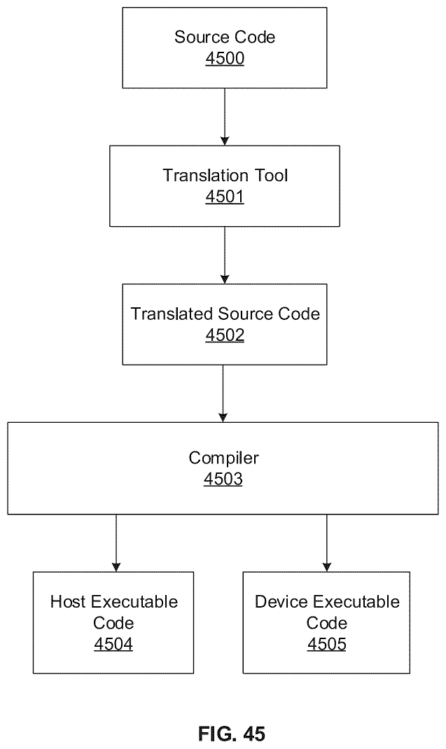

FIG. 45 illustrates translating source code prior to compiling source code, in accordance with at least one embodiment. In at least one embodiment, source code 4500 is passed through a translation tool 4501, which translates source code 4500 into translated source code 4502. In at least one embodiment, a compiler 4503 is used to compile translated source code 4502 into host executable code 4504 and device executable code 4505 in a process that is similar to compilation of source code 4300 by compiler 4301 into host executable code 4302 and device executable 4303, as discussed above in conjunction with FIG. 43.

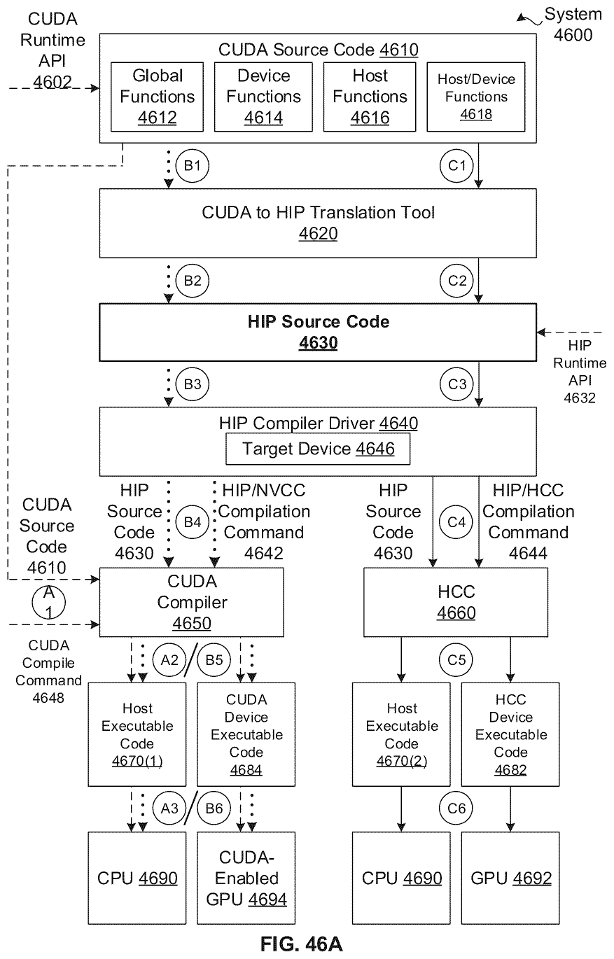

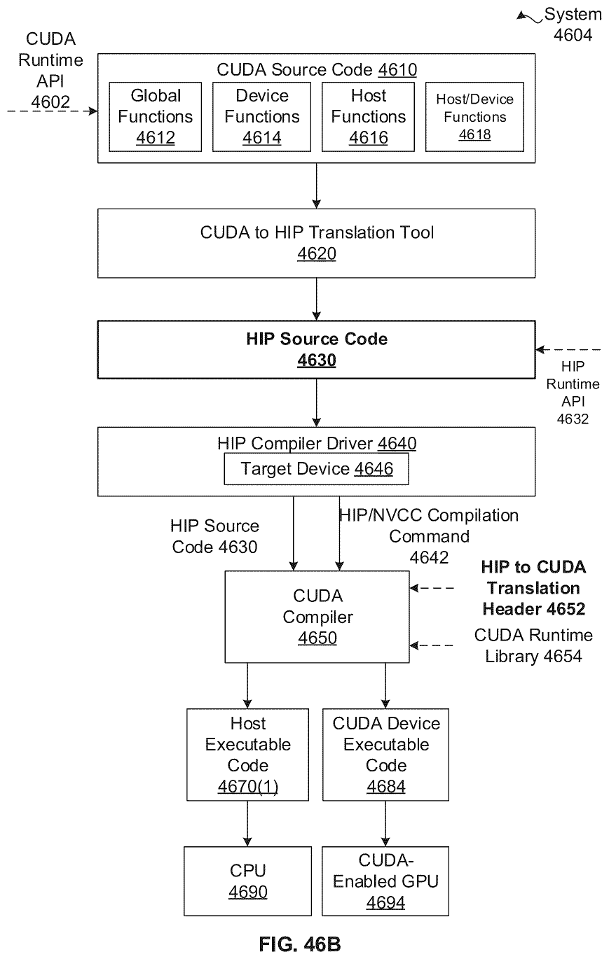

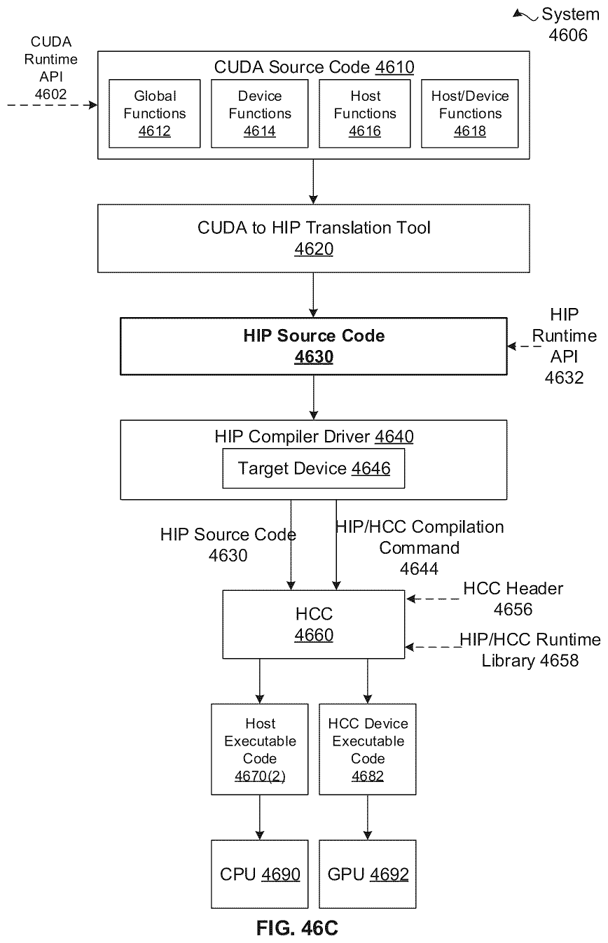

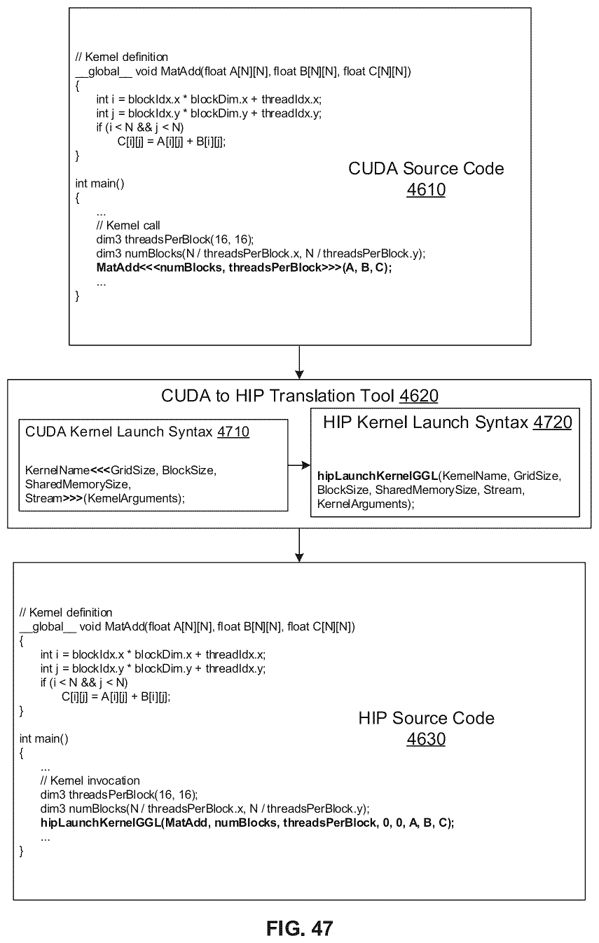

In at least one embodiment, a translation performed by translation tool 4501 is used to port source 4500 for execution in a different environment than that in which it was originally intended to run. In at least one embodiment, translation tool 4501 may include, but is not limited to, a HIP translator that is used to “hipify” CUDA code intended for a CUDA platform into HIP code that can be compiled and executed on a ROCm platform. In at least one embodiment, translation of source code 4500 may include parsing source code 4500 and converting calls to API(s) provided by one programming model (e.g., CUDA) into corresponding calls to API(s) provided by another programming model (e.g., HIP), as discussed in greater detail below in conjunction with FIGS. 46A-47. Returning to the example of hipifying CUDA code, calls to CUDA runtime API, CUDA driver API, and/or CUDA libraries may be converted to corresponding HIP API calls, in at least one embodiment. In at least one embodiment, automated translations performed by translation tool 4501 may sometimes be incomplete, requiring additional, manual effort to fully port source code 4500.

In at least one embodiment, at least one component shown or described with respect to FIG. 45 is utilized to implement techniques and/or functions described in connection with FIGS. 1-18. In at least one embodiment, at least one of host executable code 4504 or device executable code 4505 specified in source code 4500 are used to perform asynchronous memory allocation and/or asynchronous memory deallocation. In at least one embodiment, at least one of host executable code 4504 or device executable code 4505 specified in source code 4500 are used to perform an API to cause one or more memory locations to be asynchronously allocated to one or more processors. In at least one embodiment, at least one of host executable code 4504 or device executable code 4505 specified in source code 4500 are used to perform an API to cause one or more memory locations to be asynchronously allocated to one or more processors. In at least one embodiment, at least one of host executable code 4504 or device executable code 4505 specified in source code 4500 are used to perform an API to cause one or more memory locations to be asynchronously deallocated from one or more processors. In at least one embodiment, at least one of host executable code 4504 or device executable code 4505 specified in source code 4500 are used to perform at least one aspect described with respect to example computer system 100, example computer system 200, example computer system 300, example computer system 400, example process 500, example process 600, example process 700, example process 800, example data flow 900, example first part of a data flow 1000, example second part of a data flow 1100, example third part of a data flow 1200, example process 1300, example computer system 1400, example computer system 1500, example process 1600, example computer system 1700, and/or example process 1800.

### Configuring GPUs for General-Purpose Computing

The following figures set forth, without limitation, exemplary architectures for compiling and executing compute source code, in accordance with at least one embodiment.

FIG. 46A illustrates a system 4600 configured to compile and execute CUDA source code 4610 using different types of processing units, in accordance with at least one embodiment. In at least one embodiment, system 4600 includes, without limitation, CUDA source code 4610, a CUDA compiler 4650, host executable code 4670(1), host executable code 4670(2), CUDA device executable code 4684, a CPU 4690, a CUDA-enabled GPU 4694, a GPU 4692, a CUDA to HIP translation tool 4620, HIP source code 4630, a HIP compiler driver 4640, an HCC 4660, and HCC device executable code 4682.

In at least one embodiment, CUDA source code 4610 is a collection of human-readable code in a CUDA programming language. In at least one embodiment, CUDA code is human-readable code in a CUDA programming language. In at least one embodiment, a CUDA programming language is an extension of the C++ programming language that includes, without limitation, mechanisms to define device code and distinguish between device code and host code. In at least one embodiment, device code is source code that, after compilation, is executable in parallel on a device. In at least one embodiment, a device may be a processor that is optimized for parallel instruction processing, such as CUDA-enabled GPU 4690, GPU 46192, or another GPGPU, etc. In at least one embodiment, host code is source code that, after compilation, is executable on a host. In at least one embodiment, a host is a processor that is optimized for sequential instruction processing, such as CPU 4690.

In at least one embodiment, CUDA source code 4610 includes, without limitation, any number (including zero) of global functions 4612, any number (including zero) of device functions 4614, any number (including zero) of host functions 4616, and any number (including zero) of host/device functions 4618. In at least one embodiment, global functions 4612, device functions 4614, host functions 4616, and host/device functions 4618 may be mixed in CUDA source code 4610. In at least one embodiment, each of global functions 4612 is executable on a device and callable from a host. In at least one embodiment, one or more of global functions 4612 may therefore act as entry points to a device. In at least one embodiment, each of global functions 4612 is a kernel. In at least one embodiment and in a technique known as dynamic parallelism, one or more of global functions 4612 defines a kernel that is executable on a device and callable from such a device. In at least one embodiment, a kernel is executed N (where N is any positive integer) times in parallel by N different threads on a device during execution.

In at least one embodiment, each of device functions 4614 is executed on a device and callable from such a device only. In at least one embodiment, each of host functions 4616 is executed on a host and callable from such a host only. In at least one embodiment, each of host/device functions 4616 defines both a host version of a function that is executable on a host and callable from such a host only and a device version of the function that is executable on a device and callable from such a device only.

In at least one embodiment, CUDA source code 4610 may also include, without limitation, any number of calls to any number of functions that are defined via a CUDA runtime API 4602. In at least one embodiment, CUDA runtime API 4602 may include, without limitation, any number of functions that execute on a host to allocate and deallocate device memory, transfer data between host memory and device memory, manage systems with multiple devices, etc. In at least one embodiment, CUDA source code 4610 may also include any number of calls to any number of functions that are specified in any number of other CUDA APIs. In at least one embodiment, a CUDA API may be any API that is designed for use by CUDA code. In at least one embodiment, CUDA APIs include, without limitation, CUDA runtime API 4602, a CUDA driver API, APIs for any number of CUDA libraries, etc. In at least one embodiment and relative to CUDA runtime API 4602, a CUDA driver API is a lower-level API but provides finer-grained control of a device. In at least one embodiment, examples of CUDA libraries include, without limitation, cuBLAS, cuFFT, cuRAND, cuDNN, etc.

In at least one embodiment, CUDA compiler 4650 compiles input CUDA code (e.g., CUDA source code 4610) to generate host executable code 4670(1) and CUDA device executable code 4684. In at least one embodiment, CUDA compiler 4650 is NVCC. In at least one embodiment, host executable code 4670(1) is a compiled version of host code included in input source code that is executable on CPU 4690. In at least one embodiment, CPU 4690 may be any processor that is optimized for sequential instruction processing.

In at least one embodiment, CUDA device executable code 4684 is a compiled version of device code included in input source code that is executable on CUDA-enabled GPU 4694. In at least one embodiment, CUDA device executable code 4684 includes, without limitation, binary code. In at least one embodiment, CUDA device executable code 4684 includes, without limitation, IR code, such as PTX code, that is further compiled at runtime into binary code for a specific target device (e.g., CUDA-enabled GPU 4694) by a device driver. In at least one embodiment, CUDA-enabled GPU 4694 may be any processor that is optimized for parallel instruction processing and that supports CUDA. In at least one embodiment, CUDA-enabled GPU 4694 is developed by NVIDIA Corporation of Santa Clara, CA.

In at least one embodiment, CUDA to HIP translation tool 4620 is configured to translate CUDA source code 4610 to functionally similar HIP source code 4630. In a least one embodiment, HIP source code 4630 is a collection of human-readable code in a HIP programming language. In at least one embodiment, HIP code is human-readable code in a HIP programming language. In at least one embodiment, a HIP programming language is an extension of the C++ programming language that includes, without limitation, functionally similar versions of CUDA mechanisms to define device code and distinguish between device code and host code. In at least one embodiment, a HIP programming language may include a subset of functionality of a CUDA programming language. In at least one embodiment, for example, a HIP programming language includes, without limitation, mechanism(s) to define global functions 4612, but such a HIP programming language may lack support for dynamic parallelism and therefore global functions 4612 defined in HIP code may be callable from a host only.

In at least one embodiment, HIP source code 4630 includes, without limitation, any number (including zero) of global functions 4612, any number (including zero) of device functions 4614, any number (including zero) of host functions 4616, and any number (including zero) of host/device functions 4618. In at least one embodiment, HIP source code 4630 may also include any number of calls to any number of functions that are specified in a HIP runtime API 4632. In at least one embodiment, HIP runtime API 4632 includes, without limitation, functionally similar versions of a subset of functions included in CUDA runtime API 4602. In at least one embodiment, HIP source code 4630 may also include any number of calls to any number of functions that are specified in any number of other HIP APIs. In at least one embodiment, a HIP API may be any API that is designed for use by HIP code and/or ROCm. In at least one embodiment, HIP APIs include, without limitation, HIP runtime API 4632, a HIP driver API, APIs for any number of HIP libraries, APIs for any number of ROCm libraries, etc.

In at least one embodiment, CUDA to HIP translation tool 4620 converts each kernel call in CUDA code from a CUDA syntax to a HIP syntax and converts any number of other CUDA calls in CUDA code to any number of other functionally similar HIP calls. In at least one embodiment, a CUDA call is a call to a function specified in a CUDA API, and a HIP call is a call to a function specified in a HIP API. In at least one embodiment, CUDA to HIP translation tool 4620 converts any number of calls to functions specified in CUDA runtime API 4602 to any number of calls to functions specified in HIP runtime API 4632.

In at least one embodiment, CUDA to HIP translation tool 4620 is a tool known as hipify-perl that executes a text-based translation process. In at least one embodiment, CUDA to HIP translation tool 4620 is a tool known as hipify-clang that, relative to hipify-perl, executes a more complex and more robust translation process that involves parsing CUDA code using clang (a compiler front-end) and then translating resulting symbols. In at least one embodiment, properly converting CUDA code to HIP code may require modifications (e.g., manual edits) in addition to those performed by CUDA to HIP translation tool 4620.

In at least one embodiment, HIP compiler driver 4640 is a front end that determines a target device 4646 and then configures a compiler that is compatible with target device 4646 to compile HIP source code 4630. In at least one embodiment, target device 4646 is a processor that is optimized for parallel instruction processing. In at least one embodiment, HIP compiler driver 4640 may determine target device 4646 in any technically feasible fashion.

In at least one embodiment, if target device 4646 is compatible with CUDA (e.g., CUDA-enabled GPU 4694), then HIP compiler driver 4640 generates a HIP/NVCC compilation command 4642. In at least one embodiment and as described in greater detail in conjunction with FIG. 46B, HIP/NVCC compilation command 4642 configures CUDA compiler 4650 to compile HIP source code 4630 using, without limitation, a HIP to CUDA translation header and a CUDA runtime library. In at least one embodiment and in response to HIP/NVCC compilation command 4642, CUDA compiler 4650 generates host executable code 4670(1) and CUDA device executable code 4684.

In at least one embodiment, if target device 4646 is not compatible with CUDA, then HIP compiler driver 4640 generates a HIP/HCC compilation command 4644. In at least one embodiment and as described in greater detail in conjunction with FIG. 46C, HIP/HCC compilation command 4644 configures HCC 4660 to compile HIP source code 4630 using, without limitation, an HCC header and a HIP/HCC runtime library. In at least one embodiment and in response to HIP/HCC compilation command 4644, HCC 4660 generates host executable code 4670(2) and HCC device executable code 4682. In at least one embodiment, HCC device executable code 4682 is a compiled version of device code included in HIP source code 4630 that is executable on GPU 4692. In at least one embodiment, GPU 4692 may be any processor that is optimized for parallel instruction processing, is not compatible with CUDA, and is compatible with HCC. In at least one embodiment, GPU 4692 is developed by AMD Corporation of Santa Clara, CA. In at least one embodiment GPU, 4692 is a non-CUDA-enabled GPU 4692.

For explanatory purposes only, three different flows that may be implemented in at least one embodiment to compile CUDA source code 4610 for execution on CPU 4690 and different devices are depicted in FIG. 46A. In at least one embodiment, a direct CUDA flow compiles CUDA source code 4610 for execution on CPU 4690 and CUDA-enabled GPU 4694 without translating CUDA source code 4610 to HIP source code 4630. In at least one embodiment, an indirect CUDA flow translates CUDA source code 4610 to HIP source code 4630 and then compiles HIP source code 4630 for execution on CPU 4690 and CUDA-enabled GPU 4694. In at least one embodiment, a CUDA/HCC flow translates CUDA source code 4610 to HIP source code 4630 and then compiles HIP source code 4630 for execution on CPU 4690 and GPU 4692.

A direct CUDA flow that may be implemented in at least one embodiment is depicted via dashed lines and a series of bubbles annotated A1-A3. In at least one embodiment and as depicted with bubble annotated A1, CUDA compiler 4650 receives CUDA source code 4610 and a CUDA compile command 4648 that configures CUDA compiler 4650 to compile CUDA source code 4610. In at least one embodiment, CUDA source code 4610 used in a direct CUDA flow is written in a CUDA programming language that is based on a programming language other than C++ (e.g., C, Fortran, Python, Java, etc.). In at least one embodiment and in response to CUDA compile command 4648, CUDA compiler 4650 generates host executable code 4670(1) and CUDA device executable code 4684 (depicted with bubble annotated A2). In at least one embodiment and as depicted with bubble annotated A3, host executable code 4670(1) and CUDA device executable code 4684 may be executed on, respectively, CPU 4690 and CUDA-enabled GPU 4694. In at least one embodiment, CUDA device executable code 4684 includes, without limitation, binary code. In at least one embodiment, CUDA device executable code 4684 includes, without limitation, PTX code and is further compiled into binary code for a specific target device at runtime.

An indirect CUDA flow that may be implemented in at least one embodiment is depicted via dotted lines and a series of bubbles annotated B1-B6. In at least one embodiment and as depicted with bubble annotated B1, CUDA to HIP translation tool 4620 receives CUDA source code 4610. In at least one embodiment and as depicted with bubble annotated B2, CUDA to HIP translation tool 4620 translates CUDA source code 4610 to HIP source code 4630. In at least one embodiment and as depicted with bubble annotated B3, HIP compiler driver 4640 receives HIP source code 4630 and determines that target device 4646 is CUDA-enabled.

In at least one embodiment and as depicted with bubble annotated B4, HIP compiler driver 4640 generates HIP/NVCC compilation command 4642 and transmits both HIP/NVCC compilation command 4642 and HIP source code 4630 to CUDA compiler 4650. In at least one embodiment and as described in greater detail in conjunction with FIG. 46B, HIP/NVCC compilation command 4642 configures CUDA compiler 4650 to compile HIP source code 4630 using, without limitation, a HIP to CUDA translation header and a CUDA runtime library. In at least one embodiment and in response to HIP/NVCC compilation command 4642, CUDA compiler 4650 generates host executable code 4670(1) and CUDA device executable code 4684 (depicted with bubble annotated B5). In at least one embodiment and as depicted with bubble annotated B6, host executable code 4670(1) and CUDA device executable code 4684 may be executed on, respectively, CPU 4690 and CUDA-enabled GPU 4694. In at least one embodiment, CUDA device executable code 4684 includes, without limitation, binary code. In at least one embodiment, CUDA device executable code 4684 includes, without limitation, PTX code and is further compiled into binary code for a specific target device at runtime.

A CUDA/HCC flow that may be implemented in at least one embodiment is depicted via solid lines and a series of bubbles annotated C1-C6. In at least one embodiment and as depicted with bubble annotated C1, CUDA to HIP translation tool 4620 receives CUDA source code 4610. In at least one embodiment and as depicted with bubble annotated C2, CUDA to HIP translation tool 4620 translates CUDA source code 4610 to HIP source code 4630. In at least one embodiment and as depicted with bubble annotated C3, HIP compiler driver 4640 receives HIP source code 4630 and determines that target device 4646 is not CUDA-enabled.

In at least one embodiment, HIP compiler driver 4640 generates HIP/HCC compilation command 4644 and transmits both HIP/HCC compilation command 4644 and HIP source code 4630 to HCC 4660 (depicted with bubble annotated C4). In at least one embodiment and as described in greater detail in conjunction with FIG. 46C, HIP/HCC compilation command 4644 configures HCC 4660 to compile HIP source code 4630 using, without limitation, an HCC header and a HIP/HCC runtime library. In at least one embodiment and in response to HIP/HCC compilation command 4644, HCC 4660 generates host executable code 4670(2) and HCC device executable code 4682 (depicted with bubble annotated C5). In at least one embodiment and as depicted with bubble annotated C6, host executable code 4670(2) and HCC device executable code 4682 may be executed on, respectively, CPU 4690 and GPU 4692.

In at least one embodiment, after CUDA source code 4610 is translated to HIP source code 4630, HIP compiler driver 4640 may subsequently be used to generate executable code for either CUDA-enabled GPU 4694 or GPU 4692 without re-executing CUDA to HIP translation tool 4620. In at least one embodiment, CUDA to HIP translation tool 4620 translates CUDA source code 4610 to HIP source code 4630 that is then stored in memory. In at least one embodiment, HIP compiler driver 4640 then configures HCC 4660 to generate host executable code 4670(2) and HCC device executable code 4682 based on HIP source code 4630. In at least one embodiment, HIP compiler driver 4640 subsequently configures CUDA compiler 4650 to generate host executable code 4670(1) and CUDA device executable code 4684 based on stored HIP source code 4630.

FIG. 46B illustrates a system 4604 configured to compile and execute CUDA source code 4610 of FIG. 46A using CPU 4690 and CUDA-enabled GPU 4694, in accordance with at least one embodiment. In at least one embodiment, system 4604 includes, without limitation, CUDA source code 4610, CUDA to HIP translation tool 4620, HIP source code 4630, HIP compiler driver 4640, CUDA compiler 4650, host executable code 4670(1), CUDA device executable code 4684, CPU 4690, and CUDA-enabled GPU 4694.

In at least one embodiment and as described previously herein in conjunction with FIG. 46A, CUDA source code 4610 includes, without limitation, any number (including zero) of global functions 4612, any number (including zero) of device functions 4614, any number (including zero) of host functions 4616, and any number (including zero) of host/device functions 4618. In at least one embodiment, CUDA source code 4610 also includes, without limitation, any number of calls to any number of functions that are specified in any number of CUDA APIs.

In at least one embodiment, CUDA to HIP translation tool 4620 translates CUDA source code 4610 to HIP source code 4630. In at least one embodiment, CUDA to HIP translation tool 4620 converts each kernel call in CUDA source code 4610 from a CUDA syntax to a HIP syntax and converts any number of other CUDA calls in CUDA source code 4610 to any number of other functionally similar HIP calls.

In at least one embodiment, HIP compiler driver 4640 determines that target device 4646 is CUDA-enabled and generates HIP/NVCC compilation command 4642. In at least one embodiment, HIP compiler driver 4640 then configures CUDA compiler 4650 via HIP/NVCC compilation command 4642 to compile HIP source code 4630. In at least one embodiment, HIP compiler driver 4640 provides access to a HIP to CUDA translation header 4652 as part of configuring CUDA compiler 4650. In at least one embodiment, HIP to CUDA translation header 4652 translates any number of mechanisms (e.g., functions) specified in any number of HIP APIs to any number of mechanisms specified in any number of CUDA APIs. In at least one embodiment, CUDA compiler 4650 uses HIP to CUDA translation header 4652 in conjunction with a CUDA runtime library 4654 corresponding to CUDA runtime API 4602 to generate host executable code 4670(1) and CUDA device executable code 4684. In at least one embodiment, host executable code 4670(1) and CUDA device executable code 4684 may then be executed on, respectively, CPU 4690 and CUDA-enabled GPU 4694. In at least one embodiment, CUDA device executable code 4684 includes, without limitation, binary code. In at least one embodiment, CUDA device executable code 4684 includes, without limitation, PTX code and is further compiled into binary code for a specific target device at runtime.

FIG. 46C illustrates a system 4606 configured to compile and execute CUDA source code 4610 of FIG. 46A using CPU 4690 and non-CUDA-enabled GPU 4692, in accordance with at least one embodiment. In at least one embodiment, system 4606 includes, without limitation, CUDA source code 4610, CUDA to HIP translation tool 4620, HIP source code 4630, HIP compiler driver 4640, HCC 4660, host executable code 4670(2), HCC device executable code 4682, CPU 4690, and GPU 4692.

In at least one embodiment and as described previously herein in conjunction with FIG. 46A, CUDA source code 4610 includes, without limitation, any number (including zero) of global functions 4612, any number (including zero) of device functions 4614, any number (including zero) of host functions 4616, and any number (including zero) of host/device functions 4618. In at least one embodiment, CUDA source code 4610 also includes, without limitation, any number of calls to any number of functions that are specified in any number of CUDA APIs.

In at least one embodiment, CUDA to HIP translation tool 4620 translates CUDA source code 4610 to HIP source code 4630. In at least one embodiment, CUDA to HIP translation tool 4620 converts each kernel call in CUDA source code 4610 from a CUDA syntax to a HIP syntax and converts any number of other CUDA calls in source code 4610 to any number of other functionally similar HIP calls.

In at least one embodiment, HIP compiler driver 4640 subsequently determines that target device 4646 is not CUDA-enabled and generates HIP/HCC compilation command 4644. In at least one embodiment, HIP compiler driver 4640 then configures HCC 4660 to execute HIP/HCC compilation command 4644 to compile HIP source code 4630. In at least one embodiment, HIP/HCC compilation command 4644 configures HCC 4660 to use, without limitation, a HIP/HCC runtime library 4658 and an HCC header 4656 to generate host executable code 4670(2) and HCC device executable code 4682. In at least one embodiment, HIP/HCC runtime library 4658 corresponds to HIP runtime API 4632. In at least one embodiment, HCC header 4656 includes, without limitation, any number and type of interoperability mechanisms for HIP and HCC. In at least one embodiment, host executable code 4670(2) and HCC device executable code 4682 may be executed on, respectively, CPU 4690 and GPU 4692.

In at least one embodiment, at least one component shown or described with respect to FIGS. 46A-46C is utilized to implement techniques and/or functions described in connection with FIGS. 1-18. In at least one embodiment, at least one element of system 4600, system 4604, or system 4606 is used to perform asynchronous memory allocation and/or asynchronous memory deallocation. In at least one embodiment, at least one element of system 4600, system 4604, or system 4606 is used to perform an API to cause one or more memory locations to be asynchronously allocated to one or more processors. In at least one embodiment, at least one element of system 4600, system 4604, or system 4606 is used to perform an API to cause one or more memory locations to be asynchronously allocated to one or more processors. In at least one embodiment, at least one element of system 4600, system 4604, or system 4606 is used to perform an API to cause one or more memory locations to be asynchronously deallocated from one or more processors. In at least one embodiment, at least one element of system 4600, system 4604, or system 4606 is used to perform at least one aspect described with respect to example computer system 100, example computer system 200, example computer system 300, example computer system 400, example process 500, example process 600, example process 700, example process 800, example data flow 900, example first part of a data flow 1000, example second part of a data flow 1100, example third part of a data flow 1200, example process 1300, example computer system 1400, example computer system 1500, example process 1600, example computer system 1700, and/or example process 1800.

FIG. 47 illustrates an exemplary kernel translated by CUDA-to-HIP translation tool 4620 of FIG. 46C, in accordance with at least one embodiment. In at least one embodiment, CUDA source code 4610 partitions an overall problem that a given kernel is designed to solve into relatively coarse sub-problems that can independently be solved using thread blocks. In at least one embodiment, each thread block includes, without limitation, any number of threads. In at least one embodiment, each sub-problem is partitioned into relatively fine pieces that can be solved cooperatively in parallel by threads within a thread block. In at least one embodiment, threads within a thread block can cooperate by sharing data through shared memory and by synchronizing execution to coordinate memory accesses.

In at least one embodiment, CUDA source code 4610 organizes thread blocks associated with a given kernel into a one-dimensional, a two-dimensional, or a three-dimensional grid of thread blocks. In at least one embodiment, each thread block includes, without limitation, any number of threads, and a grid includes, without limitation, any number of thread blocks.

In at least one embodiment, a kernel is a function in device code that is defined using a “_global_” declaration specifier. In at least one embodiment, the dimension of a grid that executes a kernel for a given kernel call and associated streams are specified using a CUDA kernel launch syntax 4710. In at least one embodiment, CUDA kernel launch syntax 4710 is specified as “KernelName<<<GridSize, BlockSize, SharedMemorySize, Stream>>>(KernelArguments);.” In at least one embodiment, an execution configuration syntax is a “<<< . . . >>>” construct that is inserted between a kernel name (“KernelName”) and a parenthesized list of kernel arguments (“KernelArguments”). In at least one embodiment, CUDA kernel launch syntax 4710 includes, without limitation, a CUDA launch function syntax instead of an execution configuration syntax.

In at least one embodiment, “GridSize” is of a type dim3 and specifies the dimension and size of a grid. In at least one embodiment, type dim3 is a CUDA-defined structure that includes, without limitation, unsigned integers x, y, and z. In at least one embodiment, if z is not specified, then z defaults to one. In at least one embodiment, if y is not specified, then y defaults to one. In at least one embodiment, the number of thread blocks in a grid is equal to the product of GridSize.x, GridSize.y, and GridSize.z. In at least one embodiment, “BlockSize” is of type dim3 and specifies the dimension and size of each thread block. In at least one embodiment, the number of threads per thread block is equal to the product of BlockSize.x, BlockSize.y, and BlockSize.z. In at least one embodiment, each thread that executes a kernel is given a unique thread ID that is accessible within the kernel through a built-in variable (e.g., “threadldx”).

In at least one embodiment and with respect to CUDA kernel launch syntax 4710, “SharedMemorySize” is an optional argument that specifies a number of bytes in a shared memory that is dynamically allocated per thread block for a given kernel call in addition to statically allocated memory. In at least one embodiment and with respect to CUDA kernel launch syntax 4710, SharedMemorySize defaults to zero. In at least one embodiment and with respect to CUDA kernel launch syntax 4710, “Stream” is an optional argument that specifies an associated stream and defaults to zero to specify a default stream. In at least one embodiment, a stream is a sequence of commands (possibly issued by different host threads) that execute in order. In at least one embodiment, different streams may execute commands out of order with respect to one another or concurrently.

In at least one embodiment, CUDA source code 4610 includes, without limitation, a kernel definition for an exemplary kernel “MatAdd” and a main function. In at least one embodiment, main function is host code that executes on a host and includes, without limitation, a kernel call that causes kernel MatAdd to execute on a device. In at least one embodiment and as shown, kernel MatAdd adds two matrices A and B of size N×N, where N is a positive integer, and stores the result in a matrix C. In at least one embodiment, main function defines a threadsPerBlock variable as 16 by 16 and a numBlocks variable as N/16 by N/16. In at least one embodiment, main function then specifies kernel call “MatAdd<<<<<numBlocks, threadsPerBlock>>>(A, B, C);.” In at least one embodiment and as per CUDA kernel launch syntax 4710, kernel MatAdd is executed using a grid of thread blocks having a dimension N/16 by N/16, where each thread block has a dimension of 16 by 16. In at least one embodiment, each thread block includes 256 threads, a grid is created with enough blocks to have one thread per matrix element, and each thread in such a grid executes kernel MatAdd to perform one pair-wise addition.

In at least one embodiment, while translating CUDA source code 4610 to HIP source code 4630, CUDA to HIP translation tool 4620 translates each kernel call in CUDA source code 4610 from CUDA kernel launch syntax 4710 to a HIP kernel launch syntax 4720 and converts any number of other CUDA calls in source code 4610 to any number of other functionally similar HIP calls. In at least one embodiment, HIP kernel launch syntax 4720 is specified as “hipLaunchKernelGGL(KernelName, GridSize, BlockSize, SharedMemorySize, Stream, KernelArguments);.” In at least one embodiment, each of KernelName, GridSize, BlockSize, ShareMemorySize, Stream, and KernelArguments has the same meaning in HIP kernel launch syntax 4720 as in CUDA kernel launch syntax 4710 (described previously herein). In at least one embodiment, arguments SharedMemorySize and Stream are required in HIP kernel launch syntax 4720 and are optional in CUDA kernel launch syntax 4710.

In at least one embodiment, a portion of HIP source code 4630 depicted in FIG. 47 is identical to a portion of CUDA source code 4610 depicted in FIG. 47 except for a kernel call that causes kernel MatAdd to execute on a device. In at least one embodiment, kernel MatAdd is defined in HIP source code 4630 with the same “_global_” declaration specifier with which kernel MatAdd is defined in CUDA source code 4610. In at least one embodiment, a kernel call in HIP source code 4630 is “hipLaunchKernelGGL(MatAdd, numBlocks, threadsPerBlock, 0, 0, A, B, C);,” while a corresponding kernel call in CUDA source code 4610 is “MatAdd<<<numBlocks, threadsPerBlock>>>(A, B, C);.”

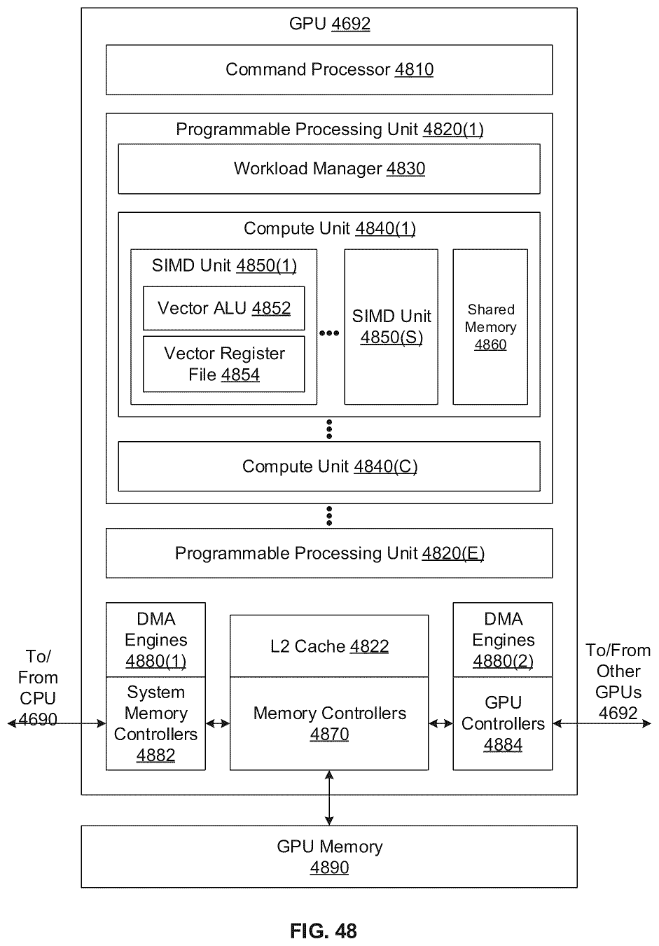

FIG. 48 illustrates non-CUDA-enabled GPU 4692 of FIG. 46C in greater detail, in accordance with at least one embodiment. In at least one embodiment, GPU 4692 is developed by AMD corporation of Santa Clara. In at least one embodiment, GPU 4692 can be configured to perform compute operations in a highly-parallel fashion. In at least one embodiment, GPU 4692 is configured to execute graphics pipeline operations such as draw commands, pixel operations, geometric computations, and other operations associated with rendering an image to a display. In at least one embodiment, GPU 4692 is configured to execute operations unrelated to graphics. In at least one embodiment, GPU 4692 is configured to execute both operations related to graphics and operations unrelated to graphics. In at least one embodiment, GPU 4692 can be configured to execute device code included in HIP source code 4630.

In at least one embodiment, GPU 4692 includes, without limitation, any number of programmable processing units 4820, a command processor 4810, an L2 cache 4822, memory controllers 4870, DMA engines 4880(1), system memory controllers 4882, DMA engines 4880(2), and GPU controllers 4884. In at least one embodiment, each programmable processing unit 4820 includes, without limitation, a workload manager 4830 and any number of compute units 4840. In at least one embodiment, command processor 4810 reads commands from one or more command queues (not shown) and distributes commands to workload managers 4830. In at least one embodiment, for each programmable processing unit 4820, associated workload manager 4830 distributes work to compute units 4840 included in programmable processing unit 4820. In at least one embodiment, each compute unit 4840 may execute any number of thread blocks, but each thread block executes on a single compute unit 4840. In at least one embodiment, a workgroup is a thread block.

In at least one embodiment, each compute unit 4840 includes, without limitation, any number of SIMD units 4850 and a shared memory 4860. In at least one embodiment, each SIMD unit 4850 implements a SIMD architecture and is configured to perform operations in parallel. In at least one embodiment, each SIMD unit 4850 includes, without limitation, a vector ALU 4852 and a vector register file 4854. In at least one embodiment, each SIMD unit 4850 executes a different warp. In at least one embodiment, a warp is a group of threads (e.g., 16 threads), where each thread in the warp belongs to a single thread block and is configured to process a different set of data based on a single set of instructions. In at least one embodiment, predication can be used to disable one or more threads in a warp. In at least one embodiment, a lane is a thread. In at least one embodiment, a work item is a thread. In at least one embodiment, a wavefront is a warp. In at least one embodiment, different wavefronts in a thread block may synchronize together and communicate via shared memory 4860.

In at least one embodiment, programmable processing units 4820 are referred to as “shader engines.” In at least one embodiment, each programmable processing unit 4820 includes, without limitation, any amount of dedicated graphics hardware in addition to compute units 4840. In at least one embodiment, each programmable processing unit 4820 includes, without limitation, any number (including zero) of geometry processors, any number (including zero) of rasterizers, any number (including zero) of render back ends, workload manager 4830, and any number of compute units 4840.

In at least one embodiment, compute units 4840 share L2 cache 4822. In at least one embodiment, L2 cache 4822 is partitioned. In at least one embodiment, a GPU memory 4890 is accessible by all compute units 4840 in GPU 4692. In at least one embodiment, memory controllers 4870 and system memory controllers 4882 facilitate data transfers between GPU 4692 and a host, and DMA engines 4880(1) enable asynchronous memory transfers between GPU 4692 and such a host. In at least one embodiment, memory controllers 4870 and GPU controllers 4884 facilitate data transfers between GPU 4692 and other GPUs 4692, and DMA engines 4880(2) enable asynchronous memory transfers between GPU 4692 and other GPUs 4692.

In at least one embodiment, GPU 4692 includes, without limitation, any amount and type of system interconnect that facilitates data and control transmissions across any number and type of directly or indirectly linked components that may be internal or external to GPU 4692. In at least one embodiment, GPU 4692 includes, without limitation, any number and type of I/O interfaces (e.g., PCIe) that are coupled to any number and type of peripheral devices. In at least one embodiment, GPU 4692 may include, without limitation, any number (including zero) of display engines and any number (including zero) of multimedia engines. In at least one embodiment, GPU 4692 implements a memory subsystem that includes, without limitation, any amount and type of memory controllers (e.g., memory controllers 4870 and system memory controllers 4882) and memory devices (e.g., shared memories 4860) that may be dedicated to one component or shared among multiple components. In at least one embodiment, GPU 4692 implements a cache subsystem that includes, without limitation, one or more cache memories (e.g., L2 cache 4822) that may each be private to or shared between any number of components (e.g., SIMD units 4850, compute units 4840, and programmable processing units 4820).

In at least one embodiment, at least one component shown or described with respect to FIG. 48 is utilized to implement techniques and/or functions described in connection with FIGS. 1-18. In at least one embodiment, at least one of GPU 4692 or programmable processing units 4820 are used to perform asynchronous memory allocation and/or asynchronous memory deallocation. In at least one embodiment, at least one of GPU 4692 or programmable processing units 4820 are used to perform an API to cause one or more memory locations to be asynchronously allocated to one or more processors. In at least one embodiment, at least one of GPU 4692 or programmable processing units 4820 are used to perform an API to cause one or more memory locations to be asynchronously allocated to one or more processors. In at least one embodiment, at least one of GPU 4692 or programmable processing units 4820 are used to perform an API to cause one or more memory locations to be asynchronously deallocated from one or more processors. In at least one embodiment, at least one of GPU 4692 or programmable processing units 4820 are used to perform at least one aspect described with respect to example computer system 100, example computer system 200, example computer system 300, example computer system 400, example process 500, example process 600, example process 700, example process 800, example data flow 900, example first part of a data flow 1000, example second part of a data flow 1100, example third part of a data flow 1200, example process 1300, example computer system 1400, example computer system 1500, example process 1600, example computer system 1700, and/or example process 1800.

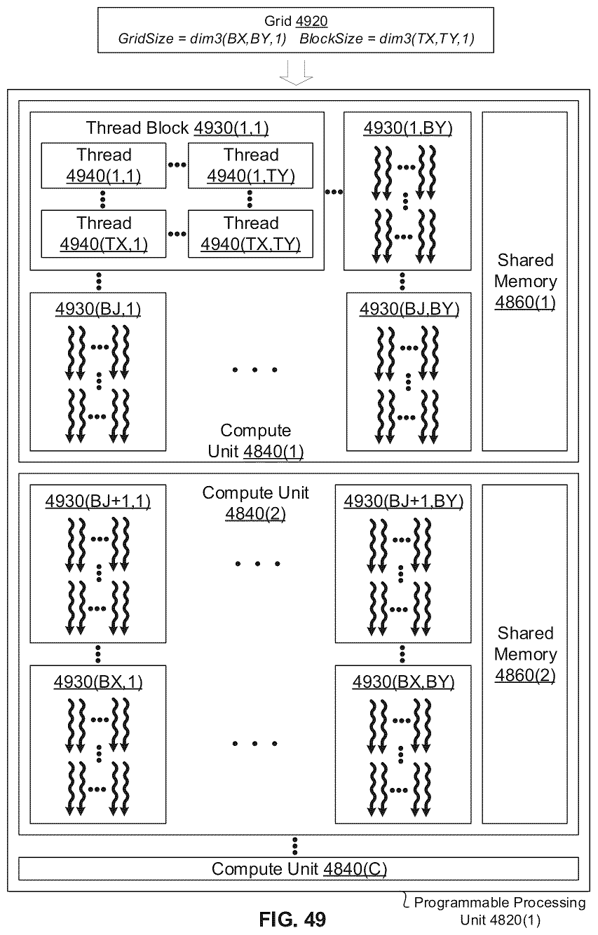

FIG. 49 illustrates how threads of an exemplary CUDA grid 4920 are mapped to different compute units 4840 of FIG. 48, in accordance with at least one embodiment. In at least one embodiment and for explanatory purposes only, grid 4920 has a GridSize of BX by BY by 1 and a BlockSize of TX by TY by 1. In at least one embodiment, grid 4920 therefore includes, without limitation, (BX*BY) thread blocks 4930 and each thread block 4930 includes, without limitation, (TX*TY) threads 4940. Threads 4940 are depicted in FIG. 49 as squiggly arrows.

In at least one embodiment, grid 4920 is mapped to programmable processing unit 4820(1) that includes, without limitation, compute units 4840(1)-4840(C). In at least one embodiment and as shown, (BJ*BY) thread blocks 4930 are mapped to compute unit 4840(1), and the remaining thread blocks 4930 are mapped to compute unit 4840(2). In at least one embodiment, each thread block 4930 may include, without limitation, any number of warps, and each warp is mapped to a different SIMD unit 4850 of FIG. 48.

In at least one embodiment, warps in a given thread block 4930 may synchronize together and communicate through shared memory 4860 included in associated compute unit 4840. For example and in at least one embodiment, warps in thread block 4930(BJ,1) can synchronize together and communicate through shared memory 4860(1). For example and in at least one embodiment, warps in thread block 4930(BJ+1,1) can synchronize together and communicate through shared memory 4860(2).

In at least one embodiment, at least one component shown or described with respect to FIG. 49 is utilized to implement techniques and/or functions described in connection with FIGS. 1-18. In at least one embodiment, at least one thread of exemplary CUDA grid 4920 is used to perform asynchronous memory allocation and/or asynchronous memory deallocation. In at least one embodiment, at least one thread of exemplary CUDA grid 4920 is used to perform an API to cause one or more memory locations to be asynchronously allocated to one or more processors. In at least one embodiment, at least one thread of exemplary CUDA grid 4920 is used to perform an API to cause one or more memory locations to be asynchronously allocated to one or more processors. In at least one embodiment, at least one thread of exemplary CUDA grid 4920 is used to perform an API to cause one or more memory locations to be asynchronously deallocated from one or more processors. In at least one embodiment, at least one thread of exemplary CUDA grid 4920 is used to perform at least one aspect described with respect to example computer system 100, example computer system 200, example computer system 300, example computer system 400, example process 500, example process 600, example process 700, example process 800, example data flow 900, example first part of a data flow 1000, example second part of a data flow 1100, example third part of a data flow 1200, example process 1300, example computer system 1400, example computer system 1500, example process 1600, example computer system 1700, and/or example process 1800.

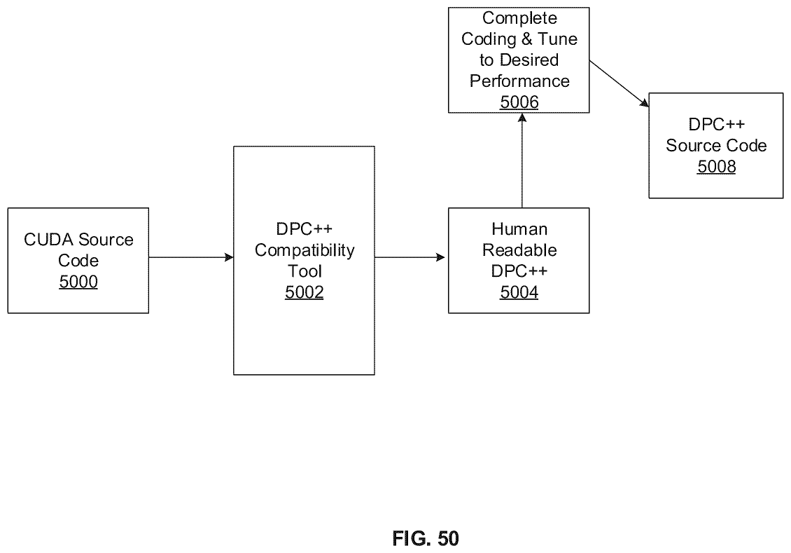

FIG. 50 illustrates how to migrate existing CUDA code to Data Parallel C++ code, in accordance with at least one embodiment. Data Parallel C++ (DPC++) may refer to an open, standards-based alternative to single-architecture proprietary languages that allows developers to reuse code across hardware targets (CPUs and accelerators such as GPUs and FPGAs) and also perform custom tuning for a specific accelerator. DPC++ use similar and/or identical C and C++ constructs in accordance with ISO C++ which developers may be familiar with. DPC++ incorporates standard SYCL from The Khronos Group to support data parallelism and heterogeneous programming. SYCL refers to a cross-platform abstraction layer that builds on underlying concepts, portability and efficiency of OpenCL that enables code for heterogeneous processors to be written in a “single-source” style using standard C++. SYCL may enable single source development where C++ template functions can contain both host and device code to construct complex algorithms that use OpenCL acceleration, and then re-use them throughout their source code on different types of data.

In at least one embodiment, a DPC++ compiler is used to compile DPC++ source code which can be deployed across diverse hardware targets. In at least one embodiment, a DPC++ compiler is used to generate DPC++ applications that can be deployed across diverse hardware targets and a DPC++ compatibility tool can be used to migrate CUDA applications to a multiplatform program in DPC++. In at least one embodiment, a DPC++ base tool kit includes a DPC++ compiler to deploy applications across diverse hardware targets; a DPC++ library to increase productivity and performance across CPUs, GPUs, and FPGAs; a DPC++ compatibility tool to migrate CUDA applications to multi-platform applications; and any suitable combination thereof.

In at least one embodiment, a DPC++ programming model is utilized to simply one or more aspects relating to programming CPUs and accelerators by using modern C++ features to express parallelism with a programming language called Data Parallel C++. DPC++ programming language may be utilized to code reuse for hosts (e.g., a CPU) and accelerators (e.g., a GPU or FPGA) using a single source language, with execution and memory dependencies being clearly communicated. Mappings within DPC++ code can be used to transition an application to run on a hardware or set of hardware devices that best accelerates a workload. A host may be available to simplify development and debugging of device code, even on platforms that do not have an accelerator available.

In at least one embodiment, CUDA source code 5000 is provided as an input to a DPC++ compatibility tool 5002 to generate human readable DPC++ 5004. In at least one embodiment, human readable DPC++ 5004 includes inline comments generated by DPC++ compatibility tool 5002 that guides a developer on how and/or where to modify DPC++ code to complete coding and tuning to desired performance 5006, thereby generating DPC++ source code 5008.

In at least one embodiment, CUDA source code 5000 is or includes a collection of human-readable source code in a CUDA programming language. In at least one embodiment, CUDA source code 5000 is human-readable source code in a CUDA programming language. In at least one embodiment, a CUDA programming language is an extension of the C++ programming language that includes, without limitation, mechanisms to define device code and distinguish between device code and host code. In at least one embodiment, device code is source code that, after compilation, is executable on a device (e.g., GPU or FPGA) and may include or more parallelizable workflows that can be executed on one or more processor cores of a device. In at least one embodiment, a device may be a processor that is optimized for parallel instruction processing, such as CUDA-enabled GPU, GPU, or another GPGPU, etc. In at least one embodiment, host code is source code that, after compilation, is executable on a host. In least one embodiment, some or all of host code and device code can be executed in parallel across a CPU and GPU/FPGA. In at least one embodiment, a host is a processor that is optimized for sequential instruction processing, such as CPU. CUDA source code 5000 described in connection with FIG. 50 may be in accordance with those discussed elsewhere in this document.

In at least one embodiment, DPC++ compatibility tool 5002 refers to an executable tool, program, application, or any other suitable type of tool that is used to facilitate migration of CUDA source code 5000 to DPC++ source code 5008. In at least one embodiment, DPC++ compatibility tool 5002 is a command-line-based code migration tool available as part of a DPC++ tool kit that is used to port existing CUDA sources to DPC++. In at least one embodiment, DPC++ compatibility tool 5002 converts some or all source code of a CUDA application from CUDA to DPC++ and generates a resulting file that is written at least partially in DPC++, referred to as human readable DPC++ 5004. In at least one embodiment, human readable DPC++ 5004 includes comments that are generated by DPC++ compatibility tool 5002 to indicate where user intervention may be necessary. In at least one embodiment, user intervention is necessary when CUDA source code 5000 calls a CUDA API that has no analogous DPC++ API; other examples where user intervention is required are discussed later in greater detail.

In at least one embodiment, a workflow for migrating CUDA source code 5000 (e.g., application or portion thereof) includes creating one or more compilation database files; migrating CUDA to DPC++ using a DPC++ compatibility tool 5002; completing migration and verifying correctness, thereby generating DPC++ source code 5008; and compiling DPC++ source code 5008 with a DPC++ compiler to generate a DPC++ application. In at least one embodiment, a compatibility tool provides a utility that intercepts commands used when Makefile executes and stores them in a compilation database file. In at least one embodiment, a file is stored in JSON format. In at least one embodiment, an intercept-built command converts Makefile command to a DPC compatibility command.

In at least one embodiment, intercept-build is a utility script that intercepts a build process to capture compilation options, macro defs, and include paths, and writes this data to a compilation database file. In at least one embodiment, a compilation database file is a JSON file. In at least one embodiment, DPC++ compatibility tool 5002 parses a compilation database and applies options when migrating input sources. In at least one embodiment, use of intercept-build is optional, but highly recommended for Make or CMake based environments. In at least one embodiment, a migration database includes commands, directories, and files: command may include necessary compilation flags; directory may include paths to header files; file may include paths to CUDA files.

In at least one embodiment, DPC++ compatibility tool 5002 migrates CUDA code (e.g., applications) written in CUDA to DPC++ by generating DPC++ wherever possible. In at least one embodiment, DPC++ compatibility tool 5002 is available as part of a tool kit. In at least one embodiment, a DPC++ tool kit includes an intercept-build tool. In at least one embodiment, an intercept-built tool creates a compilation database that captures compilation commands to migrate CUDA files. In at least one embodiment, a compilation database generated by an intercept-built tool is used by DPC++ compatibility tool 5002 to migrate CUDA code to DPC++. In at least one embodiment, non-CUDA C++ code and files are migrated as is. In at least one embodiment, DPC++ compatibility tool 5002 generates human readable DPC++ 5004 which may be DPC++ code that, as generated by DPC++ compatibility tool 5002, cannot be compiled by DPC++ compiler and requires additional plumbing for verifying portions of code that were not migrated correctly, and may involve manual intervention, such as by a developer. In at least one embodiment, DPC++ compatibility tool 5002 provides hints or tools embedded in code to help developers manually migrate additional code that could not be migrated automatically. In at least one embodiment, migration is a one-time activity for a source file, project, or application.

In at least one embodiment, DPC++ compatibility tool 50002 is able to successfully migrate all portions of CUDA code to DPC++ and there may simply be an optional step for manually verifying and tuning performance of DPC++ source code that was generated. In at least one embodiment, DPC++ compatibility tool 5002 directly generates DPC++ source code 5008 which is compiled by a DPC++ compiler without requiring or utilizing human intervention to modify DPC++ code generated by DPC++ compatibility tool 5002. In at least one embodiment, DPC++ compatibility tool generates compile-able DPC++ code which can be optionally tuned by a developer for performance, readability, maintainability, other various considerations; or any combination thereof.

In at least one embodiment, one or more CUDA source files are migrated to DPC++ source files at least partially using DPC++ compatibility tool 5002. In at least one embodiment, CUDA source code includes one or more header files which may include CUDA header files. In at least one embodiment, a CUDA source file includes a <cuda.h> header file and a <stdio.h> header file which can be used to print text. In at least one embodiment, a portion of a vector addition kernel CUDA source file may be written as or related to:

```
#include <cuda.h>
#include <stdio.h>
#define VECTOR_SIZE 256
[ ] global_ void VectorAddKernel(float* A, float* B, float* C)
{
  A[threadIdx.x] = threadIdx.x + 1.0f;
  B[threadIdx.x] = threadIdx.x + 1.0f;
  C[threadIdx.x] = A[threadIdx.x] + B[threadIdx.x];
}
int main( )
{
  float *d_A, *d_B, *d_C;
  cudaMalloc(&d_A, VECTOR_SIZE*sizeof(float));
  cudaMalloc(&d_B, VECTOR_SIZE*sizeof(float));
  cudaMalloc(&d_C, VECTOR_SIZE*sizeof(float));
  VectorAddKernel<<<1, VECTOR_SIZE>>>(d_A, d_B, d_C);
  float Result[VECTOR_SIZE] = { };
  cudaMemcpy(Result, d_C, VECTOR_SIZE*sizeof(float),
cudaMemcpyDeviceToHost);
  cudaFree(d_A);
  cudaFree(d_B);
  cudaFree(d_C);
  for (int i=0; i<VECTOR_SIZE; i++ {
    if (i % 16 == 0) {
      printf(“\n”);
    }
    printf(“%f ”, Result[i]);
  }
  return 0;
}
```

In at least one embodiment and in connection with CUDA source file presented above, DPC++ compatibility tool 5002 parses a CUDA source code and replaces header files with appropriate DPC++ and SYCL header files. In at least one embodiment, DPC++ header files includes helper declarations. In CUDA, there is a concept of a thread ID and correspondingly, in DPC++ or SYCL, for each element there is a local identifier.

In at least one embodiment and in connection with CUDA source file presented above, there are two vectors A and B which are initialized and a vector addition result is put into vector C as part of VectorAddKernel( ). In at least one embodiment, DPC++ compatibility tool 5002 converts CUDA thread IDs used to index work elements to SYCL standard addressing for work elements via a local ID as part of migrating CUDA code to DPC++ code. In at least one embodiment, DPC++ code generated by DPC++ compatibility tool 5002 can be optimized—for example, by reducing dimensionality of an nd_item, thereby increasing memory and/or processor utilization.

In at least one embodiment and in connection with CUDA source file presented above, memory allocation is migrated. In at least one embodiment, cudaMalloc( ) is migrated to a unified shared memory SYCL call malloc_device( ) to which a device and context is passed, relying on SYCL concepts such as platform, device, context, and queue. In at least one embodiment, a SYCL platform can have multiple devices (e.g., host and GPU devices); a device may have multiple queues to which jobs can be submitted; each device may have a context; and a context may have multiple devices and manage shared memory objects.

In at least one embodiment and in connection with CUDA source file presented above, a main( ) function invokes or calls VectorAddKernel( ) to add two vectors A and B together and store result in vector C. In at least one embodiment, CUDA code to invoke VectorAddKernel( ) is replaced by DPC++ code to submit a kernel to a command queue for execution. In at least one embodiment, a command group handler cgh passes data, synchronization, and computation that is submitted to the queue, parallel_for is called for a number of global elements and a number of work items in that work group where VectorAddKernel( ) is called.

In at least one embodiment and in connection with CUDA source file presented above, CUDA calls to copy device memory and then free memory for vectors A, B, and C are migrated to corresponding DPC++ calls. In at least one embodiment, C++ code (e.g., standard ISO C++ code for printing a vector of floating point variables) is migrated as is, without being modified by DPC++ compatibility tool 5002. In at least one embodiment, DPC++ compatibility tool 5002 modify CUDA APIs for memory setup and/or host calls to execute kernel on the acceleration device. In at least one embodiment and in connection with CUDA source file presented above, a corresponding human readable DPC++ 5004 (e.g., which can be compiled) is written as or related to:

```
#include <CL/sycl.hpp>
#include <dpct/dpct.hpp>
#define VECTOR_SIZE 256
void VectorAddKernel(float* A, float* B, float* C,
          sycl::nd_item<3> item_ct1)
{
  A[item_ct1.get_local_id(2)] = item_ct1.get_local_id(2) + 1.0f;
  B[item_ct1.get_local_id(2)] = item_ct1.get_local_id(2) + 1.0f;
  C[item_ct1.get_local_id(2)] =
      A[item_ct1.get_local_id(2)] + B[item_ct1.get_local_id(2)];
}
int main( )
{
  float *d_A, *d_B, *d_C;
  d_A = (float *)sycl::malloc_device(VECTOR_SIZE * sizeof(float),
    dpct::get_current_device( ),
    dpct::get_default_context( ));
  d_B = (float *)sycl::malloc_device(VECTOR_SIZE * sizeof(float),
    dpct::get_current_device( ),
    dpct::get_default_context( ));
  d_C = (float *)sycl::malloc_device(VECTOR_SIZE * sizeof(float),
    dpct::get_current_device( ),
    dpct::get_default_context( ));
  dpct::get_default_queue_wait( ).submit([&](sycl::handler &cgh) {
    cgh.parallel_for(
      sycl::nd_range<3>(sycl::range<3>(1, 1, 1) *
            sycl::range<3>(1, 1, VECTOR_SIZE) *
            sycl::range<3>(1, 1, VECTOR_SIZE)),
      [=](sycl::nd_items<3> item_ct1) {
        VectorAddKernel(d_A, d_B, d_C, item_ct1);
      });
  });
  float Result[VECTOR_SIZE] = { };
  dpct::get_default_queue_wait( )
    .memcpy(Result, d_C, VECTOR_SIZE * sizeof(float))
    .wait( );
  sycl::free(d_A, dpct::get_default_context( ));
  sycl::free(d_B, dpct::get_default_context( ));
  sycl::free(d_C, dpct::get_default_context( ));
  for (int i=0; i<VECTOR_SIZE; i++ {
    if (i % 16 == 0) {
        printf(“\n”);
    }
    printf(“%f ”, Result[i]);
  }
  return 0;
}
```

In at least one embodiment, human readable DPC++ 5004 refers to output generated by DPC++ compatibility tool 5002 and may be optimized in one manner or another. In at least one embodiment, human readable DPC++ 5004 generated by DPC++ compatibility tool 5002 can be manually edited by a developer after migration to make it more maintainable, performance, or other considerations. In at least one embodiment, DPC++ code generated by DPC++ compatibility tool 50002 such as DPC++ disclosed can be optimized by removing repeat calls to get_current_device( ) and/or get_default_context( ) for each malloc_device( ) call. In at least one embodiment, DPC++ code generated above uses a 3 dimensional nd_range which can be refactored to use only a single dimension, thereby reducing memory usage. In at least one embodiment, a developer can manually edit DPC++ code generated by DPC++ compatibility tool 5002 replace uses of unified shared memory with accessors. In at least one embodiment, DPC++ compatibility tool 5002 has an option to change how it migrates CUDA code to DPC++ code. In at least one embodiment, DPC++ compatibility tool 5002 is verbose because it is using a general template to migrate CUDA code to DPC++ code that works for a large number of cases.

In at least one embodiment, a CUDA to DPC++ migration workflow includes steps to: prepare for migration using intercept-build script; perform migration of CUDA projects to DPC++ using DPC++ compatibility tool 5002; review and edit migrated source files manually for completion and correctness; and compile final DPC++ code to generate a DPC++ application. In at least one embodiment, manual review of DPC++ source code may be required in one or more scenarios including but not limited to: migrated API does not return error code (CUDA code can return an error code which can then be consumed by the application but SYCL uses exceptions to report errors, and therefore does not use error codes to surface errors); CUDA compute capability dependent logic is not supported by DPC++; statement could not be removed. In at least one embodiment, scenarios in which DPC++ code requires manual intervention may include, without limitation: error code logic replaced with (*,0) code or commented out; equivalent DPC++ API not available; CUDA compute capability-dependent logic; hardware-dependent API (clock( )); missing features unsupported API; execution time measurement logic; handling built-in vector type conflicts; migration of cuBLAS API; and more.

In at least one embodiment, one or more techniques described herein utilize a oneAPI programming model. In at least one embodiment, a oneAPI programming model refers to a programming model for interacting with various compute accelerator architectures. In at least one embodiment, oneAPI refers to an application programming interface (API) designed to interact with various compute accelerator architectures. In at least one embodiment, a oneAPI programming model utilizes a DPC++ programming language. In at least one embodiment, a DPC++ programming language refers to a high-level language for data parallel programming productivity. In at least one embodiment, a DPC++ programming language is based at least in part on C and/or C++ programming languages. In at least one embodiment, a oneAPI programming model is a programming model such as those developed by Intel Corporation of Santa Clara, CA.

In at least one embodiment, oneAPI and/or oneAPI programming model is utilized to interact with various accelerator, GPU, processor, and/or variations thereof, architectures. In at least one embodiment, oneAPI includes a set of libraries that implement various functionalities. In at least one embodiment, oneAPI includes at least a oneAPI DPC++ library, a oneAPI math kernel library, a oneAPI data analytics library, a oneAPI deep neural network library, a oneAPI collective communications library, a oneAPI threading building blocks library, a oneAPI video processing library, and/or variations thereof.

In at least one embodiment, a oneAPI DPC++ library, also referred to as oneDPL, is a library that implements algorithms and functions to accelerate DPC++ kernel programming. In at least one embodiment, oneDPL implements one or more standard template library (STL) functions. In at least one embodiment, oneDPL implements one or more parallel STL functions. In at least one embodiment, oneDPL provides a set of library classes and functions such as parallel algorithms, iterators, function object classes, range-based API, and/or variations thereof. In at least one embodiment, oneDPL implements one or more classes and/or functions of a C++ standard library. In at least one embodiment, oneDPL implements one or more random number generator functions.

In at least one embodiment, a oneAPI math kernel library, also referred to as oneMKL, is a library that implements various optimized and parallelized routines for various mathematical functions and/or operations. In at least one embodiment, oneMKL implements one or more basic linear algebra subprograms (BLAS) and/or linear algebra package (LAPACK) dense linear algebra routines. In at least one embodiment, oneMKL implements one or more sparse BLAS linear algebra routines. In at least one embodiment, oneMKL implements one or more random number generators (RNGs). In at least one embodiment, oneMKL implements one or more vector mathematics (VM) routines for mathematical operations on vectors. In at least one embodiment, oneMKL implements one or more Fast Fourier Transform (FFT) functions.

In at least one embodiment, a oneAPI data analytics library, also referred to as oneDAL, is a library that implements various data analysis applications and distributed computations. In at least one embodiment, oneDAL implements various algorithms for preprocessing, transformation, analysis, modeling, validation, and decision making for data analytics, in batch, online, and distributed processing modes of computation. In at least one embodiment, oneDAL implements various C++ and/or Java APIs and various connectors to one or more data sources. In at least one embodiment, oneDAL implements DPC++ API extensions to a traditional C++ interface and enables GPU usage for various algorithms.

In at least one embodiment, a oneAPI deep neural network library, also referred to as oneDNN, is a library that implements various deep learning functions. In at least one embodiment, oneDNN implements various neural network, machine learning, and deep learning functions, algorithms, and/or variations thereof.

In at least one embodiment, a oneAPI collective communications library, also referred to as oneCCL, is a library that implements various applications for deep learning and machine learning workloads. In at least one embodiment, oneCCL is built upon lower-level communication middleware, such as message passing interface (MPI) and libfabrics. In at least one embodiment, oneCCL enables a set of deep learning specific optimizations, such as prioritization, persistent operations, out of order executions, and/or variations thereof. In at least one embodiment, oneCCL implements various CPU and GPU functions.

In at least one embodiment, a oneAPI threading building blocks library, also referred to as oneTBB, is a library that implements various parallelized processes for various applications. In at least one embodiment, oneTBB is utilized for task-based, shared parallel programming on a host. In at least one embodiment, oneTBB implements generic parallel algorithms. In at least one embodiment, oneTBB implements concurrent containers. In at least one embodiment, oneTBB implements a scalable memory allocator. In at least one embodiment, oneTBB implements a work-stealing task scheduler. In at least one embodiment, oneTBB implements low-level synchronization primitives. In at least one embodiment, oneTBB is compiler-independent and usable on various processors, such as GPUs, PPUs, CPUs, and/or variations thereof.

In at least one embodiment, a oneAPI video processing library, also referred to as oneVPL, is a library that is utilized for accelerating video processing in one or more applications. In at least one embodiment, oneVPL implements various video decoding, encoding, and processing functions. In at least one embodiment, oneVPL implements various functions for media pipelines on CPUs, GPUs, and other accelerators. In at least one embodiment, oneVPL implements device discovery and selection in media centric and video analytics workloads. In at least one embodiment, oneVPL implements API primitives for zero-copy buffer sharing.

In at least one embodiment, a oneAPI programming model utilizes a DPC++ programming language. In at least one embodiment, a DPC++ programming language is a programming language that includes, without limitation, functionally similar versions of CUDA mechanisms to define device code and distinguish between device code and host code. In at least one embodiment, a DPC++ programming language may include a subset of functionality of a CUDA programming language. In at least one embodiment, one or more CUDA programming model operations are performed using a oneAPI programming model using a DPC++ programming language.

It should be noted that, while example embodiments described herein may relate to a CUDA programming model, techniques described herein can be utilized with any suitable programming model, such HIP, oneAPI, and/or variations thereof.

At least one embodiment of the disclosure can be described in view of the following clauses:
1. A processor comprising:
   one or more circuits to perform an application programming interface (“API”) to cause one or more memory locations to be asynchronously allocated to one or more processors.
2. The processor of clause 1, wherein one or more of the one or more processors comprises a graphics processing unit (“GPU”).
3. The processor of clause 1 or 2, wherein the one or more memory locations are to be asynchronously allocated using a virtual memory address provided in response to the API.
4. The processor of any of clauses 1-3, wherein the one or more memory locations are to be asynchronously allocated using backing memory allocated from a memory pool.
5. The processor of any of clauses 1-4, wherein the one or more memory locations are to be asynchronously allocated using backing memory allocated when a process executes on the one or more processors.
6. The processor of any of clauses 1-5, wherein the API at least indicates a location used to return an asynchronously allocated memory address, a size of memory requested, and an execution stream that indicates a stream order of operations that use the one or more memory locations.
7. The processor of any of clauses 1-6, wherein the one or more memory locations are memory locations in GPU memory.
8. The processor of any of clauses 1-7, wherein the one or more memory locations use backing memory returned to a memory pool after a previous allocation.
9. A computer-implemented method, comprising:
   performing an application programming interface (“API”) to cause one or more memory locations to be asynchronously allocated to one or more processors.
10. The computer-implemented method of clause 9, wherein one or more of the one or more processors comprises a graphics processing unit (“GPU”).
11. The computer-implemented method of clause 9 or 10, wherein one or more of the one or more processors comprises a parallel processing unit (“PPU”).
12. The computer-implemented method of any of clauses 9-11, further comprising:
   generating a virtual memory address in response to the API; and
   providing the virtual memory address to a process executing on the one or more processors.
13. The computer-implemented method of any of clauses 9-12, further comprising: creating a memory pool;
   allocating backing memory from the memory pool; and
   associating the backing memory with the one or more memory locations.
14. The computer-implemented method of any of clauses 9-13, further comprising: allocating backing memory asynchronously when a process begins execution on the one or more processors.
15. The computer-implemented method of any of clauses 9-14, further comprising: deallocating backing memory asynchronously when a process completes execution on the one or more processors.
16. The computer-implemented method of any of clauses 9-15, further comprising:
   determining, based at least in part on a stream order specified in the API, whether a set of allocated memory from a memory pool will be available when a process begins execution on the one or more processors; and
   allocating backing memory asynchronously from the set of allocated memory when the process begins execution based at least in part on the determination.
17. A computer system comprising one or more processors and memory storing executable instructions that, as a result of being executed by the one or more processors, cause the computer system to perform an application programming interface (“API”) to asynchronously allocate one or more memory locations to one or more processors.
18. The computer system of clause 17, wherein one or more of the one or more processors comprises a graphics processing unit (“GPU”).
19. The computer system of clause 17 or 18, wherein the one or more memory locations are memory locations in GPU memory.
20. The computer system of any of clauses 17-19, wherein the API indicates a stream order of one or more of the one or more executable instructions.
21. The computer system of any of clauses 17-20, wherein the API indicates a memory pool usable to asynchronously allocate the one or more memory locations.
22. The computer system of any of clauses 17-21, wherein the one or more executable instructions at least include executable instructions to execute a process on the one or more processors.
23. The computer system of any of clauses 17-22, wherein the one or more memory locations are to be asynchronously allocated using a virtual memory address.
24. The computer system of any of clauses 17-23, wherein the one or more memory locations are to be asynchronously allocated using backing memory allocated from a memory pool when a process executes on the one or more processors.
25. A machine-readable medium having stored thereon a set of instructions, which if performed by one or more processors, cause the one or more processors to perform an application programming interface (“API”) to asynchronously allocate one or more memory locations to one or more processors.
26. The machine-readable medium of clause 25, wherein one or more of the one or more processors comprises a graphics processing unit (“GPU”).
27. The machine-readable medium of clause 25 or 26, wherein the one or more memory locations are memory locations in GPU memory.
28. The machine-readable medium of any of clauses 25-27, wherein:
   the one or more memory locations are to be asynchronously allocated using a virtual memory address provided in response to the API;
   the one or more memory locations are to be asynchronously allocated using backing memory allocated from a memory pool; and the virtual memory address is associated with the backing memory.
29. The machine-readable medium of any of clauses 25-28, the API at least indicates a location used to return an asynchronously allocated memory address, a size of memory requested, and an execution stream that indicates a stream order of operations that use the one or more memory locations.
30. The machine-readable medium of any of clauses 25-29, wherein the one or more memory locations are determined, based at least in part on, a stream execution order indicated by the API.
31. The machine-readable medium of any of clauses 25-31, wherein the one or more memory locations are determined, based at least in part on, one or more synchronization events between a plurality of processes executing on the one or more processors.
32. The machine-readable medium of any of clauses 25-31, wherein:
   the one or more memory locations are to be asynchronously allocated to the one or more processors before a process executes on the one or more processors; and
   the one or more memory locations are to be asynchronously deallocated from the one or more processors after a process executes on the one or more processors.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). A number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (e.g., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

In present document, references may be made to obtaining, acquiring, receiving, or inputting analog or digital data into a subsystem, computer system, or computer-implemented machine. Process of obtaining, acquiring, receiving, or inputting analog and digital data can be accomplished in a variety of ways such as by receiving data as a parameter of a function call or a call to an application programming interface. In some implementations, process of obtaining, acquiring, receiving, or inputting analog or digital data can be accomplished by transferring data via a serial or parallel interface. In another implementation, process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data can be accomplished by transferring data as an input or output parameter of a function call, a parameter of an application programming interface or interprocess communication mechanism.

Although discussion above sets forth example implementations of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. An acceleration processor unit (APU) comprising:
one or more core complexes, wherein the one or more core complexes include one or more central processing unit (CPU) cores;
one or more graphics complexes, wherein the one or more graphics complexes include one or more compute units (CUs);
an L2 cache;
one or more fabric interconnects;
a memory controller; and
one or more input/output (I/O) bus interfaces;
at least one comprising a peripheral component interconnect express (PCIe) interface;
wherein:
the APU is to perform a runtime application program interface (API) to cause one or more memory locations to be asynchronously allocated, in which the API is to indicate:
a location to return an asynchronously allocated memory;
a size of memory requested;
a stream to indicate a stream order; and
a memory pool from which to asynchronously allocate memory.

2. The APU of claim 1, wherein the API is further to indicate one or more locations to return one or more asynchronously allocated memories.

3. The APU of claim 1, wherein the API is to cause one or more virtual memory addresses to be associated with the one or more asynchronously allocated memory locations.

4. The APU of claim 1, wherein the API is a driver API.

5. The APU of claim 1, wherein the one or more CUs are to share the L2 cache.

6. The APU of claim 1, wherein the API is to cause the one or more memory locations to be asynchronously allocated from the memory pool.

7. The APU of claim 1, wherein the stream order is a stream order of operations that use the one or more memory locations.

8. A system comprising:
memory; and
an acceleration processor unit (APU) comprising:
one or more core complexes, wherein the one or more core complexes include one or more central processing unit (CPU) cores;
one or more graphics complexes, wherein the one or more graphics complexes include one or more compute units (CUs);
an L2 cache;
one or more fabric interconnects;
a memory controller; and
one or more input/output (I/O) bus interfaces;
at least one comprising a peripheral component interconnect express (PCIe) interface;
wherein:
the APU is to perform a runtime application program interface (API) to cause one or more memory locations to be asynchronously allocated, in which the API is to indicate:
a location to return an asynchronously allocated memory;
a size of memory requested;
a stream to indicate a stream order; and
a memory pool from which to asynchronously allocate memory.

9. The system of claim 8, wherein the API is further to indicate one or more locations to return one or more asynchronously allocated memories.

10. The system of claim 8, wherein the API is to cause one or more virtual memory addresses to be associated with the one or more asynchronously allocated memory locations.

11. The system of claim 8, wherein the API is a driver API.

12. The system of claim 8, wherein the one or more CUs are to share the L2 cache.

13. The system of claim 8, wherein the API is to cause the one or more memory locations to be asynchronously allocated from the memory pool.

14. The system of claim 8, wherein the stream order is a stream order of operations that use the one or more memory locations.

15. A method comprising:
performing a runtime application program interface (API) to cause one or more memory locations to be asynchronously allocated, in which the API is to indicate:
a location to return an asynchronously allocated memory;
a size of memory requested;
a stream to indicate a stream order; and
a memory pool from which to asynchronously allocate memory;
wherein the API is to be performed by an acceleration processor unit (APU) comprising:
one or more core complexes, wherein the one or more core complexes include one or more central processing unit (CPU) cores;
one or more graphics complexes, wherein the one or more graphics complexes include one or more compute units (CUs);
an L2 cache;
one or more fabric interconnects;
a memory controller; and
one or more input/output (I/O) bus interfaces;
at least one comprising a peripheral component interconnect express (PCIe) interface.

16. The method of claim 15, wherein the API is further to indicate one or more locations to return one or more asynchronously allocated memories.

17. The method of claim 15, wherein the API is to cause one or more virtual memory addresses to be associated with the one or more asynchronously allocated memory locations.

18. The method of claim 15, wherein the API is a driver API.

19. The method of claim 15, wherein the API is to cause the one or more memory locations to be asynchronously allocated from the memory pool.

20. The method of claim 15, wherein the stream order is a stream order of operations that use the one or more memory locations.
